(19) United States
(12) Patent Application Publication
(10) Pub. No.: US 2010/0099692 A1
(43) Pub. Date: Apr. 22, 2010

(54) HARMFUL ORGANISM CONTROL COMPOSITION

(76) Inventors: Katsuya Natsuhara, Osaka (JP); Shinya Nishimura, Osaka (JP)

Correspondence Address: BIRCH STEWART KOLASCH & BIRCH, PO BOX 747, FALLS CHURCH, VA, 22040-0747, US

(21) Appl. No.: 12/595,809

(22) PCT Filed: Apr. 11, 2008
(86) PCT No.: PCT/JP2008/057189

§ 371 Date: Oct. 13, 2009

(30) Foreign Application Priority Data
Apr. 13, 2007 (JP) 2007 105832

(51) Int. Cl. A01N 43/54; A01P 15/00

(52) U.S. Cl. 514/269

(57) ABSTRACT

This invention provides a harmful organism control composition having an excellent harmful organism control effect and comprising as an effective ingredient the following 4-(2-butynyloxy)-5-fluoro-6-(3,5-dimethylpiperidino)-pyrimidine (X):

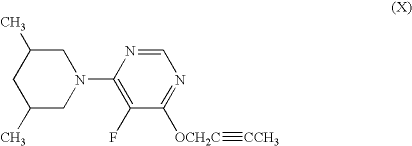

and a hydrazide compound represented by formula (I):

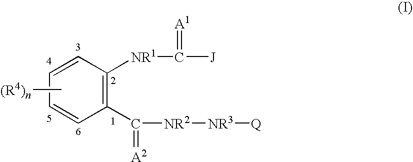

wherein A¹ and A² represent, for example, an oxygen atom; R¹, R², and R³ represent, for example, a hydrogen atom, a C₁₋₆ alkyl group optionally substituted by a halogen atom; and Q represents, for example, a methoxycarbonyl group.

### TECHNICAL FIELD

The present invention relates to a pest controlling composition (harmful organism control composition).

### BACKGROUND ART

Many compounds for controlling pests have been conventionally developed and put into practice. However, in some cases, these compounds do not necessarily have sufficient efficacy in pest control. Therefore, development of a pest controlling composition having an excellent efficacy in pest control has been desired. Patent Literature 1: JP-A 2005-350353

### DISCLOSURE OF INVENTION

### Technical Problem

It is to provide a pest controlling composition having an excellent efficacy in pest control.

### Solution to Problem

The present invention is to solve the above-described problem and provides a pest controlling composition (hereinafter, also referred to as “the composition of the present invention”) which comprises, as active ingredients, a pyrimidine compound represented by the formula (X):

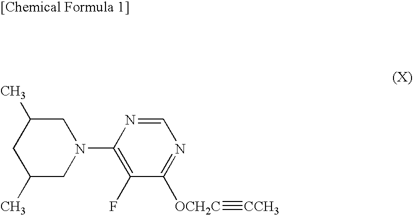

(hereinafter, also referred to as “the compound X”) and a hydrazide compound represented by the formula (I):

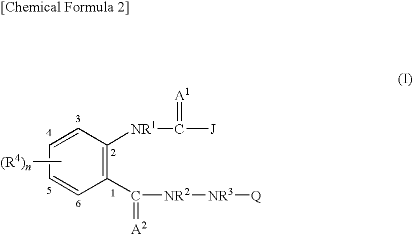

wherein

R¹ represents a hydrogen atom, an optionally halogenated C1-C6 alkyl group, a C2-C6 cyanoalkyl group, an optionally halogenated C2-C6 alkoxyalkyl group, an optionally halogenated C2-C6 alkenyl group, an optionally halogenated C3-C6 alkynyl group, or a C7-C9 phenylalkyl group in which the benzene ring moiety may be substituted with the following substituent A;

R² and R³ independently represent a hydrogen atom, a C1-C6 alkyl group optionally substituted with the following substituent D, an optionally halogenated C3-C6 alkenyl group, an optionally halogenated C3-C6 alkynyl group, a formyl group, a C2-C6 alkylcarbonyl group, a C2-C6 alkoxycarbonyl group, a C3-C7 N,N-dialkylcarbamoyl group, or a phenyl group optionally substituted with the following substituent C, or

R² and R³ may be taken together with two nitrogen atoms to which they are attached to form a 5- to 8-membered nonaromatic heterocyclic group optionally substituted with the following substituent E;

R⁴ represents a halogen atom, a cyano group, a nitro group, an optionally halogenated C1-C6 alkyl group, an optionally halogenated C1-C6 alkoxy group, an optionally halogenated phenyl group, an optionally halogenated C1-C6 alkylthio group, an optionally halogenated C1-C6 alkylsulfinyl group, or an optionally halogenated C1-C6 alkylsulfonyl group, or

two R⁴ groups which respectively form a bond to one of carbon atoms adjacent to each other may bond to one another at their terminals to form —CR⁴¹═CR⁴²—CR⁴³═CR⁴⁴— or —(CR⁴⁵R⁴⁶)ₕ— (wherein R⁴¹, R⁴², R⁴³ and R⁴⁴ independently represent a hydrogen atom, a halogen atom, a cyano group, a nitro group, an optionally halogenated C1-C6 alkyl group, an optionally halogenated C1-C6 alkoxy group, an optionally halogenated C1-C6 alkylthio group, an optionally halogenated C1-C6 alkylsulfinyl group, or an optionally halogenated C1-C6 alkylsufonyl group;

R⁴⁵ and R⁴⁶ independently represent a hydrogen atom, or an optionally halogenated C1-C6 alkyl group,

h represents an integer of 3 or 4);

n represents an integer of 0 to 4 (wherein, when n is an integer of 2 or more, R⁴'s may be the same or different);
Q represents any one of Q1 to Q6

[Chemical Formula 3]

Q1: —C(=A³¹)-R⁵

Q2: —C(=A³²)-OR⁶

Q3: —C(=A³³)-SR⁷

Q4: —C(=A³⁴)-NR⁸R⁹

Q5: —S(O)₂—R¹⁰

Q6: —S(O)₂—NR¹¹R¹²;

A³¹, A³², A³³ and A³⁴ represent an oxygen atom or a sulfur atom;

R⁵ represents a hydrogen atom, an optionally halogenated C2-C6 alkenyl group, an optionally halogenated C2-C6 alkynyl group, a C1-C6 alkyl group optionally substituted with the following substituent F, a C3-C6 cycloalkyl group optionally substituted with the following substituent B, a phenyl group optionally substituted with the following substituent G, a naphthyl group optionally substituted with the following substituent A, a 5- to 6-membered heteroaryl group optionally substituted with the following substituent A, a 3- to 8-membered nonaromatic heterocyclic group optionally substituted with the following substituent B, a C7-C9 phenylalkyl group in which the benzene ring moiety may be substituted with the following substituent A, or a C7-C9 phenoxyalkyl group in which the benzene ring moiety may be substituted with the following substituent A;

R⁶ and R⁷ represent an optionally halogenated C1-C6 alkyl group, an optionally halogenated C3-C6 alkoxyalkyl group, an optionally halogenated C2-C6 alkenyl group, an optionally halogenated C3-C6 alkynyl group, a C3-C6 cycloalkyl group optionally substituted with the following substituent B, a phenyl group optionally substituted with the following substituent G, a 5- to 6-membered heteroaryl group optionally substituted with the following substituent A, or a C7-C9 phenylalkyl group in which the benzene ring moiety may be substituted with the following substituent A;

R⁸ and R⁹ independently represent a hydrogen atom, an optionally halogenated C1-C6 alkyl group, an optionally halogenated C2-C6 alkoxyalkyl group, an optionally halogenated C2-C6 alkenyl group, an optionally halogenated C3-C6 alkynyl group, a C3-C6 cycloalkyl group optionally substituted with the following substituent B, a phenyl group optionally substituted with the following substituent G, a 5- to 6-membered heteroaryl group optionally substituted with the following substituent A, or a C7-C9 phenylalkyl group in which the benzene ring moiety may be substituted with the following substituent A;

R¹⁰ represents an optionally halogenated C1-C6 alkyl group, or a phenyl group optionally substituted with the following substituent A;

R¹¹ and R¹² independently represent an optionally halogenated C1-C6 alkyl group, a C3-C6 cycloalkyl group optionally substituted with the following substituent B, or a phenyl group optionally substituted with the following substituent A, or

R¹¹ and R¹² may be taken together with the nitrogen atom to which they are attached to form a 3- to 8-membered nonaromatic heterocyclic group optionally substituted with the following substituent E;

J represents J1 or J2,

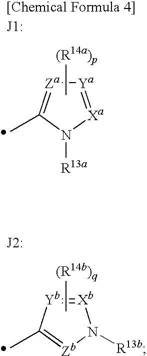

X^{a}, Y^{a}, Z^{a}, X^{b}, Y^{b} and Z^{b} independently represent CH or a nitrogen atom;

R^{13a} and R^{13b} represent an optionally halogenated C1-C6 alkyl group, a C2-C6 cyanoalkyl group, an optionally halogenated C2-C6 alkoxyalkyl group, an optionally halogenated C2-C6 alkenyl group, an optionally halogenated C2-C6 alkynyl group, a C3-C6 cycloalkyl group optionally substituted with the following substituent B, a phenyl group optionally substituted with the following substituent H, a 5- to 6-membered heteroaryl group optionally substituted with the following substituent A, a C7-C9 phenylalkyl group in which the benzene ring moiety may be substituted with the following substituent A, or a C7-C9 pyridinylalkyl group in which the pyridine ring moiety may be substituted with the following substituent A;

R^{14a} and R^{14b} represent a halogen atom, a cyano group, a nitro group, an isocyanato group, an optionally halogenated C1-C6 alkyl group, an optionally halogenated C1-C6 alkoxy group, a C2-C6 cyanoalkyloxy group, an optionally halogenated C3-C6 alkoxyalkyloxy group, an optionally halogenated C3-C6 alkenyloxy group, an optionally halogenated C3-C6 alkynyloxy group, an optionally halogenated C1-C6 alkylthio group, an optionally halogenated C1-C6 alkylsulfinyl group, an optionally halogenated C1-C6 alkylsulfonyl group, a phenyl group optionally substituted with the following substituent A, a 5- to 6-membered heteroaryl group optionally substituted with the following substituent A, or a phenoxy group optionally substituted with the following substituent A;

p represents an integer of 0 to 3;

q represents an integer of 0 to 3

(wherein, when p is an integer of 2 or 3, two or more R^{14a}'s may be the same or different and, when q is an integer of 2 or 3, two or more R^{14b}'s may be the same or different); and

A¹ and A² independently represent an oxygen atom or a sulfur atom;

wherein,

the substituent A is a substituent selected from the group consisting of (1) a halogen atom, (2) a cyano group, (3) a nitro group, (4) an optionally halogenated C1-C6 alkyl group, and (5) an optionally halogenated C1-C6 alkoxy group;

the substituent B is a substituent selected from the group consisting of (1) a halogen atom and (2) an optionally halogenated C1-C6 alkyl group;

the substituent C is a substituent selected from the group consisting of (1) a halogen atom, (2) a cyano group, (3) a nitro group and (4) an optionally halogenated C1-C6 alkyl group;

the substituent D is a substituent selected from the group consisting of (1) a halogen atom, (2) a cyano group, (3) a nitro group, (4) an optionally halogenated C1-C6 alkoxy group, (5) a formyl group, (6) a C2-C6 alkylcarbonyl group, (7) a C2-C6 alkoxycarbonyl group and (8) a C3-C7 N,N-dialkylcarbamoyl group;

the substituent E is a substituent selected from the group consisting of (1) a halogen atom, (2) an optionally halogenated C1-C6 alkyl group and (3) an optionally halogenated C2-C6 alkoxycarbonyl group;

the substituent F is a substituent selected from the group consisting of (1) a halogen atom, (2) a C1-C6 alkoxy group, (3) a C1-C6 alkylthio group, (4) a C1-C6 alkylsulfinyl group, (5) a C1-C6 alkylsulfonyl group, (6) a C2-C6 dialkylamino group and (7) a C3-C6 cycloalkyl group;

the substituent G is a substituent selected from the group consisting of (1) a halogen atom, (2) a cyano group, (3) a nitro group, (4) an optionally halogenated C1-C6 alkyl group, (5) an optionally halogenated C1-C6 alkoxy group, (6) an optionally halogenated C1-C6 alkylthio group, (7) an optionally halogenated C1-C6 alkylsulfinyl group, (8) an optionally halogenated C1-C6 alkylsulfonyl group, (9) an optionally halogenated C2-C6 dialkylamino group and (10) an optionally halogenated C2-C6 alkoxycarbonyl group; and

the substituent H is a substituent selected from the group consisting of (1) a halogen atom, (2) a cyano group, (3) a nitro group, (4) an optionally halogenated C1-C6 alkyl group, (5) an optionally halogenated C1-C6 alkoxy group, (6) an optionally halogenated C1-C6 alkylthio group, (7) an optionally halogenated C1-C6 alkylsulfinyl group and (8) an optionally halogenated C1-C6 alkylsulfonyl group; (hereinafter, also referred to as “the compound I”).

### Effect of the invention

According to the present invention, a pest controlling composition and the like having an excellent efficacy in pest control can be provided.

### BEST MODE FOR CARRYING OUT THE INVENTION

First, the compound X will be explained.

The compound X, that is, 4-(2-butynyloxy)-5-fluoro-6-(3,5-dimethylpiperidino)pyrimidine is a known compound described in JP-A 2005-350353, and can be produced by a method described in the gazette.

Then, the compound I will be explained.

The compound I can be produced, for example, by the following Production Method A-1 to Production Method C-1.

### (Production Method A-1)

Among the compound I, a compound represented by the formula (1-i):

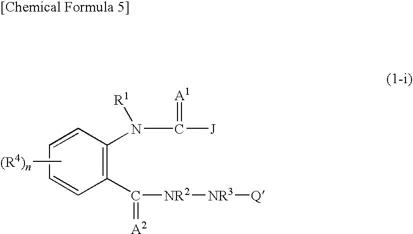

wherein R¹, R², R³, R⁴, A¹, A², J and n are as defined above, and Q′ represents any one selected from the group consisting of Q1 to Q6, provided that, the case where Q′ is Q4 and R⁸ and R⁹ are a hydrogen atom is excluded (hereinafter, referred to as “the compound (1-i)”) can be produced by reacting a compound represented by the formula (2):

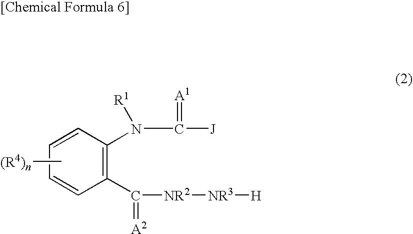

wherein R¹, R², R³, R⁴, A¹, A², J and n are as defined above (hereinafter, referred to as “the compound (2)”) with a compound represented by the formula (3):

[Chemical Formula 7]

L¹-Q′ (3)

wherein Q′ is as defined above, and L¹ represents a hydrogen atom or a Q′-O-group, provided that the case where Q′ is Q4 and R⁸ and R⁹ are a hydrogen atom is excluded (hereinafter, referred to as “the compound (3)”).

The reaction is carried out in the presence or the absence of a solvent. Examples of the solvent used in the reaction include ethers such as 1,4-dioxane, diethyl ether, tetrahydrofuran, and methyl tert-butyl ether; halogenated hydrocarbons such as dichloromethane, chloroform, carbon tetrachloride, 1,2-dichloroethane, and chlorobenzene; hydrocarbons such as toluene, benzene, and xylene; nitriles such as acetonitrile; aprotic polar solvents such as N,N-dimethylformamide, N-methylpyrrolidone, 1,3-dimethyl-2-imidazolidinone, and dimethyl sulfoxide, and their mixtures.

The amount of the compound (3) used in the reaction is usually 1 to 2 mol per 1 mol of the compound (2).

The reaction is carried out in the presence of a base, if necessary. Examples of the base used when the reaction is carried out in the presence of the base include nitrogen-containing heterocyclic compounds such as pyridine, picoline, 2,6-lutidine, 1,8-diazabicyclo[5,4,0]7-undecene (DBU), and 1,5-diazabicyclo[4,3,0]5-nonene (DBN); tertiary amines such as triethylamine, and N,N-diisopropylethylamine; and inorganic bases such as potassium carbonate, and sodium hydride. The amount of the base used when the reaction is carried out in the presence of the base is usually 1 to 2 mol per 1 mol of the compound (2). If the base used is in the liquid form under reaction conditions, such as pyridine, the base may be used in a solvent amount.

The reaction temperature of the reaction is usually from 0 to 100° C., and the reaction time is usually from 0.1 to 24 hours.

After completion of the reaction, the compound (1-i) can be isolated by pouring the reaction mixture into water and extracting the mixture with an organic solvent, or collecting a formed precipitate by filtration. The isolated compound (1-i) may be further purified by recrystallization, chromatography or the like.

### (Production Method A-2)

Among the compound I, a compound represented by the formula (1-ii):

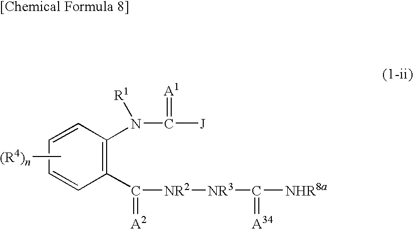

wherein R¹, R², R³, R⁴, A¹, A², A³⁴, J and n are as defined above, and R^{8a} represents an optionally halogenated C1-C6 alkyl group, an optionally halogenated C2-C6 alkoxyalkyl group, an optionally halogenated C2-C6 alkenyl group, an optionally halogenated C3-C6 alkynyl group, a C3-C6 cycloalkyl group optionally substituted with a substituent B, a phenyl group optionally substituted with a substituent G, a 5- to 6-membered heteroaryl group optionally substituted with a substituent A, or a C7-C9 phenylalkyl group in which the benzene ring moiety may be substituted with a substituent A (hereinafter, referred to as “the compound (1-ii)”) can be produced by reacting the compound (2) with a compound represented by the formula (4):

[Chemical Formula 9]

A³⁴=C═N—R^{8a} (4)

wherein A³⁴ and R^{8a} are as defined above (hereinafter, referred to as “the compound (4)”).

The reaction is carried out in the presence or the absence of a solvent. Examples of the solvent used in the reaction include ethers such as 1,4-dioxane, diethyl ether, tetrahydrofuran, and methyl tert-butyl ether; halogenated hydrocarbons such as dichloromethane, chloroform, carbon tetrachloride, 1,2-dichloroethane, and chlorobenzene; hydrocarbons such as toluene, benzene, and xylene; nitriles such as acetonitrile; aprotic polar solvents such as N,N-dimethylformamide, N-methylpyrrolidone, 1,3-dimethyl-2-imidazolidinone, and dimethyl sulfoxide, and their mixtures.

The amount of the compound (4) used in the reaction is usually 1 to 2 mol per on 1 mol of the compound (2).

The reaction temperature of the reaction is usually from 0 to 100° C., and the reaction time is usually from 0.1 to 24 hours.

After completion of the reaction, the compound (1-ii) can be isolated by pouring the reaction mixture into water and extracting the mixture with an organic solvent, or collecting a formed precipitate by filtration. The isolated compound (1-ii) may be further purified by recrystallization, chromatography or the like.

### (Production Method A-3)

Among the compound I, a compound represented by the formula (1-iii):

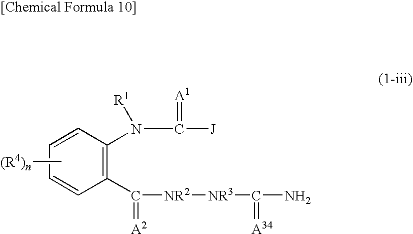

wherein R¹, R², R³, R⁴, A¹, A², A³⁴, J and n are as defined above (hereinafter, referred to as “the compound (1-iii)”) can be produced by reacting the compound (2) with cyanate or thiocyanate.

The reaction is carried out in the presence of a solvent. Examples of the solvent used in the reaction include organic acids such as acetic acid, and mineral acids such as hydrochloric acid, and mixtures of these acids with water, chloroform or the like.

The amount of cyanate or thiocyanate used in the reaction is usually 1 to 2 mol per 1 mol of the compound (2).

The reaction temperature of the reaction is usually from 0 to 100° C., and the reaction time is usually from 0.1 to 24 hours.

Examples of the cyanate or the thiocyanate include potassium cyanate, sodium cyanate, ammonium cyanate, potassium thiocyanate, sodium thiocyanate, and ammonium thiocyanate.

After completion of the reaction, the compound (1-iii) can be isolated by pouring the reaction mixture into water and extracting the mixture with an organic solvent, or collecting a formed precipitate by filtration. The isolated compound (1-iii) may be further purified by recrystallization, chromatography or the like.

### (Production Method B-1)

The compound I can be produced by reacting a compound represented by the formula (6):

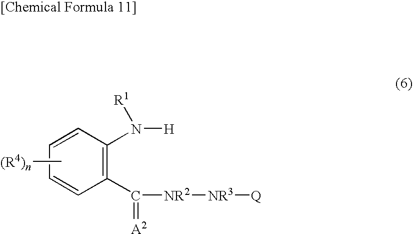

wherein R¹, R², R³, R⁴, A², Q and n are as defined above (hereinafter, referred to as “the compound (6)”) with a compound represented by the formula (7):

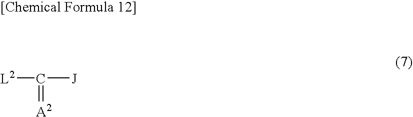

wherein A¹ and J are as defined above, and L² represents a halogen atom (hereinafter, referred to as “the compound (7)”).

The reaction is carried out in the presence or the absence of a solvent. Examples of the solvent used in the reaction include ethers such as 1,4-dioxane, diethyl ether, tetrahydrofuran, and methyl tert-butyl ether; halogenated hydrocarbons such as dichloromethane, chloroform, carbon tetrachloride, 1,2-dichloroethane, and chlorobenzene; hydrocarbons such as toluene, benzene, and xylene; nitriles such as acetonitrile; aprotic polar solvents such as N,N-dimethylformamide, N-methylpyrrolidone, 1,3-dimethyl-2-imidazolidinone, and dimethyl sulfoxide, and their mixtures.

The amount of the compound (7) used in the reaction is usually 1 to 2 mol per 1 mol of the compound (6).

The reaction is carried out in the presence of a base, if necessary. Examples of the base used when the reaction is carried out in the presence of the base include nitrogen-containing heterocyclic compounds such as pyridine, picoline, 2,6-lutidine, 1,8-diazabicyclo[5,4,0]7-undecene (DBU), and 1,5-diazabicyclo[4,3,0]5-nonene (DBN); tertiary amines such as triethylamine, and N,N-diisopropylethylamine; and inorganic bases such as potassium carbonate, and sodium hydride. The amount of the base used when the reaction is carried out in the presence of the base is usually 1 to 2 mol per 1 mol of the compound (6). If the base used is in the liquid form under reaction conditions, such as pyridine, the base may be used in a solvent amount.

The reaction temperature of the reaction is usually from 0 to 100° C., and the reaction time is usually from 0.1 to 24 hours.

After completion of the reaction, the compound I can be isolated by pouring the reaction mixture into water and extracting the mixture with an organic solvent, or collecting a formed precipitate by filtration. The isolated compound I may be further purified by recrystallization, chromatography or the like.

### (Production Method B-2)

Among the compound I, a compound represented by the formula (1-iv):

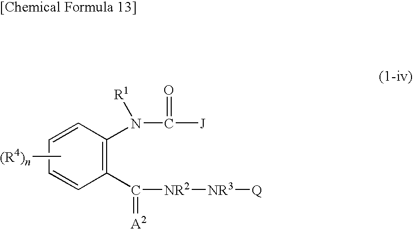

wherein R¹, R², R³, R⁴, A², J, Q and n are as defined above (hereinafter, referred to as “the compound (1-iv)”) can be produced by reacting the compound (6) with a compound represented by the formula (8):

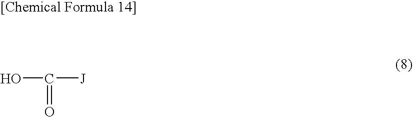

wherein J is as defined above (hereinafter, referred to as “the compound (8)”) in the presence of a dehydrating agent.

The reaction is carried out in the presence or the absence of a solvent. Examples of the solvent used in the reaction include ethers such as 1,4-dioxane, diethyl ether, tetrahydrofuran, and methyl tert-butyl ether; halogenated hydrocarbons such as dichloromethane, chloroform, carbon tetrachloride, 1,2-dichloroethane, and chlorobenzene; hydrocarbons such as toluene, benzene, and xylene; nitriles such as acetonitrile; aprotic polar solvents such as N,N-dimethylformamide, N-methylpyrrolidone, 1,3-dimethyl-2-imidazolidinone, and dimethyl sulfoxide, and their mixtures.

The amount of the compound (8) used in the reaction is usually 1 to 2 mol per 1 mol of the compound (6).

Examples of the dehydrating agent used in the reaction include carbodiimide such as dicyclohexylcarbodiimide (DCC), and 1-ethyl-3-(3-dimethylaminopropyl)carbodiimide hydrochloride (WSC). The amount of the dehydrating agent used is usually from 1 to 2 mol per 1 mol of the compound (6).

The reaction temperature of the reaction is usually from 0 to 100° C., and the reaction time is usually from 0.1 to 24 hours.

After completion of the reaction, the compound (1-iv) can be isolated by pouring the reaction mixture into water and extracting the mixture with an organic solvent, or collecting a formed precipitate by filtration. The isolated compound (1-iv) may be further purified by recrystallization, chromatography or the like.

### (Production Method C-1)

Among the compound I, a compound represented by the formula (1-v):

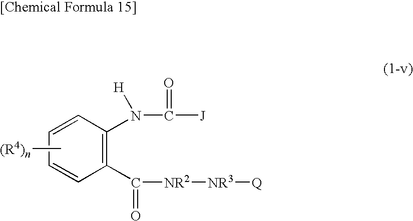

wherein R², R³, J, Q and n are as defined above (hereinafter, referred to as “the compound (1-v)”) can be produced by reacting a compound represented by the formula (9)

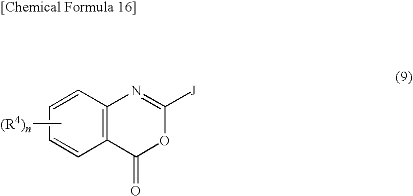

wherein R⁴, J and n are as defined above (hereinafter, referred to as “the compound (9)”) with a compound represented by the formula (10):

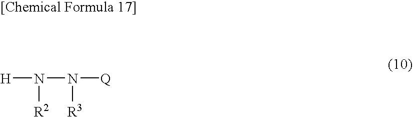

wherein R², R³, and Q are as defined above (hereinafter, referred to as “the compound (10)”).

The reaction is carried out in the presence or the absence of a solvent. Examples of the solvent used in the reaction include ethers such as 1,4-dioxane, diethyl ether, tetrahydrofuran, and methyl tert-butyl ether; halogenated hydrocarbons such as dichloromethane, chloroform, carbon tetrachloride, 1,2-dichloroethane, and chlorobenzene; hydrocarbons such as toluene, benzene, and xylene; nitriles such as acetonitrile; aprotic polar solvents such as N,N-dimethylformamide, N-methylpyrrolidone, 1,3-dimethyl-2-imidazolidinone, and dimethyl sulfoxide, and their mixtures.

The amount of the compound (10) used in the reaction is usually 1 to 20 mol per 1 mol of the compound (9).

The reaction temperature of the reaction is usually from 0 to 100° C., and the reaction time is usually from 0.1 to 48 hours.

After completion of the reaction, the compound (1-v) can be isolated by pouring the reaction mixture into water and extracting the mixture with an organic solvent, or collecting a formed precipitate by filtration. The isolated compound (1-v) may be further purified by recrystallization, chromatography or the like.

### (Production Method C-2)

Among the compound I, a compound represented by the formula (1-vi):

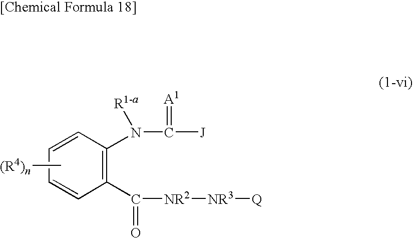

wherein R², R³, R⁴, A¹, J, Q and n are as defined above, R^{1-a} represents an optionally halogenated C1-C6 alkyl group, a C2-C6 cyanoalkyl group, an optionally halogenated C2-C6 alkoxyalkyl group, an optionally halogenated C2-C6 alkenyl group, an optionally halogenated C3-C6 alkynyl group, or a C7-C9 phenylalkyl group in which the benzene ring moiety may be substituted with a substituent A (hereinafter, referred to as “the compound (1-vi)”) can be produced by reacting a compound represented by the formula (11):

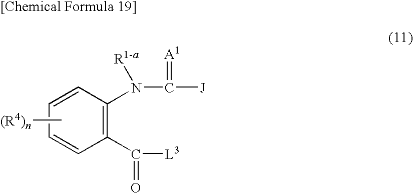

wherein R^{1-a}, R⁴, A¹, J and n are as defined above, and L³ represents a halogen atom (hereinafter, referred to as “the compound (11)”) with the compound (10).

The reaction is carried out in the presence or the absence of a solvent. Examples of the solvent used in the reaction include ethers such as 1,4-dioxane, diethyl ether, tetrahydrofuran, and methyl tert-butyl ether; halogenated hydrocarbons such as dichloromethane, chloroform, carbon tetrachloride, 1,2-dichloroethane, and chlorobenzene; hydrocarbons such as toluene, benzene, and xylene; nitriles such as acetonitrile; aprotic polar solvents such as N,N-dimethylformamide, N-methylpyrrolidone, 1,3-dimethyl-2-imidazolidinone, and dimethyl sulfoxide, and their mixtures.

The amount of the compound (10) used in the reaction is usually 1 to 2 mol per 1 mol of the compound (11).

The reaction is carried out in the presence of a base, if necessary. Examples of the base used when the reaction is carried out in the presence of the base include nitrogen-containing heterocyclic compounds such as pyridine, picoline, 2,6-lutidine, 1,8-diazabicyclo[5,4,0]7-undecene (DBU), and 1,5-diazabicyclo[4,3,0]5-nonene (DBN); tertiary amines such as triethylamine, and N,N-diisopropylethylamine; and inorganic bases such as potassium carbonate, and sodium hydride. The amount of the base used when the reaction is carried out in the presence of the base is usually 1 to 2 mol per 1 mol of the compound (6). If the base used is in the liquid form under reaction conditions, such as pyridine, the base may be used in a solvent amount.

The reaction temperature of the reaction is usually from 0 to 100° C., and the reaction time is usually from 0.1 to 24 hours.

After completion of the reaction, the compound (1-vi) can be isolated by pouring the reaction mixture into water and extracting the mixture with an organic solvent, or collecting a formed precipitate by filtration. The isolated compound (1-vi) may be further purified by recrystallization, chromatography or the like.

### (Production Method C-3)

The compound (1-vi) can be also produced by reacting a compound represented by the formula (12):

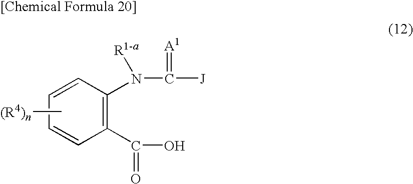

wherein R⁴, R^{1-a}, A¹, J and n are as defined above (hereinafter, referred to as “the compound (12)”) with the compound (10) in the presence of a dehydrating agent.

The reaction is carried out in the presence or the absence of a solvent. Examples of the solvent used in the reaction include ethers such as 1,4-dioxane, diethyl ether, tetrahydrofuran, and methyl tert-butyl ether; halogenated hydrocarbons such as dichloromethane, chloroform, carbon tetrachloride, 1,2-dichloroethane, and chlorobenzene; hydrocarbons such as toluene, benzene, and xylene; nitriles such as acetonitrile; aprotic polar solvents such as N,N-dimethylformamide, N-methylpyrrolidone, 1,3-dimethyl-2-imidazolidinone, and dimethyl sulfoxide, and their mixtures.

The amount of the compound (10) used in the reaction is usually 1 to 2 mol per 1 mol of the compound (12).

Examples of the dehydrating agent used in the reaction include carbodiimide such as dicyclohexylcarbodiimide (DCC), and 1-ethyl-3-(3-dimethylaminopropyl)carbodiimide hydrochloride (WSC). The amount of the dehydrating agent used is usually from 1 to 2 mol per 1 mol of the compound (12).

The reaction temperature of the reaction is usually from 0 to 100° C., and the reaction time is usually from 0.1 to 24 hours.

After completion of the reaction, the compound (1-vi) can be isolated by pouring the reaction mixture into water and extracting the mixture with an organic solvent, or collecting a formed precipitate by filtration. The isolated compound (1-vi) may be further purified by recrystallization, chromatography or the like.

Then, a method of producing intermediates for producing the compound I will be explained.

### (Reference Production Method 1)

Among the compound (2), a compound represented by the formula (2-i):

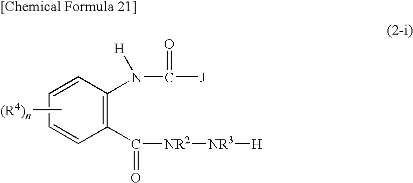

wherein R², R³, R⁴, J and n are as defined above (hereinafter, referred to as “the compound (2-i)”) can be produced by reacting the compound (9) and a compound represented by the formula (13):

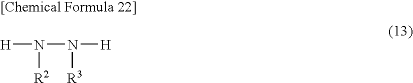

wherein R² and R³ are as defined above (hereinafter, referred to as “the compound (13)”).

The reaction is carried out in the presence or the absence of a solvent. Examples of the solvent used in the reaction include ethers such as 1,4-dioxane, diethyl ether, tetrahydrofuran, and methyl tert-butyl ether; halogenated hydrocarbons such as dichloromethane, chloroform, carbon tetrachloride, 1,2-dichloroethane, and chlorobenzene; hydrocarbons such as toluene, benzene, and xylene; nitriles such as acetonitrile; aprotic polar solvents such as N,N-dimethylformamide, N-methylpyrrolidone, 1,3-dimethyl-2-imidazolidinone, and dimethyl sulfoxide; alcohols such as methanol, ethanol, and 2-propanol, and their mixtures.

The amount of the compound (13) used in the reaction is usually 1 to 5 mol per 1 mol of the compound (9).

The reaction temperature of the reaction is usually from −50 to 100° C., and the reaction time is usually from 0.1 to 24 hours.

After completion of the reaction, the compound (2-i) can be isolated by pouring the reaction mixture into water and extracting the mixture with an organic solvent, or collecting a formed precipitate by filtration. The isolated compound (2-i) may be further purified by recrystallization, chromatography or the like.

### (Reference Production Method 2)

Among the compound (2), a compound represented by the formula (2-ii):

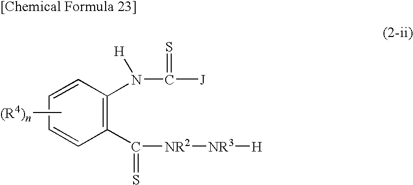

wherein R², R³, R⁴, J and n are as defined above (hereinafter, referred to as “the compound (2-ii)”) can be produced by reacting a compound represented by the formula (14):

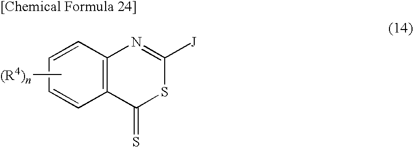

wherein R⁴, J and n are as defined above (hereinafter, referred to as “the compound (14)”) with the compound (13).

The reaction is carried out in the presence or the absence of a solvent. Examples of the solvent used in the reaction include ethers such as 1,4-dioxane, diethyl ether, tetrahydrofuran, and methyl tert-butyl ether; halogenated hydrocarbons such as dichloromethane, chloroform, carbon tetrachloride, 1,2-dichloroethane, and chlorobenzene; hydrocarbons such as toluene, benzene, and xylene; nitriles such as acetonitrile; aprotic polar solvents such as N,N-dimethylformamide, N-methylpyrrolidone, 1,3-dimethyl-2-imidazolidinone, and dimethyl sulfoxide; alcohols such as methanol, ethanol, and 2-propanol, and their mixtures.

The amount of the compound (13) used in the reaction is usually 1 to 5 mol based on 1 mol of the compound (14).

The reaction temperature of the reaction is usually from −50 to 100° C., and the reaction time is usually from 0.1 to 24 hours.

After completion of the reaction, the compound (2-ii) can be isolated by pouring the reaction mixture into water and extracting the mixture with an organic solvent, or collecting a formed precipitate by filtration. The isolated compound (2-ii) may be further purified by recrystallization, chromatography or the like.

### (Reference Production Method 3)

Among the compound (2), a compound represented by the formula (2-iii):

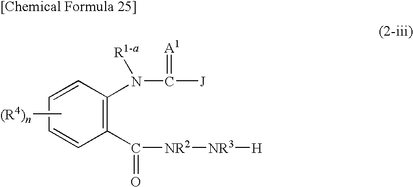

wherein R^{1-a}, R², R³, R⁴, A¹, J and n are as define above (hereinafter, referred to as “the compound (2-iii)”) can be produced by reacting the compound (11) with the compound (13).

The reaction is carried out in the presence or the absence of a solvent. Examples of the solvent used in the reaction include ethers such as 1,4-dioxane, diethyl ether, tetrahydrofuran, and methyl tert-butyl ether; halogenated hydrocarbons such as dichloromethane, chloroform, carbon tetrachloride, 1,2-dichloroethane, and chlorobenzene; hydrocarbons such as toluene, benzene, and xylene; nitriles such as acetonitrile; aprotic polar solvents such as N,N-dimethylformamide, N-methylpyrrolidone, 1,3-dimethyl-2-imidazolidinone, and dimethyl sulfoxide, and their mixtures.

The amount of the compound (13) used in the reaction is usually 2 to 10 mol per 1 mol of the compound (11).

The reaction temperature of the reaction is usually from −50 to 100° C., and the reaction time is usually from 0.1 to 24 hours.

After completion of the reaction, the compound (2-iii) can be isolated by pouring the reaction mixture into water and extracting the mixture with an organic solvent, or collecting a formed precipitate by filtration. The isolated compound (2-iii) may be further purified by recrystallization, chromatography or the like.

### (Reference Production Method 4)

The compound (9) can be produced by reacting a compound represented by the formula (16):

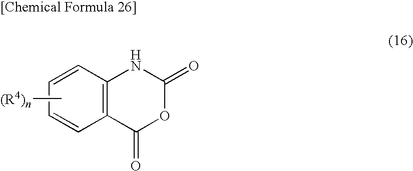

wherein R⁴ and n are as defined above (hereinafter, referred to as “the compound (16)”) with a compound represented by the formula (7′):

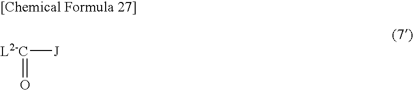

wherein J and L² are as defined above (hereinafter, referred to as “the compound (7′)”).

The reaction is carried out in the presence of a base, or in the presence or the absence of a solvent. Examples of the solvent used in the reaction include ethers such as 1,4-dioxane, diethyl ether, tetrahydrofuran, and methyl tert-butyl ether; halogenated hydrocarbons such as dichloromethane, chloroform, carbon tetrachloride, 1,2-dichloroethane, and chlorobenzene; hydrocarbons such as toluene, benzene, and xylene; nitriles such as acetonitrile; aprotic polar solvents such as N,N-dimethylformamide, N-methylpyrrolidone, 1,3-dimethyl-2-imidazolidinone, and dimethyl sulfoxide, and their mixtures.

The amount of the compound (7′) used in the reaction is usually 0.5 to 2 mol per 1 mol of the compound (16).

Examples of the base used in the reaction include nitrogen-containing heterocyclic compounds such as pyridine, picoline, 2,6-lutidine, 1,8-diazabicyclo[5,4,0]7-undecene (DBU), and 1,5-diazabicyclo[4,3,0]5-nonene (DBN); tertiary amines such as triethylamine, and N,N-diisopropylethylamine; and inorganic bases such as potassium carbonate, and sodium hydride. The amount of the base used is usually 1 to 2 mol per 1 mol of the compound (16). If the base used is in the liquid form under reaction conditions, such as pyridine, the base may be used in a solvent amount.

The reaction temperature of the reaction is usually from 50 to 150° C., and the reaction time is usually from 1 to 24 hours.

After completion of the reaction, the compound (9) can be isolated by pouring the reaction mixture into water and extracting the mixture with an organic solvent, or collecting a formed precipitate by filtration. The isolated compound (9) may be further purified by recrystallization, chromatography or the like.

### (Reference Production Method 5)

The compound (9) can be produced by reacting a compound represented by the formula (17):

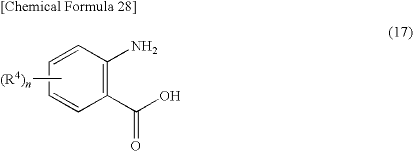

wherein R⁴ and n are as defined above (hereinafter, referred to as “the compound (17)”) with the compound (7′).

The reaction is carried out in the presence or the absence of a solvent. Examples of the solvent used in the reaction include ethers such as 1,4-dioxane, diethyl ether, tetrahydrofuran, and methyl tert-butyl ether; halogenated hydrocarbons such as dichloromethane, chloroform, carbon tetrachloride, 1,2-dichloroethane, and chlorobenzene; hydrocarbons such as toluene, benzene, and xylene; nitriles such as acetonitrile; aprotic polar solvents such as N,N-dimethylformamide, N-methylpyrrolidone, 1,3-dimethyl-2-imidazolidinone, and dimethyl sulfoxide, and their mixtures.

The production method consists of the following step 5-1 and step 5-2.

### (Step 5-1)

The step is carried out by reacting the compound (17) with the compound (7′) in the presence of a base.

The amount of the compound (7′) used in the step is usually 1 to 2 mol per 1 mol of the compound (17). Examples of the base used in the step include nitrogen-containing heterocyclic compounds such as pyridine, picoline, 2,6-lutidine, 1,8-diazabicyclo[5,4,0]7-undecene (DBU), and 1,5-diazabicyclo[4,3,0]5-nonene (DBN); tertiary amines such as triethylamine, and N,N-diisopropylethylamine; and inorganic bases such as potassium carbonate, and sodium hydride. The amount of the base used is usually 1 to 2 mol per 1 mol of the compound (17).

The reaction temperature of the step is usually from 0 to 50° C., and the reaction time is usually from 0.1 to 24 hours.

After completion of the step, usually, the reaction mixture is directly used in the next step 5-2.

### (Step 5-2)

The step is carried out by reacting the reaction mixture obtained in the above step 5-1 with sulfonic acid halide in the presence of a base.

Examples of sulfonic acid halide used in the step include methanesulfonic acid chloride, p-toluenesulfonic acid chloride, and trifluoromethanesulfonic acid chloride. The amount of sulfonic acid halide used in the step is usually 1 to 2 mol per 1 mol of the compound (17) used in the Step 5-1.

Examples of the base used in the step are the same as those described for the step 5-1, and usually, the same base as used in the step 5-1 is used. The amount of the base used is usually 2 to 4 mol per 1 mol of the compound (17) used in the step 5-1.

The reaction temperature of the step is usually from 0 to 50° C., and the reaction time is usually from 0.1 to 24 hours.

After completion of the step, the compound (9) can be isolated by pouring the reaction mixture into water and then usually extracting the mixture with an organic solvent, or the like. The isolated compound (9) may be further purified by recrystallization, chromatography or the like.

### (Reference Production Method 6)

The compound (14) can be produced by reacting the compound (9) with a thiocarbonylating agent.

The reaction is carried out in the presence or the absence of the solvent. Examples of the solvent used in the reaction include ethers such as 1,4-dioxane, diethyl ether, tetrahydrofuran, methyl tert-butyl ether, and diglyme; halogenated hydrocarbons such as dichloromethane, chloroform, carbon tetrachloride, 1,2-dichloroethane, and chlorobenzene; hydrocarbons such as toluene, benzene, and xylene; nitriles such as acetonitrile; pyridines such as pyridine, picoline, and lutidine; and their mixtures.

Examples of the thiocarbonylating agent used in the reaction include diphosphorus pentasulfide, and Lawesson's reagent (2,4-bis-(4-methoxyphenyl)-1,3-dithia-2,4-diphosphethane 2,4-disulfide).

The amount of the thiocarbonylating agent used in the reaction is usually 1 to 3 mol per 1 mol of the compound (9).

The reaction temperature of the reaction is usually from 0° C. to 200° C., and the reaction time is usually from 1 to 24 hours.

After completion of the reaction, the compound (14) can be isolated, for example, by collecting a precipitate formed in the reaction mixture by filtration, or extracting the reaction mixture an organic solvent. The isolated compound (14) may be further purified by recrystallization, chromatography or the like.

### (Reference Production Method 7)

The compound (11) can be produced by reacting the compound (12) with a halogenating agent.

The reaction is carried out in the presence or the absence of a solvent. Examples of the solvent used in the reaction include ethers such as 1,4-dioxane, diethyl ether, tetrahydrofuran, and methyl tert-butyl ether; halogenated hydrocarbons such as dichloromethane, chloroform, carbon tetrachloride, 1,2-dichloroethane, and chlorobenzene; hydrocarbons such as toluene, benzene, and xylene; nitriles such as acetonitrile; aprotic polar solvents such as N,N-dimethylformamide, N-methylpyrrolidone, 1,3-dimethyl-2-imidazolidinone, and dimethyl sulfoxide, and their mixtures.

Examples of the halogenating agent used in the reaction include thionyl chloride, thionyl bromide, phosphorus oxychloride, phosphorus oxybromide, phosphorus pentachloride, oxalyl chloride, and phosgene.

The amount of the halogenating agent used in the reaction is usually 1 to 2 mol per 1 mol of the compound (12). The halogenating agent can be used in a solvent amount depending on the case.

The reaction temperature of the reaction is usually from 0° C. to 150° C., and the reaction time is usually from 0.1 to 24 hours.

After completion of the reaction, the compound (11) can be isolated by collecting a precipitate formed in the reaction mixture by filtration, or concentrating the reaction mixture. Usually the isolated compound (11) is directly used in the next step, or if necessary, can be further purified by recrystallization or the like.

### (Reference Production Example 8)

The compound (12) can be produced by reacting a compound represented by the formula (18′):

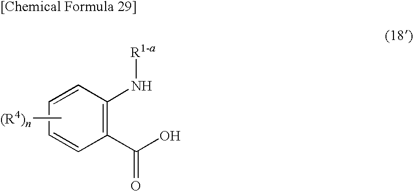

wherein R^{1-a}, R⁴ and n are as defined above (hereinafter, referred to as “the compound (18′)”) with the compound (7).

The reaction is carried out in the presence or the absence of a solvent. Examples of the solvent used in the reaction include ethers such as 1,4-dioxane, diethyl ether, tetrahydrofuran, and methyl tert-butyl ether; halogenated hydrocarbons such as dichloromethane, chloroform, carbon tetrachloride, 1,2-dichloroethane, and chlorobenzene; hydrocarbons such as toluene, benzene, and xylene; nitriles such as acetonitrile; aprotic polar solvents such as N,N-dimethylformamide, N-methylpyrrolidone, 1,3-dimethyl-2-imidazolidinone, and dimethyl sulfoxide, and their mixtures.

The amount of the compound (7) used in the reaction is usually 1 to 2 mol per 1 mol of the compound (18′).

The reaction is performed in the presence of a base. Examples of the base used include nitrogen-containing heterocyclic compounds such as pyridine, picoline, 2,6-lutidine, 1,8-diazabicyclo[5,4,0]7-undecene (DBU), and 1,5-diazabicyclo[4,3,0]5-nonene (DBN); tertiary amines such as triethylamine, and N,N-diisopropylethylamine; and inorganic bases such as potassium carbonate, and sodium hydride. The amount of the base used is usually 1 to 2 mol per 1 mol of the compound (18′).

The reaction temperature of the reaction is usually from 0 to 50° C., and the reaction time is usually from 0.1 to 24 hours.

After completion of the step, the compound (12) can be isolated by pouring the reaction mixture into water and then usually extracting the mixture with an organic solvent, or collecting a formed precipitate by filtration. The isolated compound (12) may be purified by recrystallization, chromatography or the like.

### (Reference Production Method 9)

The compound (6) can be produced by reacting a compound represented by the formula (20):

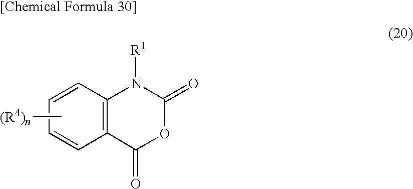

wherein R¹, R⁴ and n are as defined above (hereinafter, referred to as “the compound (20)”) with the compound (10).

The reaction is carried out in the presence or the absence of a solvent. Examples of the solvent used in the reaction include ethers such as 1,4-dioxane, diethyl ether, tetrahydrofuran, and methyl tert-butyl ether; halogenated hydrocarbons such as dichloromethane, chloroform, carbon tetrachloride, 1,2-dichloroethane, and chlorobenzene; hydrocarbons such as toluene, benzene, and xylene; nitriles such as acetonitrile; aprotic polar solvents such as N,N-dimethylformamide, N-methylpyrrolidone, 1,3-dimethyl-2-imidazolidinone, and dimethyl sulfoxide; alcohols such as methanol, ethanol, and 2-propanol, and their mixtures.

The amount of the compound (10) used in the reaction is usually 1 to 2 mol per 1 mol of the compound (20).

The reaction temperature of the reaction is usually from −20 to 150° C., and the reaction time is usually from 0.1 to 24 hours.

After completion of the reaction, the compound (20) can be isolated by pouring the reaction mixture into water and then extracting the mixture with an organic solvent, or collecting a formed precipitate by filtration. The isolated compound (20) may be further purified by recrystallization, chromatography or the like.

The compounds (3), (4) and (13) are known compounds, or can be produced from known compounds according to known methods (see, e.g. Organic Functional Group Preparations, 2^{nd} edition, Vol. 1, chapter 12, p. 359-376 (Stanley R. Sandler, Wolf Karo.), or Organic Functional Group Preparations, 2^{nd} edition, Vol. 1, chapter 14, p. 434-465 (Stanley R. Sandler, Wolf Karo.)).

Compounds obtained by the above-described Production Method A-1 to Production Method C-1 and Reference Production Methods 1 to 9 can be isolated and purified by a conventional method such as grinding, powderization, recrystallization, column chromatography, high performance liquid column chromatography (HPLC), medium pressure preparative HPLC, desalting resin column chromatography, or re-precipitation.

The compound (10) can be produced, for example, according to the following Scheme (1).

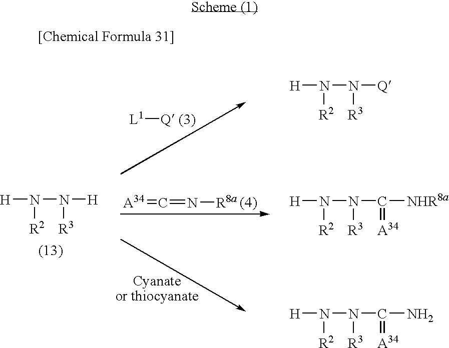

wherein, A³⁴, L¹, Q′, R², R³ and R^{8a} are as defined above.

Among the compound (10), a compound represented by the formula (10-i):

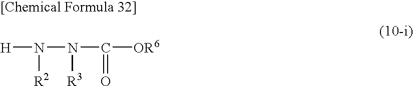

wherein R², R³ and R⁴ are as defined above, can be produced, for example, according to the following Scheme (2).

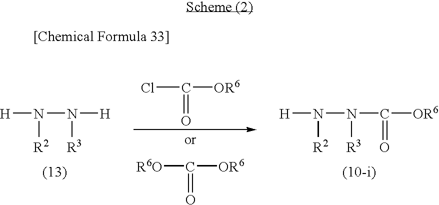

wherein, R², R³ and R⁶ are as defined above.

The compound (17) can be produced, for example, according to the following Scheme (3).

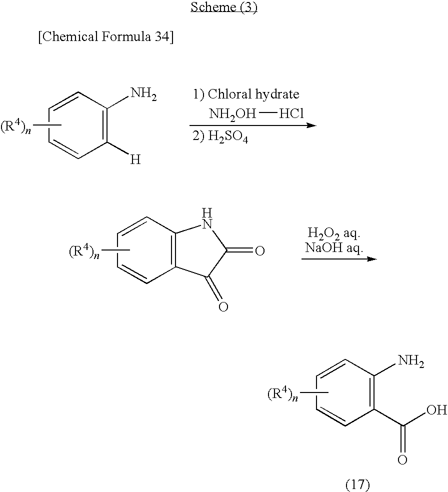

wherein, R⁴ and n are as defined above.

The compounds (16), (18′) and (20) can be produced, for example, according to the following Scheme (4).

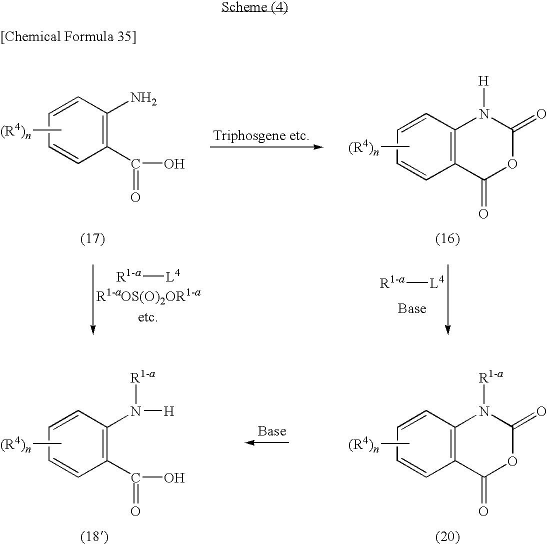

wherein, R^{1-a}, R⁴ and n are as defined above and L⁴ represents a leav. Triphosgene ect. (e.g. halogen atom, methanesulfonyloxy group, or a p-toluenesulfonyloxy group)

Among the compounds (17) and (18), a compound represented^{etc.} the formula (17-i)_{Base}

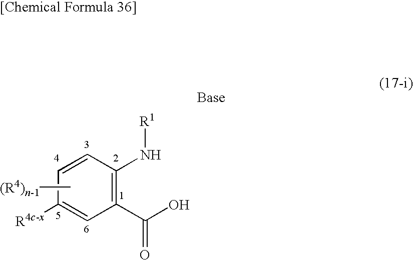

wherein R¹ and R⁴ are as defined above, R^{4c-x} represents a halogen atom or a cyano group, and n-1 represents an integer of 0 to 3, can be produced, for example, according to the following Scheme (5).

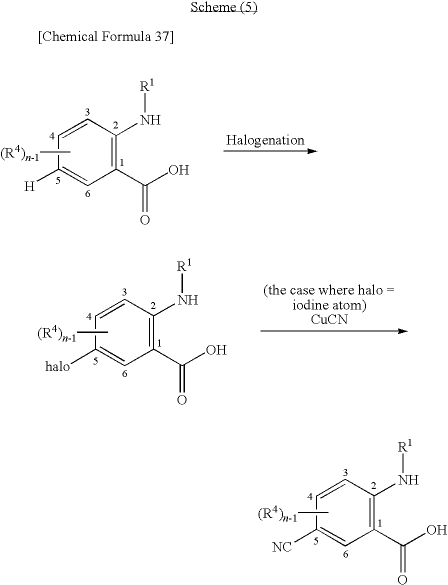

wherein, R¹, R⁴ and n-1 are as define above, and halo represents a halogen atom.

Among the compounds (17) and (18), a compound represented by the formula (17-ii):

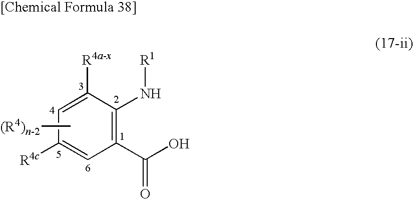

wherein R¹ and R⁴ are as defined above, R^{4a-x} represents a halogen atom, R^{4c} represents the same meaning as that of R⁴, and n-2 represents an integer of 0 to 2, can be produced, for example, according to the flowing Scheme (6).

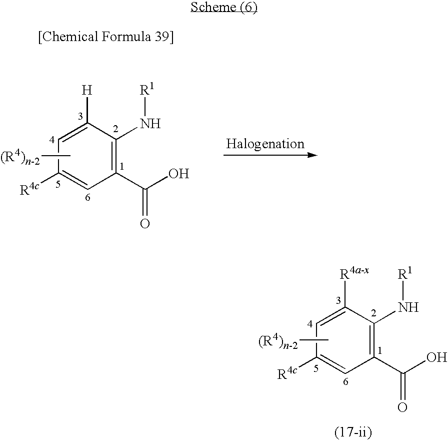

wherein, R, R⁴, R^{4a-x}, R^{4c} and n-2 are as defined above.

The compound (8) can be produced, for example, according to a method shown in Scheme (7).

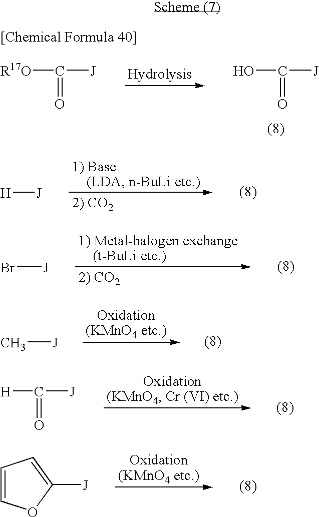

wherein, J is as defined above, R¹⁷ represents a methyl group or an ethyl group, LDA represents lithium diisoproamide, n-BuLi represents normal butyllithium, and t-BuLi represents tertiary butylithium.

Among the compound (8), a compound represented by the formula (8-i):

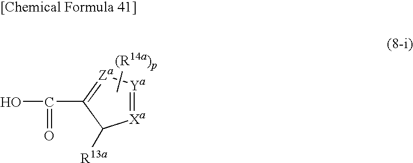

wherein R^{13a}, R^{14a}, X^{a}, Y^{a}, Z^{a} and p are as defined above, can be produced, for example, according to a method shown in the following Scheme (8).

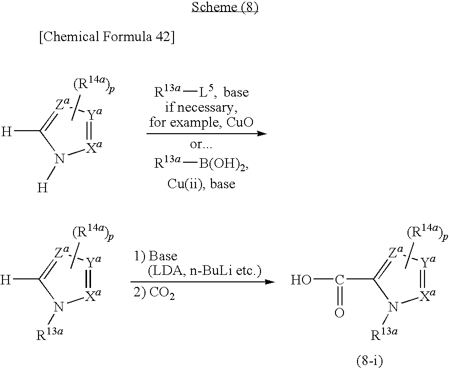

wherein, R^{13a}, R^{14a}, X^{a}, Y^{a}, Z^{a}, p, LDA and n-BuLi are as defined above, and L⁵ represents a leaving group (e.g. halogen atom, a methanesulfonyloxy group, a p-toluenesulfonyloxy group, a methylsulfonyl group, etc.).

Among the compound (8), a compound represented by the formula (8-ii):

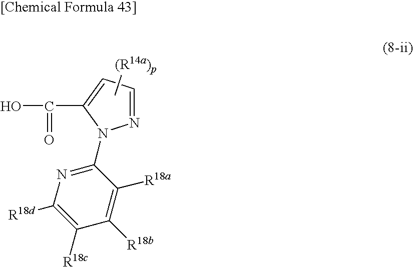

wherein R^{14a} and p are as defined above, R^{18a}, R^{18b}, R^{18c} and R^{18d} independently represent a hydrogen atom, a halogen atom, a cyano group, a nitro group, an optionally halogenated C1-C6 alkyl group, an optionally halogenated C1-C6 alkoxy group, an optionally halogenated C1-C6 alkylthio group, an optionally halogenated C1-C6 alkylsulfinyl group, or an optionally halogenated C1-C6 alkylsulfonyl group, can be produced, for example, according to a method shown in the following Scheme (9).

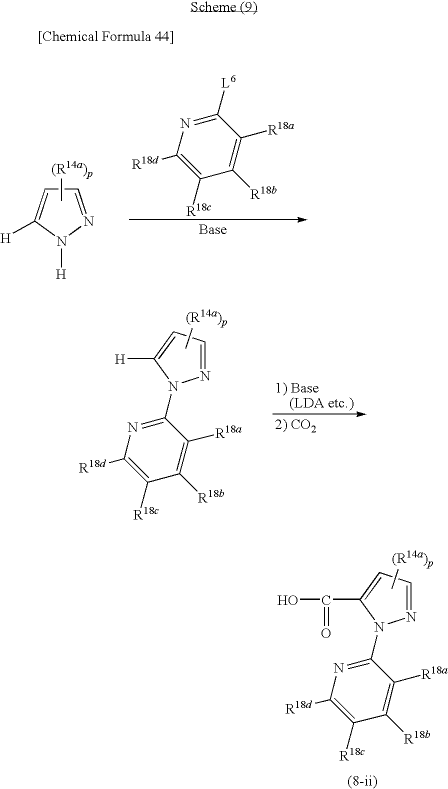

wherein, R^{14a}, R^{18a}, R^{18b}, R^{18c}, R^{18d}, LDA and p are as defined above, and L⁶ represents a leaving group (e.g. a halogen atom, a methylsulfonyl group, etc.).

Among the compound (8), a compound represented by the formula (8-iii):

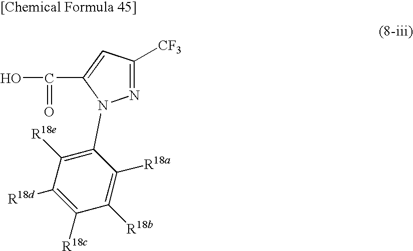

wherein R^{18a}, R^{18b}, R^{18c}, R^{18d} and R^{18e} independently represent a hydrogen atom, a halogen atom, a cyano group, a nitro group, an optionally halogenated C1-C6 alkyl group, an optionally halogenated C1-C6 alkoxy group, an optionally halogenated C1-C6 alkylthio group, an optionally halogenated C1-C6 alkylsulfinyl group, or an optionally halogenated C1-C6 alkylsulfonyl group, can be produced, for example, according to a method shown in the following Scheme (10).

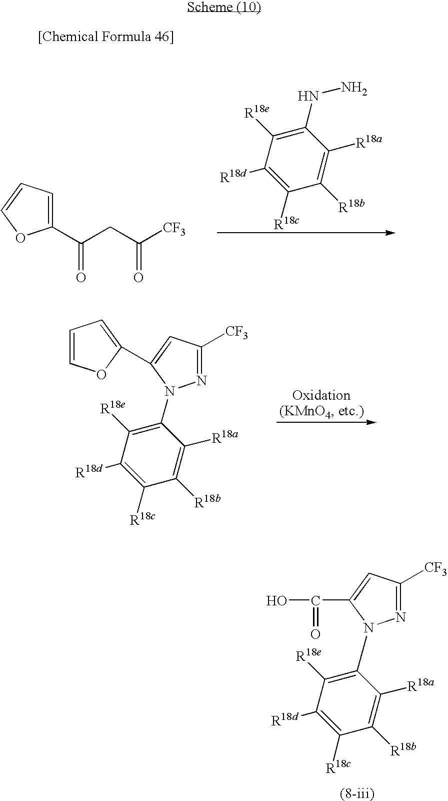

wherein, R^{18a}, R^{18b}, R^{18c}, R^{18d}, and R^{18e} are as defined above.

Among the compound (8), a compound represented by the formula (8-iv):

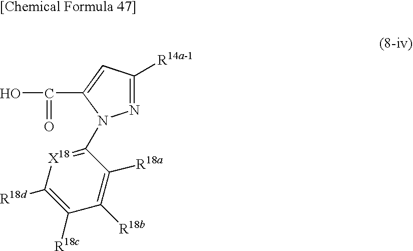

wherein X¹⁸ represents a nitrogen atom or CR^{18e}, R^{18a}, R^{18b}, R^{18c}, R^{18d} and R^{18e} are as defined above, and R^{14a-1} represents an optionally halogenated C1-C6 alkyl group, can be produced, for example, according to a method shown in the following Scheme (11).

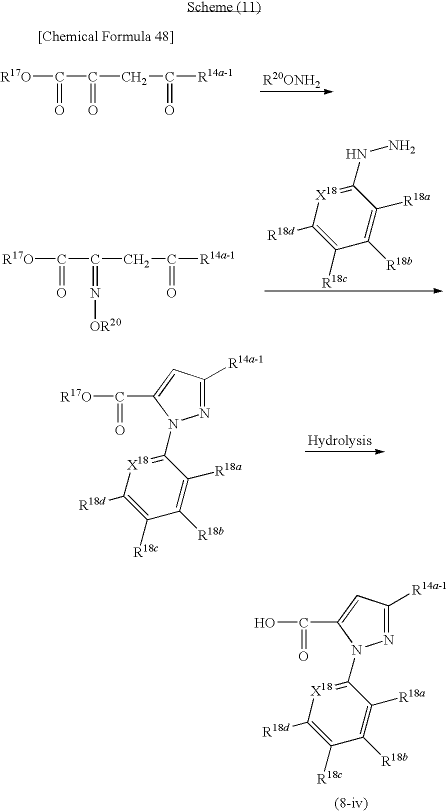

wherein, R^{14a-1}, R¹⁷, R^{18a}, R^{18b}, R^{18c}, R^{18d} and X¹⁸ are as defined above, and R²⁰ represents a methyl group or an ethyl group.

Among the compound (8), a compound represented by the formula (8-vii):

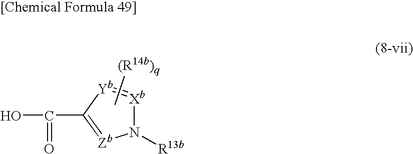

wherein R^{13b}, R^{14b}, X^{b}, Y^{b}, Z^{b} and q are as defined above, can be produced, for example, according to a method shown in the following Scheme (12).

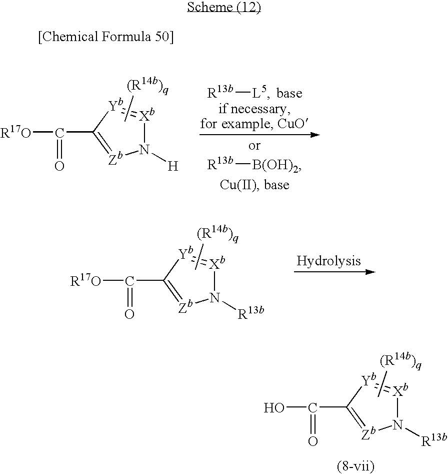

wherein, R^{13b}, R^{14b}, R¹⁷, X^{b}, Y^{b}, Z^{b}, L⁵ and q are defined above.

Among the compound (8), compounds represented by the formula (8-viii) and the formula (8-ix):

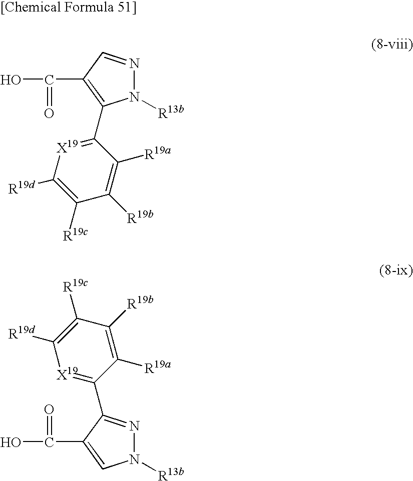

wherein, R^{13b} is as defined above, X¹⁹ represents a nitrogen atom or CR^{19e}, R^{19a}, R^{19b}, R^{19c}, R^{19d} and R^{19e} independently represent a hydrogen atom, a halogen atom, a cyano group, a nitro group, an optionally halogenated C1-C6 alkyl group, an optionally halogenated C1-C6 alkoxy group, an optionally halogenated C1-C6 alkylthio group, an optionally halogenated C1-C6 alkylsulfinyl group, or an optionally halogenated C1-C6 alkylsulfonyl group, can be produced, for example, according to a method shown in the following Scheme (13).

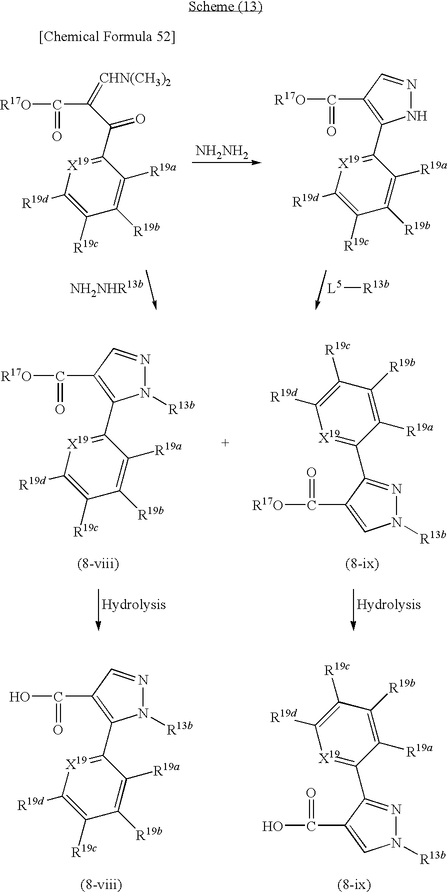

wherein, R^{13b}, R¹⁷, R^{19a}, R^{19b}, R^{19c}, R^{19d}, L⁵ and X¹⁹ are as defined above.

Among the compound (7), a compound represented by the formula (7-i):

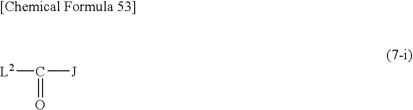

wherein L² and j are as define above, can be produced, for example, according to a method shown in the following Scheme (14).

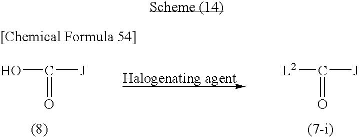

wherein, L² and J are as defined above.

Among the compound (7), a compound represented by the formula (7-ii):

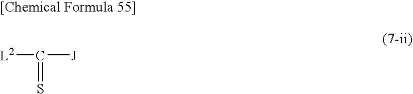

wherein L² and J are as defined above, can be produced, for example, according to a method shown in the following Scheme (15).

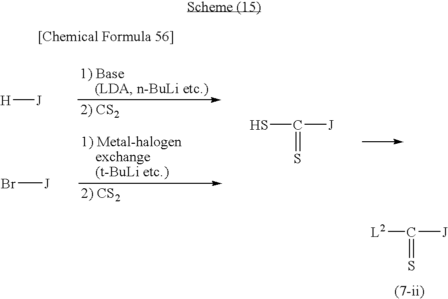

wherein, L² and J are as defined above, LDA represents lithium diisoproamide, n-BuLi represents normal butyllithium and t-BuLi represents tertiary butyllithium.

Among the compound (8), a compound represented by the formula (8-v):

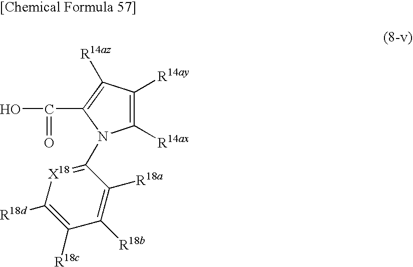

wherein R^{18a}, R^{18b}, R^{18c}, R^{18d}, and X¹⁸ are as defined above, R^{14ax}, R^{14ay} and R^{14az} independently represent a hydrogen atom, a halogen atom, a cyano group, an optionally halogenated C1-C6 alkyl group, an optionally halogenated C1-C6 alkoxy group, an optionally halogenated C1-C6 alkylthio group, an optionally halogenated C1-C6 alkylsulfinyl group, or an optionally halogenated C1-C6 alkylsulfonyl group, can be produced, for example, according a method shown in the following Scheme (16).

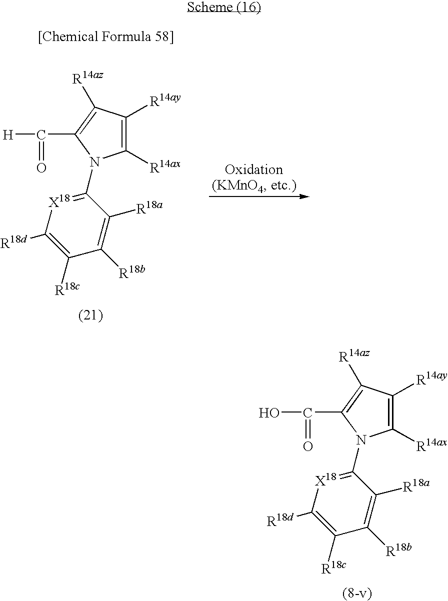

wherein, R^{18a}, R^{18b}, R^{18c}, R^{18d}, X¹⁸, R^{14ax}, R^{14ay} and R^{14az} are as defined above.

The compound (21) in the Scheme (16) can be produced, for example, according to a method shown in the following Scheme (17).

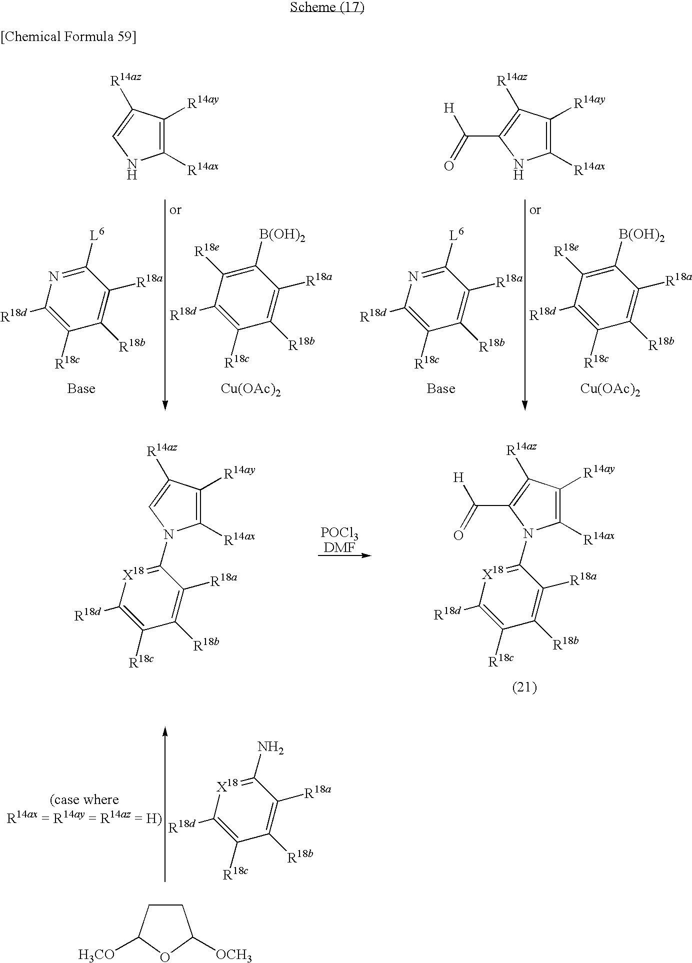

wherein, R^{18a}, R^{18b}, R^{18c}, R^{18d}, R^{18e}, X¹⁸, R^{14ax}, R^{16ay}, R^{14az} and L⁶ are as defined above.

Among the compound (21) in the Scheme (17), compounds represented by the formula (21-i), the formula (21-ii) and the formula (21-iii):

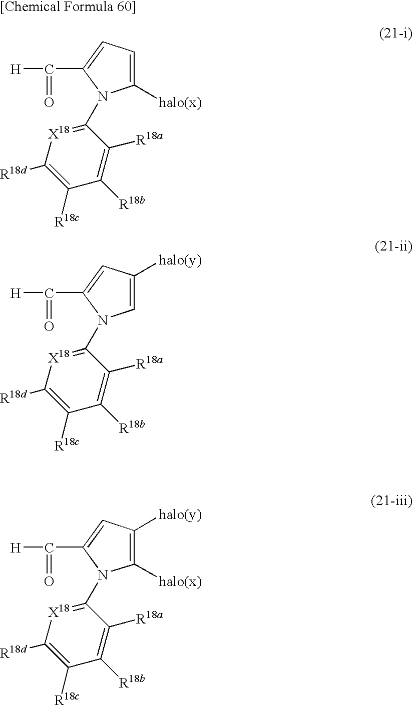

wherein R^{18a}, R^{18b}, R^{18c}, R^{18d} and X¹⁸ are as defined above, and halo (x) and halo (y) independently represent a halogen atom, can be produced, for example, according to a method shown in the following the Scheme (18).

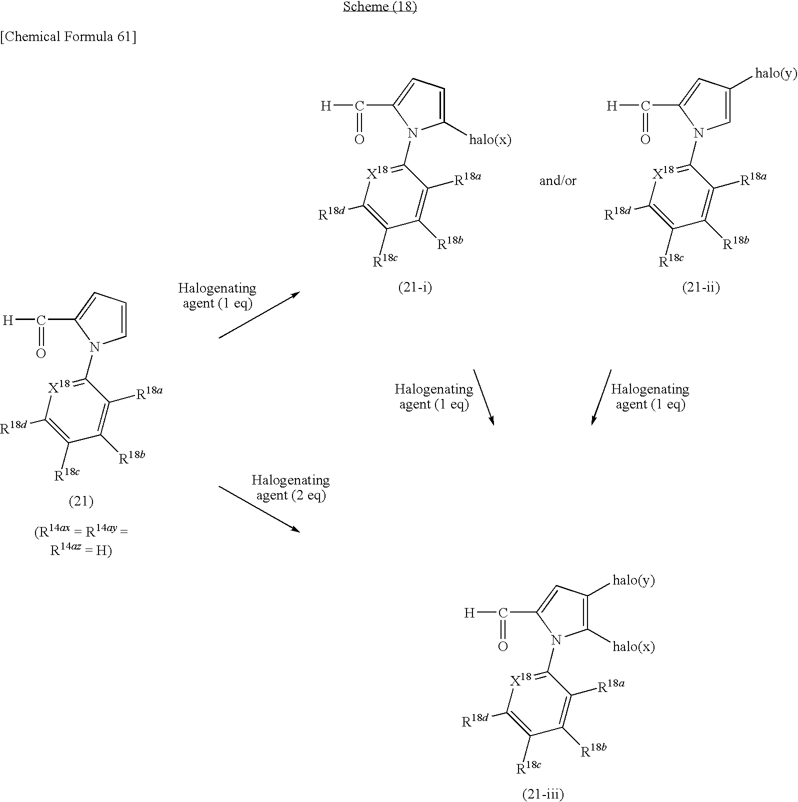

wherein, R^{18a}, R^{18b}, R^{18c}, R^{18d}, X¹⁸, halo (x) and halo (y) are as defined above.

Among the compound (8), a compound represented by the formula (8-vi):

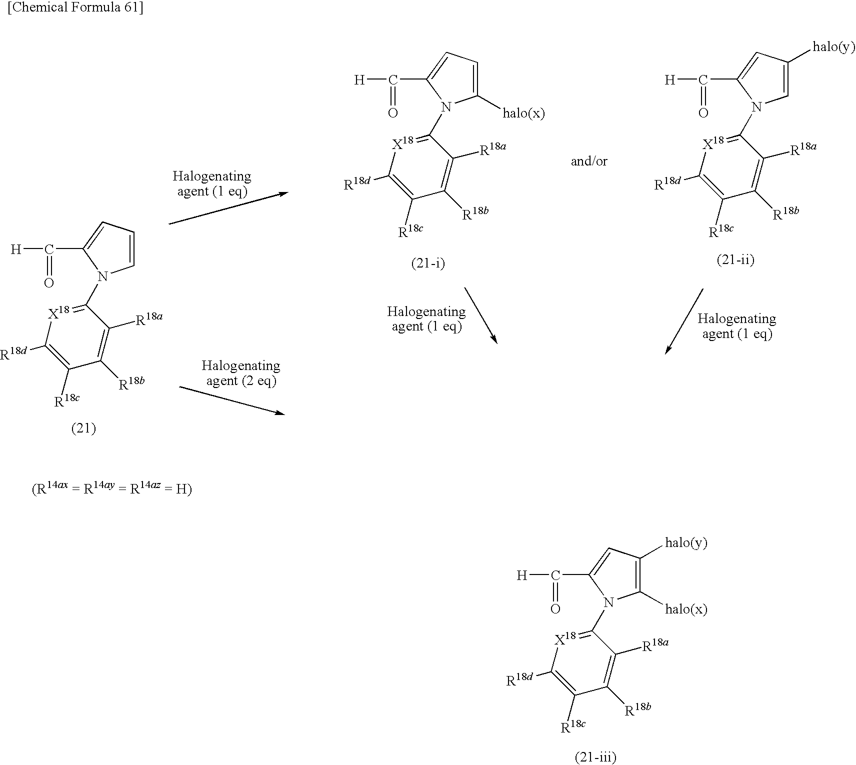

wherein R^{18a}, R^{18b}, R^{18c}, R^{18d}, and X¹⁸ are as defined above, R^{14ay-1} represents a hydrogen atom or halogen atom, R³⁰ represents an optionally halogenated C1-C6 alkyl group, and r represents an integer of 0 to 2, can be produced, for example, according to a method shown in the following Scheme (19).

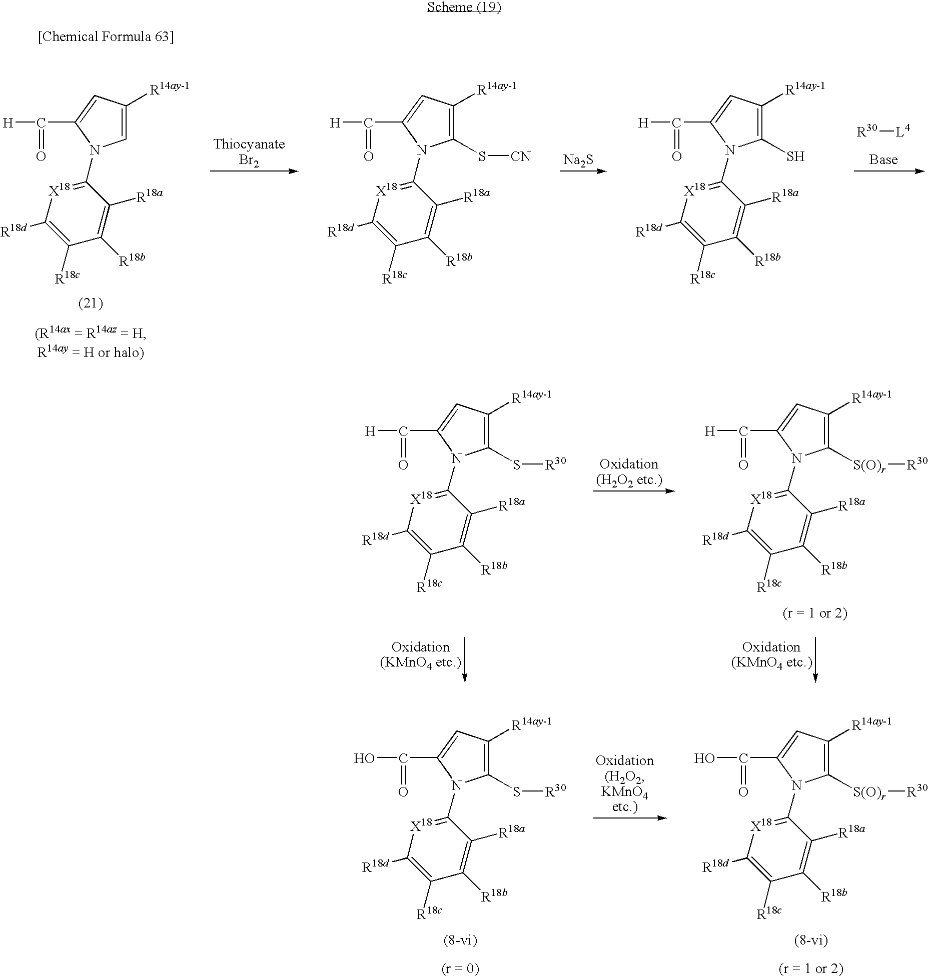

wherein, R^{18a}, R^{18b}, R^{18c}, R^{18d}, X¹⁸, R^{14ay-1}, R³⁰, r and L⁴ are as defined above.

Preferred examples of the compound I in the present invention include the following aspects:

### (Aspect 1)

A hydrazide compound of the formula (I), wherein

R¹ is a hydrogen atom or an optionally halogenated C1-C6 alkyl group; R² is a hydrogen atom or a C1-C6 alkyl group optionally substituted with a substituent D, and R³ is a hydrogen atom, an optionally halogenated C1-C6 alkyl group, or a C2-C6 alkoxycarbonyl group, or R² and R³ are taken together with two nitrogen atoms to which they are attached to form a 5- to 8-membered nonaromatic heterocyclic group; R⁴ is a halogen atom, a cyano group, an optionally halogenated C1-C6 alkyl group, an optionally halogenated C1-C6 alkoxy group, or an optionally halogenated phenyl group, or two R⁴ groups which respectively form a bond to one of carbon atoms adjacent to each other may bond to one another at their terminals to form —CH═CH—CH═CH—; n is an integer of 0 to 3; Q is any one of Q1 to Q6; A³¹, A³² and A³³ are an oxygen atom; A³⁴ is an oxygen atom or a sulfur atom; R⁵ is a hydrogen atom, a C1-C6 alkyl group optionally substituted with the substituent F, a C3-C6 cycloalkyl group optionally substituted with the substituent B, a phenyl group optionally substituted with the substituent G, a 5- to 6-membered heteroaryl group optionally substituted with the substituent A, or a 3- to 8-membered nonaromatic heterocyclic group optionally substituted with the substituent B; R⁶ is an optionally halogenated C1-C6 alkyl group, an optionally halogenated C2-C6 alkenyl group, or a phenyl group optionally substituted with the substituent G; R⁷ is an optionally halogenated C1-C6 alkyl group; R⁸ and R⁹ are independently a hydrogen atom, an optionally halogenated C1-C6 alkyl group, or a phenyl group optionally substituted with the substituent G; R¹⁰ is an optionally halogenated C1-C6 alkyl group optionally; R¹¹ and R¹² are independently an optionally halogenated C1-C6 alkyl group; J is J1 or J2; X^{a} is CH or a nitrogen atom; Y^{a} is CH; Z^{a} is CH or a nitrogen atom; X^{b} is CH or a nitrogen atom; Y^{b} is CH; Z^{b} is CH or a nitrogen atom; R^{13a} is an optionally halogenated C1-C6 alkyl group, a C3-C6 cycloalkyl group optionally substituted with the substituent B, a phenyl group optionally substituted with the substituent H, or a 5- to 6-membered heteroaryl group optionally substituted with the substituent A; R^{13b} is an optionally halogenated C1-C6 alkyl group; R^{14a} is a halogen atom, a cyano group, an optionally halogenated C1-C6 alkyl group, an optionally halogenated C1-C6 alkylthio group, an optionally halogenated C1-C6 alkylsulfinyl group, an optionally halogenated C1-C6 alkylsulfonyl group, or a phenyl group optionally substituted with the substituent A; R^{14b} is an optionally halogenated C1-C6 alkyl group, or a phenyl group optionally substituted with the substituent A; p is an integer of 0 to 2 (wherein, when p is 2, two R^{14a}s may be the same or different), q is 1; A¹ and A² are an oxygen atom.

### (Aspect 2)

A hydrazide compound of the formula (1), wherein

R¹ is a hydrogen atom, or an optionally halogenated C1-C6 alkyl group; R² is a hydrogen atom, or an optionally halogenated C1-C6 alkyl group; R³ is a hydrogen atom, an optionally halogenated C1-C6 alkyl group, or a C2-C6 alkoxycarbonyl group; R⁴ is a halogen atom, a cyano group, an optionally halogenated C1-C6 alkyl group, an optionally halogenated C1-C6 alkoxy group, or an optionally halogenated phenyl group, or two R⁴ groups which respectively form a bond to one of carbon atoms adjacent to each other may bond to one another at their terminals to form —CH═CH—CH═CH—; n is an integer of 0 to 3; Q is any one of Q1 to Q4; A³¹, A³², A³³ and A³⁴ are an oxygen atom; R⁵ is a hydrogen atom, a C1-C6 alkyl group optionally substituted with the substituent F, a C3-C6 cycloalkyl group optionally substituted with the substituent B, a phenyl group optionally substituted with the substituent G, a 5- to 6-membered heteroaryl group optionally substituted with the substituent A, or a 3- to 8-membered nonaromatic heterocyclic group optionally substituted with the substituent B; R⁶ is an optionally halogenated C1-C6 alkyl group, an optionally halogenated C2-C6 alkenyl group, or a phenyl group optionally substituted with the substituent G; R⁷ is an optionally halogenated C1-C6 alkyl group; R⁹ and R⁹ are independently a hydrogen atom, an optionally halogenated C1-C6 alkyl group, or a phenyl group optionally substituted with the substituent G; J is J1; X^{a} is CH or a nitrogen atom; Y^{a} is CH; Z^{a} is CH; R^{13a} is a 5- to 6-membered heteroaryl group optionally substituted with the substituent A; R^{14a} is a halogen atom, a cyano group, or an optionally halogenated C1-C6 alkyl group; p is an integer of 0 to 1; and A¹ and A² are an oxygen atom.

### (Aspect 3)

A hydrazide compound represented by the formula (I-o):

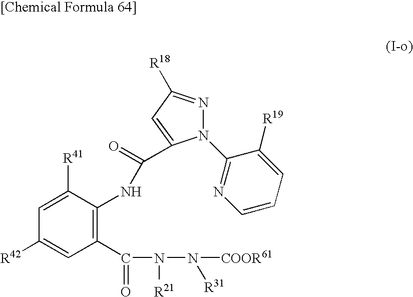

wherein R²¹ and R³¹ independently represent a hydrogen atom or a C1-C6 alkyl group, R⁶¹ represents a C1-C6 alkyl group, R⁴¹ represents a halogen atom or a C1-C6 alkyl group, R⁴² represents a halogen atom or a cyano group, R¹⁸ represents a halogen atom, or an optionally halogenated C1-C6 alkyl group, and R¹⁹ represents a halogen atom.

### (Aspect 4)

A hydrazide compound of the formula (I-o), wherein R²¹ and R³¹ are independently a hydrogen atom, a methyl group or an ethyl group, R⁶¹ is a methyl group, R⁴¹ is a chlorine atom, a bromine atom or a methyl group, R⁴² is a chlorine atom, a bromine atom or a cyano group, a R¹⁸ is a chlorine atom, a bromine atom or a trifluoromethyl group, and R¹⁹ is a chlorine atom.

In the present invention, the halogen atom includes a fluorine atom, a chlorine atom, a bromine atom and an iodine atom.

Examples of the “optionally halogenated C1-C6 alkyl group” include a methyl group, an ethyl group, a 2,2,2-trifluoroethyl group, a propyl group, an isopropyl group, a butyl group, an isobutyl group, a sec-butyl group, a tert-butyl group, a pentyl group and a hexyl group.

Examples of the “C2-C6 cyanoalkyl group” include a cyanomethyl group and a 2-cyanoethyl group.

Examples of the “optionally halogenated C2-C6 alkoxyalkyl group” include a 2-methoxyethyl group, a 2-ethoxyethyl group and a 2-isopropyloxyethyl group.

Examples of the “optionally halogenated C2-C6 alkenyl group” include a 2-propenyl group, a 3-chloro-2-propenyl group, a 2-chloro-2-propenyl group, a 3,3-dichloro-2-propenyl group, a 2-butenyl group, a 3-butenyl group, a 2-methyl-2-propenyl group, a 3-methyl-2-butenyl group, a 2-pentenyl group and a 2-hexenyl group.

Examples of the “optionally halogenated C3-C6 alkynyl group” include a 2-propynyl group, a 3-chloro-2-propynyl group, a 3-bromo-2-propynyl group, a 2-butynyl group and a 3-butynyl group.

Examples of the “C7-C9 phenylalkyl group in which the benzene ring moiety may be substituted with the substituent A” include a benzyl group, a 1-phenylethyl group, a 2-phenylethyl group, a 2-chlorobenzyl group, a 3-chlorobenzyl group, a 4-chlorobenzyl group, a 2-cyanobenzyl group, a 3-cyanobenzyl group, a 4-cyanobenzyl group, a 2-nitrobenzyl group, a 3-nitrobenzyl group, a 4-nitrobenzyl group, a 2-methylbenzyl group, a 3-methylbenzyl group, a 4-methylbenzyl group, a 2-(trifluoromethyl)benzyl group, a 3-(trifluoromethyl)benzyl group, a 4-(trifluoromethyl)benzyl group, a 2-methoxybenzyl group, 3-methoxybenzyl group and a 4-methoxybenzyl group.

Examples of the “C1-C6 alkyl group optionally substituted with the substituent D” include a methyl group, an ethyl group, a 2,2,2-trifluoroethyl group, a propyl group, an isopropyl group, a butyl group, an isobutyl group, a sec-butyl group, a tert-butyl group, a pentyl group and a hexyl group.

Examples of the “C2-C6 acyl group” include an acetyl group, a propionyl group, an isobutyryl group and a trimethylacetyl group.

Examples of the “C2-C6 alkoxycarbonyl group” include a methoxycarbonyl group, an ethoxycarbonyl group, an isopropoxycarbonyl group and a tert-butoxycarbonyl group.

Examples of the “C3-C7 N,N-dialkylcarbamoyl group” include an N,N-dimethylcarbamoyl group and an N,N-diethylcarbamoyl group.

Examples of the “phenyl group optionally substituted with the substituent C” include a phenyl group, a 2-chlorophenyl group, a 3-chlorophenyl group, a 4-chlorophenyl group, a 2-cyanophenyl group, a 3-cyanophenyl group, a 4-cyanophenyl group, a 2-nitorphenyl group, a 3-nitrophenyl group, a 4-nitrophenyl group, a 2-methylphenyl group, a 3-methylphenyl group, a 4-methylphenyl group, a 2-(trifluoromethyl)phenyl group, a 3-(trifluoromethyl)phenyl group and a 4-(trifluoromethyl)phenyl group.

Examples of the “5- to 8-membered nonaromatic heterocyclic group optionally substituted with the substituent E” formed by R² and R³ and two nitrogen atoms to which they are attached include 1,2-diazacyclopentane, 1,2-diazacyclohexane, 1,2-diazacycloheptane and 1-oxa-3,4-diazacyclopentane.

Examples of the “optionally halogenated C1-C6 alkoxy group” include a methoxy group, a trifluoromethoxy group, an ethoxy group, a 2,2,2-trifluoroethoxy group, a propyloxy group, an isopropyloxy group, a butoxy group, an isobutyloxy group, a sec-butoxy group, a tert-butoxy group, a pentyloxy group and a hexyloxy group.

Examples of the “optionally halogenated C1-C6 alkvlthio group” include a methylthio group, a trifluoromethylthio group, and an ethylthio group.

Examples of the “optionally halogenated C1-C6 alkylsulfinyl group” include a methylsulfinyl group, a trifluoromethylsulfinyl group and an ethylsulfinyl group.

Examples of the “optionally halogenated C1-C6 alkylsulfonyl group” include a methylsulfonyl group, a trifluoromethylsulfonyl group, and an ethylsulfonyl group.

Examples of the “C1-C6 alkyl group optionally substituted with the substituent F” include a methyl group, a trifluoromethyl group, a trichloromethyl group, a chloromethyl group, a dichloromethyl group, a fluoromethyl group, a difluoromethyl group, a methoxymethyl group, an ethoxymethyl group, a methylthiomethyl group, an ethylthiomethyl group, a methylsulfinylmethyl group, a methylsulfonylmethyl group, a dimethylaminomethyl group, a cyclopropylmethyl group, a cyclopentylmethyl group, a cyclohexylmethyl group, an ethyl group, a pentafluoroethyl group, a propyl group, an isopropyl group, a butyl group, an isobutyl group, a sec-butyl group, a tert-butyl group, a pentyl group, and a hexyl group.

Examples of the “C3-C6 cycloalkyl group optionally substituted with the substituent B” include a cyclopropyl group, a 2-methylcyclopropyl group, a cyclobutyl group, a cyclopentyl group, and a cyclohexyl group.

Examples of the “phenyl group optionally substituted with the substituent G” include a phenyl group, a 2-chlorophenyl group, a 3-chlorophenyl group, a 4-chlorophenyl group, a 4-fluorophenyl group, a 4-bromophenyl group, a 4-iodophenyl group, a 2-cyanophenyl group, a 3-cyanophenyl group, a 4-cyanophenyl group, a 2-nitrophenyl group, a 3-nitrophenyl group, a 4-nitrophenyl group, a 2-methylphenyl group, a 3-methylphenyl group, a 4-methylphenyl group, a 2-(trifluoromethyl)phenyl group, a 3-(trifluoromethyl)phenyl group, a 4-(trifluoromethyl)phenyl group, a 2-methoxyphenyl group, a 3-methoxyphenyl group, a 4-methoxyphenyl group, a 4-(trifluoromethoxy)phenyl group, a 4-(methylthio)phenyl group, a 4-(methylsulfinyl)phenyl group, a 4-(methylsulfonyl)phenyl group, and a 4-(methoxycarbonyl)phenyl group.

Examples of the “naphthyl group optionally substituted with the substituent A” include a 1-naphthyl group and a 2-naphthyl group.

Examples of the “5- to 6-membered heteroaryl group optionally substituted with the substituent A” include a 1-methyl-2-pyrrolyl, a 1-pyrrolyl group, a 2-furyl group, a 3-furyl group, a 5-bromo-2-furyl group, a 5-nitro-2-furyl group, a 2-methyl-3-furyl group, a 2,5-dimethyl-3-furyl group, a 2,4-dimethyl-3-furyl group, a 2-thienyl group, a 3-thienyl group, a 5-methyl-2-thienyl group, a 3-methyl-2-thienyl group, a 1-methyl-3-trifluoromethyl-5-pyrazolyl group, a 5-chloro-1,3-dimethyl-4-pyrazolyl group, a 2-pyridinyl group, a 3-pyridinyl group, a 4-pyridinyl group, a 2-methyl-3-pyridinyl group, a 6-methyl-3-pyridinyl group, 2-chloro-3-pyridinyl group, a 6-chloro-3-pyridinyl group, and a pyrazinyl group.

Examples of the “C3- to C8-membered nonaromatic heterocyclic group optionally substituted with the substituent B” include a tetrahydro-2-furyl group, a tetrahydro-3-furyl group, a piperidino group and a morpholino group.

Examples of the “C7-C9 phenylalkyl group in which the benzene ring moiety may be substituted with the substituent A” include a benzyl group, a 1-phenylethyl group, a 2-phenylethyl group, a 2-chlorobenzyl group, a 3-chlorobenzyl group, a 4-chlorobenzyl group, a 2-cyanobenzyl group, a 3-cyanobenzyl group, a 4-cyanobenzyl group, a 2-nitrobenzyl group, a 3-nitrobenzyl group, a 4-nitrobenzyl group, a 2-methylbenzyl group, a 3-methylbenzyl group, a 4-methylbenzyl group, a 2-(trifluoromethyl)benzyl group, a 3-(trifluoromethyl)benzyl group, a 4-(trifluoromethyl)benzyl group, a 2-methoxybenzyl group, a 3-methoxybenzyl group, and a 4-methoxybenzyl group.

Examples of the “C7-C9 phenoxyalkyl group in which the benzene ring moiety may be substituted with the substituent A” include a phenoxymethyl group, a 2-phenoxyethyl group, and a 1-phenoxyethyl group.

Examples of the “optionally halogenated C1-C6 alkyl group” include a methyl group, a trifluoromethyl group, a trichloromethyl group, an ethyl group, a 2-chloroethyl group, a 2,2,2-trifluoroethyl group, a propyl group, an isopropyl group, a butyl group, an isobutyl group, a sec-butyl group, a tert-butyl group, a pentyl group, and a hexyl group.

When R¹¹ and R¹² are taken together with the nitrogen atom to which they are attached to form a 3- to 8-membered nonaromatic heterocyclic group, examples of the “3- to 8-membered nonaromatic heterocyclic group” include a pyrrolidin-1-yl group, a piperidino group, a 3,5-dimethylpiperidino group, a morpholino group, a 2,6-dimethylmorpholino group, a thiomorpholin-4-yl group, a 4-methylpiperazin-1-yl group, a 4-(ethoxycarbonyl)piperazin-1-yl group and a 4-phenylpiperazin-1-yl group.

Examples of the “phenyl group optionally substituted with the substituent H” include a phenyl group, a 2-fluorophenyl group, a 3-fluorophenyl group, a 4-fluorophenyl group, a 2-chiorophenyl group, a 3-cholorophenyl group, a 4-chloropheyl group, a 2-bromophenyl group, a 2-iodophenyl group, a 2,6-difluorophenyl group, a 2,6-dichiorophenyl group, a 2-chloro-6-fluorophenyl group, a 2-chloro-4-fluorophenyl group, a 2-cyanophenyl group, a 3-cyanophenyl group, a 4-cyanophenyl group, a 2-nitrophenyl group, a 3-nitrophenyl group, a 4-nitrophenyl group, a 2-methylphenyl group, a 3-methylphenyl group, a 4-methylphenyl group, a 2-ethylphenyl group, a 2-isopropylphenyl group, a 2-tert-butylphenyl group, a 2-(trifluoromethyl)phenyl group, a 3-(trifluoromethyl)phenyl group, a 4-(trifluoromethyl)phenyl group, a 2-methoxyphenyl group, a 3-methoxyphenyl group, a 4-methoxyphenyl group, a 2-ethoxyphenyl group, a 2-(trifluoromethoxy)phenyl group, a 2-(methylthio)phenyl group, a 2-(methylsulfinyl)phenyl group, and a 2-(methylsulfonyl)phenyl group.

Examples of the “C7-C9 pyridinylalkyl group in which the pyridine ring moiety may be substituted with the substituent A” include a 2-pyridinylmethyl group, a 3-pyridinylmethyl group, a 4-pyridinylmethyl group, a 3-chloro-2-pyridinylmethyl group, and a 2-chloro-3-pyridinylmethyl group.

Examples of the “C2-C6 cyanoalkyloxy group” include a cyanomethoxy group and a 2-cyanoethoxy group.

Examples of the “optionally halogenated C3-C6 alkoxyalkyloxy group” include a 2-(methoxy)ethoxy group.

Examples of the “optionally halogenated C3-C6 alkenyloxy group” include a 2-propenyloxy group, and a 2-methy-propenyloxy group.

Examples of the “optionally halogenated C3-C6 alkynyloxy group” include a 2-propynyloxy group, and a 2-butynyloxy group.

Examples of a group represented by J1 include a 1-phenylpyrazol-5-yl group, a 1-(2-chlorophenyl)pyrazol-5-yl group, a 1-(2-pyridinyl)pyrazol-5-yl group, a 1-(3-chloro-2-pyridinyl)pyrazol-5-yl group, a 3-fluoro-1-phenylpyrazol-5-yl group, a 1-(2-chlorophenyl)-3-fluoropyrazol-5-yl group, a 3-fluoro-1-(2-pyridinyl)pyrazol-5-yl group, a 3-fluoro-1-(3-chloro-2-pyridinyl)pyrazol-5-yl group, a 3-chloro-1-phenylpyrazol-5-yl group, a 3-chloro-1-(2-chlorophenyl)pyrazol-5-yl group, a 3-chloro-1-(2-pyridinyl)pyrazol-5-yl group, a 3-chloro-1-(3-chloro-2-pyridinyl)pyrazol-5-yl group, a 3-bromo-1-phenylpyrazol-5-yl group, a 3-bromo-1-(2-chlorophenyl)pyrazol-5-yl group, a 3-bromo-1-(2-pyridinyl)pyrazol-5-yl group, a 3-bromo-1-(3-chloro-2-pyridinyl)pyrazol-5-yl group, a 3-iodo-1-phenylpyrazol-5-yl group, a 3-iodo-1-(2-chlorophenyl)pyrazol-5-yl group, a 3-iodo-1-(2-pyridinyl)pyrazol-5-yl group, a 3-iodo-1-(3-chloro-2-pyridinyl)pyrazol-5-yl group, a 3-methyl-1-phenylpyrazol-5-yl group, a 1-(2-chlorophenyl)-3-methylpyrazol-5-yl group, a 3-methyl-1-(2-pyridinyl)pyrazol-5-yl group, a 1-(3-chloro-2-pyridinyl)-3-methylpyrazol-5-yl group, a 1-phenyl-3-(trifluoromethyl)pyrazol-5-yl group, a 1-(2-chlorophenyl)-3-(trifluoromethyl)pyrazol-5-yl group, a 1-(2-pyridinyl)-3-(trifluoromethyl)pyrazol-5-yl group, a 1-(3-chloro-2-pyridinyl)-3-(trifluoromethyl)pyrazol-5-yl group,

a 3-chloro-1-methylpyrazol-5-yl group, a 3-chloro-1-ethylpyrazol-5-yl group, a 3-chloro-1-propylpyrazol-5-yl group, a 1-tert-butyl-3-chloropyrazol-5-yl group, a 3-chloro-1-(3-fluoro-2-pyridinyl)pyrazol-5-yl group, a 1-(3-bromo-2-pyridinyl)-3-chloropyrazol-5-yl group, a 3-chloro-1-(3-iodo-2-pyridinyl)pyrazol-5-yl group, a 3-chloro-1-(3-methyl-2-pyridinyl)pyrazol-5-yl group, a 3-chloro-1-(3-trifluoromethyl-2-pyridinyl)pyrazol-5-yl group, a 3-chloro-1-(3-methoxy-2-pyridinyl)pyrazol-5-yl group, a 3-chloro-1-(3-cyano-2-pyridinyl)pyrazol-5-yl group, a 3-chloro-1-(3-nitro-2-pyridinyl)pyrazol-5-yl group,

a 3-bromo-1-methylpyrazol-5-yl group, a 3-bromo-1-ethylpyrazol-5-yl group, a 3-bromo-1-isopropylpyrazol-5-yl group, a 3-bromo-1-tert-butylpyrazol-5-yl group, a 3-bromo-1-(3-fluoro-2-pyridinyl)pyrazol-5-yl group, a 3-bromo-1-(3-bromo-2-pyridinyl)pyrazol-5-yl group, a 3-bromo-1-(3-iodo-2-pyridinyl)pyrazol-5-yl group, a 3-bromo-1-(3-methyl-2-pyridinyl)pyrazol-5-yl group, a 3-bromo-1-(3-trifluoromethyl-2-pyridinyl)pyrazol-5-yl group, a 3-bromo-1-(3-methoxy-2-pyridinyl)pyrazol-5-yl group, a 3-bromo-1-(3-cyano-2-pyridinyl)pyrazol-5-yl group, a 3-bromo-1-(3-nitro-2-pyridinyl)pyrazol-5-yl group,

a 1-methyl-3-(trifluoromethyl)pyrazol-5-yl group, a 1-ethyl-3-(trifluoromethyl)pyrazol-5-yl group, a 1-isopropyl-3-(trifluoromethyl)pyrazol-5-yl group, a 1-tert-butyl-3-(trifluoromethyl)pyrazol-5-yl group, a 1-(3-fluoro-2-pyridinyl)-3-(trifluoromethyl)pyrazol-5-yl group, a 1-(3-bromo-2-pyridinyl)-3-(trifluoromethyl)pyrazol-5-yl group, a 1-(3-iodo-2-pyridinyl)-3-(trifluoromethyl)pyrazol-5-yl group, a 1-(3-methyl-2-pyridinyl)-3-(trifluoromethyl)pyrazol-5-yl group, a 1-(3-trifluoromethyl-2-pyridinyl)-3-(trifluoromethyl)pyrazol-5-yl group, a 1-(3-methoxy-2-pyridinyl)-3-(trifluoromethyl)pyrazol-5-yl group, a 1-(3-cyano-2-pyridinyl)-3-(trifluoromethyl)pyrazol-5-yl group, a 1-(3-nitro-2-pyridinyl)-3-(trifluoromethyl)pyrazol-5-yl group,

a 1-(3-chloro-2-pyridinyl)-3-ethylpyrazol-5-yl group, a 1-(3-chloro-2-pyridinyl)-3-isopropylpyrazol-5-yl group, a 3-tert-butyl-1-(3-chloro-2-pyridinyl)pyrazol-5-yl group, a 1-(3-chloro-2-pyridinyl)-3-(methylthio)pyrazol-5-yl group, a 1-(3-chloro-2-pyridinyl)-3-(ethylthio)pyrazol-5-yl group, a 1-(3-chloro-2-pyridinyl)-3-(isopropylthio)pyrazol-5-yl group, a 3-tert-butylthio-1-(3-chloro-2-pyridinyl)pyrazol-5-yl group, a 1-(3-chloro-2-pyridinyl)-3-(methylsulfinyl)pyrazol-5-yl group, a 1-(3-chloro-2-pyridinyl)-3-(ethylsulfinyl)pyrazol-5-yl group, a 1-(3-chloro-2-pyridinyl)-3-(isopropylsulfinyl)pyrazol-5-yl group, a 3-tert-butylsulfinyl-1-(3-chloro-2-pyridinyl)pyrazol-5-yl group, a 1-(3-chloro-2-pyridinyl)-3-(methylsulfonyl)pyrazol-5-yl group, a 1-(3-chloro-2-pyridinyl)-3-(ethylsulfonyl)pyrazol-5-yl group, a 1-(3-chloro-2-pyridinyl)-3-(isopropylsulfonyl)pyrazol-5-yl group, a 3-tert-butylsulfonyl-1-(3-chloro-2-pyridinyl)pyrazol-5-yl group, a 1-(3-chloro-2-pyridinyl)-3-(2,2,2-trifluoroethoxy)pyrazol-5-yl group, a 1-(3-chloro-2-pyridinyl)-3-cyanopyrazol-5-yl group,

a 1-(2-chlorophenyl)pyrrol-2-yl group, a 1-(3-chloro-2-pyridinyl)pyrrol-2-yl group, a 4-chloro-1-(2-chlorophenyl)pyrrol-2-yl group, a 4-chloro-1-(3-chloro-2-pyridinyl)pyrrol-2-yl group, a 5-chloro-1-(2-chlorophenyl)pyrrol-2-yl group, a 5-chloro-1-(3-chloro-2-pyridinyl)pyrrol-2-yl group, a 1-(2-chlorophenyl)-4,5-dichloropyrrol-2-yl group, a 1-(3-chloro-2-pyridinyl)-4,5-dichloropyrrol-2-yl group, a 4-bromo-1-(2-chlorophenyl)pyrrol-2-yl group, a 4-bromo-1-(3-chloro-2-pyridinyl)pyrrol-2-yl group, a 5-bromo-1-(2-chlorophenyl)pyrrol-2-yl group, a 5-bromo-1-(3-chloro-2-pyridinyl)pyrrol-2-yl group, a 1-(2-chlorophenyl)-4,5-dibromopyrrol-2-yl group, a 1-(3-chloro-2-pyridinyl)-4,5-dibromopyrrol-2-yl group, a 1-(2-chlorophenyl)-4-iodopyrrol-2-yl group, a 1-(3-chloro-2-pyridinyl)-4-iodopyrrol-2-yl group, a 1-(2-chlorophenyl)-5-iodopyrrol-2-yl group, a 1-(3-chloro-2-pyridinyl)-5-iodopyrrol-2-yl group, a 1-(2-chlorophenyl)-4,5-diiodopyrrol-2-yl group, a 1-(3-chloro-2-pyridinyl)-4,5-diiodopyrrol-2-yl group, a 1-(2-chlorophenyl)-4-(trifluoromethyl)pyrrol-2-yl group, a 1-(3-chloro-2-pyridinyl)-4-(trifluoromethyl)pyrrol-2-yl group, a 1-(2-chlorophenyl)-5-(trifluoromethyl)pyrrol-2-yl group, a 1-(3-chloro-2-pyridinyl)-5-(trifluoromethyl)pyrrol-2-yl group,

a 1-(2-chlorophenyl)imidazol-2-yl group, a 1-(3-chloro-2-pyridinyl)imidazol-2-yl group, 4-chloro-1-(2-chlorophenyl)imidazol-2-yl group, a 4-chloro-1-(3-chloro-2-pyridinyl)imidazol-2-yl group, a 4-bromo-1-(2-chlorophenyl)imidazol-2-yl group, a 4-bromo-1-(3-chloro-2-pyridinyl)imidazol-2-yl group, a 1-(2-chlorophenyl)-4-(trifluoromethyl)imidazol-2-yl group, a 1-(3-chloro-2-pyridinyl)-4-(trifluoromethyl)imidazol-2-yl group, a 1-(2-chlorophenyl)-1,2,4-triazol-5-yl group, a 1-(3-chloro-2-pyridinyl)-1,2,4-triazol-5-yl group, a 3-chloro-1-(2-chlorophenyl)-1,2,4-triazol-5-yl group, a 3-chloro-1-(3-chloro-2-pyridinyl)-1,2,4-triazol-5-yl group, a 3-bromo-1-(2-chlorophenyl)-1,2,4-triazol-5-yl group, a 3-bromo-1-(3-chloro-2-pyridinyl)-1,2,4-triazol-5-yl group, a 1-(2-chlorophenyl)-3-(trifluoromethyl)-1,2,4-triazol-5-yl group, and a 1-(3-chloro-2-pyridinyl)-3-(trifluoromethyl)-1,2,4-triazol-5-yl group.

Examples of the group represented by J2 include a 1-methyl-3-phenylpyrazol-4-yl group, a 3-(2-chlorophenyl)-1-methylpyrazol-4-yl group, a 1-methyl-3-(2-pyridinyl)pyrazol-4-yl group, a 3-(3-chloro-2-pyridinyl)-1-methylpyrazol-4-yl group, a 1-methyl-5-phenylpyrazol-4-yl group, a 5-(2-chlorophenyl)-1-methylpyrazol-4-yl group, a 1-methyl-5-(2-pyridinyl)pyrazol-4-yl group, a 5-(3-chloro-2-pyridinyl)-1-methylpyrazol-4-yl group, a 3-phenyl-1-(2,2,2-trifluoroethyl)pyrazol-4-yl group, a 3-(2-chlorophenyl)-1-(2,2,2-trofluoroethyl)pyrazol-4-yl group, a 3-(2-pyridinyl)-1-(2,2,2-trifluoroethyl)pyrazol-4-yl group, a 3-(3-chloro-2-pyridinyl)-1-(2,2,2-trifluoroethyl)pyrazol-4-yl group, a 5-phenyl-1-(2,2,2-trifluoroethyl)pyrazol-4-yl group, a 5-(2-chlorophenyl)-1-(2,2,2-trifluoroethyl)pyrazol-4-yl group, a 5-(2-pyridinyl)-1-(2,2,2-trifluoroethyl)pyrazol-4-yl group, a 5-(3-chloro-2-pyridinyl)-1-(2,2,2-trifluoroethyl)pyrazol-4-yl group, a 1-(difluoromethyl)-3-phenylpyrazol-4-yl group, a 3-(2-chlorophenyl)-1-(difluoromethyl)pyrazol-4-yl group, a 1-(difluoromethyl)-3-(2-pyridinyl)pyrazol-4-yl group, a 3-(3-chloro-2-pyridinyl)-1-(difluoromethyl)pyrazol-4-yl group, a 1-(difluoromethyl)-5-phenylpyrazol-4-yl group, a 5-(2-chlorophenyl)-1-(difluoromethyl)pyrazol-4-yl group, a 1-(difluoromethyl)-5-(2-pyridinyl)pyrazol-4-yl group, a 5-(3-chloro-2-pyridinyl)-1-(difluoromethyl)pyrazol-4-yl group, a 3-(2-chlorophenyl)-1-ethylpyrazol-4-yl group, a 3-(3-chloro-2-pyridinyl)-1-ethylpyrazol-4-yl group, a 5-(2-chlorophenyl)-1-ethylpyrazol-4-yl group, a 5-(3-chloro-2-pyridinyl)-1-ethylpyrazol-4-yl group, a 3-(2-chlorophenyl)-1-isopropylpyrazol-4-yl group, a 3-(3-chloro-2-pyridinyl)-1-isopropylpyrazol-4-yl group, a 5-(2-chlorophenyl)-1-isopropylpyrazol-4-yl group, a 5-(3-chloro-2-pyridinyl)-1-isopropylpyrazol-4-yl group, a 3-(2-chlorophenyl)-1-tert-butylpyrazol-4-yl group, a 3-(3-chloro-2-pyiridnyl)-1-tert-butylpyrazol-4-yl group, a 5-(2-chlorophenyl)-1-tert-butylpyrazol-4-yl group, and 5-(3-chloro-2-pyridinyl)-1-tert-butylpyrazol-4-yl group.

Examples of the pest on which the composition of the present invention has effect include arthropods such as insects and mites, and nemathelminthes such as nematodes, and specifically, the following organisms.

Hemiptera:

Planthoppers (Delphacidae) such as small brown planthopper (Laodelphax striatellus), brown rice planthopper (Nilaparvata lugens), and white-backed rice planthopper (Sogatella furcifera); leafhoppers (Deltocephalidae) such as green rice leafhopper (Nephotettix cincticeps), and tea green leafhopper (Empoasca onukii); aphids (Aphididae) such as cotton aphid (Aphis gossypii), and green peach aphid (Myzus persicae); stink bugs; whiteflies (Aleyrodidae) such as greenhouse whitefly (Trialeurodes vaporariorum), sweetpotato whitefly (Bemisia tabaci), and silver leaf whitefly (Bemisia argentifolii); scale insects; lace bugs; psyllids; and the like;

Lepidoptera:

Pyralid moths (Pyralidae) such as rice stem borer (Chilo suppressalis), rice leafroller (Cnaphalocrocis medinalis), European corn borer (Ostrinia nubilalis), and bluegrass webworm (Parapediasia teterrella); owlet moths (Noctuidae) such as common cutworm (Spodoptera litura), beet armyworm (Spodoptera exigua), armyworm (Pseudaletia separata), cabbage armyworm (Mamestra brassicae), black cutworm (Agrotis ipsilon), Trichoplusia spp., Heliothis spp., Helicoverpa spp., and Earias spp.; white butterflies (Pieridae) such as common white (Pieris rapae crucivora); tortricid moths (Tortricidae) such as summer fruit tortrix (Adoxophyes orana fasciata), oriental fruit moth (Grapholita molesta), and codling moth (Cydia pomonella); Carposinidae such as peach fruit moth (Carposina niponensis); Bucculatrigidae such as peach leafminer (Lyonetia clerkella); leafblotch miners (Gracillariidae) such as apple leafminer (Phyllonorycter ringoniella); Phyllocnistidae such as citrus leafminer (Phyllocnistis citrella); yponomeutid moths (Yponomeutidae) such as diamondback (Plutela xylostella); gelechiid moths (Gelechiidae) such as pink bollworm (Pectinophora gossypiella); tiger moths; tineid moths; and the like;

Diptera:

House mosquitoes (Culex spp.) such as Culex pipiens pallens, Culex tritaeniorhynchus, and Culex quinquefasciatus; Aedes spp. such as Aedes aegypti, and Aedes albopictus; Anopheles spp. such as Anopheles sinensis; Chironomidae; house flies (Muscidae) such as Musca domestica, and Muscina stabulans; Calliphoridae; Sarcophagidae; Fanniidae; Anthomyiidae such as Delia platura, and Delia antique; Tephritidae; Drosophilidae; Psychodidae; Simuliidae; Tabanidae; Stomoxys; Agromyzidae; and the like;

Coleoptera:

Corn Rootworms such as western corn rootworm (Diabrotica virgifera virgifera) and southern corn rootworm (Diabrotica undecimpunctata howardi); chafers (Scarabaeidae) such as cupreous chafer (Anomala cuprea) and soybean beetle (Anomala rufocuprea); weevils (Curculionidae) such as maize weevil (Sitophilus zeamais), rice water weevil (Lissorhoptrus oryzophilus), and azuki bean weevil (Callosobruchuys chienensis); darkling beetles (Tenebrionidae) such as yellow mealworm (Tenebrio molitor), and red flour beetle (Tribolium castaneum); leaf beetles (Chrysomelidae) such as rice leaf beetle (Oulema oryzae), cucurbit leaf beetle (Aulacophora femoralis), striped flea beetle (Phyllotreta striolata), and Colorado beetle (Leptinotarsa decemlineata); death watch beetles; Epilachna such as Twenty-eight-spotted ladybird (Epilachna vigintioctopunctata); Lyctidae; Bostrychidae; Cerambycidae; Paederus fuscipes; and the like;

Thysanoptera:

Thrips (Thripidae) such as Thrips spp. such as melon thrips (Thrips palmi), Frankliniella spp. such as yellow citrus thrips (Frankliniella occidentalis), and Sciltothrips spp. such as yellow tea thrips (Sciltothrips dorsalis); Phlaeothripidae; and the like;

Hymenoptera: sawflies, ants, hornets, and the like;

Dictyoptera: cockroaches, Blatellidae, and the like;

Orthoptera: locusts, mole crickets, and the like;

Siphonaptera: human fleas, and the like;

Anoplura: body lice, and the like;

Isoptera: termites, and the like;

Acarina:

Spider mites (Tetranychidae) such as two-spotted spider mite (Tetranychus urticae), Kanzawa spider mite (Tetranychus kanzawai), citrus red mite (Panonychus citri), European red mite (Panonychus ulmi), and Oligonychus spp.; eriophyid mites (Eriophyidae) such as pink citrus rust mite (Aculops pelekassi), and apple rust mite (Aculus schlechtendali); tarosonemid mites (Tarsonemidae) such as broad mite (Polyphagotarsonemus latus); Tenuipalpidae; Tuckerellidae; ticks (Ixodidae) such as Haemaphysalis longicornis, Haemaphysalis flava, Dermacentor taiwanicus, Ixodes ovatus, Ixodes persulcatus, and Boophilus microplus; acarid mites (Acaridae) such as Tyrophagus putrescentiae; Pyroglyphidae such as Dermatophagoides farinae, and Dermatophagoides ptrenyssnus; cheyletide mites (Cheyletidae) such as Cheyletus eruditus, Cheyletus malaccensis, and Cheyletus moorei; Dermanyssidae; and the like;

Nematodes: coffee root-lesion nematode (Pratylenchus coffeae), Pratylenchus fallax, soybean cyst nematode (Heterodera glycines), potato cyst nematode (Globodera rostochiensis), northern root-knot nematode (Meloidogyne hapla), southern root-knot nematode (Meloidogyne incognita), and the like.

In the composition of the present invention, a mixing ratio of the compound X and the compound I is not particularly limited, and it is usually 25:1 to 1:250, preferably 2.5:1 to 1:25.

The composition of the present invention may contain only the compound X and the compound I. However, the composition of the present invention is usually prepared by mixing the compound X and the compound I, mixing the mixture with a solid carrier, a liquid carrier or/and a gaseous carrier and, if necessary, adding a pharmaceutical additive such as a surfactant, a binder, a dispersant or a stabilizer, followed by formulation into a wettable powder, a suspension, a granule, a dry flowable, an emulsifiable concentrate, an aqueous liquid, an oil solution, a smoking pesticide, an aerosol, a microcapsule or the like. Alternatively, the composition of the present invention is prepared by formulating the compound X and the compound I separately as described above, and if necessary diluting the respective formulations thus obtained with water, and then mixing these formulations. The formulation usually contains the active ingredient compounds in a total amount of 0.05 to 95% by weight.

Examples of the solid carrier used for formulation include finely-divided powders or granules of clays (kaolin clay, diatomaceous earth, synthetic hydrous silicon oxide, bentonite, Fubasami clay, acid clay, etc.), talc, ceramics, other inorganic minerals (sericite, quartz, sulfur, active carbon, calcium carbonate, hydrated silica, etc.), chemical fertilizers (ammonium sulfate, ammonium phosphate, ammonium nitrate, urea, ammonium chloride, etc.) and the like. Examples of the liquid carrier include water, alcohols (methanol, ethanol, etc.), ketones (acetone, methyl ethyl ketone, etc.), aromatic hydrocarbons (benzene, toluene, xylene, ethylbenzene, methylnaphthalene, etc.), aliphatic hydrocarbons (hexane, cyclohexane, kerosene, gas oil, etc.), esters (ethyl acetate, butyl acetate, etc.), nitriles (acetonitrile, isobutyronitrile, etc.), ethers (diisopropyl ether, dioxane, etc.), acid amides (N,N-dimethylformamide, N,N-dimethylacetamide, etc.), halogenated hydrocarbons (dichloromethane, trichloroethane, carbon tetrachloride, etc.), dimethyl sulfoxide, and vegetable oils (soybean oil, cotton seed oil, etc.).

Examples of the gaseous carrier include fluorocarbon, butane gas, LPG (liquefied petroleum gas), dimethyl ether and carbon dioxide.

Examples of the surfactant include alkylsulfate, alkylsulfonate, alkylarylsulfonate, alkyl aryl ethers and polyoxyethylenated compounds thereof, polyethylene glycol ethers, polyhydric alcohol esters, and sugar alcohol derivatives.

Examples of other pharmaceutical additives include a binder, a dispersant and a stabilizer, specifically, casein, gelatin, polysaccharides (starch powder, gum arabic, cellulose derivatives, alginic acid, etc.), lignin derivatives, bentonite, saccharides, synthetic water-soluble polymers (polyvinyl alcohol, polyvinylpyrrolidone, polyacrylic acids, etc.), PAP (acidic isopropyl phosphate), BHT (2,6-di-tertiary butyl-4-methylphenol), BHA (a mixture of 2-tertiary butyl-4-methoxyphenol and 3-tertiary butyl-4-methoxyphenol), vegetable oils, mineral oils, and fatty acid or ester thereof.

Examples of a base for a poison bait include bait components such as serial powder, vegetable oil, sugar, and crystalline cellulose, antioxidants such as dibutylhydroxytoluene, and nordihydroguaiaretic acid, preservatives such as dehydroacetic acid, agents for preventing erroneous eating by children or pets such as hot pepper powder, pest attractive perfumes such as a cheese perfume, an onion perfume, and a peanut oil.

The method for controlling pests of the present invention is usually carried out by applying the composition of the present invention to pests or a place where pests inhabit.

When the composition of the present invention is used for pest control in agriculture and forestry, the application amount is usually 0.1 to 1000 g/1000 m², preferably 10 to 500 g/1000 m² of the active ingredients. When the composition of the present invention is in the form of an emulsifiable concentrate, a wettable powder, a flowable formulation or a microcapsule formulation, it is aprayed after dilution with water so as to contain usually 1 to 10,000 ppm, preferably 10 to 500 ppm of the active ingredients. When the composition of the present invention is in the form of a granule or a dust, it is usually used as it is.

The composition of the present invention can be used to treat the foliage of plants to be protected from pests, such as crop plants. Seedbeds before planting or planting holes or plant feet in planting can be also treated with the composition of the present invention. Soil in cropland can be also treated with the composition of the present invention to control pests living in the soil. Further, a resin formulation of the composition of the present invention in the form of a sheet or a string can be also used by winding around crop plants with the resin formulation, stretching the resin preparation in the vicinity of crop plants, and/or laying the resin formulation on the soil surface at the plant feet.

### Examples

Hereinafter, the present invention will be explained in more detail by way of Reference Examples, Formulation Examples, and Test Examples which the present invention is not limited to. In the following Examples, unless otherwise indicated, the term “part(s)” represents a part(s) by weight. First, Preparation Examples of the embodiment of the compound I will be explained.

### Reference Example 1

A mixture of 0.22 g of N-(3-aminobenzoyl)-N′-ethoxycarbonylhydrazine, 0.31 g of 1-(3-chloro-2-pyridinyl)-3-trifluoromethyl-1H-pyrazole-5-carbonyl chloride and 10 mL of pyridine was stirred at room temperature for 2 hours. Water was poured into the reaction mixture, and a formed precipitate was collected by filtration to obtain 0.13 g of a compound I-(1).

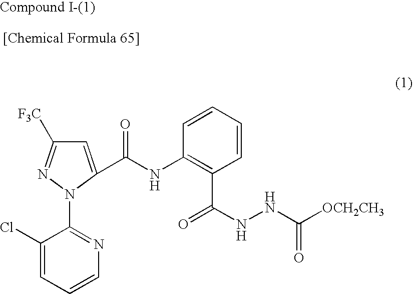

¹H-NMR (CDCl₃, TMS) δ(ppm): 1.35 (3H, t, J=8 Hz), 4.29 (2H, q, J=8 Hz), 6.85 (1H, brs), 7.10 (1H, t, J=8 Hz), 7.24 (1H, s), 7.44 (1H, t, J=8 Hz), 7.47 (1H, dd, J=8 Hz, 4 Hz), 7.62 (1H, d, J=8 Hz), 7.93 (1H, d, J=4 Hz), 8.42 (1H, brs), 8.46 (1H, d, J=8 Hz), 8.52 (1H, d, J=8 Hz), 11.86 (1H, brs)

### Reference Example 2

A mixture of 0.13 g of 1-methyl-1H-pyrrole-2-carboxylic acid, 0.15 g of thionyl chloride and 5 mL of hexane was heated to reflux for 2 hours. The reaction mixture was concentrated under reduced pressure to obtain 0.14 g of 1-methyl-1H-pyrrole-2-carbonyl chloride. To a mixture of 0.22 g of N-(2-aminobenzoyl)-N′-ethoxycarbonylhydrazine and 10 mL of pyridine was added 0.14 g of the resulting 1-methyl-1H-pyrrole-2-carbonyl chloride, and the mixture was stirred at room temperature for 2 hours. Water was poured into the reaction mixture, and a formed precipitate was collected by filtration to obtain 0.11 g of a compound I-(2).

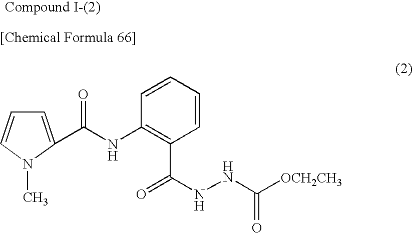

¹H-NMR (DMSO-d₆, TMS) δ(ppm): 1.02-1.28 (3H, m), 3.91 (3H, s), 4.00-4.16 (2H, m), 6.13 (1H, d, J=4 Hz), 6.78 (1H, d, J=4 Hz), 7.06 (1H, m), 7.15 (1H, t, J=8 Hz), 7.56 (1H, t, J=8 Hz), 7.79 (1H, d, J=8 Hz), 8.57 (1H, d, J=8 Hz), 9.30 (1H, brs), 10.57 (1H, brs), 11.63 (1H, brs)

### Reference Example 3

A mixture of 0.19 g of 1-methyl-3-trifluoromethyl-1H-pyrazole-5-carboxylic acid, 0.15 g of thionyl chloride and 5 mL of hexane was heated to reflux for 2 hours. The reaction mixture was concentrated under reduced pressure to obtain 0.14 g of 1-methyl-3-trifluoromethyl-1H-pyrazole-5-carbonyl chloride. To a mixture of 0.22 g of N-(2-aminobenzoyl)-N′-ethoxycarbonylhydrazine and 10 mL of pyridine was added 0.14 g of the resulting 1-methyl-3-trifluoromethyl-1H-pyrazole-5-carbonyl chloride, and the mixture was stirred at room temperature for 2 hours. Water was poured into the reaction mixture, and a formed precipitate was collected by filtration to obtain 0.23 g of a compound I-(3).

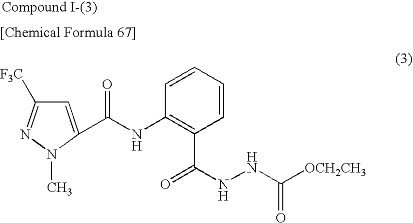

¹H-NMR (DMSO-d₆, TMS) δ(ppm): 1.20 (3H, t, J=8 Hz), 4.10 (2H, q, J=8 Hz), 4.19 (3H, s), 7.17 (1H, s), 7.28 (1H, t, J=8 Hz), 7.60 (1H, t, J=8 Hz), 7.79 (1H, d, J=8 Hz), 8.37 (1H, d, J=8 Hz), 9.02 (1H, brs), 10.41 (1H, brs), 11.50 (1H, brs)

### Reference Example 4

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.06 g of ethyl chloroformate and 10 mL of pyridine was stirred at room temperature for 2 hours. Water was poured into the reaction solution, and a formed precipitate was collected by filtration to obtain 0.08 g of a compound I-(4).

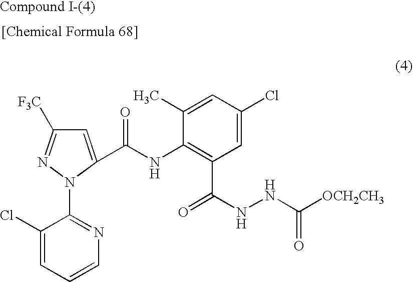

¹H-NMR (DMSO-d₆, TMS) δ(ppm): 0.96-1.26 (3H, m), 2.16 (3H, s), 3.90-4.12 (2H, m), 7.38 (1H, s), 7.55 (1H, s), 7.66 (1H, dd, J=8 Hz, 4 Hz), 7.71 (1H, s), 8.22 (1H, d, J=8 Hz), 8.53 (1H, d, J=4 Hz), 9.25 (1H, brs), 10.14 (1H, brs), 10.37 (1H, brs)

### Reference Example 5

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.05 g of methyl chloroformate and 10 mL of pyridine was stirred at room temperature for 2 hours. Water was poured into the reaction mixture, and a formed precipitate was collected by filtration to obtain 0.16 g of a compound I-(5).

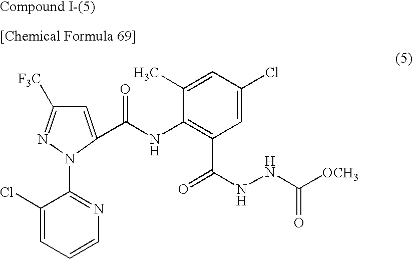

¹H-NMR (DMSO-d₆, TMS) δ(ppm): 2.16 (3H, s), 3.62 (3H, s), 7.39 (1H, s), 7.56 (1H, s), 7.67 (1H, dd, J=8 Hz, 4 Hz), 7.70 (1H, s), 8.22 (1H, d, J=8 Hz), 8.54 (1H, d, J=4 Hz), 9.31 (1H, brs), 10.17 (1H, brs), 10.38 (1H, brs)

### Reference Example 6

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.05 g of isopropyl chloroformate and 10 mL of pyridine was stirred at room temperature for 2 hours. Water was poured into the reaction mixture, and a formed precipitate was collected by filtration to obtain 0.21 g of a compound I-(6).

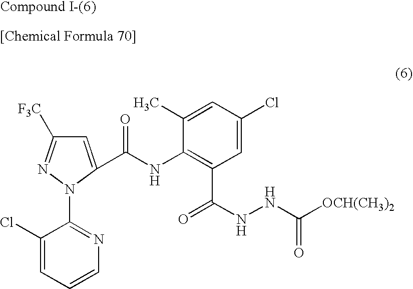

¹H-NMR (DMSO-d₆, TMS) δ(ppm): 0.97-1.31 (6H, m), 2.16 (3H, s), 4.68-4.89 (1H, m), 7.38 (1H, s), 7.55 (1H, s), 7.66 (1H, dd, J=8 Hz, 4 Hz), 7.71 (1H, s), 8.22 (1H, d, J=8 Hz), 8.53 (1H, d, J=4 Hz), 9.18 (1H, brs), 10.12 (1H, brs), 10.37 (1H, brs)

### Reference Example 7

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.05 g of cyclopropanecarbonyl chloride and 10 mL of pyridine was stirred at room temperature for 2 hours. Water was poured into the reaction mixture, and a formed precipitate was collected by filtration to obtain 0.20 g of a compound I-(7).

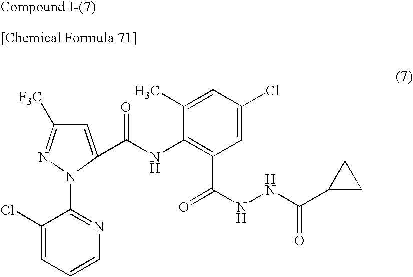

¹H-NMR (DMSO-d₆, TMS) δ(ppm): 0.57-0.82 (4H, m), 1.63-1.73 (1H, m), 2.16 (3H, s), 7.43 (1H, s), 7.54 (1H, s), 7.66 (1H, dd, J=8 Hz, 4 Hz), 7.74 (1H, s), 8.22 (1H, d, J=⁸ Hz), 8.53 (1H, d, J=4 Hz), 10.19 (1H, brs), 10.40 (1H, brs)

### Reference Example 8

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.07 g of benzoyl chloride and 10 mL of pyridine was stirred at room temperature for 2 hours. Water was poured into the reaction mixture, and a formed precipitate was collected by filtration to obtain 0.15 g of a compound I-(8).

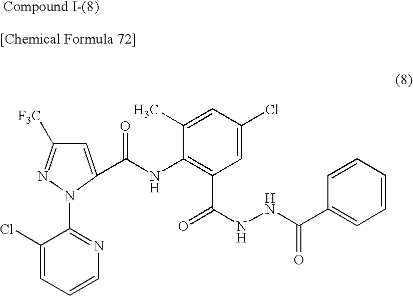

¹H-NMR (DMSO-d₆, TMS) δ(ppm): 2.18 (3H, s), 7.48-7.69 (5H, m), 7.77 (1H, s), 7.90-7.96 (3H, m), 8.22 (1H, d, J=8 Hz), 8.55 (1H, d, J=4 Hz), 10.36 (1H, brs), 10.42 (1H, brs), 10.60 (1H, brs)

### Reference Example 9

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.07 g of 4-morpholinecarbonyl chloride and 10 mL of pyridine was stirred at room temperature for 2 hours. Water was poured into the reaction mixture, and a formed precipitate was collected by filtration to obtain 0.12 g of a compound I-(9).

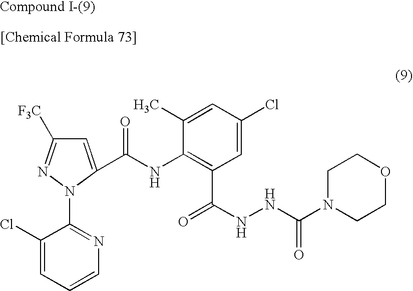

¹H-NMR (DMSO-d₆, TMS) δ(ppm): 2.15 (3H, s), 3.22-3.42 (4H, m), 3.53-3.63 (4H, m), 7.44 (1H, s), 7.53 (1H, s), 7.66 (1H, dd, J=8 Hz, 4 Hz), 7.77 (1H, s), 8.22 (1H, d, J=8 Hz), 8.54 (1H, d, J=4 Hz), 8.78 (1H, brs), 9.88 (1H, brs), 10.33 (1H, brs)

### Reference Example 10

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.06 g of N,N-dimethylcarbamoyl chloride and 10 mL of pyridine was stirred at room temperature for 2 hours. Water was poured into the reaction mixture, and a formed precipitate was collected by filtration to obtain 0.13 g of a compound I-(10).

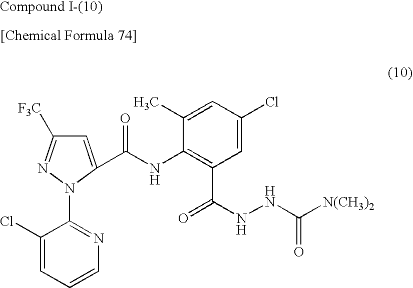

¹H-NMR (DMSO-d₆, TMS) δ(ppm): 2.14 (3H, s), 2.86 (6H, s), 7.42 (1H, s), 7.52 (1H, s), 7.67 (1H, dd, J=8 Hz, 4 Hz), 7.82 (1H, s), 8.22 (1H, d, J=8 Hz), 8.48-8.58 (2H, m), 9.83 (1H, brs), 10.31 (1H, brs)

### Reference Example 11

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.06 g of n-propyl chloroformate and 10 mL of pyridine was stirred at room temperature for 2 hours. Water was poured into the reaction mixture, and a formed precipitate was collected by filtration to obtain 0.24 g of a compound I-(11).

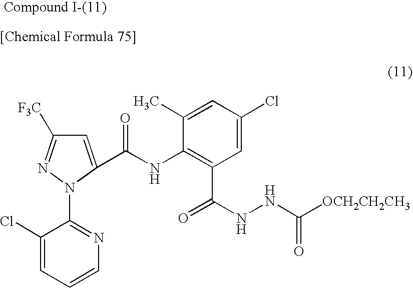

¹H-NMR (DMSO-d₆, TMS) δ(ppm): 0.66-0.98 (3H, m), 1.37-1.66 (2H, m), 2.16 (3H, s), 3.83-4.08 (2H, m), 7.38 (1H, s), 7.55 (1H, s), 7.66 (1H, dd, J=8 Hz, 4 Hz), 7.71 (1H, s), 8.22 (1H, d, J=8 Hz), 8.53 (1H, d, J=4 Hz), 9.26 (1H, brs), 10.14 (1H, brs), 10.37 (1H, brs)

### Reference Example 12

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.05 g of ethyl isocyanate and 10 mL of tetrahydrofuran was stirred at room temperature for 2 hours. Water was poured into the reaction mixture, and a formed precipitate was collected by filtration to obtain 0.16 g of a compound I-(12).

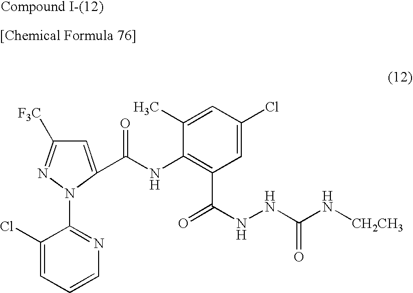

¹H-NMR (DMSO-d₆, TMS) δ(ppm): 1.12 (3H, t, J=6 Hz), 2.18 (3H, s), 3.78 (2H, q, J=6 Hz), 6.34 (1H, m), 7.48 (1H, s), 7.54 (1H, s), 7.65-7.69 (2H, m), 7.74 (1H, brs), 8.23 (1H, d, J=8 Hz), 8.54 (1H, d, J=4 Hz), 9.99 (1H, brs), 10.34 (1H, brs)

### Reference Example 13

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.07 g of phenyl isocyanate and 10 mL of tetrahydrofuran was stirred at room temperature for 2 hours. Water was poured into the reaction mixture, and a formed precipitate was collected by filtration to obtain 0.12 g of a compound I-(13).

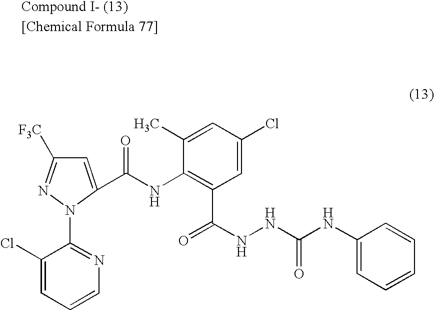

¹H-NMR (DMSO-d₆, TMS) δ(ppm): 2.18 (3H, s), 6.93-7.00 (2H, m), 7.21-7.31 (2H, m), 7.40-7.47 (2H, m), 7.51 (1H, s), 7.54-7.58 (1H, m), 7.66 (1H, dd, J=8 Hz, 4 Hz), 7.71 (1H, s), 8.22 (1H, d, J=8 Hz), 8.53 (1H, d, J=4 Hz), 8.73 (1H, brs), 10.18 (1H, brs), 10.40 (1H, brs)

### Reference Example 14

A mixture of 0.24 g of N-(2-methylaminobenzoyl)-N′-ethoxycarbonylhydrazine, 0.31 g of 1-(3-chloro-2-pyridinyl)-3-trifluoromethyl-1H-pyrazole-5-carbonyl chloride and 10 mL of pyridine was stirred at room temperature for 2 hours. Water was poured into the reaction mixture, and a formed precipitate was collected by filtration to obtain 0.20 g of a compound I-(14).

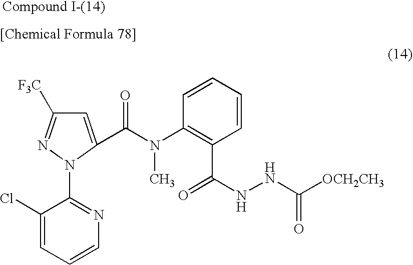

¹H-NMR (DMSO-d₆, TMS) δ(ppm): 1.06-1.27 (3H, m), 3.18 (3H, s), 4.01-4.16 (2H, m), 6.34 (1H, s), 7.31-7.37 (1H, m), 7.53-7.61 (3H, m), 7.71 (1H, dd, J=8 Hz, 4 Hz), 8.31 (1H, d, J=8 Hz), 8.62 (1H, d, J=4 Hz), 9.33 (1H, brs), 10.44 (1H, brs)

### Reference Example 15

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.05 g of ethanesulfonyl chloride and 10 mL of pyridine was stirred at room temperature for 2 hours. Water was poured into the reaction mixture, and a formed precipitate was collected by filtration to obtain 0.14 g of a compound I-(15).

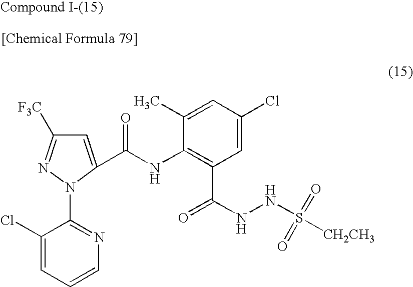

¹H-NMR (DMSO-d₆, TMS) δ(ppm): 1.20 (3H, t, J=8 Hz), 2.18 (3H, s), 3.02 (2H, q, J=8 Hz), 7.39 (1H, s), 7.57 (1H, s), 7.66 (1H, dd, J=8 Hz, 4 Hz), 7.68 (1H, s), 8.22 (1H, d, J=8 Hz), 8.53 (1H, d, J=4 Hz), 9.95 (1H, brs), 10.41 (1H, brs), 10.57 (1H, brs)

### Reference Example 16

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.05 g of N,N-dimethylsulfamoyl chloride and 10 mL of pyridine was stirred at room temperature for 2 hours. Water was poured into the reaction mixture, and a formed precipitate was collected by filtration to obtain 0.14 g of a compound I-(16).

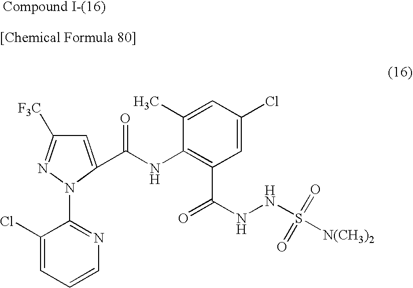

¹H-NMR (DMSO-d₆, TMS) δ(ppm): 2.16 (3H, s), 2.71 (6H, s), 7.28 (1H, s), 7.57 (1H, s), 7.66 (1H, dd, J=8 Hz, 4 Hz), 7.75 (1H, s), 8.22 (1H, d, J=8 Hz), 8.53 (1H, d, J=4 Hz), 9.31 (1H, brs), 10.42 (1H, brs), 10.51 (1H, brs)

### Reference Example 17

Under ice-cooling, 0.22 g of N-[4-chloro-2-(hydrazinocarbonyl)-6-methylpheny1]-1-(3-chloro-2-pyridinyl)-3-trifluoromethyl-1H-pyrazole-5-carboxamide, 10 mL of formic acid and 5 mL of acetic anhydride were mixed. The mixture was stirred at room temperature for 2 hours. Water was poured into the reaction mixture, and a formed precipitate was collected by filtration to obtain 0.02 g of a compound I-(17).

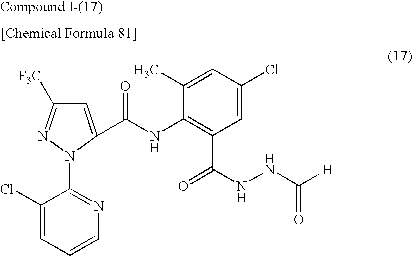

¹H-NMR (DMSO-d₆, TMS) δ(ppm): 2.16 (3H, s), 7.43 (1H, s), 7.56 (1H, s), 7.66 (1H, dd, J=8 Hz, 4 Hz), 7.73 (1H, s), 8.05 (1H, s), 8.22 (1H, d, J=8 Hz), 8.53 (1H, d, J=4 Hz), 10.13 (1H, brs), 10.39 (1H, brs), 10.46 (1H, brs)

### Reference Example 18

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.05 g of propionyl chloride and 10 mL of pyridine was stirred at room temperature for 2 hours. Water was poured into the reaction mixture, and a formed precipitate was collected by filtration to obtain 0.15 g of a compound I-(18).

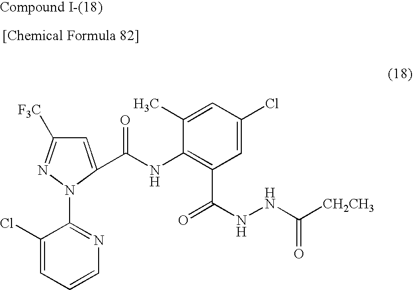

¹H-NMR (DMSO-d₆, TMS) δ(ppm): 1.04 (3H, t, J=8 Hz), 2.13 (5H, m), 7.44 (1H, s), 7.55 (1H, s), 7.66 (1H, dd, J=8 Hz, 4 Hz), 7.74 (1H, s), 8.22 (1H, d, J=8 Hz), 8.54 (1H, d, J=4 Hz), 9.91 (1H, brs), 10.16 (1H, brs), 10.36 (1H, brs)

### Reference Example 19

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.05 g of n-butyl chloroformate and 10 mL of pyridine was stirred at room temperature for 2 hours. Water was poured into the reaction mixture, and a formed precipitate was collected by filtration to obtain 0.19 g of a compound I-(19).

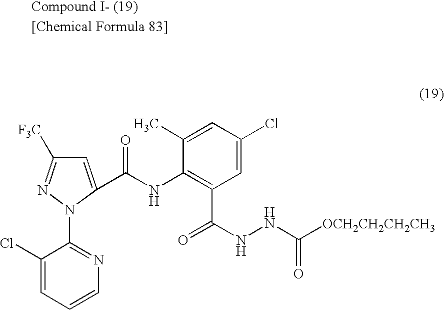

¹H-NMR (DMSO-d₆, TMS) δ(ppm): 0.79-0.94 (3H, m), 1.22-1.40 (2H, m), 1.46-1.62 (2H, m), 2.17 (3H, s), 3.92-4.13 (2H, m), 7.37 (1H, s), 7.56 (1H, s), 7.66 (1H, dd, J=8 Hz, 4 Hz), 7.70 (1H, s), 8.22 (1H, d, J=8 Hz), 8.53 (1H, d, J=4 Hz), 9.25 (1H, brs), 10.14 (1H, brs), 10.37 (1H, brs)

### Reference Example 20

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.05 g of allyl chloroformate and 10 mL of pyridine was stirred at room temperature for 2 hours. Water was poured into the reaction mixture, and a formed precipitate was collected by filtration to obtain 0.23 g of a compound I-(20).

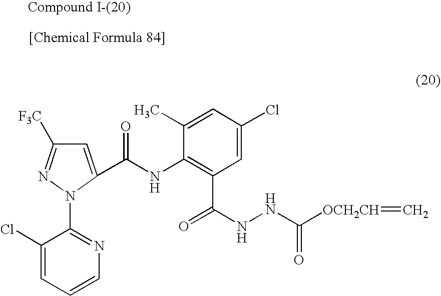

¹H-NMR (DMSO-d₆, TMS) δ(ppm): 2.16 (3H, s), 4.43-4.60 (2H, m), 5.21 (1H, d, J=6 Hz), 5.33 (1H, d, J=8 Hz), 5.86-6.00 (1H, m), 7.39 (1H, s), 7.56 (1H, s), 7.66 (1H, dd, J=8 Hz, 4 Hz), 7.70 (1H, s), 8.22 (1H, d, J=8 Hz), 8.54 (1H, d, J=4 Hz), 9.39 (1H, brs), 10.18 (1H, brs), 10.38 (1H, brs)

### Reference Example 21

A mixture of 0.22 g of N-[4-chloro-2-(methylhydrazinocarbonyl)-6-methylphenyl]-1-(3-chloro-2-pyridinyl)-3-trifluoromethyl-1H-pyrazole-5-carboxamide, 0.05 g of methyl chloroformate and 10 mL of pyridine was stirred at room temperature for 2 hours. Water was poured into the reaction solution, and a formed precipitate was collected by filtration to obtain 0.09 g of a compound I-(21).

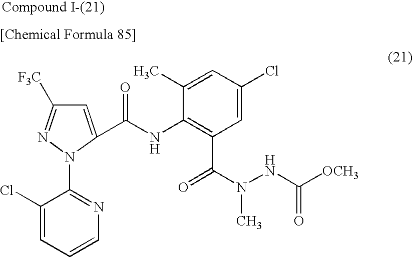

¹H-NMR (DMSO-d₆, TMS) δ(ppm): 2.11 (3H, s), 3.06 (3H, s), 3.33 (3H, s), 7.07 (1H, s), 7.45 (1H, s), 7.68 (1H, s), 7.69 (1H, dd, J=8 Hz, 4 Hz), 8.24 (1H, d, J=8 Hz), 8.55 (1H, d, J=4 Hz), 9.11 (0.6H, brs), 10.20 (1H, brs), 10.54 (0.4H, brs)

### Reference Example 22

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.05 g of N,N-dimethylcarbamoyl chloride and 10 mL of pyridine was stirred at room temperature for 2 hours. Water was poured into the reaction mixture, and a formed precipitate was collected by filtration to obtain 0.19 g of a compound I-(22).

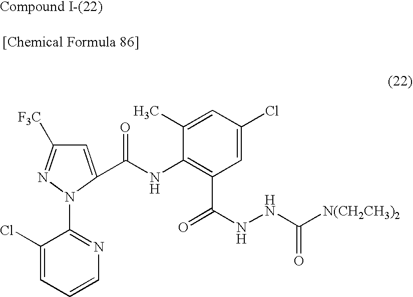

¹H-NMR (DMSO-d₆, TMS) δ(ppm): 1.06 (6H, t, J=6 Hz), 2.14 (3H, s), 3.26 (4H, q, J=6 Hz), 7.42 (1H, s), 7.52 (1H, s), 7.68 (1H, dd, J=8 Hz, 4 Hz), 7.82 (1H, s), 8.23 (1H, d, J=8 Hz), 8.48 (1H, brs), 8.53 (1H, d, J=4 Hz), 9.84 (1H, brs), 10.35 (1H, brs)

### Reference Example 23

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.10 g of N-methyl-N-phenylcarbamoyl chloride and 10 mL of pyridine was stirred at room temperature for 2 hours. Water was poured into the reaction mixture, and a formed precipitate was collected by filtration to obtain 0.19 g of a compound I-(23).

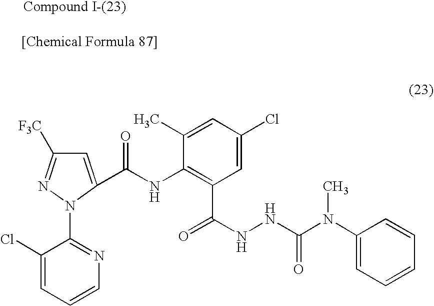

¹H-NMR (DMSO-d₆, TMS) δ(ppm): 2.15 (3H, s), 3.08 (3H, s), 7.10-7.45 (6H, m), 7.53 (1H, s), 7.66 (1H, dd, J=8 Hz, 4 Hz), 7.76 (1H, s), 8.14 (1H, brs), 8.20 (1H, d, J=8 Hz), 8.50 (1H, d, J=4 Hz), 9.97 (1H, brs), 10.32 (1H, brs)

### Reference Example 24

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.15 g of N,N-diphenylcarbamoyl chloride and 10 mL of pyridine was stirred at room temperature for 2 hours. Water was poured into the reaction mixture, and a formed precipitate was collected by filtration to obtain 0.24 g of a compound I-(24).

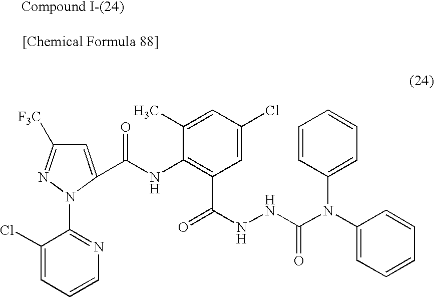

¹H-NMR (DMSO-d₆, TMS) δ(ppm): 2.15 (3H, s) , 6.77 (1H, t, J=8 Hz), 6.81 (1H, t, J=8 Hz), 7.05-7.39 (9H, m), 7.52 (1H, s), 7.64 (1H, dd, J=8 Hz, 4 Hz), 7.72 (1H, s), 8.13 (1H, brs), 8.19 (1H, d, J=8 Hz), 8.47 (1H, d, J=4 Hz), 10.08 (1H, brs), 10.34 (1H, brs)

### Reference Example 25

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.07 g of picolinoyl chloride hydrochloride and 10 mL of pyridine was stirred at room temperature for 2 hours. Water was poured into the reaction mixture, and a formed precipitate was collected by filtration to obtain 0.16 g of a compound I-(25).

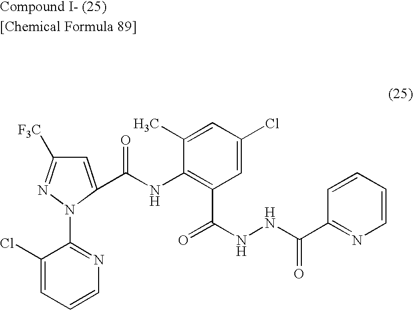

¹H-NMR (DMSO-d₆, TMS) δ(ppm): 2.18 (3H, s), 7.50-7.59 (2H, m), 7.63-7.71 (3H, m), 7.77-7.88 (1H, m), 8.05 (1H, s), 8.06 (1H, s), 8.23 (1H, d, J=8 Hz), 8.54 (1H, d, J=4 Hz), 8.70 (1H, d, J=4 Hz), 10.35-10.70 (2H, m)

### Reference Example 26

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.07 g of phenyl chloroformate and 10 mL of pyridine was stirred at room temperature for 2 hours. Water was poured into the reaction mixture, and a formed precipitate was collected by filtration to obtain 0.16 g of a compound I-(26).

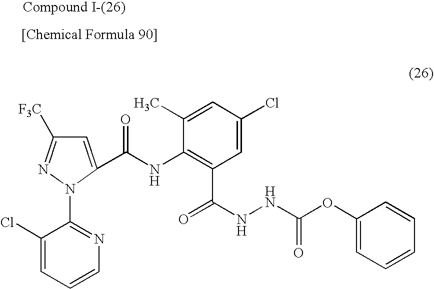

¹H-NMR (DMSO-d₆, TMS) δ(ppm): 2.17 (3H, s), 7.13-7.69 (9H, m), 8.22 (1H, d, J=8 Hz), 8.53 (1H, d, J=4 Hz), 9.95 (1H, brs), 10.43 (1H, brs), 10.45 (1H, brs)

### Reference Example 27

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.04 g of acetyl chloride and 10 mL of pyridine was stirred at room temperature for 2 hours. Water was poured into the reaction mixture, and a formed precipitate was collected by filtration to obtain 0.22 g of a compound I-(27).

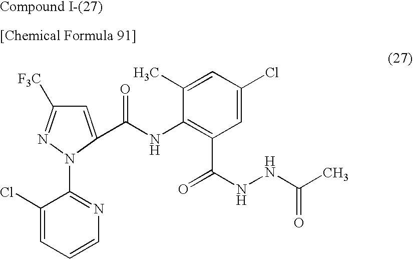

¹H-NMR (DMSO-d₆, TMS) δ(ppm): 1.89 (3H, s), 2.16 (3H, s), 7.44 (1H, s), 7.55 (1H, s), 7.66 (1H, dd, J=8 Hz, 4 Hz), 7.73 (1H, s), 8.21 (1H, d, J=8 Hz), 8.54 (1H, d, J=4 Hz), 9.94 (1H, brs), 10.17 (1H, brs), 10.38 (1H, brs)

### Reference Example 28

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.06 g of trimethylacetyl chloride and 10 mL of pyridine was stirred at room temperature for 2 hours. Water was poured into the reaction mixture, and a formed precipitate was collected by filtration to obtain 0.25 g of a compound I-(28).

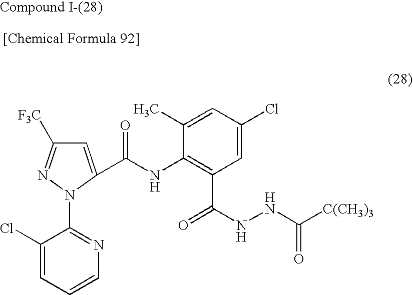

¹H-NMR (DMSO-d₆, TMS) δ(ppm): 1.17 (9H, s), 2.15 (3H, s), 7.46 (1H, s), 7.54 (1H, s), 7.66 (1H, dd, J=8 Hz, 4 Hz), 7.76 (1H, s), 8.23 (1H, d, J=8 Hz), 8.54 (1H, d, J=4 Hz), 9.66 (1H, brs), 10.01 (1H, brs), 10.32 (1H, brs)

### Reference Example 29

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.05 g of methyl chlorothiolformate:

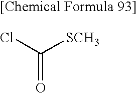

and 10 mL of pyridine was stirred at room temperature for 2 hours. Water was poured into the reaction mixture, and a formed precipitate was collected by filtration to obtain 0.10 g of a compound I-(29).

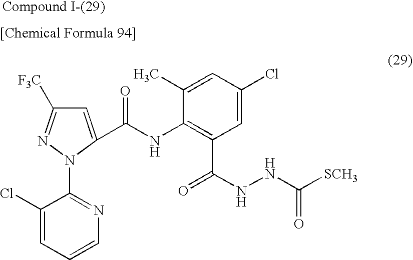

¹H-NMR (DMSO-d₆, TMS) δ(ppm): 2.03-2.34 (6H, m), 7.40 (1H, s), 7.58 (1H, s), 7.66 (1H, dd, J=8 Hz, 4 Hz), 7.71 (1H, s), 8.22 (1H, d, J=8 Hz), 8.53 (1H, d, J=4 Hz), 9.84 (1H, brs), 10.41 (1H, brs), 10.56 (1H, brs)

### Reference Example 30

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.09 g of 3-methylbenzoyl chloride and 10 mL of pyridine was stirred at room temperature for 2 hours. Water was poured into the reaction mixture, and a formed precipitate was collected by filtration to obtain 0.19 g of a compound I-(30).

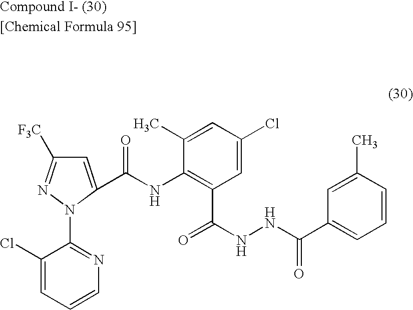

¹H-NMR (DMSO-d₆, TMS) δ(ppm): 2.18 (3H, s), 2.30 (3H, s), 7.40 (1H, s), 7.55 (1H, s), 7.58 (1H, s), 7.65-7.73 (4H, m), 7.77 (1H, s), 8.23 (1H, d, J=8 Hz), 8.54 (1H, d, J=4 Hz), 10.35 (1H, brs), 10.41 (1H, brs), 10.54 (1H, brs)

### Reference Example 31

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.09 g of 4-methoxybenzoyl chloride and 10 mL of pyridine was stirred at room temperature for 2 hours. Water was poured into the reaction mixture, and a formed precipitate was collected by filtration to obtain 0.09 g of a compound I-(31).

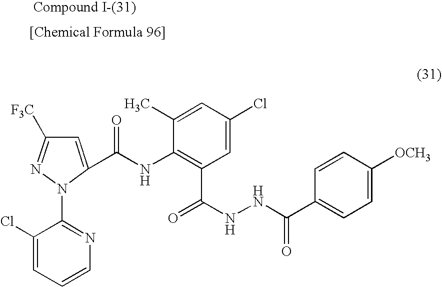

¹H-NMR (DMSO-d₆, TMS) δ(ppm): 2.18 (3H, s), 3.83 (3H, s), 7.04 (2H, d, J=8 Hz), 7.55 (1H, s), 7.58 (1H, s), 7.69 (1H, dd, J=8 Hz, 4 Hz), 7.77 (1H, s), 7.90 (2H, d, 8 Hz), 8.23 (1H, d, J=8 Hz), 8.54 (1H, d, J=4 Hz), 10.28 (1H, brs), 10.41 (1H, brs), 10.45 (1H, brs)

### Reference Example 32

A mixture of 0.18 g of 1-(3-chloro-2-pyridinyl)-N-[2-(hydrazinocarbonyl)-6-methylphenyl]-3-trifluoromethyl-1H-pyrazole-5-carboxamide, 0.06 mL of ethyl chloroformate and 1 mL of pyridine was stirred at room temperature for 2 hours. Water and toluene were sequentially added to the reaction mixture, followed by concentration under reduced pressure. The resulting residue was mixed with methyl tert-butyl ether and water, and layers were separated. The resulting organic layer was washed with a saturated solution of sodium chloride in water, dried over anhydrous magnesium sulfate, and concentrated under reduced pressure. The resulting residue was subjected to silica gel column chromatography to obtain 0.14 g of a compound I-(32).

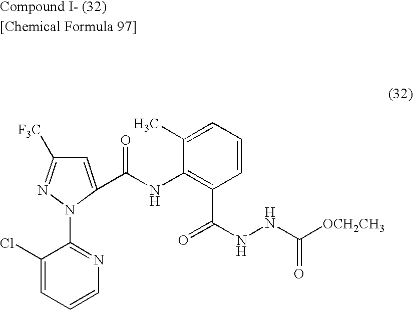

¹H-NMR (CDCl₃, TMS) δ(ppm): 1.26 (3H, brm), 2.21 (3H, s), 4.18 (2H, brq, J=7 Hz), 6.88 (1H, brs), 7.17 (1H, t, J=8 Hz), 7.28-7.39 (4H, m), 7.86 (1H, d, J=8 Hz), 8.05 (1H, brs), 8.43 (1H, d, J=4 Hz), 9.73 (1H, brs)

### Reference Example 33

A mixture of 0.21 g of N-[2-chloro-6-(hydrazinocarbonyl)phenyl]-1-(3-chloro-2-pyridinyl)-3-trifluoromethyl-1H-pyrazole-5-carboxamide, 0.06 mL of ethyl chloroformate and 5 mL of pyridine was stirred at room temperature for 2 hours. Water was poured into the reaction mixture, followed by extraction with methyl tert-butyl ether three times. Organic layers were combined, washed sequentially with 2 mol/L hydrochloric acid, a saturated solution of sodium hydrogen carbonate in water and a saturated solution of sodium chloride in water, dried over anhydrous magnesium sulfate, and concentrated under reduced pressure. The resulting residue was subjected to silica gel column chromatography to obtain 0.16 g of a compound I-(33).

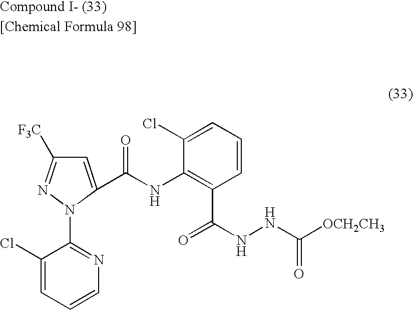

¹H-NMR (CDCl₃, TMS) δ(ppm): 1.28 (3H, t, J=7 Hz), 4.21 (2H, q, J=7 Hz), 6.76 (1H, brs), 7.23-7.30 (2H, m), 7.42 (1H, dd, J=8 Hz, 4 Hz), 7.50 (1H, d, J=8 Hz), 7.55 (1H, d, J=8 Hz), 7.85 (1H, brs), 7.90 (1H, dd, J=8 Hz, 1 Hz), 8.47 (1H, dd, J=4 Hz, 1 Hz), 9.16 (1H, brs)

### Reference Example 34

A mixture of 0.30 g of 3-bromo-N-[4-chloro-2-(hydrazinocarbonyl)-6-methylphenyl]-1-(3-chloro-2-pyridinyl)-1H-pyrazole-5-carboxamide, 0.20 mL of methyl chloroformate, 0.09 mL of triethylamine, 20 mL of acetonitrile and 10 mL of N,N-dimethylformamide was stirred at room temperature for 3 hours. Water was poured into the reaction mixture, followed by extraction with methyl tert-butyl ether three times. Organic layers were combined, washed with a saturated solution of sodium chloride in water, dried over anhydrous magnesium sulfate, and concentrated under reduced pressure. The resulting residue was subjected to silica gel column chromatography to obtain 0.13 g of a compound I-(34).

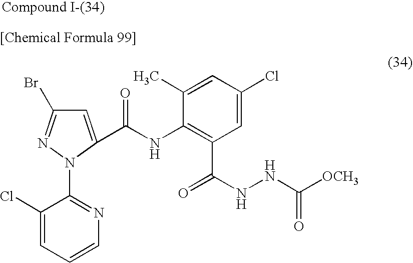

¹H-NMR (DMSO-d₆) δ(ppm): 2.14 (3H, s), 3.61 (3H, brs), 7.33 (1H, s), 7.37 (1H, brs), 7.53 (1H, brs), 7.60 (1H, dd, J=8 Hz, 4 Hz), 8.16 (1H, dd, J=8 Hz, 1 Hz), 8.49 (1H, dd, J=4 Hz, 1 Hz), 9.29 (1H, brs), 10.15 (1H, brs), 10.22 (1H, brs)

### Reference Example 35

A mixture of 0.30 g of 3-bromo-N-[4-chloro-2-(hydrazinocarbonyl)-6-methylphenyl]-1-(3-chloro-2-pyridinyl)-1H-pyrazole-5-carboxamide, 0.09 mL of ethyl chloroformate and 3 mL of pyridine was stirred at room temperature for 3 hours, and concentrated under reduced pressure. Water and toluene were added to the resulting residue, which was filtered. The filtered substance was mixed with methyl tert-butyl ether and water, and layers were separated. The organic layer was washed with a saturated solution of sodium chloride in water, dried over anhydrous magnesium sulfate, and concentrated under reduced pressure. The resulting residue was subjected to silica gel column chromatography to obtain 0.23 g of a compound I-(35).

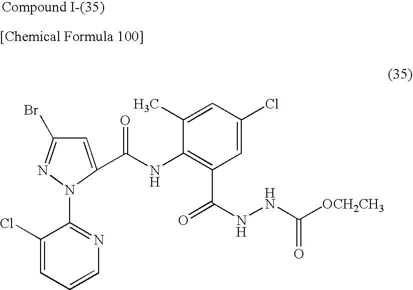

¹H-NMR (DMSO-d₆) δ(ppm): 1.18 (3H, brm), 2.14 (3H, s), 4.06 (2H, brm), 7.34 (1H, s), 7.37 (1H, brs), 7.53 (1H, s), 7.60 (1H, dd, J=8 Hz, 4 Hz), 8.16 (1H, dd, J=8 Hz, 1 Hz), 8.49 (1H, dd, J=4 Hz, 1 Hz), 9.24 (1H, brs), 10.12 (1H, brs), 10.21 (1H, brs)

### Reference Examples 36 and 37

To a solution of 0.30 g of N-[4-chloro-2-(hydrazinocarbonyl)-6-methylphenyl]-1-(2-chlorophenyl)-3-trifluoromethyl-1H-pyrazole-5-carboxamide in 10 mL of acetonitrile were added 0.10 mL of methyl chloroformate and 0.09 mL of triethylamine. The mixture was stirred at room temperature for 1 hour. Then, 0.10 mL of methyl chloroformate was added thereto, and the mixture was further stirred for 3 hours. Water was poured into the reaction mixture, followed by extraction with methyl-tert-butyl three times. Organic layers were combined, washed with a saturated solution of sodium chloride in water, dried over anhydrous magnesium sulfate, and concentrated under reduced pressure. The resulting residue was subjected to silica gel column chromatography to obtain 0.16 g of a compound I-(36) and 0.16 g of a compound I-(37).

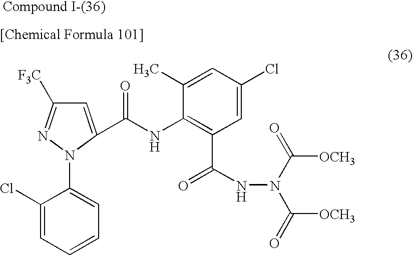

¹H-NMR (CDCl₃, TMS) δ(ppm): 2.15 (3H, s), 3.76 (6H, s), 7.23-7.27 (3H, m), 7.30-7.40 (2H, m), 7.43-7.47 (2H, m), 8.84 (1H, brs), 9.29 (1H, brs).

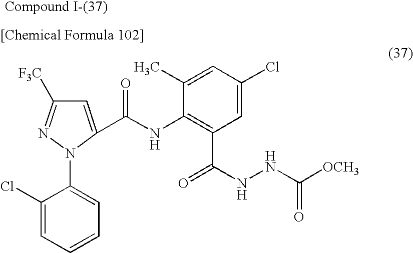

¹H-NMR (DMSO-₆) δ(ppm): 2.22 (3H, s), 3.68 (3H, brs), 7.44 (1H, brs), 7.53-7.72 (6H, m), 9.35 (1H, brs), 10.23 (1H, brs), 10.32 (1H, brs).

### Reference Example 38

A mixture of 0.30 g of N-[4-chloro-2-(hydrazinocarbonyl)-6-methylphenyl]-1-(2-chlorophenyl)-3-trifluoromethyl-1H-pyrazole-5-carboxamide, 2 mL of pyridine and 0.09 mL of ethyl chloroformate was stirred at room temperature for 1 hour, and concentrated under reduced pressure. Water and toluene were added to the resulting residue, which was filtered. The filtered substance was subjected to silica gel column chromatography to obtain 0.22 g of a compound I-(38).

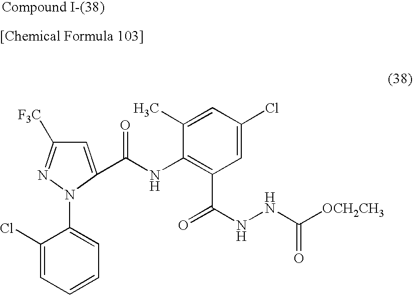

¹H-NMR (DMSO-d₆) δ(ppm): 1.19 (3H, brm), 2.15 (3H, s), 4.05 (2H, brm), 7.37 (1H, s), 7.49-7.66 (6H, m), 9.22 (1H, brs), 10.14 (1H, brs), 10.25 (1H, brs)

### Reference Example 39

A mixture of 0.18 g of 1-(3-chloro-2-pyridinyl)-N-[2-(hydrazinocarbonyl)-6-methylphenyl]-3-trifluoromethyl-1H-pyrazole-5-carboxamide, 0.05 mL of methyl chloroformate and 1 mL of pyridine was stirred at room temperature for 2 hours. Water was poured into the reaction mixture, and toluene was added thereto, followed by concentration under reduced pressure. The resulting residue was mixed with methyl tert-butyl ether and water, and layers were separated. The organic layer was washed with a saturated solution of sodium chloride in water, dried over anhydrous magnesium sulfate, and concentrated under reduced pressure. The resulting residue was subjected to silica gel column chromatography to obtain 0.13 g of a compound I-(39).

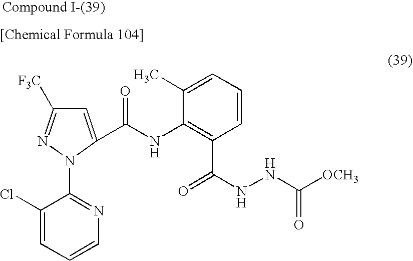

¹H-NMR (CDCl₃, TMS) δ(ppm): 2.22 (3H, s), 3.75 (3H, brs), 6.86 (1H, brs), 7.19 (1H, t, J=8 Hz), 7.27 (1H, s), 7.34-7.40 (3H, m), 7.87 (1H, dd, J=8 Hz, 1.5 Hz), 7.97 (1H, brs), 8.44 (1H, dd, J=4 Hz, 1 Hz), 9.68 (1H, brs)

### Reference Example 40

A mixture of 0.30 g of N-[4-chloro-2-(hydrazinocarbonyl)-6-methylphenyl]-1-(3-chloro-2-pyridinyl)-1H-pyrazole-5-carboxamide, 0.09 mL of methyl chloroformate and 3 mL of pyridine was stirred at room temperature for 1.5 hours. Water and toluene were sequentially added to the reaction mixture, followed by concentration under reduced pressure. The resulting residue was mixed with ethyl acetate and water, and layers were separated. The organic layer was washed with a saturated solution of sodium chloride in water, dried over anhydrous magnesium sulfate, and concentrated under reduced pressure. The resulting residue was subjected to silica gel column chromatography to obtain 0.20 g of a compound I-(40).

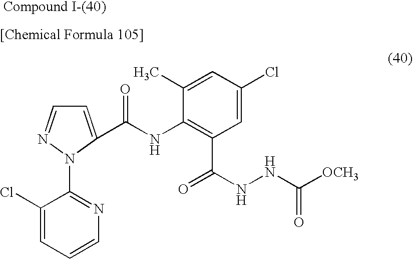

¹H-NMR (DMSO-d₆) δ(ppm): 2.17 (3H, s), 3.62 (3H, brs), 7.25 (1H, d, J=2 Hz), 7.40 (1H, brs), 7.52 (1H, d, J=2 Hz), 7.56 (1H, dd, J=8 Hz, 4 Hz), 7.86 (1H, d, J=2 Hz), 8.11 (1H, dd, J=8 Hz, 1 Hz), 8.48 (1H, dd, J=4 Hz, 1 Hz), 9.31 (1H, brs), 10.11 (1H, brs), 10.13 (1H, brs)

### Reference Example 41

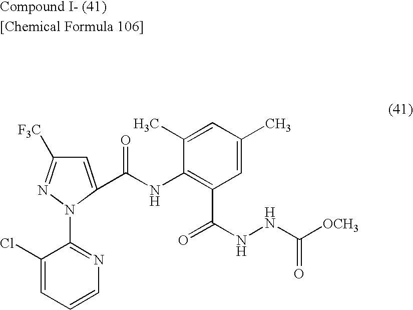

¹H-NMR (DMSO-d₆, TMS) δ(ppm): 2.11 (3H, s), 2.29 (3H, s), 3.55-3.68 (3H, m), 7.19-7.25 (2H, m), 7.66 (1H, dd, J=8 Hz, 4 Hz), 7.71 (1H, s), 8.22 (1H, d, J=8 Hz), 8.53 (1H, d, J=4 Hz), 9.23 (1H, brs), 9.98 (1H, brs), 10.22 (1H, brs)

### Reference Example 42

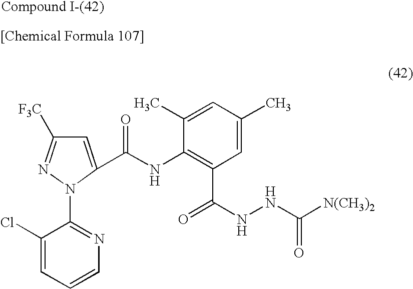

¹H-NMR (DMSO-d₆, TMS) δ(ppm): 2.13 (3H, s), 2.31 (3H, s), 2.86 (6H, s), 7.14-7.27 (2H, m), 7.65-7.70 (1H, m), 7.82 (1H, s), 8.23 (1H, d, J=8 Hz), 8.48 (1H, brs), 8.53 (1H, d, J=4 Hz), 9.65 (1H, brs), 10.16 (1H, brs)

### Reference Example 43

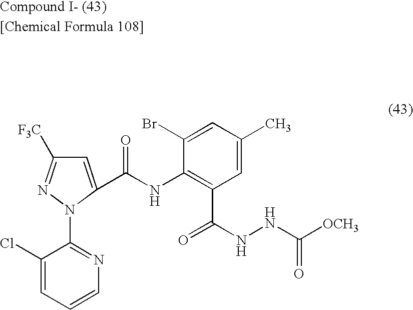

¹H-NMR (DMSO-d₆, TMS) δ(ppm): 2.35 (3H, s), 3.53-3.65 (3H, m), 7.35 (1H, s), 7.65 (1H, dd, J=8 Hz, 4 Hz), 7.68-7.70 (1H, m), 7.76 (1H, s), 8.20 (1H, d, J=8 Hz), 8.53 (1H, d, J=4 Hz), 9.27 (1H, brs), 10.04 (1H, brs), 10.47 (1H, brs)

### Reference Example 44

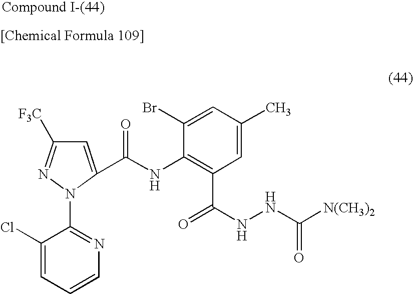

¹H-NMR (DMSO-d₆, TMS) δ(ppm): 2.34 (3H, s), 2.84 (6H, s), 7.40 (1H, s), 7.62-7.70 (2H, m), 7.83 (1H, s), 8.20 (1H, d, J=8 Hz), 8.48 (1H, brs), 8.51-8.56 (1H, m), 9.69 (1H, brs), 10.42 (1H, brs)

### Reference Example 45

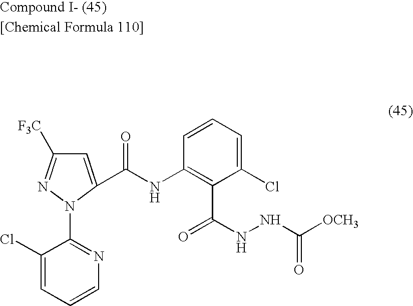

¹H-NMR (DMSO-d₆, TMS) δ(ppm): 3.67-3.74 (3H, m), 7.37-7.47 (2H, m), 7.69-7.74 (1H, m), 7.82-7.88 (2H, m), 8.25-8.33 (1H, m), 8.57 (1H, d, J=4 Hz), 9.71 (1H, brs), 9.83 (1H, brs), 10.56 (1H, brs)

### Reference Example 46

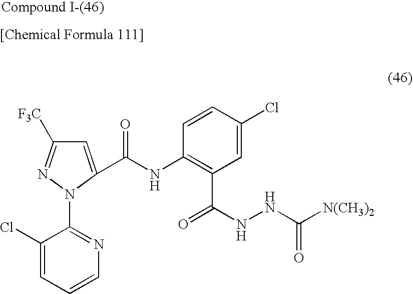

¹H-NMR (DMSO-d₆, TMS) δ(ppm): 2.90 (6H, s), 7.57 (1H, d, J=8 Hz), 7.68-7.70 (1H, m), 7.73 (1H, dd, 8 Hz, 4 Hz), 7.81 (1H, s), 8.18 (1H, d, J=8 Hz), 8.29 (1H, d, J=8 Hz), 8.57 (1H, d, J=4 Hz), 8.83 (1H, brs), 10.36 (1H, brs), 11.27 (1H, brs)

### Reference Example 47

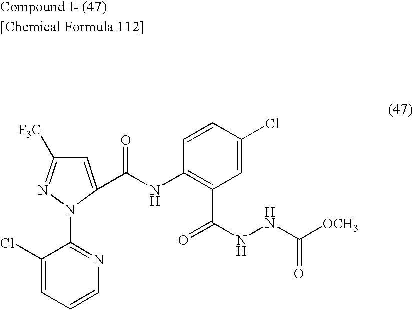

¹H-NMR (DMSO-d₆, TMS) δ(ppm): 3.64-3.71 (3H, m), 7.59 (1H, s), 7.63 (1H, d, J=8 Hz); 7.72 (1H, dd, J=8 Hz, 4 Hz), 7.86 (1H, s), 8.12 (1H, d, J=8 Hz), 8.29 (1H, d, J=8 Hz), 8.58 (1H, d, J=4 Hz), 9.51 (1H, brs), 10.75 (1H, brs), 11.68 (1H, brs)

### Reference Example 48

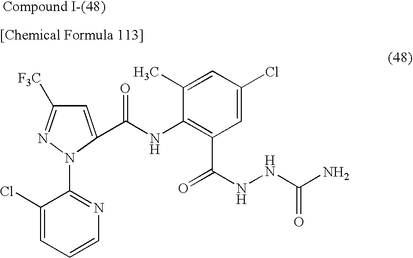

¹H-NMR (DMSO-d₆, TMS) δ(ppm): 2.16 (3H, s), 5.97 (2H, brs), 7.52-7.54 (2H, m), 7.67 (1H, dd, J=8 Hz, 4 Hz), 7.70 (1H, s), 7.76 (1H, brs), 8.22 (1H, d, J=8 Hz), 8.54 (1H, d, J=4 Hz), 10.01 (1H, brs), 10.39 (1H, brs)

### Reference Example 49

A compound I-(49) was obtained according to the same manner as that of Reference Example 5, using N-[4,6-dibromo-2-(hydrazinocarbonyl)phenyl]-1-(3-chloro-2-pyridinyl)-3-trifluoromethyl-1H-pyrazole-5-carboxamide in place of N-[4-chloro-2-(hydrazinocarbonyl)-6-methylphenyl]-1-(3-chloro-2-pyridinyl)-3-trifluoromethyl-1H-pyrazole-5-carboxamide.

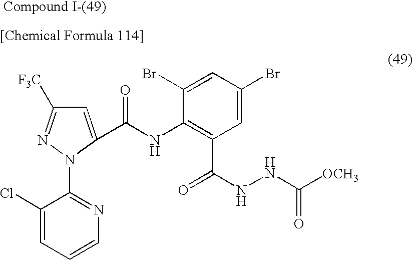

¹H-NMR (DMSO-d₆, TMS) δ(ppm): 3.40-3.70 (3H, m), 7.63-7.69 (2H, m), 7.76 (1H, s), 8.16 (1H, s), 8.21 (1H, d, J=8 Hz), 8.54 (1H, d, J=4 Hz), 9.35 (1H, brs), 10.23 (1H, brs), 10.63 (1H, brs)

### Reference Example 50

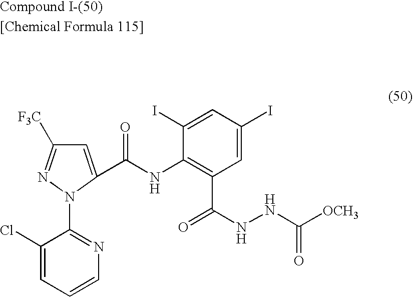

¹H-NMR (DMSO-d₆, TMS) δ(ppm): 3.55-3.65 (3H, m), 7.65 (1H, dd, J=8 Hz, 4 Hz), 7.75-7.82 (2H, m), 8.20 (1H, d, J=8 Hz), 8.39 (1H, s), 8.53 (1H, d, J=4 Hz), 9.31 (1H, brs), 10.14 (1H, brs), 10.59 (1H, brs)

### Reference Example 51

A mixture of 0.22 g of N-[4-chloro-2-(hydrazinocarbonyl)-6-methylphenyl]-1-(3-chloro-2-pyridinyl)-3-trifluoromethyl-1H-pyrazole-5-carboxamide, 0.05 g of methyl isothiocyanate and 10 mL of tetrahydrofuran was stirred at room temperature for 2 hours. Water was poured into the reaction mixture, and a formed precipitate was collected by filtration to obtain 0.20 g of a compound I-(51).

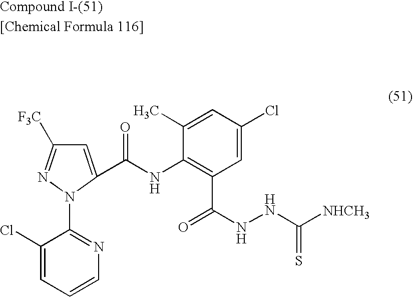

¹H-NMR (DMSO-d₆, TMS) δ(ppm): 2.20 (3H, s), 2.85 (3H, d, J=4 Hz), 7.57 (1H, s), 7.60-7.63 (2H, m), 7.68 (1H, dd, J=8 Hz, 4 Hz), 7.72 (1H, brs), 8.24 (1H, d, J=8 Hz), 8.57 (1H, d, J=4 Hz), 9.13 (1H, brs), 10.31 (1H, brs), 10.42 (1H, brs)

### Reference Example 52

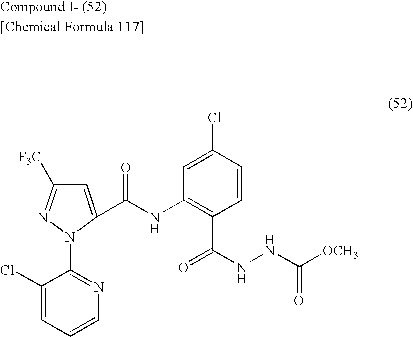

¹H-NMR (DMSO-d₆, TMS) δ(ppm): 3.60-3.77 (3H, m), 7.40 (1H, d, J=8 Hz), 7.57 (1H, s), 7.74 (1H, dd, J=8 Hz, 4 Hz), 7.85 (1H, d, J=8 Hz), 8.22 (1H, s), 8.31 (1H, d, J=8 Hz), 8.59 (1H, d, J=4 Hz), 9.49 (1H, brs), 10.77 (1H, brs), 12.04 (1H, brs)

### Reference Example 53

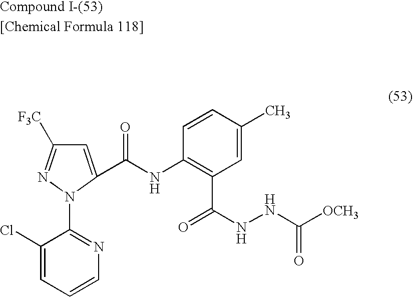

¹H-NMR (DMSO-d₆, TMS) δ(ppm): 2.32 (3H, s), 3.60-3.72 (³H, m), 7.37 (1H, d, J=8 Hz), 7.55 (1H, s), 7.65 (1H, s), 7.73 (1H, dd, J=8 Hz, 4 Hz), 8.02 (1H, d, J=8 Hz), 8.29 (1H, d, J=8 Hz), 8.57 (1H, d, J=4 Hz), 9.43 (1H, brs), 10.64 (1H, brs), 11.72 (1H, brs)

### Reference Example 54

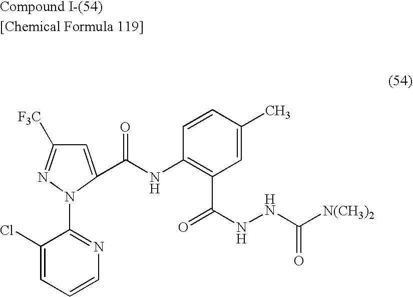

¹H-NMR (DMSO-d₆, TMS) δ(ppm): 2.31 (3H, s), 2.91 (6H, s), 7.29-7.34 (1H, m), 7.48-7.51 (1H, m), 7.70-7.79 (2H, m), 8.04-8.09 (1H, m), 8.26-8.33 (1H, m), 8.55-8.60 (1H, m), 8.75 (1H, brs), 10.24 (1H, brs), 11.30 (1H, brs)

### Reference Example 55

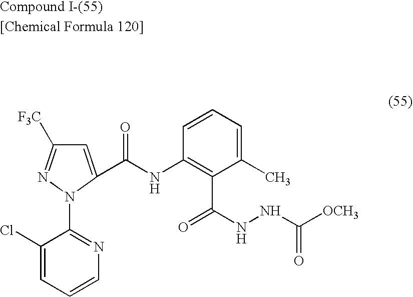

¹H-NMR (DMSO-d₆, TMS) δ(ppm): 2.32 (3H, s), 3.62-3.75 (3H, m), 7.12 (1H, d, J=8 Hz), 7.31 (1H, t, J=8 Hz), 7.61 (1H, d, J=8 Hz), 7.68-7.73 (1H, m), 7.80 (1H, s), 8.27 (1H, d, J=8 Hz), 8.56 (1H, d, J=4 Hz), 9.59 (1H, brs), 9.66 (1H, brs), 10.30 (1H, brs)

### Reference Example 56

A compound I-(56) was obtained according to the same manner as that of Reference Example 5, using N-[4,6-dichloro-2-(hydrazinocarbonyl)phenyl]-1-(3-chloro-2-pyridinyl)-3-trifluoromethyl-1H-pyrazole-5-carboxamide in place of N-[4-chloro-2-(hydrazinocarbonyl)-6-methylphenyl]-1-(3-chloro-2-pyridinyl)-3-trifluoromethyl-1H-pyrazaole-5-carboxamide.

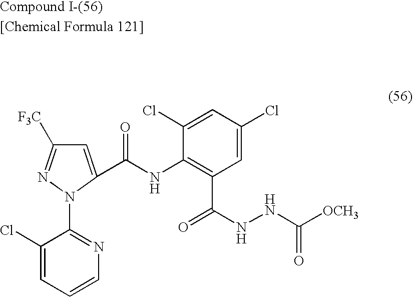

¹H-NMR (DMSO-d₆, TMS) δ(ppm): 3.45-3.66 (3H, m), 7.51 (1H, s), 7.66 (1H, dd, J=8 Hz, 4 Hz), 7.76 (1H, s), 7.94 (1H, s), 8.21 (1H, d, J=8 Hz), 8.53 (1H, d, J=4 Hz), 9.37 (1H, brs), 10.27 (1H, brs), 10.64 (1H, brs)

### Reference Example 57

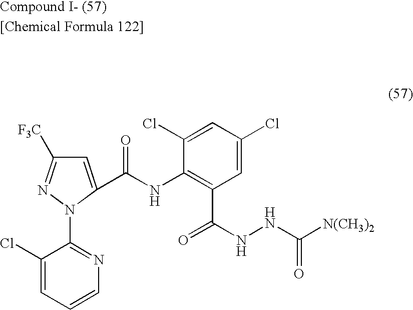

¹H-NMR (DMSO-d₆, TMS) δ(ppm): 2.85 (6H, s), 7.58 (1H, s), 7.64-7.70 (1H, m), 7.85 (1H, s), 7.90 (1H, s), 8.22 (1H, d, J=8 Hz), 8.54 (1H, d, J=4 Hz), 8.58 (1H, brs), 9.91 (1H, brs), 10.59 (1H, brs)

### Reference Example 58

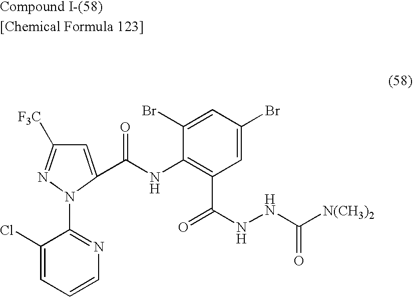

¹H-NMR (DMSO-d₆, TMS) δ(ppm): 2.84 (6H, s), 7.67 (1H, dd, J=8 Hz, 4 Hz), 7.74 (1H, s), 7.83 (1H, s), 8.13 (1H, s), 8.21 (1H, d, J=8 Hz), 8.52-8.57 (2H, m), 9.88 (1H, brs), 10.60 (1H, brs)

### Reference Example 59

A compound I-(59) was obtained according to the same manner as that of Reference Example 5, using N-[6-bromo-4-chloro-2-(hydrazinocarbonyl)phenyl]-1-(3-chloro-2-pyridinyl)-3-trifluoromethyl-1H-pyrazole-5-carboxamide in place of N-[4-chloro-2-(hydrazinocarbonyl)-6-methylphenyl]-1-(3-chloro-2-pyridinyl)-3-trifluoromethyl-1H-pyrazole-5-carboxamide.

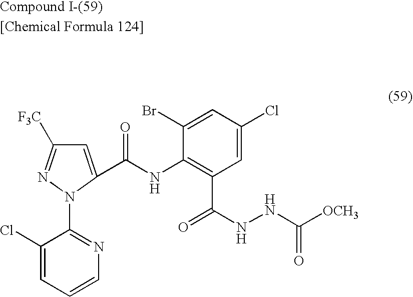

¹H-NMR (DMSO-d₆, TMS) δ(ppm): 3.55-3.65 (3H, m), 7.54 (1H, s), 7.66 (1H, dd, J=8 Hz, 4 Hz), 7.76 (1H, s), 8.06 (1H, s), 8.21 (1H, d, J=8 Hz), 8.53 (1H, d, J=4 Hz), 9.36 (1H, brs), 10.23 (1H, brs), 10.64 (1H, brs)

### Reference Example 60

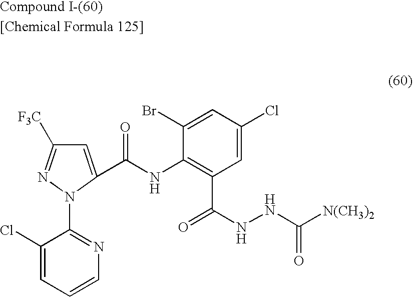

¹H-NMR (DMSO-d₆, TMS) δ(ppm): 2.84 (6H, s), 7.62 (1H, s), 7.67 (1H, dd, J=8 Hz, 4 Hz), 7.83 (1H, s), 8.02 (1H, s), 8.21 (1H, d, J=8 Hz), 8.52-8.57 (2H, m), 9.87 (1H, brs), 10.60 (1H, brs)

### Reference Example 61

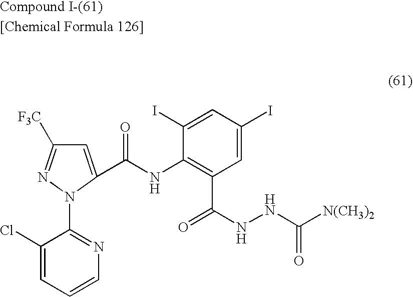

¹H-NMR (DMSO-d₆, TMS) δ(ppm): 2.83 (6H, s), 7.66 (1H, dd, J=8 Hz, 4 Hz), 7.82 (1H, s), 7.88 (1H, s), 8.21 (1H, d, J=8 Hz), 8.37 (1H, s), 8.48 (1H, brs), 8.53 (1H, d, J=4 Hz), 9.78 (1H, brs), 10.55 (1H, brs)

### Reference Example 62

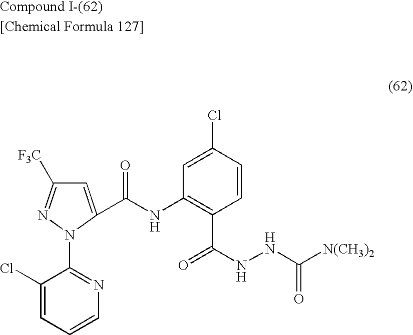

¹H-NMR (DMSO-d₆, TMS) δ(ppm): 2.91 (6H, s), 7.33-7.48 (1H, m), 7.67-7.81 (3H, m), 8.24-8.35 (2H, m), 8.56-8.63 (1H, m), 8.80 (1H, brs), 10.38 (1H, brs), 11.57 (1H, brs)

### Reference Example 63

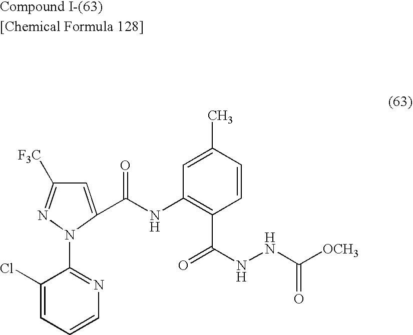

¹H-NMR (DMSO-d₆, TMS) δ(ppm): 2.32 (3H, s), 3.60-3.69 (3H, m), 7.09 (1H, d, J=8 Hz), 7.54 (1H, s), 7.71-7.79 (2H, m), 8.06 (1H, s), 8.30 (1H, d, J=8 Hz), 8.58 (1H, d, J=4 Hz), 9.41 (1H, brs), 10.64 (1H, brs), 12.19 (1H, brs)

### Reference Example 64

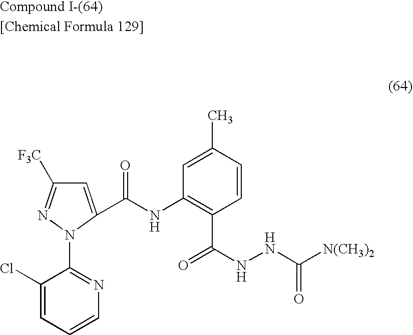

¹H-NMR (DMSO-d₆, TMS) δ(ppm): 2.31 (3H, s), 2.90 (6H, s), 7.07 (1H, d, J=8 Hz), 7.64-7.68 (2H, m), 7.74 (1H, dd, J=8 Hz, 4 Hz), 8.07 (1H, s), 8.31 (1H, d, J=8 Hz), 8.58 (1H, d, J=4 Hz), 8.67 (1H, brs), 10.28 (1H, brs), 11.82 (1H, brs)

### Reference Example 65

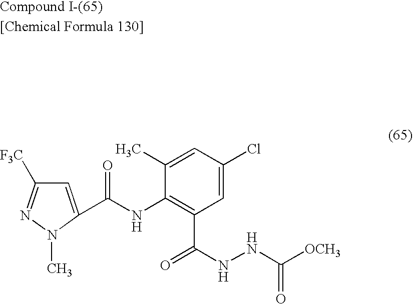

¹H-NMR (DMSO-d₆, TMS) δ(ppm): 2.25 (3H, s), 3.59 (3H, s), 4.13 (3H, s), 7.40 (1H, s), 7.44 (1H, s), 7.59 (1H, s), 9.26 (1H, brs), 10.11 (1H, brs), 10.17 (1H, brs)

### Reference Example 66

A mixture of 0.28 g of N-[1-chloro-3-(hydrazinocarbonyl)-6-naphthyl]-1-(3-chloro-2-pyridinyl)-3-trifluoromethyl-1H-pyrazole-5-carboxamide, 0.06 g of methyl chloroformate and 10 mL of pyridine was stirred at room temperature for 2 hours. Water was poured into the reaction mixture, and a formed precipitate was collected by filtration to obtain 0.08 g of a compound I-(66).

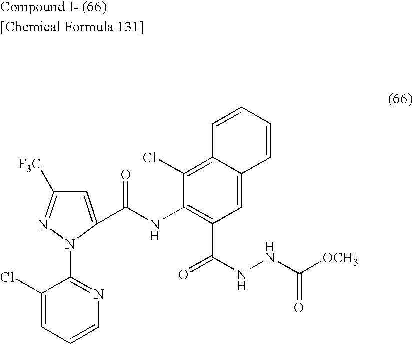

¹H-NMR (DMSO-d₆, TMS) δ(ppm): 3.60-3.68 (3H, m), 7.35-7.43 (1H, m), 7.60-7.85 (3H, m), 8.12-8.28 (3H, m), 8.52-8.60 (2H, m), 9.35 (1H, brs), 10.32 (1H, brs), 10.76 (1H, brs)

### Reference Example 67

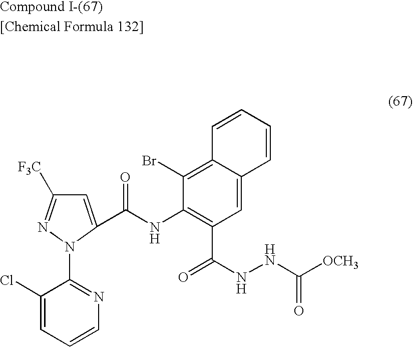

¹H-NMR (DMSO-d₆, TMS) δ(ppm): 3.58-3.69 (3H, m), 7.34-7.44 (1H, m), 7.60-7.85 (3H, m), 8.10-8.28 (3H, m), 8.50-8.62 (2H, m), 9.33 (1H, brs), 10.28 (1H, brs), 10.78 (1H, brs)

### Reference Example 68

A mixture of 0.30 g of 2-[3-bromo-1-(3-chloro-2-pyridinyl)-1H-pyrazol-5-yl]-6,8-dibromo-4H-3,1-benzoxazin-4-one, 0.45 g of methyl carbazate and 10 mL of N,N-dimethylformamide was stirred at room temperature for 10 hours. After 30 mL of water was poured into the reaction mixture, the mixture was extracted with ethyl acetate three times. Organic layers were combined, washed with a saturated solution of sodium chloride in water, dried over anhydrous magnesium sulfate, and concentrated under reduced pressure. The resulting residue was subjected to silica gel column chromatography to obtain 0.14 g of a compound I-(68).

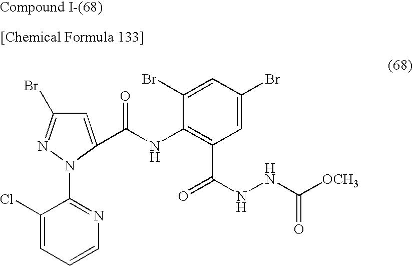

¹H-NMR (DMSO-d₆, TMS) δ(ppm): 3.44-3.66 (3H, m), 7.45 (1H, s), 7.60 (1H, dd, J=8 Hz, 4 Hz), 7.65 (1H, s), 8.14-8.18 (2H, m), 8.50 (1H, d, J=4 Hz), 9.36 (1H, brs), 10.26 (1H, brs), 10.55 (1H, brs)

### Reference Example 69

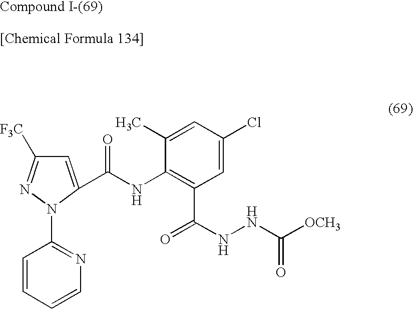

¹H-NMR (DMSO-d₆) δ(ppm): 2.33 (3H, s), 3.63 (3H, s), 7.36 (2H, s), 7.52 (1H, dd, J=8 Hz, 4 Hz), 7.58 (1H, s), 7.81 (1H, d, J=8 Hz), 8.06 (1H, t, J=8 Hz), 8.46 (1H, d, J=4 Hz), 9.33 (1H, brs), 10.19 (1H, brs), 10.34 (1H, brs)

### Reference Example 70

A mixture of 0.30 g of 2-[3-bromo-1-(3-chloro-2-pyridinyl)-1H-pyrazol-5-yl]-8-bromo-6-chloro-4H-3,1-benzoxazin-4-one, 0.45 g of methyl carbazate and 10 mL of N,N-dimethylformamide was stirred at room temperature for 10 hours. After 30 mL of water was poured into the reaction mixture, the mixture was extracted with ethyl acetate three times. Organic layers were combined, washed with a saturated solution of sodium chloride in water, dried over anhydrous magnesium sulfate, and concentrated under reduced pressure. The resulting residue was subjected to silica gel column chromatography to obtain 0.13 g of a compound I-(70).

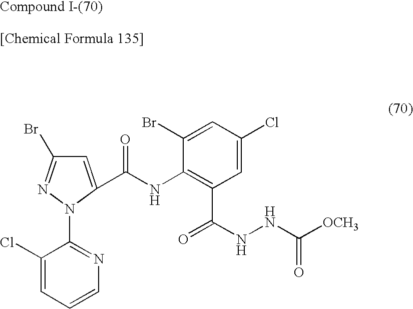

¹H-NMR (DMSO-d₆, TMS) δ(ppm): 3.48-3.62 (3H, m), 7.41 (1H, s), 7.53-7.62 (2H, m), 8.05 (1H, s), 8.16 (1H, d, J=8 Hz), 8.50 (1H, d, J=4 Hz), 9.36 (1H, brs), 10.21 (1H, brs), 10.48 (1H, brs).

### Reference Example 71

A mixture of 0.30 g of 2-[3-bromo-1-(3-chloro-2-pyridinyl)-1H-pyrazol-5-yl]-8-bromo-6-methyl-4H-3,1-benzoxazin-4-one, 0.45 g of methyl carbazate and 10 mL of N,N-dimethylformamide was stirred at room temperature for 10 hours. After 30 mL of water was poured into the reaction mixture, the mixture was extracted with ethyl acetate three times. Organic layers were combined, washed with a saturated solution of sodium chloride in water, dried over anhydrous magnesium sulfate, and concentrated under reduced pressure. The resulting residue was subjected to silica gel column chromatography to obtain 0.17 g of a compound I-(71).

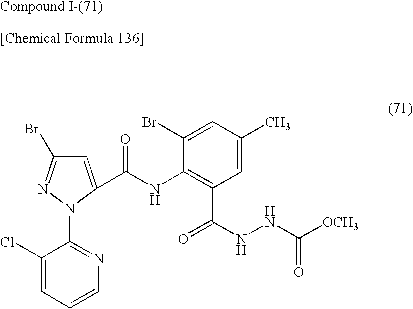

¹H-NMR (DMSO-d₆, TMS) δ(ppm): 2.34 (3H, s), 3.56-3.64 (3H, m), 7.32-7.44 (2H, m), 7.59 (1H, dd, J=8 Hz, 4 Hz), 7.66-7.71 (1H, m), 8.15 (1H, d, J=8 Hz), 8.49 (1H, d, J=4 Hz), 9.27 (1H, brs), 10.01 (1H, brs), 10.31 (1H, brs)

### Reference Example 72

A mixture of 0.21 g of 2-[3-bromo-1-(3-chloro-2-pyridinyl)-1H-pyrazol-5-yl]-8-chloro-4H-3,1-benzoxazin-4-one, 0.9 g of methyl carbazate and 10 mL of N,N-dimethylformamide was stirred at room temperature for 10 hours. Water was poured into the reaction mixture, followed by extraction with ethyl acetate. The organic layer was washed with water, dried over anhydrous magnesium sulfate, and concentrated under reduced pressure. The resulting residue was subjected to silica gel column chromatography to obtain 0.10 g of a compound I-(72).

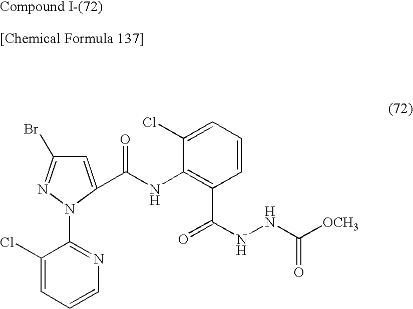

¹H-NMR (DMSO-d₆, TMS) δ(ppm): 3.44-3.65 (3H, m), 7.40-7.54 (3H, m), 7.59 (1H, dd, J=8 Hz, 4 Hz), 7.68 (1H, d, J=8 Hz), 8.15 (1H, d, J=8 Hz), 8.49 (1H, d, J=4 Hz), 9.29 (1H, brs), 10.11 (1H, brs), 10.39 (1H, brs)

### Reference Example 73

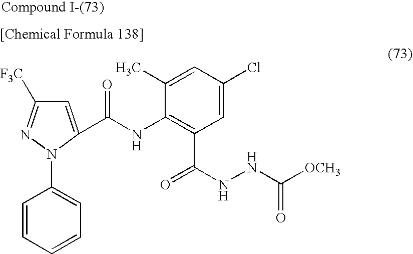

¹H-NMR (DMSO-d₆) δ(ppm): 2.18 (3H, s), 3.61 (3H, s), 7.37 (1H, s), 7.49-7.55 (7H, m), 9.31 (1H, brs), 10.22 (1H, brs), 10.30 (1H, brs)

### Reference Example 74

A compound I-(74) was obtained according to the same manner as that of Reference Example 72, using 6-bromo-2-[1-(3-chloro-2-pyridinyl)-3-trifluoromethyl-1H-pyrazol-5-yl]-8-methyl-4H-3,1-benzoxazin-4-one in place of 2-[3-bromo-1-(3-chloro-2-pyridinyl)-1H-pyrazol-5-yl]-8-chloro-4H-3,1-benzoxazin-4-one.

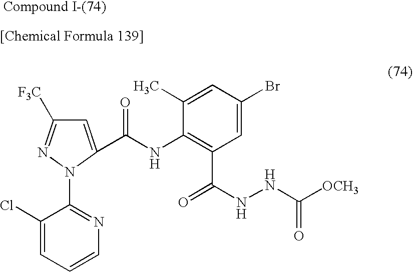

¹H-NMR (DMSO-d₆, TMS) δ(ppm): 2.15 (3H, s), 3.56-3.65 (3H, m), 7.47-7.55 (1H, m), 7.62-7.75 (3H, m), 8.22 (1H, d, J=8 Hz), 8.53 (1H, d, J=4 Hz), 9.31 (1H, brs), 10.17 (1H, brs), 10.38 (1H, brs)

### Reference Example 75

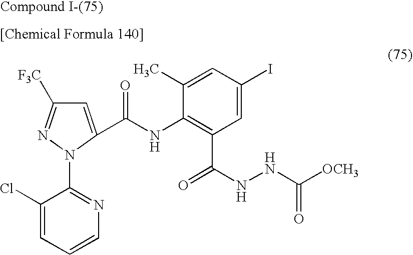

¹H-NMR (DMSO-d₆, TMS) δ(ppm): 2.12 (3H, s), 3.55-3.66 (3H, m), 7.63-7.72 (3H, m), 7.83 (1H, s), 8.22 (1H, d, J=8 Hz), 8.53 (1H, d, J=4 Hz), 9.28 (1H, brs), 10.14 (1H, brs), 10.35 (1H, brs)

### Reference Example 76

Under ice-cooling, 0.18 g of N-[4-chloro-2-(hydrazinocarbonyl)-6-methylphenyl]-3-(2-chlorophenyl)-1-methyl-1H-pyrazole-4-carboxamide, 45 mg of methyl chloroformate, 68 mg of pyridine and 5 mL of acetonitrile were mixed. The mixture was stirred at room temperature for 0.5 hours. Water was poured into the reaction mixture, followed by extraction with ethyl acetate. The organic layer was washed with water, dried over anhydrous sodium sulfate, and concentrated under reduced pressure. The resulting residue was subjected to silica gel column chromatography to obtain 0.12 g of a compound I-(76).

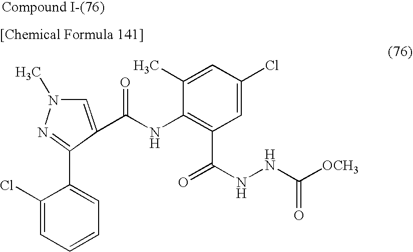

¹H-NMR (DMSO-d₆) δ(ppm): 2.13 (3H, s), 3.37-3.67 (6H, m), 7.37 (1H, brs), 7.42-7.52 (4H, m), 7.60 (1H, d, J=8 Hz), 8.13 (1H, s), 9.28-9.37 (2H, m), 10.13 (1H, brs)

### Reference Example 77

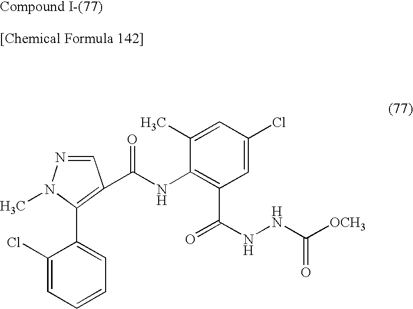

¹H-NMR (DMSO-d₆) δ(ppm): 2.17 (3H, s), 3.46-3.62 (3H, m), 3.94 (3H, s), 7.32-7.41 (4H, m), 7.44-7.46 (1H, m), 7.50 (1H, s), 8.36 (1H, s), 9.30-9.34 (2H, m), 10.17 (1H, brs)

### Reference Example 78

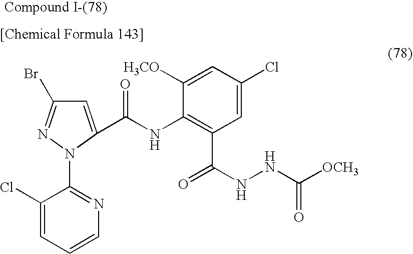

¹H-NMR (DMSO-d₆, TMS) δ(ppm): 3.56-3.64 (3H, m), 3.77-3.80 (3H, m), 7.12 (1H, brs), 7.32 (1H, brs), 7.38 (1H, brs), 7.59 (1H, dd, J=8 Hz, 4 Hz), 8.15 (1H, d, J=8 Hz), 8.49 (1H, d, J=4 Hz), 9.28 (1H, brs), 9.95 (1H, brs), 10.07 (1H, brs)

### Reference Example 79

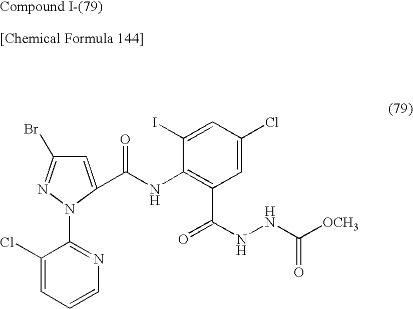

¹H-NMR (DMSO-d₆, TMS) δ(ppm): 3.56-3.64 (3H, m), 7.43 (1H, s), 7.53 (1H, s), 7.60 (1H, dd, J=8 Hz, 4 Hz), 8.12-8.19 (2H, m), 8.50 (1H, d, J=4 Hz), 9.34 (1H, brs), 10.16 (1H, brs), 10.47 (1H, brs)

### Reference Example 80

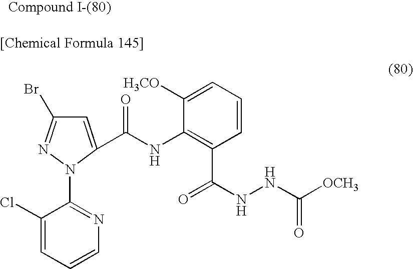

¹H-NMR (DMSO-d₆, TMS) δ(ppm): 3.52-3.64 (3H, m), 3.74 (3H, s), 7.07-7.14 (1H, m), 7.21 (1H, d, J=8 Hz), 7.31-7.42 (2H, m), 7.59 (1H, dd, J=8 Hz, 4 Hz), 8.15 (1H, d, J=8 Hz), 8.49 (1H, d, J=4 Hz), 9.21 (1H, brs), 9.87 (1H, brs), 9.92 (1H, brs)

### Reference Example 81

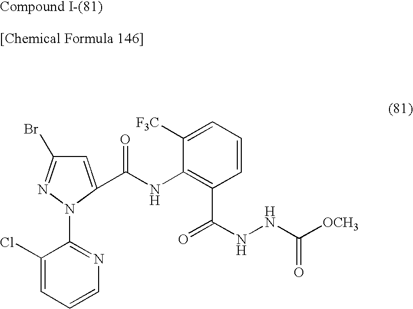

¹H-NMR (DMSO-d₆, TMS) δ(ppm): 3.46-3.69 (3H, m), 7.41 (1H, s), 7.59 (1H, dd, J=8 Hz, 4 Hz), 7.68 (1H, t, J=8 Hz), 7.77-7.87 (1H, m), 7.90-7.97 (1H, m), 8.14 (1H, d, J=8 Hz), 8.48 (1H, d, J=4 Hz), 9.32 (1H, brs), 10.14 (1H, brs), 10.48 (1H, brs)

### Reference Example 82

To a mixture of 0.25 g of 3-chloro-2-(3-trifluoromethyl-1H-1,2,4-triazol-1-yl)pyridine and 5 mL of tetrahydrofuran was added dropwise 0.50 mL of a 2.0 M solution of lithium diisopropylamide in heptane/tetrahydrofuran/ethylbenzene was at −78° C., and the mixture was stirred at −78° C. for 15 minutes. Carbon dioxide was introduced at such a rate that the mixture was retained at an internal temperature of −60° C. or lower. When the mixture turned yellow, the mixture was further stirred at −78° C. for 10 minutes. The reaction mixture was warmed to room temperature, followed by concentration. After a 2 N solution of sodium hydroxide in water was added to the concentrate so that an aqueous layer has pH 10 to 12, layers were separated. The organic layer was extracted with a 0.5 N solution of sodium hydroxide in water. Aqueous layers were combined, washed with chloroform, and 2 N hydrochloric acid was poured thereto until the pH of the aqueous layer became about 3, followed by extraction with ethyl acetate three times. Organic layers were combined, washed with a saturated solution of sodium chloride in water, dried over magnesium sulfate, and concentrated under reduced pressure to obtain 0.13 g of crude 1-(3-chloro-2-pyridinyl)-3-trifluoromethyl-1H-1,2,4-triazole-5-carboxylic acid.

### 1-(3-Chloro-2-pyridinyl)-3-trifluoromethyl-1H-1,2,4-triazole-5-carboxylic acid

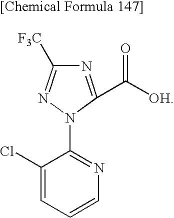

A mixture of 0.13 g of the resulting crude 1-(3-chloro-2-pyridinyl)-3-trifluoromethyl-1H-1,2,4-triazole-5-carboxylic acid and 0.10 mL of thionyl chloride was heated to reflux in 10 mL of acetonitrile for 2 hours. The reaction mixture was allowed to cool to room temperature, and then concentrated under reduced pressure. The resulting residue was dissolved in 10 mL of acetonitrile, and 0.11 g of N-(2-amino-5-chloro-3-methylbenzoyl)-N′-methoxycarbonylhydrazine and 0.10 mL of isopropylethylamine were added. The mixture was stirred at room temperature for 16 hours. Water was poured into the reaction mixture, followed by extraction with ethyl acetate two times. Organic layers were combined, washed with a saturated solution of sodium chloride in water, dried over anhydrous magnesium sulfate, and concentrated under reduced pressure. The resulting residue was subjected to silica gel chromatography to obtain 12 mg of a compound I-(82).

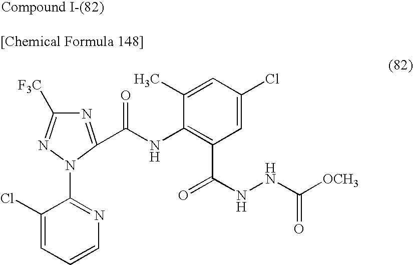

¹H-NMR (DMSO-d₆, TMS) δ(ppm): 2.31 (3H, s), 3.64 (3H, s), 7.40 (1H, s), 7.60 (1H, s), 7.90 (1H, brs), 8.77 (1H, d, J=7 Hz), 9.33 (1H, brs), 9.50 (1H, brs), 10.27 (1H, brs), 10.44 (1H, brs)

### Reference Example 83

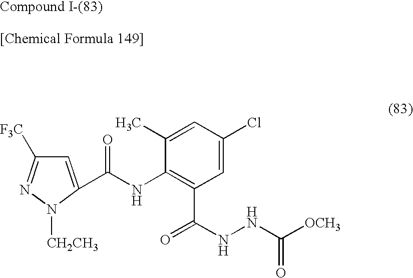

¹H-NMR (DMSO-d₆) δ(ppm): 1.37 (3H, t, J=7 Hz), 2.26 (3H, s), 3.60 (3H, s), 4.55 (2H, q, J=7 Hz), 7.41 (2H, s), 7.58 (1H, s), 9.26 (1H, brs), 10.12 (1H, brs), 10.18 (1H, brs)

### Reference Example 84

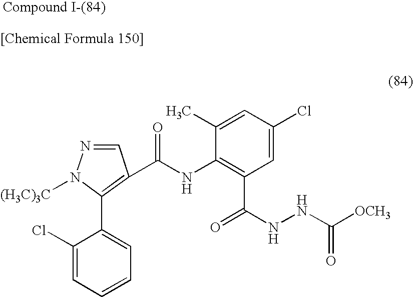

¹H-NMR (DMSO-d₆) δ(ppm): 1.39 (9H, s), 2.05 (3H, s), 3.47-3.62 (3H, m), 7.36-7.53 (6H, m), 8.10 (1H, s), 9.19-9.26 (2H, m), 10.12 (1H, brs).

### Reference Example 85

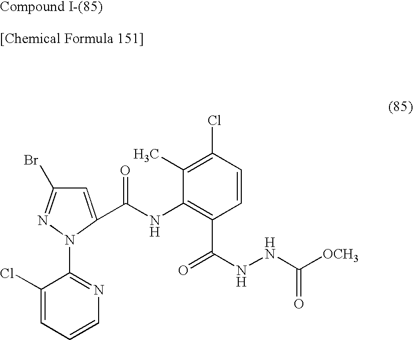

¹H-NMR (DMSO-d₆, TMS) δ(ppm): 2.17 (3H, s), 3.60-3.65 (3H, m), 7.35-7.43 (2H, m), 7.54 (1H, d, J=8 Hz), 7.61 (1H, dd, J=8 Hz, 4 Hz), 8.17 (1H, d, J=8 Hz), 8.50 (1H, d, J=4 Hz), 9.28 (1H, brs), 10.14 (1H, brs), 10.41 (1H, brs)

### Reference Example 86

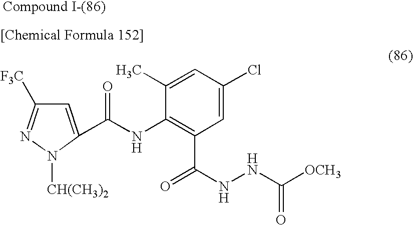

¹H-NMR (DMSO-d₆) δ(ppm): 1.43 (6H, d, J=6 Hz), 2.26 (3H, s), 3.60 (3H, s), 5.41-5.45 (1H, m), 7.35 (1H, s), 7.40 (1H, s), 7.59 (1H, s), 9.26 (1H, brs), 10.10 (1H, brs), 10.17 (1H, brs)

### Reference Example 87

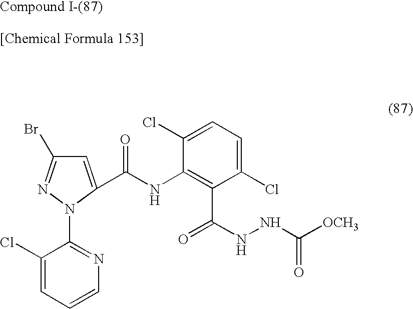

¹H-NMR (DMSO-d₆, TMS) δ(ppm): 3.50-3.68 (3H, m), 7.47 (1H, s), 7.52-7.65 (3H, m), 8.17 (1H, d, J=8 Hz), 8.49 (1H, d, J=4 Hz), 9.43 (1H, brs), 10.17 (1H, brs), 10.47 (1H, brs)

### Reference Example 88

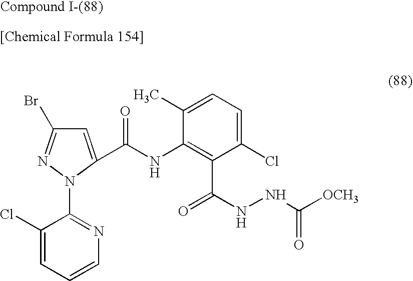

¹H-NMR (DMSO-d₆, TMS) δ(ppm): 2.09 (3H, s), 3.51-3.68 (3H, m), 7.31-7.45 (3H, m), 7.61 (1H, dd, J=8 Hz, 4 Hz), 8.19 (1H, d, J=8 Hz), 8.49 (1H, d, J=4 Hz), 9.43 (1H, brs), 10.04 (1H, brs), 10.13 (1H, brs)

### Reference Example 89

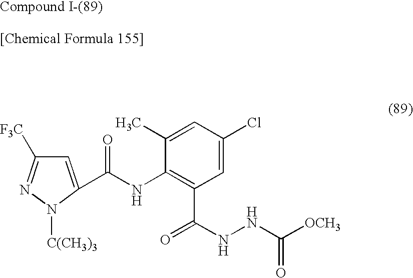

¹H-NMR (DMSO-d₆) δ(ppm): 1.67 (9H, s), 2.28 (3H, s), 3.64 (3H, s), 7.11 (1H, s), 7.42 (1H, s), 7.55 (1H, s), 9.29 (1H, brs), 10.18 (1H, brs), 10.23 (1H, brs)

### Reference Example 90

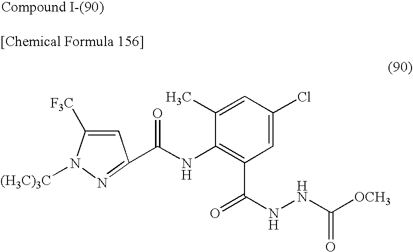

¹H-NMR (DMSO-d₆) δ(ppm): 1.69 (9H, s), 2.26 (3H, s), 3.57 (3H, s), 7.43 (1H, s), 7.62 (1H, d, J=2 Hz), 7.82 (1H, d, J=2 Hz), 9.30 (1H, brs), 10.23 (1H, brs), 10.56 (1H, brs)

### Reference Example 91

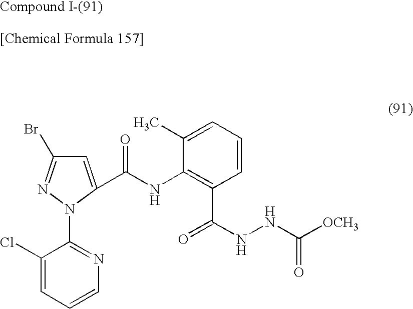

¹H-NMR (DMSO-d₆, TMS) δ(ppm): 2.15 (3H, s), 3.55-3.67 (3H, m), 7.25-7.45 (3H, m), 7.61 (1H, dd, J=8 Hz, 4 Hz), 7.94-7.97 (1H, m), 8.17 (1H, d, J=8 Hz), 8.48-8.53 (1H, m), 9.25 (1H, brs), 10.04 (1H, brs), 10.20 (1H, brs)

### Reference Example 92

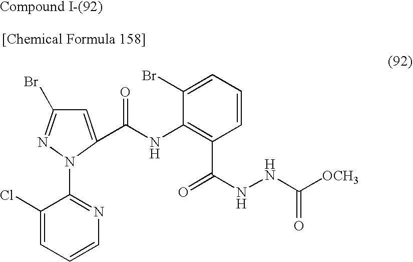

¹H-NMR (DMSO-d₆, TMS) δ(ppm): 3.45-3.67 (3H, m), 7.34-7.44 (2H, m), 7.53 (1H, s), 7.60 (1H, dd, J=8 Hz, 4 Hz), 7.84 (1H, d, J=8 Hz), 8.15 (1H, d, J=8 Hz), 8.50 (1H, d, J=4 Hz), 9.29 (1H, brs), 10.08 (1H, brs), 10.42 (1H, brs)

### Reference Example 93

A mixture of 0.20 g of 4-bromo-N-[4-chloro-2-(hydrazinocarbonyl)-6-methylphenyl]-1-(3-chloro-2-pyridinyl)-1H-pyrrole-2-carboxamide, 0.05 g of methyl chloroformate and 0.07 ml of pyridine in N,N-dimethylformamide was stirred at room temperature for 8 hours. Water was poured into the reaction mixture, and a formed precipitate was collected by filtration to obtain 0.16 g of a compound I-(93).

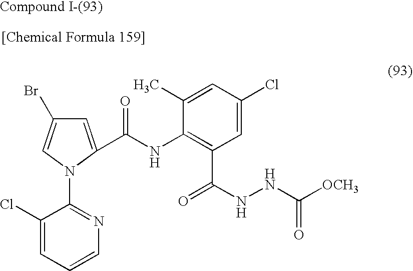

¹H-NMR (DMSO-d₆) δ(ppm): 2.16 (3H, s), 3.63 (3H, s), 7.23 (1H, s), 7.41 (1H, d, J=2 Hz), 7.48-7.51 (3H, m), 8.05 (1H, dd, J=8 Hz, 2 Hz), 8.43 (1H, dd, J=5 Hz, 2 Hz), 9.31 (1H, brs), 9.75 (1H, brs), 10.12 (1H, brs)

### Reference Example 94

A mixture of 0.26 g of 3-bromo-N-[4-chloro-2-(N′-isopropylhydrazinocarbonyl)-6-methylphenyl]-1-(3-chloro-2-pyridinyl)-1H-pyrazole-5-carboxamide, 0.06 mL of methyl chloroformate and 2 mL of pyridine was stirred at room temperature for 1.5 hours. Water was poured into the reaction mixture, followed by extraction with methyl-t-butyl ether three times. Organic layers were combined, washed sequentially with 1 N hydrochloric acid, a saturated solution of sodium bicarbonate in water and a saturated solution of sodium chloride in water, dried over anhydrous magnesium sulfate, and concentrated under reduced pressure. The resulting residue was subjected to silica gel chromatography to obtain 0.18 g of a compound I-(94).

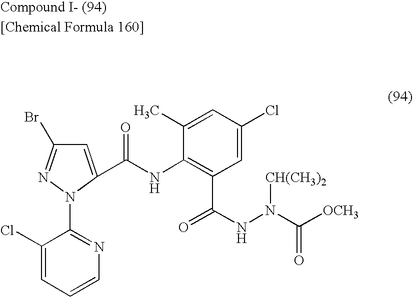

¹H-NMR (DMSO-d₆, 80° C.) δ(ppm): 1.03 (6H, d, J=7 Hz), 2.18 (3H, s), 3.53 (3H, s), 4.24 (1H, hept., J=7 Hz), 7.29 (1H, s), 7.37 (1H, d, J=2 Hz), 7.49 (1H, d, J=2 Hz), 7.57 (1H, dd, J=8 Hz, 4 Hz), 8.10 (1H, dd, J=8 Hz, 1 Hz), 8.45 (1H, dd, J=4 Hz, 1 Hz), 9.92 (1H, s), 9.98 (1H, s)

### Reference Example 95

To a mixture of 4.11 g of the compound I-(34), 1.45 mL of triethylamine and 80 mL of tetrahydrofuran was added dropwise 0.69 mL of methyl chloroformate under ice-cooling. The resulting mixture was stirred at room temperature for 1 hour, and water was poured into the reaction mixture, followed by extraction with ethyl acetate three times. Organic layers were combined, washed with a saturated solution of sodium chloride in water, dried over anhydrous magnesium sulfate, and concentrated under reduced pressure. The resulting residue was subjected to silica gel column chromatography to obtain 2.66 g of a compound I-(95).

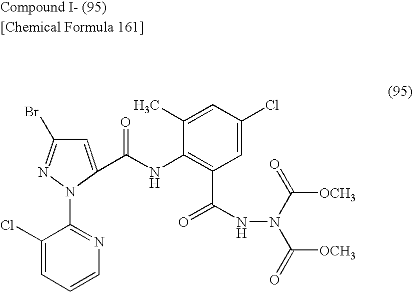

¹H-NMR (CDCl₃, TMS) δ(ppm): 2.22 (3H, s), 3.82 (6H, s), 6.99 (1H, s), 7.34-7.37 (2H, m), 7.41 (1H, d, J=2 Hz), 7.88 (1H, dd, J=8 Hz, 1 Hz), 8.37 (1H, dd, J=4 Hz, 1 Hz), 8.43 (1H, s), 9.21 (1H, s)

### Reference Example 96

A mixture of 0.11 g of N-[4-chloro-2-(hydrazinocarbonyl)-6-methylphenyl]-1-(3-chloro-2-pyridinyl)-3-iodo-1H-pyrazole-5-carboxamide, 0.095 mL of methyl chloroformate and 2 mL of pyridine was stirred at room temperature for 2.75 hours. Water and toluene were poured into the reaction mixture, and concentrated under reduced pressure. The residue was separated into layers with water and ethyl acetate. The organic layer was washed with a saturated solution of sodium chloride in water, dried over anhydrous magnesium sulfate, and concentrated under reduced pressure. The resulting residue was subjected to silica gel chromatography to obtain 0.11 g of a compound I-(96).

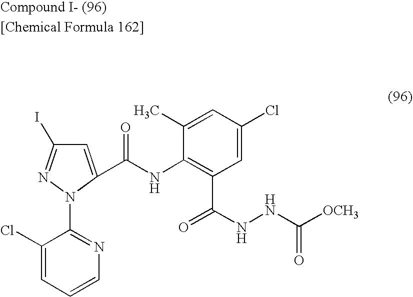

¹H-NMR (DMSO-d₆) δ(ppm): 2.15 (3H, s), 3.63 (3H, brs), 7.40 (2H, brs), 7.54 (1H, s), 7.59 (1H, dd, J=8 Hz, 4 Hz), 8.15 (1H, d, J=8 Hz), 8.49 (1H, d, J=4 Hz), 9.31 (1H, brs), 10.16 (2H, brs)

### Reference Example 97

A mixture of 0.27 g of 4-bromo-N-[4-chloro-2-(hydrazinocarbonyl)-6-methylphenyl]-1-(3-chloro-2-pyridinyl)-1H-pyrazole-5-carboxamide, 0.13 mL of methyl chloroformate and 3 mL of pyridine was stirred at room temperature for 1.75 hours. Water and toluene were poured into the reaction mixture, followed by concentration under reduced pressure. The residue was partitioned between water and ethyl acetate. The organic layer was washed with a saturated solution of sodium chloride in water, dried over anhydrous magnesium sulfate, and concentrated under reduced pressure. The resulting residue was subjected to silica gel chromatography to obtain 0.24 g of a compound I-(97).

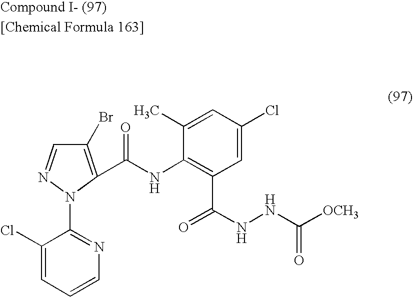

¹H-NMR (DMSO-d₆, 80° C.) δ(ppm): 2.14 (3H, s), 3.59 (3H, brs), 7.43 (1H, s), 7.48 (1H, s), 7.57 (1H, dd, J=8 Hz, 4 Hz), 8.03 (1H, s), 8.12 (1H, d, J=8 Hz), 8.47 (1H, d, J=4 Hz), 8.94 (1H, brs), 9.81 (1H, brs), 10.11 (1H, brs)

### Reference Example 98

A mixture of 0.30 g of N-[4-chloro-2-(hydrazinocarbonyl)-6-methylphenyl]-1-(3-chloro-2-pyridinyl)-3-phenyl-1H-pyrazole-5-carboxamide, 0.15 mL of methyl chloroformate and 3 mL of pyridine was stirred at room temperature for 1.75 hours. Water and toluene were poured into the reaction mixture, and concentrated under reduced pressure. The residue was partitioned between water and ethyl acetate. The organic layer was washed with a saturated solution of sodium chloride in water, dried over anhydrous magnesium sulfate, and concentrated under reduced pressure. The resulting residue was subjected to silica gel chromatography to obtain 0.30 g of a compound I-(98).

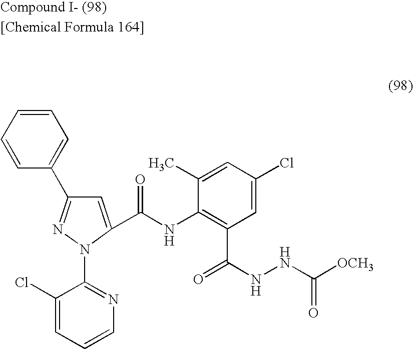

¹H-NMR (DMSO-d₆) δ(ppm): 2.19 (3H, s), 3.62 (3H, brs), 7.42-7.52 (4H, m), 7.55 (1H, brs), 7.60 (1H, dd, J=8 Hz, 4 Hz), 7.70 (1H, brs), 7.88 (2H, d, J=7 Hz), 8.17 (1H, dd, J=8 Hz, 1 Hz), 8.32 (1H, dd, J=4 Hz, 1 Hz), 9.34 (1H, brs), 10.19 (2H, brs)

### Reference Example 99

A mixture of 0.27 g of N-[4-chloro-2-(hydrazinocarbonyl)-6-methylphenyl]-1-(3-chloro-2-pyridinyl)-3-methylthio-1H-pyrazole-5-carboxamide, 0.14 mL of methyl chloroformate and 3 mL of pyridine was stirred at room temperature for 2 hours. Water and toluene were poured into the reaction mixture, and concentrated under reduced pressure. The residue were partitioned between water and ethyl acetate. The organic layer was washed with a saturated solution of sodium chloride in water, dried over anhydrous magnesium sulfate, and concentrated under reduced pressure. The resulting residue was subjected to silica gel chromatography to obtain 0.14 g of a compound I-(99).

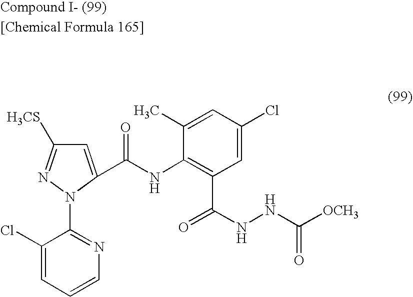

¹H-NMR (DMSO-d₆) δ(ppm): 2.16 (3H, s), 2.54 (3H, s)3.62 (3H, brs), 7.20 (1H, s), 7.38 (1H, brs), 7.54-7.58 (2H, m), 8.13 (1H, dd, J=8 Hz, 1 Hz), 8.48 (1H, dd, J=4 Hz, 1.5 Hz), 9.32 (1H, brs), 10.11 (1H, s), 10.14 (1H, s)

### Reference Example 100

A mixture of 0.20 g of 6-chloro-2-[1-(3-chloro-2-pyridinyl)-3-methylsulfonyl-1H-pyrazol-5-yl]-8-methyl-4H-3,1-benzoxazine-4-one, 0.40 g of methyl carbazate and 8 mL of N,N-dimethylformamide was stirred at room temperature for 22 hours. Water was poured into the reaction mixture, followed by extraction with methyl t-butyl ether three times. Organic layers were combined, washed sequentially with water and a saturated solution of sodium chloride in water, dried over anhydrous magnesium sulfate, and concentrated under reduced pressure. The resulting residue was subjected to silica gel chromatography to obtain 0.13 g of a compound I-(100).

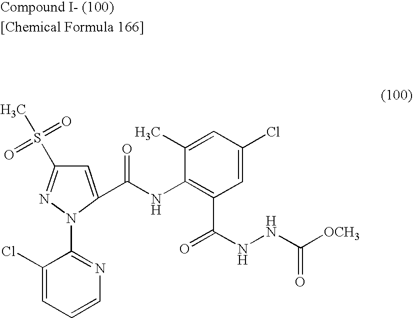

¹H-NMR (DMSO-d₆) δ(ppm): 2.16 (3H, s), 3.39 (3H, s), 3.62 (3H, brs), 7.39 (1H, brs), 7.56 (1H, s), 7.67 (1H, dd, J=8 Hz, 4 Hz), 7.78 (1H, s), 8.23 (1H, dd, J=8 Hz, 1 Hz), 8.54 (1H, dd, J=4 Hz, 1 Hz), 9.31 (1H, brs), 10.16 (1H, brs), 10.41 (1H, brs)

### Reference Example 101

A mixture of 0.10 g of 6-chloro-2-[1-(3-chloro-2-pyridinyl)-3-methylsulfinyl-1H-pyrazol-5-yl]-8-methyl-4H-3,1-benzoxazine-4-one, 0.21 g of methyl carbazate and 4 mL of N,N-dimethylformamide was stirred at room temperature for 20 hours. Water was poured into the reaction mixture, followed by extraction with methyl t-butyl ether three times. Organic layers were combined, washed with sequentially water and a saturated solution of sodium chloride in water, dried over anhydrous magnesium sulfate, and concentrated under reduced pressure. The resulting residue was subjected to silica gel chromatography to obtain 0.092 g of a compound I-(101).

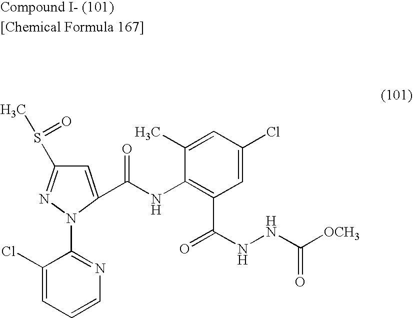

¹H-NMR (DMSO-d₆) δ(ppm): 2.16 (3H, s), 2.99 (3H, s)3.62 (³H, brs), 7.39 (1H, brs), 7.55 (1H, s), 7.64 (1H, dd, J=8 Hz, 4 Hz), 7.74 (1H, s), 8.20 (1H, dd, J=8 Hz, 1.5 Hz), 8.52 (1H, dd, J=4 Hz, 1 Hz), 9.32 (1H, brs), 10.15 (1H, brs), 10.35 (1H, brs)

### Reference Example 102

A mixture of 0.12 g of 6-chloro-2-[1-(3-chloro-2-pyridinyl)-3-methyl-1H-pyrazol-5-yl]-8-methyl-4H-3,1-benoxazine-4-one, 0.27 g of methyl carbazate and 4 mL of N,N-dimethylformamide was stirred at room temperature for 24 hours. Water was poured into the reaction mixture, followed by extraction with methyl t-butyl ether three times. Organic layers were combined, washed with sequentially water and a saturated solution of sodium chloride in water, dried over anhydrous magnesium sulfate, and concentrated under reduced pressure. The resulting residue was subjected to silica gel chromatography to obtain 0.10 g of a compound I-(102).

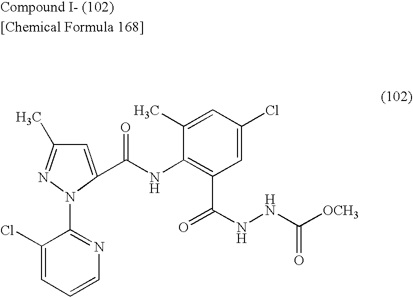

¹H-NMR (DMSO-d₆) δ(ppm): 2.15 (3H, s), 2.31 (3H, s), 3.62 (3H, brs), 7.02 (1H, s), 7.40 (1H, brs), 7.52-7.55 (2H, m), 8.11 (1H, dd, J=8 Hz, 1 Hz), 8.46 (1H, dd, J=4 Hz, 1 Hz), 9.31 (1H, brs), 10.03 (1H, brs), 10.14 (1H, brs)

### Reference Example 103

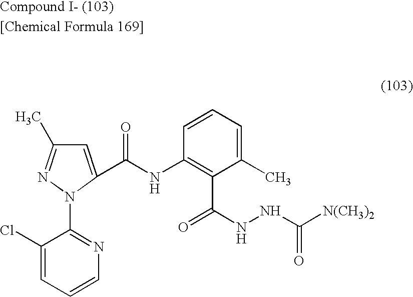

¹H-NMR (DMSO-d₆) δ(ppm): 2.29 (3H, s), 2.93 (6H, s), 7.07 (1H, d, J=8 Hz), 7.27 (1H, t, J=8 Hz), 7.71 (1H, dd, J=8 Hz, 4 Hz), 7.86 (1H, d, J=8 Hz), 8.11 (1H, s), 8.28 (1H, d, J=8 Hz), 8.56 (1H, d, J=4 Hz), 8.99 (1H, brs), 10.10 (1H, brs), 10.19 (1H, brs)

### Reference Example 104

A mixture of 0.20 g of 6-chloro-2-[1-(3-chloro-2-pyridinyl)-3-isopropyl-1H-pyrazol-5-yl]-8-methyl-4H-3,1-benzoxazine-4-one, 0.43 g of methyl carbazate and 5 mL of N,N-dimethylformamide was stirred at room temperature for 20 hours. Water was poured into the reaction mixture, followed by extraction with methyl t-butyl ether three times. Organic layers were combined, washed with sequentially water and a saturated solution of sodium chloride in water, dried over anhydrous magnesium sulfate, and concentrated under reduced pressure. The resulting residue was subjected to silica gel chromatography to obtain 0.22 g of a compound I-(104).

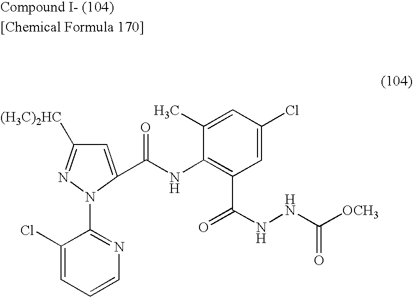

¹H-NMR (DMSO-d₆) δ(ppm): 1.35 (6H, d, J=7 Hz), 2.22 (3H, s), 3.08 (1H, hept., J=7 Hz), 3.68 (3H, brs), 7.17 (1H, s), 7.45 (1H, brs), 7.58-7.62 (2H, m), 8.17 (1H, dd, J=8 Hz, 1 Hz), 8.52 (1H, dd, J=4 Hz, 1 Hz), 9.39 (1H, brs), 10.09 (1H, brs), 10.20 (1H, brs)

### Reference Example 105

A mixture of 0.20 g of 2-[1-(3-chloro-2-pyridinyl)-3-isopropyl-1H-pyrazol-5-yl]-6,8-dibromo-4H-3,1-benzoxazine-4-one, 0.34 g of methyl carbazate and 4 mL of N,N-dimethylformamide was stirred at room temperature for 17 hours. Water was poured into the reaction mixture, followed by extraction with methyl t-butyl ether three times. Organic layers were combined, washed with sequentially water and a saturated solution of sodium chloride in water, dried over anhydrous magnesium sulfate, and concentrated under reduced pressure. The resulting residue was subjected to silica gel chromatography to obtain 0.16 g of a compound 1-(105).

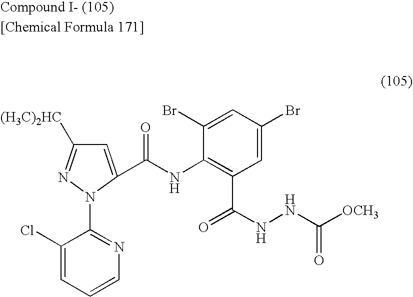

¹H-NMR (DMSO-d₆) δ(ppm): 1.27 (6H, d, J=7 Hz), 3.01 (1H, hept., J=7 Hz), 3.60 (3H, brs), 7.16 (1H, s), 7.53 (1H, dd, J=8 Hz, 4 Hz), 7.64 (1H, brs), 8.07 (1H, dd, J=8 Hz, 1 Hz), 8.11 (1H, brs), 8.45 (1H, dd, J=4 Hz, 1 Hz), 9.35 (1H, brs), 10.16 (1H, brs), 10.22 (1H, brs)

### Reference Example 106

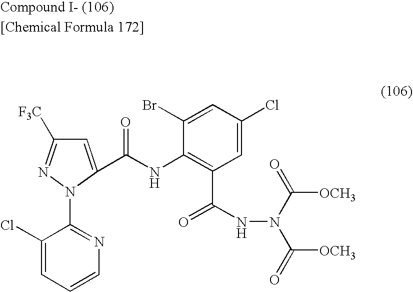

¹H-NMR (CDCl₃, TMS) δ(ppm): 3.73 (6H, s), 7.38-7.45 (3H, m), 7.64 (1H, d, J=2 Hz), 7.89 (1H, d, J=8 Hz), 8.37 (1H, d, J=4 Hz), 8.67 (1H, brs), 9.21 (1H, brs)

### Reference Example 107

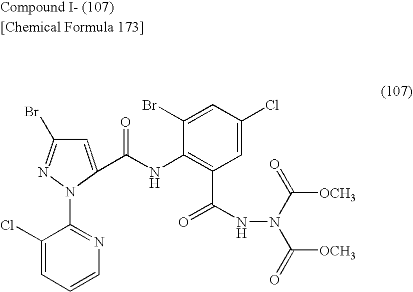

¹H-NMR (CDCl₃, TMS) δ(ppm): 3.77 (6H, s), 7.09 (1H, s), 7.36 (1H, dd, J=8 Hz, 4 Hz), 7.51 (1H, d, J=2 Hz), 7.69 (1H, d, J=2 Hz), 7.88 (1H, dd, J=8 Hz, 1 Hz), 8.35 (1H, dd, J=4 Hz, 1 Hz), 8.63 (1H, brs), 8.95 (1H, brs)

### Reference Example 108

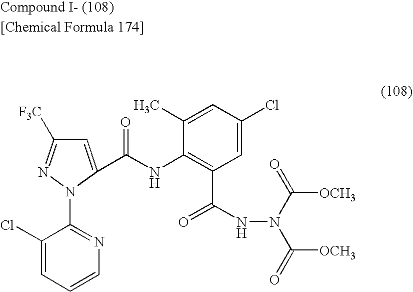

¹H-NMR (CDCl₃, TMS) δ(ppm): 2.23 (3H, s), 3.81 (6H, s), 7.24 (1H, s), 7.36 (1H, d, J=2 Hz), 7.39-7.42 (2H, m), 7.91 (1H, dd, J=8 Hz, 1 Hz), 8.28 (1H, s), 8.40 (1H, dd, J=4 Hz, 1 Hz), 9.27 (1H, s).

### Reference Example 109

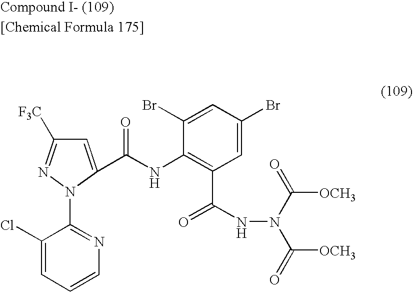

¹H-NMR (CDCl₃, TMS) δ(ppm): 3.75 (6H, s), 7.37-7.43 (2H, m), 7.63 (1H, d, J=2 Hz), 7.84 (1H, d, J=2 Hz), 7.90 (1H, dd, J=8 Hz, 1 Hz), 8.38 (1H, dd, J=4 Hz, J=1 Hz), 8.57 (1H, brs), 9.17 (1H, brs).

### Reference Example 110

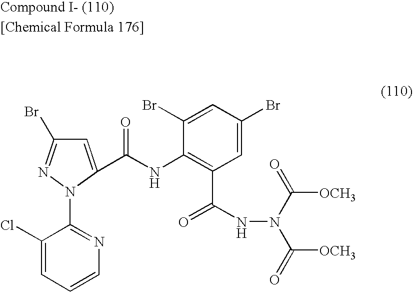

¹H-NMR (CDCl₃, TMS) δ(ppm): 3.87 (6H, s), 7.08 (1H, s), 7.37 (1H, dd, J=8 Hz, 4 Hz), 7.76 (1H, J=2 Hz), 7.87-7.90 (2H, m), 8.35 (1H, dd, J=4 Hz, 1 Hz), 8.54 (1H, brs), 8.88 (1H, brs).

### Reference Example 111

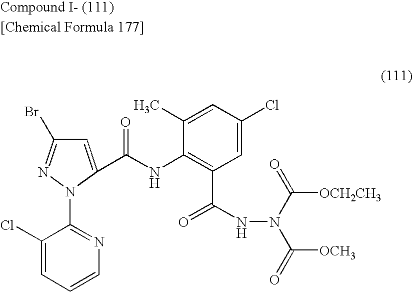

¹H-NMR (CDCl₃, TMS) δ(ppm): 1.30 (3H, t, J=7 Hz), 2.24 (3H, s), 3.82 (3H, s), 4.30 (2H, q, J=7 Hz), 6.97 (1H, s), 7.34-7.38 (2H, m), 7.45 (1H, s), 7.88 (1H, dd, J=8 Hz, 2 Hz), 8.27 (1H, s), 8.38 (1H, dd, J=5 Hz, 2 Hz), 9.21 (1H, s).

### Reference Example 112

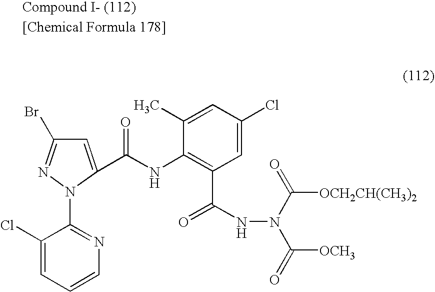

¹H-NMR (CDCl₃, TMS) δ(ppm): 0.94 (6H, d, J=7 Hz), 1.98 (1H, hept, J=7 Hz), 2.24 (3H, s), 3.82 (3H, s), 4.04 (2H, d, J=7 Hz), 6.96 (1H, s), 7.34-7.37 (2H, m), 7.45 (1H, d, J=2 Hz), 7.88 (1H, dd, J=8 Hz, 2 Hz), 8.29 (1H, s), 8.38 (1H, dd, J=5 Hz, 2 Hz), 9.23 (1H, s).

### Reference Example 113

A mixture of 0.10 g of 6-chloro-2-[1-(3-chloro-2-pyridinyl)-3-cyano-1H-pyrazol-5-yl]-8-methyl-4H-3,1-benoxazine-4-one, 0.23 g of methyl carbazate and 4 mL of N,N-dimethylformamide was stirred at room temperature for 18 hours. Water was poured into the reaction mixture, followed by extraction with methyl t-butyl ether three times. Organic layers were combined, washed with sequentially water and a saturated solution of sodium chloride in water, dried over anhydrous magnesium sulfate, and concentrated under reduced pressure. The resulting residue was subjected to silica gel chromatography to obtain 0.090 g of a compound I-(113).

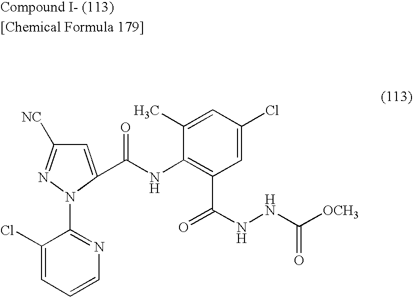

¹H-NMR (DMSO-d₆) δ(ppm): 2.14 (3H, s), 3.61 (3H, brs), 7.38 (1H, brs), 7.54 (1H, s), 7.67 (1H, dd, J=8 Hz, 5 Hz), 7.81 (1H, s), 8.22 (1H, d, J=8 Hz), 8.53 (1H, d, J=5 Hz), 9.29 (1H, brs), 10.16 (1H, brs), 10.44 (1H, brs).

### Reference Example 114

A mixture of 0.30 g of 2-[3-bromo-1-(3-chloro-2-pyridinyl)-1H-pyrazol-5-yl]-6-chloro-8-methyl-4H-3,1-benoxazine-4-one, 0.69 g of N-methyl-N-methoxycarbonylhydrazine and 15 mL of N,N-dimethylformamide was stirred at 60° C. for 9 hours and at 80° C. for 22 hours. Water was poured into the reaction mixture, followed by extraction with methyl t-butyl ether three times. Organic layers were combined, washed with sequentially water and a saturated solution of sodium chloride in water, dried over anhydrous magnesium sulfate, and concentrated under reduced pressure. The resulting residue was subjected to silica gel column chromatography to obtain 0.036 g of a compound I-(114).

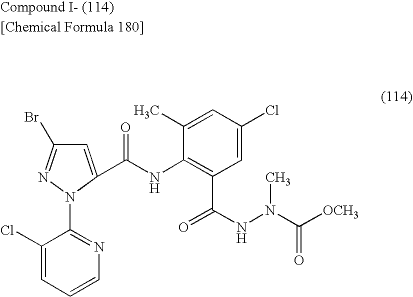

¹H-NMR (CDCl₃, TMS) δ(ppm): 2.20 (3H, s), 3.21 (3H, s), 3.74 (3H, brs), 7.05 (1H, s), 7.26-7.38 (3H, m), 7.86 (1H, dd, J=8 Hz, 2 Hz), 8.03 (1H, s), 8.42 (1H, dd, J=5 Hz, 2 Hz), 9.47 (1H, s).

### Reference Example 115

A mixture of 0.60 g of 3-bromo-N-[4-chloro-2-(N-methylhydrazinocarbonyl)-6-methylphenyl]-1-(3-chloro-2-pyridinyl)-1H-pyrazole-5-carboxamide, 0.41 mL of methyl chloroformate and 6 mL of pyridine was stirred at room temperature for 3 hours. Water was poured into the reaction mixture, and concentrated under reduced pressure. The residue was partitioned between water and ethyl acetate. The organic layer was washed with a saturated solution of sodium chloride in water, dried over anhydrous magnesium sulfate, and concentrated under reduced pressure. The resulting residue was subjected to silica gel column chromatography to obtain 0.46 g of a compound I-(115).

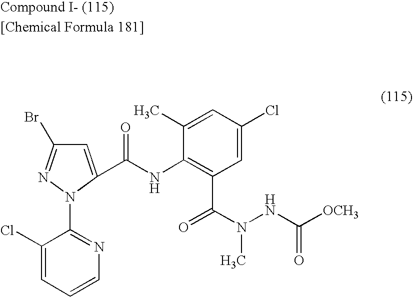

¹H-NMR (CDCl₃, TMS) δ(ppm): 2.04 (3H, s), 3.22 (3H, s), 3.57 (2.6H, s), 3.80 (0.4H, s), 7.01 (1H, s), 7.04 (1H, s), 7.28 (1H, s), 7.40 (1H, dd, J=8 Hz, 5 Hz), 7.61 (1H, brs), 7.87 (1H, dd, J=8 Hz, 2 Hz), 8.46 (1H, dd, J=5 Hz, 2 Hz), 9.80 (1H, brs).

### Reference Example 116

A compound I-(116) was obtained according to the same manner as that of Reference Example 72, using 2-[3-bromo-1-(3-chloro-2-pyridinyl)-1H-pyrazol-5-yl]-6,7-dichloro-8-methyl-4H-3,1-benzoxazine-4-one in place of 2-[3-bromo-1-(3-chloro-2-pyridinyl)-1H-pyrazol-5-yl]-8-chloro-4H-3,1-benzoxazine-4-one.

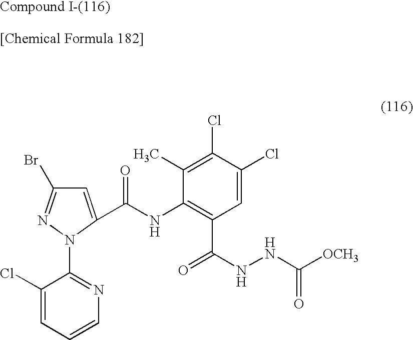

¹H-NMR (DMSO-d₆, TMS) δ(ppm): 2.25 (3H, s), 3.45-3.68 (3H, m), 7.36 (1H, s), 7.57-7.65 (2H, m), 8.18 (1H, d, J=8 Hz), 8.50 (1H, d, J=4 Hz), 9.36 (1H, brs), 10.24 (1H, brs), 10.49 (1H, brs).

### Reference Example 117

A compound I-(117) was obtained according to the same manner as that of Reference Example 72, using 2-[3-bromo-1-(3-chloro-2-pyridinyl)-1H-pyrazol-5-yl]-8-methyl-6-cyano-4H-3,1-benzoxazine-4-one in place of 2-[3-bromo-1-(3-chloro-2-pyridinyl)-1H-pyrazol-5-yl]-8-chloro-4H-3,1-benzoxazine-4-one.

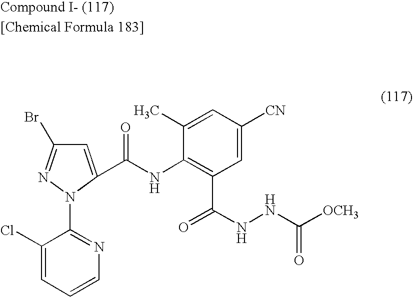

¹H-NMR (DMSO-d₆, TMS) δ(ppm): 2.20 (3H, s), 3.45-3.68 (3H, m), 7.38 (1H, s), 7.61 (1H, dd, J=8 Hz, 5 Hz), 7.77 (1H, s), 7.96 (1H, s), 8.17 (1H, d, J=8 Hz), 8.50 (1H, d, J=5 Hz), 9.36 (1H, brs), 10.27 (1H, brs), 10.49 (1H, brs).

### Reference Example 118

A mixture of 0.59 g of 3,5-dibromo-2-{N-[3-bromo-1-(3-chloro-2-pyridinyl)-1H-pyrazole-5-carbonyl]-N-methylamino}benzoic acid, 2 mL of thionyl chloride and one droplet of N,N-dimethylformamide was stirred at 80° C. for 1 hour. After the reaction mixture was concentrated under reduced pressure, 10 mL of hexane were added, followed by further concentration under reduced pressure. The resulting residue, 10 mL of tetrahydrofuran, 0.10 g of methyl carbazate and 1 mL of pyridine were mixed, and the mixture was stirred at room temperature for 3 hours. The reaction mixture was poured into 30 mL of water, followed by extracted with ethyl acetate three times. Organic layers were combined, washed with sequentially water and a saturated solution of sodium chloride in water, dried over anhydrous magnesium sulfate, and concentrated under reduced pressure. The resulting residue was subjected to silica gel chromatography to obtain 0.23 g of a compound I-(118).

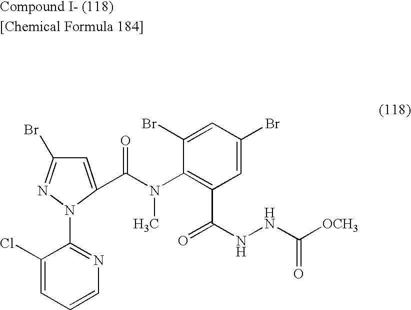

¹H-NMR (DMSO-d₆, TMS) δ(ppm): 3.05 (1.9H, s), 3.38 (1.1H, s), 3.52-3.73 (3H, m), 5.68 (0.7H, brs), 7.11 (0.3H, brs), 7.57-7.81 (2H, m), 8.16-8.32 (2H, m), 8.49-8.55 (1H, m), 9.42 (1H, brs), 10.54 (1H, brs).

### Reference Example 119

A mixture of 0.30 g of 3-bromo-N-[4-chloro-2-(N,N′-dimethylhydrazinocarbonyl)-6-methylphenyl]-1-(3-chloro-2-pyridinyl)-1H-pyrazole-5-carboxamide, 0.07 mL of methyl chloroformate and 5 mL of pyridine was stirred at room temperature for 1 hour. Water was poured into the reaction solution, followed by extracted with ethyl acetate three times. Organic layers were combined, dried over anhydrous magnesium sulfate, and concentrated under reduced pressure. The resulting residue was washed with a mixed solvent of ethyl acetate and hexane to obtain 0.09 g of a compound I-(119).

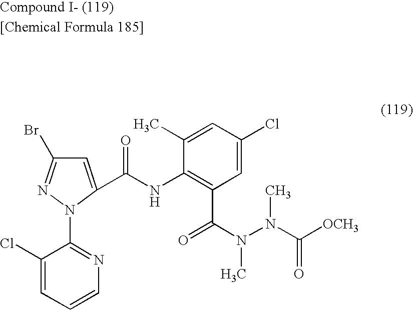

¹H-NMR (DMSO-d₆, TMS) δ(ppm): 2.10-2.24 (3H, m), 2.61-2.87 (3H, m), 2.90-3.18 (3H, m), 3.45-3.74 (3H, m), 7.12-7.30 (1H, m), 7.33-7.44 (1H, m), 7.44-7.58 (1H, m), 7.58-7.66 (1H, m), 8.20 (1H, d, J=8 Hz), 8.47-8.54 (1H, m), 10.10-10.50 (1H, m).

### Reference Example 120

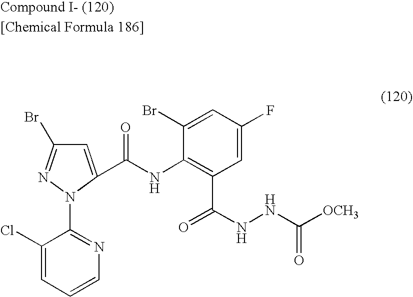

¹H-NMR (DMSO-d₆, TMS) δ(ppm): 3.42-3.69 (3H, m), 7.34 (1H, d, J=8 Hz), 7.41 (1H, s), 7.60 (1H, dd, J=8 Hz, 5 Hz), 7.89 (1H, d, J=8 Hz), 8.16 (1H, d, J=8 Hz), 8.50 (1H, d, J=5 Hz), 9.36 (1H, brs), 10.18 (1H, brs), 10.42 (1H, brs).

### Reference Example 121

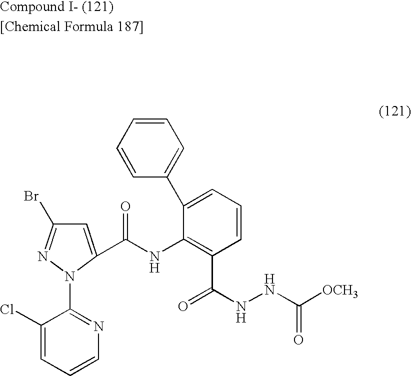

¹H-NMR (DMSO-d₆, TMS) δ(ppm): 3.49-3.68 (3H, m), 7.24-7.67 (10H, m), 8.08 (1H, d, J=8 Hz), 8.43 (1H, d, J=4 Hz), 9.29 (1H, brs), 10.08 (1H, brs), 10.19 (1H, brs).

### Reference Example 122

A mixture of 0.17 g of 6,8-dibromo-2-[4-bromo-1-(3-chloro-2-pyridinyl)-1H-pyrrol-2-yl]-4H-3,1-benzoxazine-4-one, 0.27 g of methyl carbazate and 20 mL of N,N-dimethylformamide was stirred at room temperature for 2 days. Water was poured into the reaction mixture, followed by extraction with ethyl acetate. The organic layer was washed with water, dried over sodium sulfate, and concentrated under reduced pressure to obtain 0.15 g of a compound I-(122).

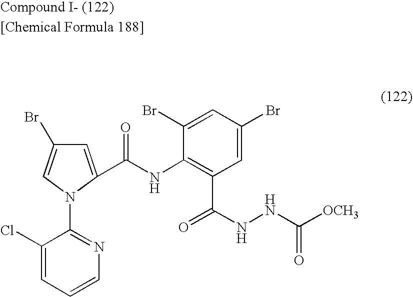

¹H-NMR (DMSO-d₆) δ(ppm): 3.67 (3H, s), 7.36 (1H, s), 7.46 (1H, d, J=2 Hz), 7.54 (1H, dd, J=8 Hz, 5 Hz), 7.70 (1H, s), 8.09 (1H, d, J=8 Hz), 8.13 (1H, d, J=2 Hz), 8.48 (1H, d, J=5 Hz), 9.40 (1H, brs), 9.97 (1H, brs), 10.18 (1H, brs)

### Reference Example 123

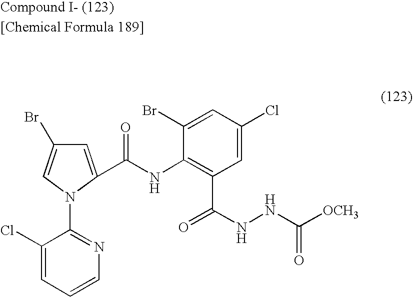

¹H-NMR (DMSO-d₆) δ(ppm): 3.62 (3H, s), 7.30 (1H, s), 7.39 (1H, d, J=2 Hz), 7.48 (1H, dd, J=8 Hz, 5 Hz), 7.52 (1H, s), 7.96 (1H, d, J=2 Hz), 8.03 (1H, dd, J=8 Hz, 2 Hz), 8.42 (1H, dd, J=5 Hz, 2 Hz), 9.35 (1H, brs), 9.92 (1H, brs), 10.11 (1H, brs)

### Reference Example 124

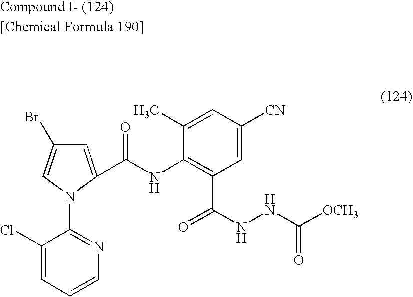

¹H-NMR (DMSO-d₆) δ(ppm): 2.21 (3H, s), 3.64 (3H, s), 7.25 (1H, d, J=2 Hz), 7.41 (1H, d, J=2 Hz), 7.49 (1H, dd, J=8 Hz, 5 Hz), 7.77 (1H, s), 7.88 (1H, s), 8.04 (1H, dd, J=8 Hz, 2 Hz), 8.43 (1H, dd, J=5 Hz, 2 Hz), 9.36 (1H, brs), 10.05 (1H, brs), 10.27 (1H, brs)

### Reference Example 125

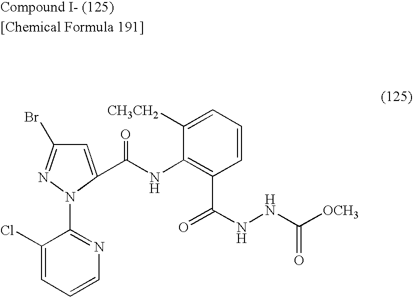

¹H-NMR (DMSO-d₆, TMS) δ(ppm): 1.06-1.13 (3H, m), 2.45-2.60 (2H, m), 3.55-3.70 (3H, m), 7.25-7.47 (4H, m), 7.57-7.63 (1H, m), 8.14-8.19 (1H, m), 8.46-8.53 (1H, m), 9.24 (1H, brs), 9.98 (1H, brs), 10.16 (1H, brs).

### Reference Example 126

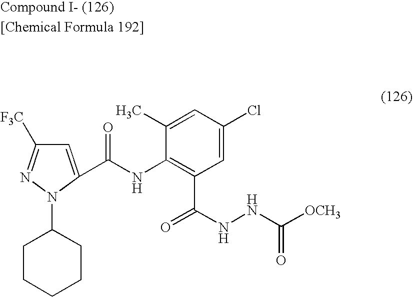

¹H-NMR (DMSO-d₆) δ(ppm): 1.20-1.41 (3H, m), 1.67-1.80 (5H, m), 1.98-2.00 (2H, m), 2.25 (3H, s), 3.56 (3H, s), 5.00-5.08 (1H.m), 7.33 (1H, s), 7.40 (1H, d, J=2 Hz), 7.55 (1H, d, J=2 Hz), 9.02 (1H, brs), 9.94 (1H, brs), 10.04 (1H, brs)

### Reference Example 127

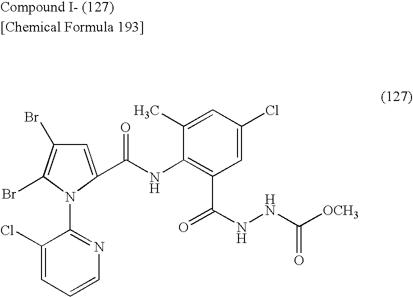

¹H-NMR (DMSO-d₆) δ(ppm): 2.09 (3H, s), 3.63 (3H, s), 7.36 (1H, s), 7.42 (1H, s), 7.49 (1H, s), 7.57 (1H, dd, J=8 Hz, 5 Hz), 8.14 (1H, d, J=8 Hz), 8.50 (1H, d, J=5 Hz), 9.29 (1H, brs), 9.79 (1H, brs), 10.12 (1H, brs)

### Reference Example 128

A mixture of 0.20 g of 4,5-dibromo-N-[4-chloro-2-(hydrazinocarbonyl)-6-methylphenyl]-1-(3-chloro-2-pyridinyl)-1H-pyrrole-2-carboxamide, 0.04 g of N,N-dimethylcarbamoyl chloride and 0.08 mL of pyridine in N,N-dimethylformamide was stirred at room temperature for 14 hours. Water was poured into the reaction mixture, followed by extraction with ethyl acetate. The organic layer was washed with water, dried over sodium sulfate, and concentrated under reduced pressure. The resulting residue was subjected to silica gel chromatography to obtain 0.16 g of a compound I-(128).

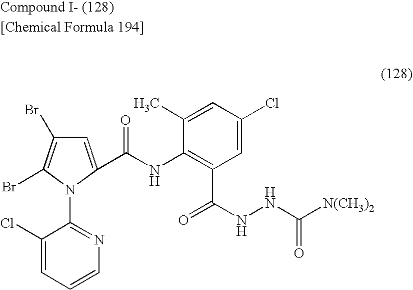

¹H-NMR (DMSO-d₆) δ(ppm): 2.08 (3H, s), 2.88 (6H, s), 7.40 (1H, d, J=2 Hz), 7.44 (1H, d, J=2 Hz), 7.52 (1H, s), 7.58 (1H, dd, J=8 Hz, 5 Hz), 8.14 (1H, dd, J=8 Hz, 1 Hz), 8.50 (1H, dd, J=5 Hz, 1 Hz), 8.56 (1H, brs), 9.75 (1H, brs), 9.81 (1H, brs)

### Reference Example 129

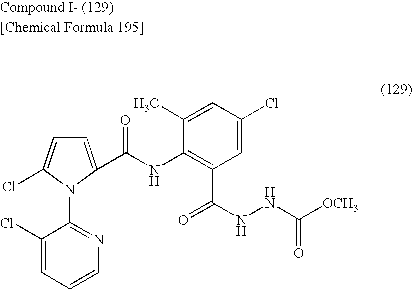

¹H-NMR (DMSO-d₆, TMS) δ(ppm): 2.11 (3H, s), 3.63 (3H, s), 6.48 (1H, d, J=4 Hz), 7.24 (1H, d, J=4 Hz), 7.48 (1H, s), 7.55 (1H, dd, J=8 Hz, 5 Hz), 7.95 (1H, s), 8.12 (1H, dd, J=8 Hz, 2 Hz), 8.49 (1H, dd, J=5 Hz, 2 Hz), 9.31 (1H, brs), 9.74 (1H, brs), 10.13 (1H, brs)

### Reference Example 130

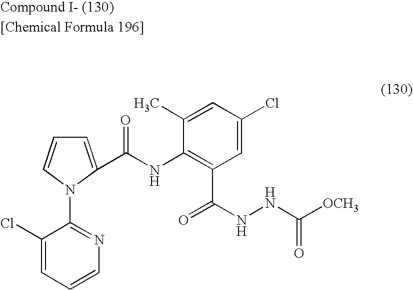

¹H-NMR (DMSO-d₆, TMS) δ(ppm): 2.16 (3H, s), 3.61 (3H, s), 6.37 (1H, d, J=3 Hz), 7.12-7.18 (2H, m), 7.40 (1H, s), 7.45-7.50 (2H, m), 8.03 (1H, d, J=8 Hz), 8.42 (1H, d, J=5 Hz), 9.33 (1H, brs), 9.71 (1H, brs), 10.14 (1H, brs)

### Reference Example 131

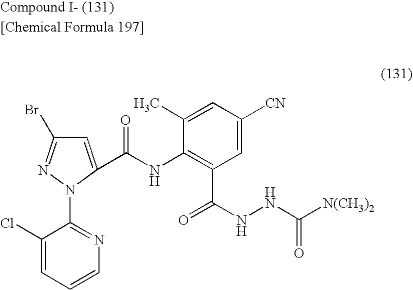

¹H-NMR (DMSO-d₆, TMS) δ(ppm): 2.18 (3H, s), 2.88 (6H, s), 7.49 (1H, s), 7.62 (1H, dd, J=8 Hz, 5 Hz), 7.82 (1H, s), 7.93 (1H, s), 8.19 (1H, dd, J=8 Hz, 1 Hz), 8.50 (1H, dd, J=5 Hz, 1 Hz), 8.63 (1H, brs), 9.93 (1H, brs), 10.42 (1H, brs)

### Reference Example 132

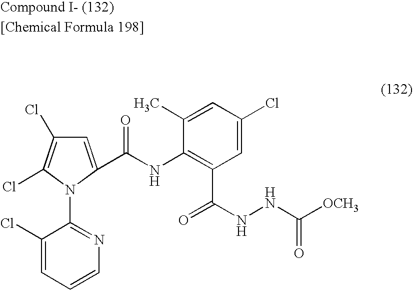

¹H-NMR (DMSO-d₆, TMS) δ(ppm): 2.10 (3H, s), 3.63 (3H, s), 7.39 (2H, s), 7.49 (1H, s), 7.59 (1H, dd, J=8 Hz, 5 Hz), 8.15 (1H, dd, J=8 Hz, 1 Hz), 8.51 (1H, dd, J=5 Hz, 1 Hz), 9.30 (1H, brs), 9.82 (1H, brs), 10.12 (1H, brs)

### Reference Example 133

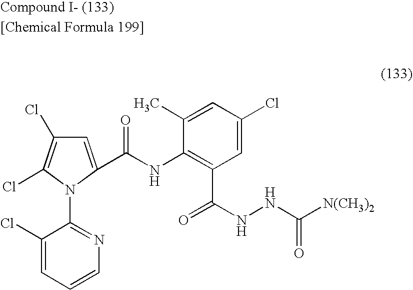

¹H-NMR (DMSO-d₆, TMS) δ(ppm): 2.10 (3H, s), 2.53 (6H, s), 7.37-7.39 (2H, m), 7.51 (1H, d, J=2 Hz), 7.59 (1H, dd, J=8 Hz, 5 Hz), 8.17 (1H, dd, J=8 Hz, 2 Hz), 8.52 (1H, dd, J=5 Hz, 2 Hz), 9.31 (1H, brs), 9.82 (1H, brs), 10.13 (1H, brs)

### Reference Example 134

A mixture of 0.50 g of 4-bromo-N-[4-chloro-2-(N-methylhydrazinocarbonyl)-6-methylphenyl]-1-(3-chloro-2-pyridinyl)-1H-pyrrole-2-carboxamide, 0.11 g of methyl chloroformate, 0.18 mL of pyridine and 5 mL of N,N-dimethylformamide was stirred at room temperature for 3 hours. The reaction mixture was poured into water, and then extracted with ethyl acetate three times. Organic layers were combined, washed sequentially with water and a saturated solution of sodium chloride in water, dried over anhydrous sodium sulfate, and concentrated under reduced pressure. The resulting residue was subjected to silica gel chromatography to obtain 0.09 g of a compound I-(134).

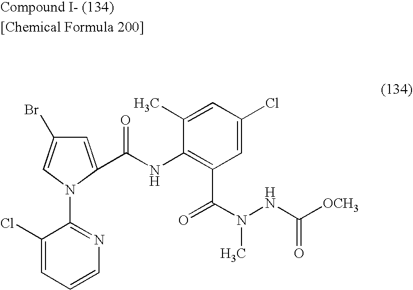

¹H-NMR (CDCl₃, TMS) δ(ppm): 2.05-2.12 (3H, m), 3.21 (3H, s), 3.54-3.76 (3H, m), 7.02 (1H, d, J=2 Hz), 7.06 (2H, s), 7.29 (1H, brs), 7.33 (1H, dd, J=8 Hz, 5 Hz), 7.80-7.86 (2H, m), 8.40 (1H, dd, J=5 Hz, 2 Hz), 8.99 (1H, brs)

### Reference Example 135

A compound I-(135) was obtained according to the same manner as that of Reference Example 72, using 2-[3-bromo-1-(3-chloro-2-pyridinyl)-1H-pyrazol-5-yl]-6,8-dichloro-4H-3,1-benzoxazine-4-one in place of 2-[3-bromo-1-(3-chloro-2-pyridinyl)-1H-pyrazol-5-yl]-8-chloro-4H-3,1-benzoxazine-4-one.

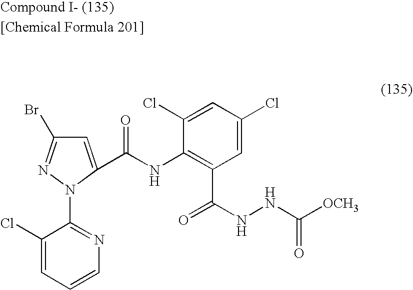

¹H-NMR (DMSO-d₆, TMS) δ(ppm): 3.47-3.62 (3H, m), 7.40 (1H, s), 7.51 (1H, s), 7.60 (1H, dd, J=8 Hz, 5 Hz), 7.93 (1H, s), 8.16 (1H, dd, J=8 Hz, 1 Hz), 8.50 (1H, dd, J=5 Hz, 1 Hz), 9.37 (1H, brs), 10.24 (1H, brs), 10.48 (1H, brs)

### Reference Example 136

A mixture of 0.25 g of 4-bromo-N-[4-chloro-2-(N-methylhydrazinocarbonyl)-6-methylphenyl]-1-(3-chloro-2-pyridinyl)-1H-pyrrole-2-carboxamide, 0.06 g of N,N-dimethylcarbamoyl chloride, 0.09 mL of pyridine and N,N-dimethylformamide was stirred at 70° C. for 8 hours. Water was poured into the reaction mixture, and a formed precipitate was collected by filtration. The resulting solid was washed with acetonitrile to obtain 0.10 g of a compound I-(136).

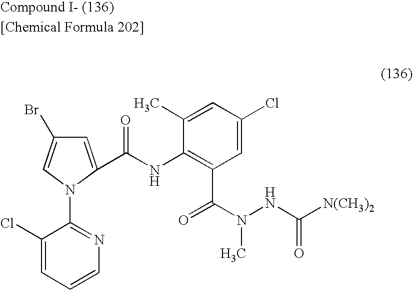

¹H-NMR (DMSO-d₆, TMS) δ(ppm): 2.11 (3H, s), 2.65-2.85 (6H, m), 3.19-3.29 (3H, m), 7.07 (1H, s), 7.14 (1H, s), 7.28 (1H, s), 7.40 (1H, s), 7.50 (1H, dd, J=8 Hz, 5 Hz), 7.60 (1H, brs), 8.06 (1H, d, J=8 Hz), 8.43 (1H, d, J=5 Hz), 9.86 (1H, brs)

### Reference Example 137

Under ice-cooling, 0.50 g of 4-bromo-N-[4-chloro-2-(hydrazinocarbonyl)-6-methylphenyl]-1-(3-chloro-2-pyridinyl)-1H-pyrrole-2-carboxamide, 4 mL of formic acid and 2 mL of acetic anhydride were mixed. The mixture was stirred at room temperature for 2 hours. The reaction mixture was poured into water, and then extracted with ethyl acetate three times. Organic layers were combined, washed with sequentially with water and a saturated solution of sodium chloride in water, dried over anhydrous sodium sulfate, and concentrated under reduced pressure. The residue was washed with acetonitrile to obtain 0.20 g of a compound I-(137).

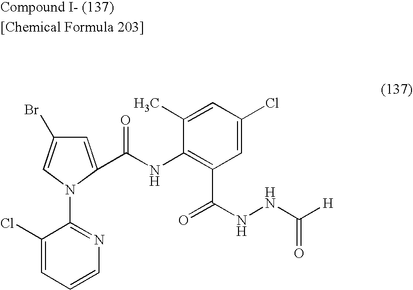

¹H-NMR (DMSO-d₆, TMS) δ(ppm): 2.15 (3H, s), 7.23 (1H, s), 7.42-7.44 (2H, m), 7.48-7.52 (2H, m), 8.05 (1H, d, J=7 Hz), 8.43 (1H, d, J=3 Hz), 8.98 (1H, s), 9.76 (1H, s), 9.96 (1H, brs), 10.12 (1H, brs)

### Reference Example 138

A compound I-(138) was obtained according to the same manner as that of Reference Example 115, using 3-bromo-1-(3-chloro-2-pyridinyl)-N-[4-cyano-2-(N-methylhydrazinocarbonyl)-6-methylphenyl]-1H-pyrazole-5- carboxamide in place of 3-bromo-N-[4-chloro-2-(N-methylhydrazinocarbonyl)-6-methylphenyl]-1-(3-chloro-2-pyridinyl)-1H-pyrazole-5-carboxamide.

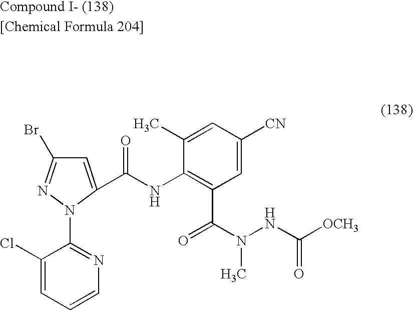

¹H-NMR (DMSO-d₆, TMS) δ(ppm): 2.21 (3H, s), 3.08 (3H, s), 3.45-3.70 (3H, m), 7.30-7.43 (1H, m), 7.44-7.61 (1H, m), 7.63 (1H, dd, J=8 Hz, 5 Hz), 7.82-7.94 (1H, m), 8.21 (1H, d, J=8 Hz, 1 Hz), 8.51 (1H, dd, J=5 Hz, 1 Hz), 9.21 (1H, brs), 10.24 (1H, brs)

### Reference Example 139

A compound I-(139) was obtained according to the same manner as that of Reference Example 134, using 4-bromo-1-(3-chloro-2-pyridinyl)-N-[4-cyano-2-(N-methylhydrazinocarbonyl)-6-methylphenyl]-1H-pyrrole-2- carboxamide in place of 4-bromo-N-[4-chloro-2-(N-methylhydrazinocarbonyl)-6-methylphenyl]-1-(3-chloro-2-pyridinyl)-1H-pyrrole-2-carboxamide.

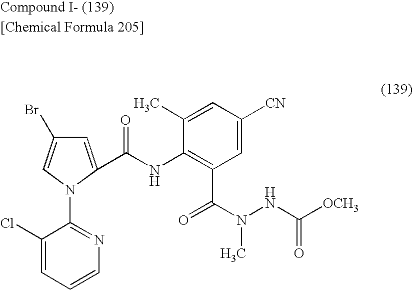

¹H-NMR (DMSO-d₆, TMS) δ(ppm): 2.21 (3H, s), 3.08 (3H, s), 3.47-3.70 (3H, m), 7.18-7.30 (1H, m), 7.41-7.50 (1H, m), 7.51-7.56 (2H, m), 7.80-7.90 (1H, m), 8.12 (1H, dd, J=8 Hz, 1 Hz), 8.45 (1H, dd, J=5 Hz, 1 Hz), 9.10 (1H, brs), 9.73 (1H, brs)

### Reference Example 140

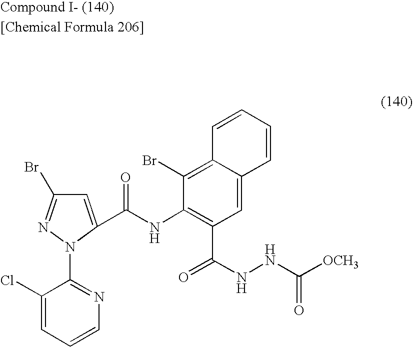

¹H-NMR (DMSO-d₆, TMS) δ(ppm): 3.42-3.71 (3H, m), 7.48 (1H, s), 7.58 (1H, dd, J=8 Hz, 5 Hz), 7.72 (1H, t, J=7 Hz), 7.81 (1H, t, J=7 Hz), 8.10-8.21 (3H, m), 8.24 (1H, d, J=8 Hz), 8.50 (1H, d, J=5 Hz), 9.34 (1H, brs), 10.26 (1H, brs), 10.64 (1H, brs)

### Reference Example 141

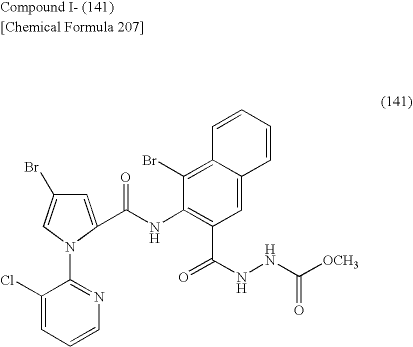

¹H-NMR (DMSO-d₆, TMS) δ(ppm): 3.43-3.70 (3H, m), 7.37 (1H, s), 7.42-7.52 (2H, m), 7.70 (1H, t, J=7 Hz), 7.79 (1H, t, J=7 Hz), 8.03 (1H, d, J=7 Hz), 8.06-8.20 (2H, m), 8.23 (1H, d, J=8 Hz), 8.43 (1H, d, J=4 Hz), 9.34 (1H, brs), 10.09 (1H, brs), 10.19 (1H, brs)

### Reference Example 142

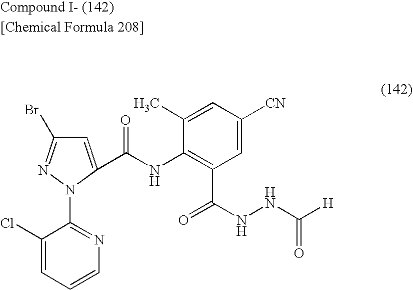

¹H-NMR (DMSO-d₆, TMS) δ(ppm): 2.16-2.34 (3H, m), 7.35-7.45 (1H, m), 7.57-7.66 (1H, m), 7.76-7.88 (1H, m), 7.93-8.02 (1H, m), 8.03-8.12 (1H, m), 8.17 (1H, d, J=7 Hz), 8.50 (1H, brs), 9.55-10.03 (1H, m), 10.17-10.58 (2H, m)

### Reference Example 143

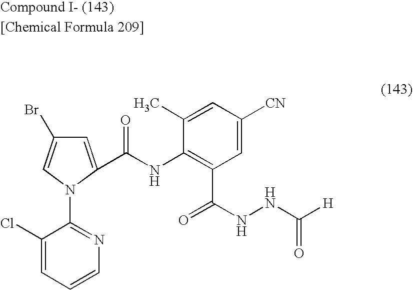

¹H-NMR (DMSO-d₆, TMS) δ(ppm): 2.17-2.30 (3H, m), 7.24-7.36 (1H, m), 7.45-7.55 (2H, m), 7.74-7.82 (1H, m), 7.88-7.95 (1H, m), 8.03-8.09 (2H, m), 8.44 (1H, d, J=5 Hz), 10.02 (1H, brs), 10.21 (1H, brs), 10.46 (1H, brs)

### Reference Example 144

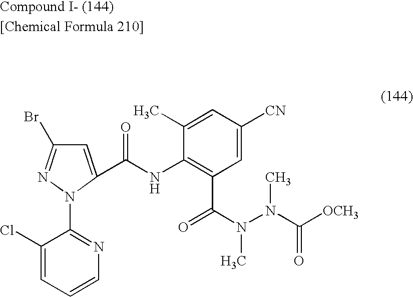

¹H-NMR (DMSO-d₆, TMS) δ(ppm): 2.14-2.29 (3H, m), 2.64-2.87 (3H, m), 2.87-3.15 (3H, m), 3.42-3.73 (3H, m), 7.30-7.45 (1H, m), 7.54-7.81 (2H, m), 7.83-8.01 (1H, m), 8.15-8.24 (1H, m), 8.50 (1H, brs), 10.20-10.68 (1H, m)

### Reference Example 145

A mixture of 0.25 g of 3-bromo-N-[1-bromo-3-(hydrazinocarbonyl)-2-naphthyl]-1-(3-chloro-2-pyridinyl)-1H-pyrazole-5-carboxamide, 0.22 g of N,N-dimethylcarbamoyl chloride, 4 mL of acetonitrile and 1 mL of pyridine was stirred at room temperature for 2 hours, and allowed to stand at room temperature overnight. Water was poured into the reaction mixture, followed by extraction with ethyl acetate three times. Organic layers were combined, washed sequentially with water and a saturated solution of sodium chloride in water, dried over anhydrous magnesium sulfate, and concentrated under reduced pressure to obtain 0.20 g of a compound I-(145).

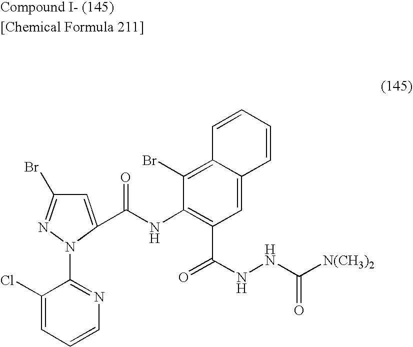

¹H-NMR (DMSO-d₆, TMS) δ(ppm): 2.88 (6H, s), 7.54 (1H, s), 7.59 (1H, dd, J=8 Hz, 5 Hz), 7.72 (1H, t, J=7 Hz), 7.79 (1H, t, J=7 Hz), 8.09 (1H, d, J=7 Hz), 8.15 (1H, dd, J=8 Hz, 1 Hz), 8.19-8.26 (2H, m), 8.50 (1H, dd, J=5, 1 Hz), 8.54 (1H, brs), 9.90 (1H, brs), 10.57 (1H, brs)

### Reference Example 146

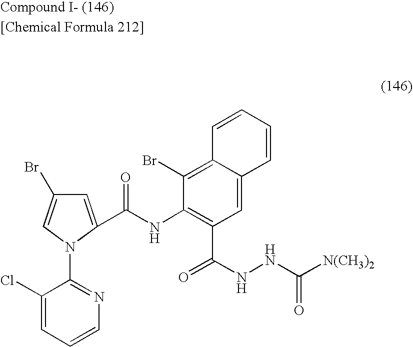

¹H-NMR (DMSO-d₆, TMS) δ(ppm): 2.88 (6H, s), 7.37-7.44 (1H, m), 7.44-7.51 (2H, m), 7.69 (1H, t, J=7 Hz), 7.77 (1H, t, J=7 Hz), 8.01-8.10 (2H, m), 8.19-8.25 (2H, m), 8.43 (1H, dd, J=5 Hz, 1 Hz), 8.55 (1H, brs), 9.84 (1H, brs), 10.05 (1H, brs)

### Reference Example 147

A mixture of 0.26 g of 4-bromo-N-[4-chloro-2-(N,N′-dimethylhydrazinocarbonyl)-6-methylphenyl]-1-(3-chloro-2-pyridinyl)-1H-pyrrole-2-carboxamide, 0.05 g of methyl chloroformate, 0.09 mL of pyridine and 5 mL of N,N-dimethylformamide was stirred at room temperature for 3 hours. The reaction mixture was poured into water, and then extracted with ethyl acetate three times. Organic layers were combined, washed sequentially with water and a saturated solution of sodium chloride in water, dried over anhydrous magnesium sulfate, and concentrated under reduced pressure. The resulting residue was subjected to silica gel chromatography to obtain 0.20 g of a compound I-(147).

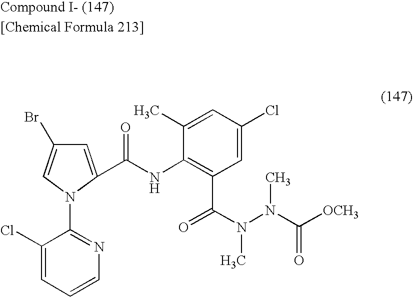

¹H-NMR (CDCl₃, TMS) δ(ppm): 2.18 (3H, s), 2.88-2.98 (3H, m), 3.13-3.22 (3H, m), 3.63-3.82 (3H, m), 7.01-7.12 (3H, m), 7.20 (1H, s), 7.30 (1H, d, J=5 Hz), 7.79-7.80 (1H, m), 8.37-8.38 (1H, m), 8.45-8.58 (1H, brm)

### Reference Example 148

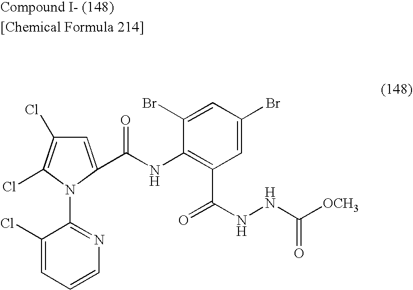

¹H-NMR (DMSO-d₆, TMS) δ(ppm): 3.62 (3H, s), 7.45 (1H, s), 7.58 (1H, dd, J=8 Hz, 5 Hz), 7.63 (1H, s), 8.10 (1H, s), 8.15 (1H, dd, J=8 Hz, 2 Hz), 8.51 (1H, dd, J=5 Hz, 2 Hz), 9.34 (1H, brs), 10.00 (1H, brs), 10.15 (1H, brs)

### Reference Example 149

A mixture of 0.50 g of 3-bromo-N-[4-chloro-2-(N-methylhydrazinocarbonyl)-6-methylphenyl]-1-(3-chloro-2-pyridinyl)-1H-pyrazole-5-carboxamide, 0.09 g of acetyl chloride, 0.09 g of pyridine and 10 mL of tetrahydrofuran was stirred at room temperature for 2 hours. Water was poured into the reaction mixture, followed by extraction with ethyl acetate. The organic layer was washed with water, dried over anhydrous magnesium sulfate, and concentrated under reduced pressure. The resulting residue was washed with methyl tert-butyl ether and hexane to obtain 0.48 g of a compound I-(149).

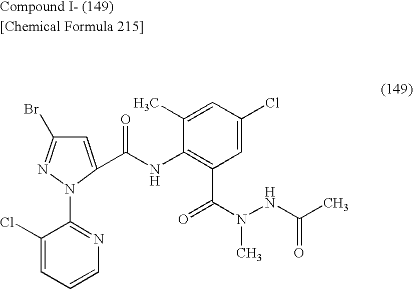

¹H-NMR (CDCl₃, TMS) δ(ppm): 1.56 (3H, s), 2.01 (3H, s), 3.24 (3H, s), 6.97 (2H, d, J=2 Hz), 7.39-7.42 (2H, m), 7.88 (1H, dd, J=8 Hz, 1 Hz), 8.39 (1H, s), 8.47 (1H, dd, J=5 Hz, 1 Hz), 10.12 (1H, brs)

### Reference Example 150

A mixture of 0.50 g of 3-bromo-N-[4-chloro-2-(N-methylhydrazinocarbonyl)-6-methylphenyl]-1-(3-chloro-2-pyridinyl)-1H-pyrazole-5-carboxamide, 0.12 g of methyl chlorothiol formate:

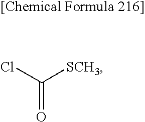

0.09 g of pyridine and 10 mL of tetrahydrofuran was stirred at room temperature for 2 hours. Water was poured into the reaction mixture, followed by extraction with ethyl acetate. The organic layer was washed with water, dried over anhydrous magnesium sulfate, and concentrated under reduced pressure. The resulting residue was washed with methyl tert-butyl ether and hexane to obtain 0.50 g of a compound I-(150).

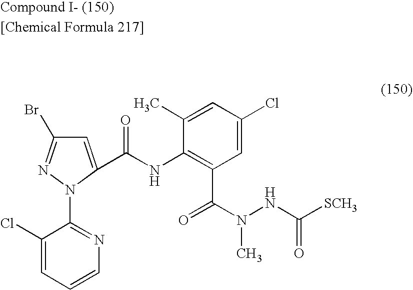

¹H-NMR (CDCl₃, TMS) δ(ppm): 2.06 (3H, brs), 2.25 (3H, brs), 3.20 (3H, brs), 6.99-7.29 (3H, m), 7.41 (1H, dd, J=8 Hz, 5 Hz), 7.88 (1H, dd, J=8 Hz, 1 Hz), 8.01-8.23 (1H, brm), 8.46 (1H, d, J=5 Hz), 9.49-9.79 (1H, brm)

### Reference Example 151

A mixture of 0.49 g of 2-[3-bromo-1-(3-chloro-2-pyridinyl)-1H-pyrazol-5-yl]-10-chloro-4H-naphtho[2,3-d][1,3]oxazine-4-one, 0.90 g of methyl carbazate and 5 mL of N,N-dimethylformamide was stirred at room temperature for 2 hours. Water was poured into the reaction mixture, and followed by extraction with ethyl acetate three times. Organic layers were combined, washed sequentially with water and a saturated solution of sodium chloride in water, dried over anhydrous magnesium sulfate, and concentrated under reduced pressure to obtain 0.31 g of a compound I-(151).

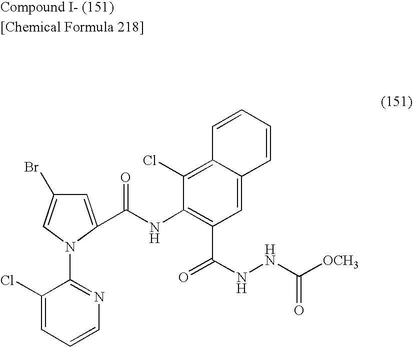

¹H-NMR (DMSO-d₆, TMS) δ(ppm): 3.59-3.68 (3H, m), 7.47 (1H, s), 7.56-7.62 (1H, m), 7.74 (1H, d, J=7 Hz), 7.80 (1H, d, J=7 Hz), 8.12-8.18 (3H, m), 8.25 (1H, d, J=7 Hz), 8.50 (1H, d, J=5 Hz), 9.35 (1H, brs), 10.30 (1H, brs), 10.60 (1H, brs)

### Reference Example 152

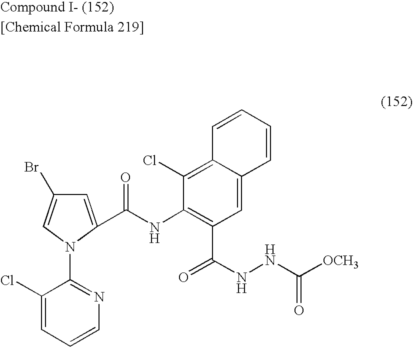

¹H-NMR (DMSO-d₆, TMS) δ(ppm): 3.55-3.70 (3H, m), 7.35 (1H, s), 7.43-7.51 (2H, m), 7.71 (1H, t, J=8 Hz), 7.79 (1H, t, J=8 Hz), 8.04 (1H, d, J=8 Hz), 8.12 (2H, d, J=8 Hz), 8.23 (1H, d, J=8 Hz), 8.43 (1H, d, J=5 Hz), 9.35 (1H, brs), 10.06 (1H, brs), 10.24 (1H, brs)

### Reference Example 153

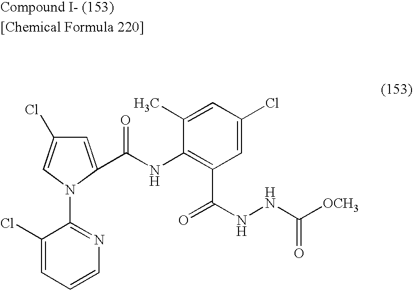

¹H-NMR (DMSO-d₆, TMS) δ(ppm): 2.17 (3H, s), 3.63 (3H, s), 7.18 (1H, d, J=2 Hz), 7.35 (1H, d, J=2 Hz), 7.39 (1H, s), 7.47 (1H, s), 7.49 (1H, dd, J=8 Hz, 5 Hz), 8.03 (1H, dd, J=8 Hz, 2 Hz), 8.42 (1H, dd, J=5 Hz, 2 Hz), 9.31 (1H, brs), 9.76 (1H, brs), 10.12 (1H, brs)

### Reference Example 154

A mixture of 0.52 g of 3-bromo-N-[4,6-dichloro-2-(N-methylhydrazinocarbonyl)phenyl]-1-(3-chloro-2-pyridinyl)-1H-pyrazole-5-carboxamide, 0.10 g of methyl chloroformate, 0.09 g of pyridine and 7 mL of tetrahydrofuran was stirred at room temperature for 1 hour. Water was poureed into the reaction mixture, followed by extraction with ethyl acetate.

The organic layer was washed with water, dried over anhydrous magnesium sulfate, and concentrated under reduced pressure. The resulting residue was washed with methyl tert-butyl ether and hexane to obtain 0.49 g of a compound I-(154).

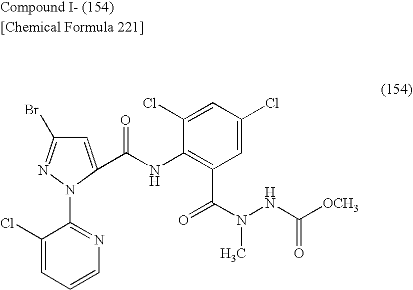

¹H-NMR (CDCl₃, TMS) δ(ppm): 3.12-3.18 (3H, brm), 3.60-3.84 (3H, brm), 7.21-7.22 (2H, m), 7.34 (1H, brs), 7.41 (1H, dd, J=8 Hz, 5 Hz), 7.51 (1H, brs), 7.88 (1H, dd, J=8 Hz, 1 Hz), 8.48 (1H, dd, J=5 Hz, 1 Hz), 9.85 (1H, brs)

### Reference Example 155

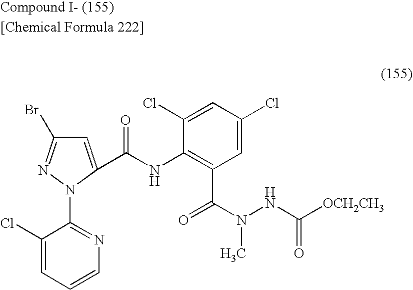

¹H-NMR (CDCl₃, TMS) δ(ppm): 1.11-1.39 (3H, m), 3.12-3.18 (3H, brm), 4.06-4.25 (2H, brm), 7.08-7.22 (2H, m), 7.34 (1H, brs), 7.41 (1H, dd, J=8 Hz, 5 Hz), 7.43 (1H, brs), 7.88 (1H, dd, J=8 Hz, 1 Hz), 8.49 (1H, dd, J=5 Hz, 1 Hz), 9.87 (1H, brs)

### Reference Example 156

A mixture of 0.50 g of 3-bromo-N-[4-chloro-2-(N-methylhydrazinocarbonyl)-6-methylphenyl]-1-(3-chloro-2-pyridinyl)-1H-pyrazole-5-carboxamide and 5 mL of formic acid was stirred at 50° C. for 1 hour. Water was poured into the reaction mixture, followed by extraction with ethyl acetate. The organic layer was washed with water, dried over anhydrous magnesium sulfate, and concentrated under reduced pressure. The resulting residue was washed with methyl tert-butyl ether and hexane to obtain 0.40 g of a compound I-(156).

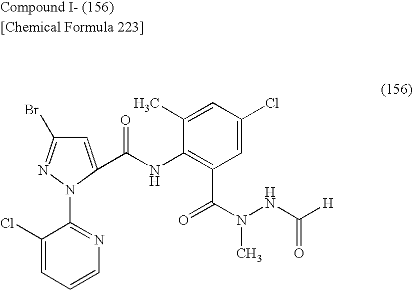

¹H-NMR (CDCl₃, TMS) δ(ppm): 2.02 (3H, s), 3.25 (3H, s), 6.99 (2H, d, J=4 Hz), 7.35 (1H, s), 7.41 (1H, dd, J=8 Hz, 5 Hz), 7.64 (1H, s), 7.88 (1H, dd, J=8 Hz, 2 Hz), 8.47 (1H, dd, J=5 Hz, 2 Hz), 8.58 (1H, s), 10.08 (1H, s)

### Reference Example 157

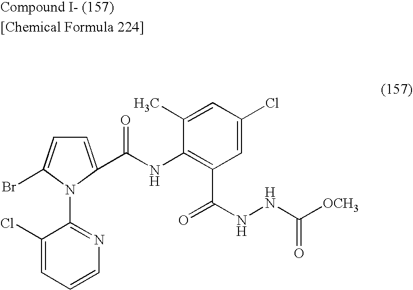

¹H-NMR (DMSO-d₆, TMS) δ(ppm): 2.11 (3H, s), 3.63 (3H, s), 6.54 (1H, d, J=3 Hz), 7.24 (1H, d, J=3 Hz), 7.39 (1H, s), 7.46 (1H, s), 7.54 (1H, dd, J=8 Hz, 4 Hz), 8.09 (1H, d, J=8 Hz), 8.28 (1H, d, J=4 Hz), 9.30 (1H, brs), 9.74 (1H, brs), 10.13 (1H, brs)

### Reference Example 158

To a mixture of 0.50 g of the compound I-(93), 0.26 mL of triethylamine and 15 mL of tetrahydrofuran was added dropwise 0.14 mL of methyl chloroformate under ice-cooling. After the mixture was stirred at room temperature for 5 hours, water was poured into the reaction mixture, followed by extracted with ethyl acetate three times. Organic layers were combined, washed sequentially with water and a saturated solution of sodium chloride in water, dried over anhydrous magnesium sulfate, and concentrated under reduced pressure. The resulting residue was silica gel column chromatography to obtain 0.21 g of a compound I-(158).

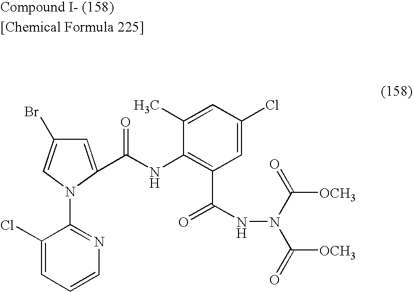

¹H-NMR (CDCl₃, TMS) δ(ppm): 2.22 (3H, s), 3.79 (6H, s), 7.01 (1H, d, J=2 Hz), 7.07 (1H, d, J=2 Hz), 7.30 (1H, dd, J=8 Hz, 5 Hz), 7.32 (1H, s), 7.39 (1H, s), 7.82 (1H, d, J=8 Hz), 8.33 (1H, d, J=5 Hz), 8.45 (1H, brs), 8.88 (1H, brs)

### Reference Example 159

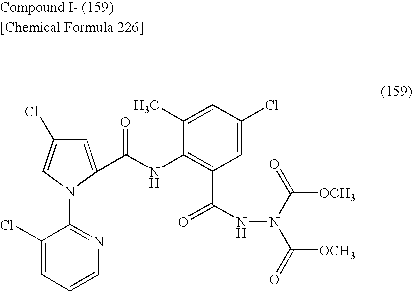

¹H-NMR (CDCl₃, TMS) δ(ppm): 2.18 (3H, s), 3.73 (6H, s), 7.00-7.01 (2H, m), 7.24-7.28 (3H, m), 7.79 (1H, d, J=8 Hz), 8.29 (1H, d, J=4 Hz), 8.82 (1H, brs), 9.06 (1H, brs)

### Reference Example 160

Under ice-cooling, 0.50 g of 3-bromo-N-[4-chloro-2-(N-methylhydrazinocarbonyl)-6-methylphenyl]-1-(3-chloro-2-pyridinyl)-1H-pyrazole-5-carboxamide, 0.12 g of N,N-dimethylcarbamoyl chloride, 0.09 g of pyridine and 20 mL of tetrahydrofuran were mixed. The mixture was stirred at 50° C. for 14 hours. To the mixture were further added 0.12 g of N,N-dimethylcarbamoyl chloride and 0.09 g of pyridine, and the mixture was stirred at 50° C. for 9 hours. Water was poured into the reaction mixture, followed by extraction with ethyl acetate. The organic layer was washed with water, dried over anhydrous magnesium sulfate, and concentrated under reduced pressure. The resulting residue was washed with methyl tert-butyl ether and hexane to obtain 0.15 g of a compound I-(160).

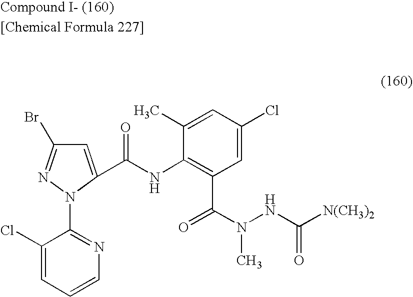

¹H-NMR (CDCl₃, TMS) δ(ppm): 1.98 (3H, s), 2.46 (6H, s), 3.30 (3H, s), 6.95 (1H, d, J=2 Hz), 7.05 (1H, d, J=2 Hz), 7.37 (1H, dd, J=8 Hz, 5 Hz), 7.51 (1H, s), 7.81 (1H, s), 7.85 (1H, dd, J=8 Hz, 2 Hz), 8.45 (1H, dd, J=5 Hz, 2 Hz), 10.34 (1H, brs).

### Reference Example 161

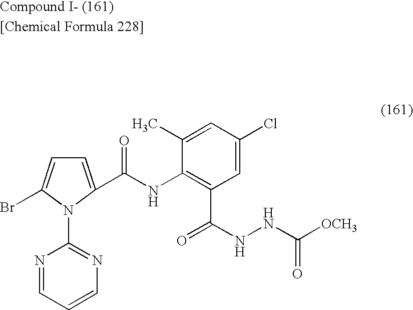

¹H-NMR (DMSO-d₆, TMS) δ(ppm): 2.14 (3H, s), 3.46-3.67 (3H, m), 6.08-6.50 (1H, m), 7.08-7.29 (1H, m), 7.38 (1H, s), 7.51 (1H, s), 7.58-7.65 (1H, m), 8.89-8.95 (2H, m), 9.09-9.39 (1H, m), 9.74-9.90 (1H, m), 10.11 (1H, brs)

### Reference Example 162

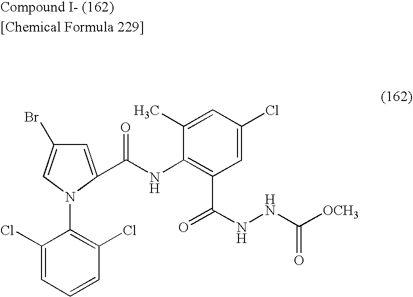

¹H-NMR (DMSO-d₆, TMS) δ(ppm): 2.11 (3H, s), 3.46-3.68 (3H, m), 7.27 (1H, s), 7.30-7.47 (3H, m), 7.50 (1H, s), 7.53-7.65 (2H, m), 9.02-9.38 (1H, m), 9.71 (1H, brs), 10.13 (1H, brs)

### Reference Example 163

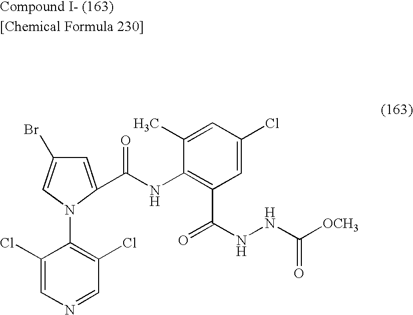

¹H-NMR (DMSO-d₆, TMS) δ(ppm): 2.12 (3H, s), 3.48-3.67 (3H, m), 7.33-7.40 (2H, m), 7.46 (1H, d, J=2 Hz), 7.51 (1H, d, J=2 Hz), 8.76 (2H, s), 9.31 (1H, brs), 9.82 (1H, brs), 10.14 (1H, brs)

### Reference Example 164

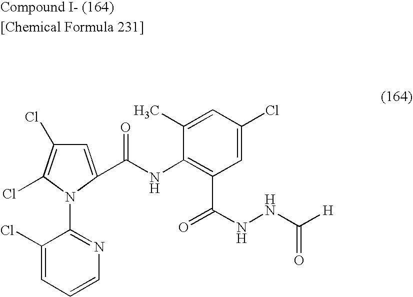

¹H-NMR (DMSO-d₆, TMS) δ(ppm): 2.09-2.19 (3H, s), 7.34-7.53 (3H, m), 7.59 (1H, dd, J=8 Hz, 5 Hz), 8.06 (1H, s), 8.16 (1H, d, J=8 Hz), 8.52 (1H, d, J=5 Hz), 9.87 (1H, brs), 10.13 (1H, brs)10.38 (1H, brs)

### Reference Example 165

Under ice-cooling, 0.43 g of N-[4-chloro-2-(hydrazinocarbonyl)-6-methylphenyl]-1-(2,6-dichlorophenyl)-1H-pyrrole-3-carboxamide, 0.15 g of methyl chlorocarbonate, 2 mL of pyridine and 10 mL of acetonitrile were mixed. The mixture was stirred for 1 hour under ice-cooling. Water was poured into the reaction mixture, followed by extraction with ethyl acetate three times. Organic layers were combined, washed sequentially with water and a saturated solution of sodium chloride in water, dried over anhydrous magnesium sulfate, and concentrated under reduced pressure to obtain 0.16 g of a compound I-(165).

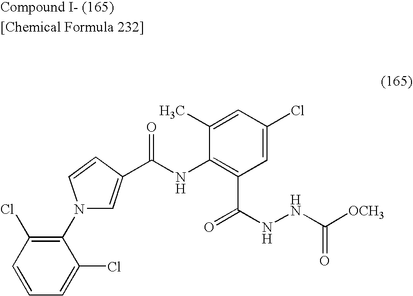

¹H-NMR (DMSO-d₆TMS) δ(ppm): 2.24 (3H, s), 3.38-3.65 (3H, m), 6.81 (1H, brs), 6.96 (1H, brs), 7.33-7.61 (4H, m), 7.68-7.74 (2H, m), 9.37 (1H, brs), 9.52 (1H, brs), 10.21 (1H, brs)

### Reference Example 166

A mixture of 0.56 g of 2-[3-bromo-1-(3-chloro-2-pyridinyl)-1H-pyrazol-5-yl]-6,8-dibromo-4H-3,1-benzoxazin-4-one, 0.47 g of 2,4,4-trimethylsemicarbazide:

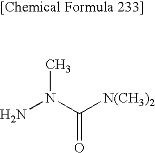

and 15 mL of N-methylpyrrolidinone was stirred at room temperature for 22 hours. Water was poured into the reaction mixture, followed by extraction with ethyl acetate. The organic layer was washed with water, dried over anhydrous magnesium sulfate, and concentrated under reduced pressure. The resulting residue was washed with ethyl acetate to obtain 0.11 g of a compound I-(166).

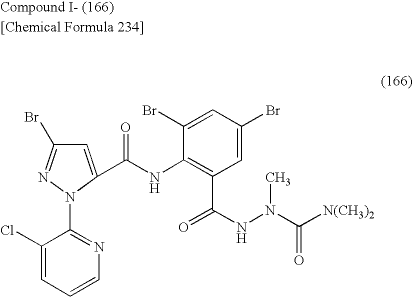

¹H-NMR (DMSO-d₆, TMS) δ(ppm): 2.66 (6H, s), 2.68 (3H, s), 7.45 (1H, brs), 7.59-7.63 (2H, m), 8.15-8.17 (2H, m), 8.49 (1H, d, J=4 Hz), 10.50 (1H, brs), 10.55 (1H, brs).

### Reference Example 167

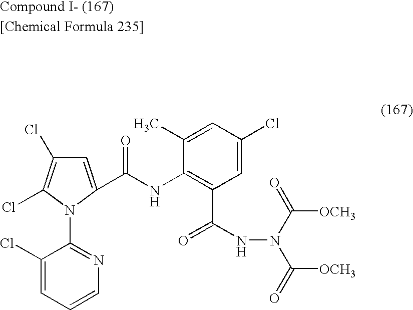

¹H-NMR (CDCl₃, TMS) δ(ppm): 2.18 (3H, s), 3.82 (6H, s), 7.00 (1H, s), 7.32 (1H, d, J=2 Hz), 7.36-7.39 (2H, m), 7.86 (1H, dd, J=8 Hz, 2 Hz), 8.12 (1H, s), 8.43 (1H, dd, J=5 Hz, 2 Hz), 8.85 (1H, brs)

### Reference Example 168

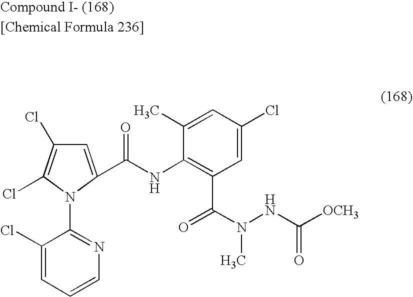

¹H-NMR (CDCl₃, TMS) δ(ppm): 2.02-2.11 (3H, m), 3.02-3.28 (3H, m), 3.54-3.89 (3H, m), 6.95-7.15 (1H, m), 7.22-7.31 (2H, m), 7.39 (1H, dd, J=8 Hz, 5 Hz), 7.70 (1H, brs), 7.87 (1H, dd, J=8 Hz, 2 Hz), 8.47 (1H, dd, J=5 Hz, 2 Hz), 9.23 (1H, brs)

### Reference Example 169

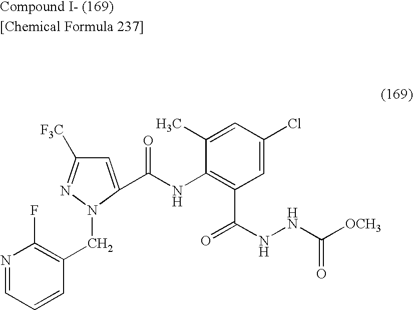

¹H-NMR (DMSO-d₆, TMS) δ(ppm): 2.14 (3H, s), 3.52-3.62 (3H, m), 5.85 (2H, s), 7.30-7.36 (1H, m), 7.39 (1H, s), 7.51 (1H, s), 7.59 (1H, d, J=2 Hz), 7.61-7.71 (1H, m), 8.19 (1H, d, J=5 Hz), 9.26 (1H, brs), 10.20 (1H, brs), 10.25 (1H, brs)

### Reference Example 170

Under ice-cooling, 0.08 g of N-[4-chloro-2-(hydrazinocarbonyl)-6-methylphenyl]-1-[(3-chloro-2-pyridinyl)methyl]-5-trifluoromethyl-1H-pyrazole-3- carboxamide, 0.05 g of methyl chlorocarbonate, 1 mL of pyridine and 10 mL of acetonitrile were mixed. The mixture was stirred for 1 hour under ice-cooling. Water was poured into the reaction mixture, followed by extraction with ethyl acetate three times. Organic layers were combined, washed sequentially with water and a saturated solution of sodium chloride in water, dried over anhydrous magnesium sulfate, and concentrated under reduced pressure to obtain 0.06 g of a compound I-(170).

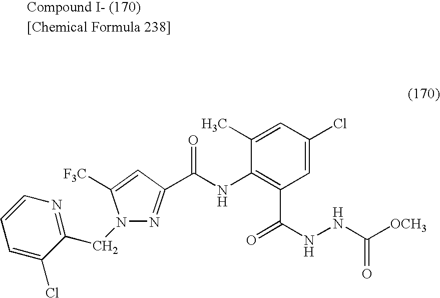

¹H-NMR (DMSO-d₆, TMS) δ(ppm): 2.20 (3H, s), 3.53-3.64 (3H, m), 5.86 (2H, s), 7.41-7.49 (3H, m), 7.59 (1H, s), 8.03 (1H, d, J=7 Hz), 8.44 (1H, d, J=4 Hz), 9.32 (1H, brs), 9.96 (1H, brs), 10.25 (1H, brs)

### Reference Example 171

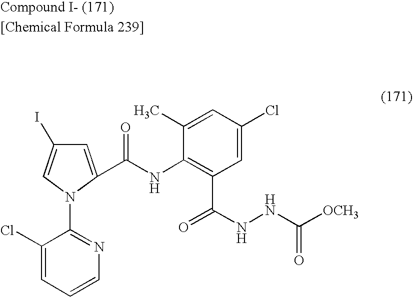

¹H-NMR (DMSO-d₆, TMS) δ(ppm): 2.15 (3H, s), 3.63 (3H, s), 7.25 (1H, s), 7.38 (1H, s), 7.40 (1H, s), 7.49 (1H, dd, J=8 Hz, 5 Hz), 7.51 (1H, s), 8.05 (1H, dd, J=8 Hz, 2 Hz), 8.43 (1H, dd, J=5 Hz, 2 Hz), 9.33 (1H, brs), 9.72 (1H, brs), 10.12 (1H, brs)

### Reference Example 172

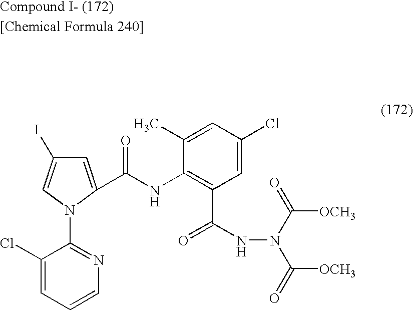

¹H-NMR (CDCl₃, TMS) δ(ppm): 2.19 (3H, s), 3.73 (6H, s), 7.10 (1H, d, J=1 Hz), 7.14 (1H, d, J=1 Hz), 7.25-7.31 (3H, m), 7.79 (1H, dd, J=8 Hz, 2 Hz), 8.31 (1H, dd, J=5 Hz, 2 Hz), 9.20 (1H, s), 9.23 (1H, brs)

### Reference Example 173

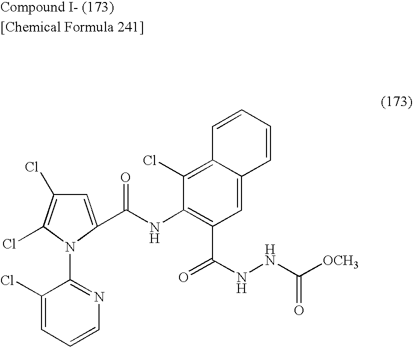

¹H-NMR (CDCl₃, TMS) δ(ppm): 3.60 (3H, s), 7.46-7.59 (2H, m), 7.69-7.81 (2H, m), 8.11-8.23 (4H, m), 8.48-8.52 (1H, m), 9.32 (1H, brs), 10.09 (1H, brs), 10.22 (1H, brs)

### Reference Example 174

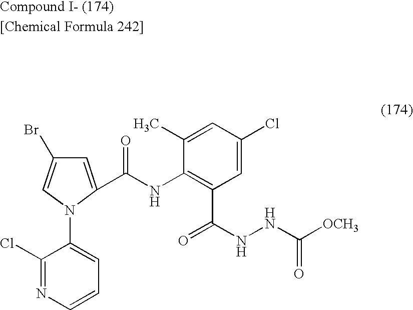

¹H-NMR (DMSO-d₆, TMS) δ (ppm): 2.15 (3H, s), 3.45-3.67 (3H, m), 7.27 (1H, s), 7.36 (1H, s), 7.42 (1H, d, J=1 Hz), 7.48-7.54 (2H, m), 7.94 (1H, dd, J=8 Hz, 1 Hz), 8.42 (1H, dd, J=5 Hz, 1 Hz), 9.29 (1H, brs), 9.73 (1H, brs), 10.12 (1H, brs)

### Reference Example 175

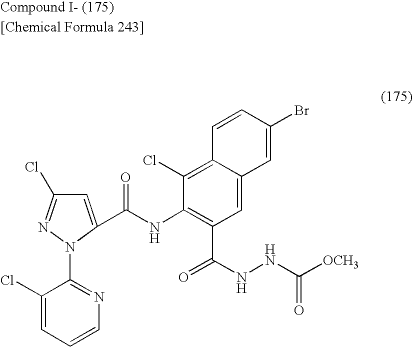

¹H-NMR (DMSO-d₆, TMS) δ(ppm): 3.58-3.70 (3H, m), 7.46 (1H, s), 7.59 (1H, dd, J=8 Hz, 5 Hz), 7.93 (1H, d, J=9 Hz), 8.08-8.21 (3H, m), 8.46-8.53 (2H, m), 9.36 (1H, brs), 10.33 (1H, brs), 10.62 (1H, brs)

### Reference Example 176

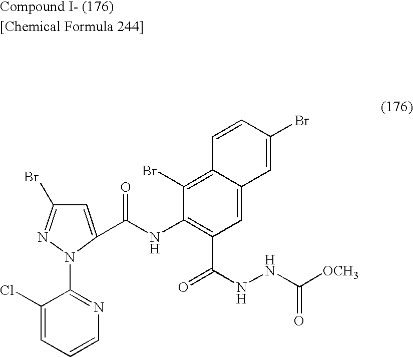

¹H-NMR (DMSO-d₆, TMS) δ(ppm): 3.59-3.69 (3H, m), 7.47 (1H, s), 7.56-7.62 (1H, m), 7.92 (1H, d, J=9 Hz), 8.10-8.20 (3H, m), 8.45-8.54 (2H, m), 9.35 (1H, brs), 10.29 (1H, brs), 10.66 (1H, brs)

### Reference Example 177

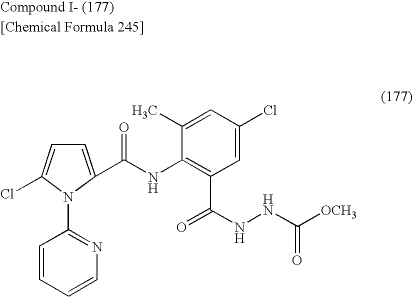

¹H-NMR (DMSO-d₆, TMS) δ(ppm): 2.13 (3H, s), 3.63 (3H, s), 6.42 (1H, d, J=4 Hz), 7.13 (1H, d, J=4 Hz), 7.37 (1H, s), 7.42-7.47 (2H, m), 7.50 (1H, d, J=2 Hz), 7.94 (1H, td, J=8 Hz, 2 Hz), 8.50 (1H, dd, J=5 Hz, 2 Hz), 9.33 (1H, brs), 9.69 (1H, brs), 10.12 (1H, brs)

### Reference Example 178

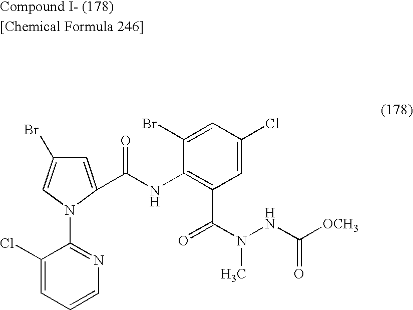

¹H-NMR (CDCl₃, TMS) δ(ppm): 3.15 (3H, s), 3.58 (3H, s), 7.04 (1H, d, J=2 Hz), 7.26 (1H, s), 7.35 (1H, dd, J=8 Hz, 5 Hz), 7.46 (1H, d, J=2 Hz), 7.70 (1H, s), 7.82 (1H, dd, J=8 Hz, 2 Hz), 8.43 (1H, dd, J=5 Hz, 2 Hz), 8.55 (1H, brs), 8.80 (1H, brs)

### Reference Example 179

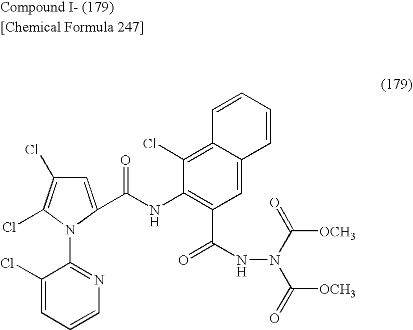

¹H-NMR (CDCl₃, TMS) δ(ppm): 3.81 (6H, s), 7.15 (1H, s), 7.35 (1H, dd, J=8 Hz, 5 Hz), 7.52-7.63 (2H, m), 7.84 (1H, d, J=8 Hz), 7.85 (1H, d, J=8 Hz), 8.04 (1H, s), 8.15 (1H, dd, J=8 Hz, 2 Hz), 8.41 (1H, dd, J=5 Hz, 2 Hz), 8.46 (1H, brs), 8.68 (1H, brs)

### Reference Example 180

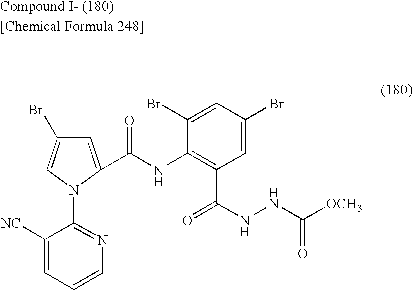

¹H-NMR (DMSO-d₆, TMS) δ(ppm): 3.62 (3H, s), 7.36 (1H, d, J=2 Hz), 7.64 (1H, d, J=2 Hz), 7.64 (1H, s), 7.67 (1H, dd, J=8 Hz, 5 Hz), 8.11 (1H, s), 8.47 (1H, dd, J=8 Hz, 2 Hz), 8.74 (1H, dd, J=5 Hz, 2 Hz), 9.24 (1H, brs), 10.03 (1H, brs), 10.14 (1H, brs)

### Reference Example 181

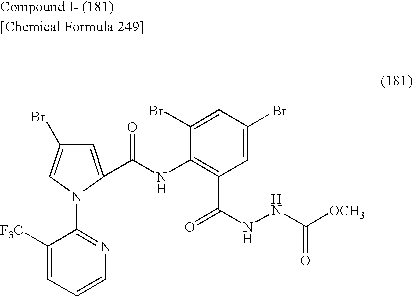

¹H-NMR (DMSO-d₆, TMS) δ(ppm): 3.62 (3H, s), 7.33 (1H, s), 7.50 (1H, s), 7.63 (1H, s), 7.72 (1H, dd, J=8 Hz, 5 Hz), 8.08 (1H, s), 8.33 (1H, d, J=8 Hz), 8.74 (1H, d, J=5 Hz), 9.35 (1H, brs), 9.88 (1H, brs), 10.11 (1H, brs)

### Reference Example 182

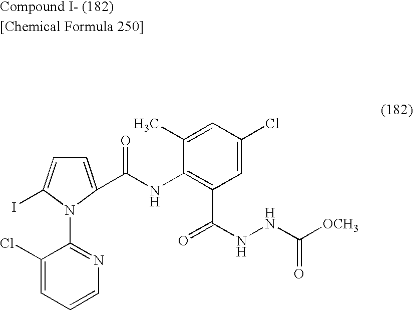

¹H-NMR (DMSO-d₆, TMS) δ(ppm): 2.11 (3H, s), 3.63 (3H, s), 6.63 (1H, d, J=4 Hz), 7.19 (1H, d, J=4 Hz), 7.40 (1H, s), 7.43 (1H, s), 7.52 (1H, dd, J=8 Hz, 5 Hz), 8.06 (1H, dd, J=8 Hz, 2 Hz), 8.48 (1H, dd, J=5 Hz, 2 Hz), 9.28 (1H, brs), 9.71 (1H, brs), 10.13 (1H, brs)

### Reference Example 183

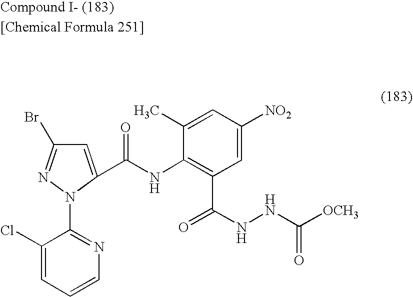

¹H-NMR (DMSO-d₆, TMS) δ(ppm): 2.29 (3H, s), 3.51-3.68 (3H, m), 7.37-7.42 (1H, m), 7.58-7.65 (1H, m), 8.14-8.22 (2H, m), 8.32-8.39 (1H, m), 8.48-8.54 (1H, m), 9.39 (1H, brs), 10.41 (1H, brs), 10.58 (1H, brs)

### Reference Example 184

To a mixture of 0.26 g of N,N′-dimethylhydrazine dihydrochloride, 2 mL of water, 0.5 g of potassium carbonate and 10 mL of N,N-dimethylformamide was added 0.20 g of 2-[3-bromo-1-(3-chloro-2-pyridinyl)-1H-pyrazol-5-yl]-8-methyl-6-nitro-4H-3,1-benzoxazin-4-one, and the mixture was stirred at room temperature for 2 hours. The reaction mixture was poured into water, and then extracted with ethyl acetate three times. Organic layers were combined, washed sequentially with water and a saturated solution of sodium chloride in water, dried over anhydrous sodium sulfate, and concentrated under reduced pressure to obtain crude 3-bromo-1-(3-chloro-2-pyridinyl)-N-[2-(N,N′-dimethylhydrazinocarbonyl)-6-methyl-4-nitrophenyl]-1H-pyrazole-5-carboxamide.

### 3-Bromo-1-(3-chloro-2-pyridinyl)-N-[2-(N,N′-dimethylhydrazinocarbonyl)-6-methyl-4-nitrophenyl]-1H-pyrazole-5-carboxamide

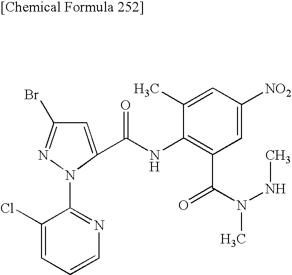

To a mixture of the obtained crude 3-bromo-1-(3-chloro-2-pyridinyl)-N-[2-(N,N′-dimethylhydrazinocarbonyl)-6-methyl-4-nitrophenyl]-1H-pyrazole-5-carboxamide, 1 mL of pyridine and 10 mL of acetonitrile was added 0.1 g of methyl chlorocarbonate under ice-cooling, and the mixture was stirred at room temperature for 2 hours. Water was poured into the reaction mixture, followed by extraction with ethyl acetate twice. Organic layers were combined, washed sequentially with water and a saturated solution of sodium chloride in water, dried over anhydrous sodium sulfate, and concentrated under reduced pressure. The resulting residue was subjected to silica gel chromatography to obtain 0.07 g of a compound I-(184).

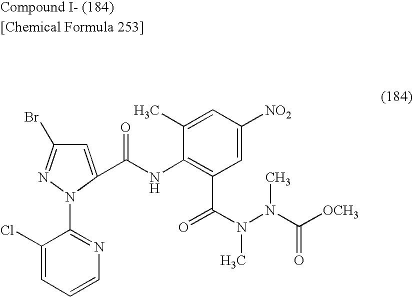

¹H-NMR (DMSO-d₆, TMS) δ(ppm): 2.27-2.37 (3H, m), 2.70-2.88 (3H, m), 2.88-3.11 (3H, m), 3.45-3.74 (3H, m), 7.38-7.46 (1H, m), 7.63 (1H, dd, J=8 Hz, 5 Hz), 7.92-8.04 (1H, m), 8.21 (1H, dd, J=8 Hz, 1 Hz), 8.24-8.34 (1H, m), 8.51 (1H, dd, J=5 Hz, 1 Hz), 10.40-10.75 (1H, m)

### Reference Example 185

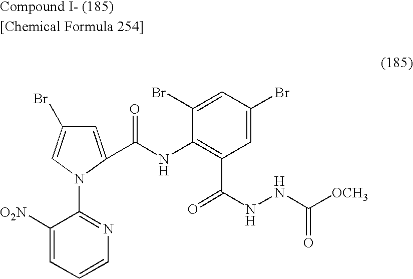

¹H-NMR (DMSO-d₆, TMS) δ(ppm): 3.61 (3H, s), 7.36 (1H, s), 7.57 (1H, d, J=2 Hz), 7.62 (1H, s), 7.78 (1H, dd, J=8 Hz, 5 Hz), 8.10 (1H, d, J=2 Hz), 8.61 (1H, dd, J=8 Hz, 2 Hz), 8.79 (1H, dd, J=5 Hz, 2 Hz), 9.24 (1H, brs), 9.95 (1H, brs), 10.12 (1H, brs)

### Reference Example 186

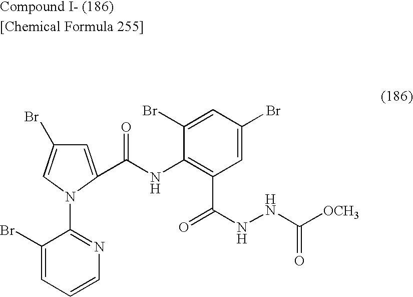

¹H-NMR (DMSO-d₆, TMS) δ(ppm): 3.61 (3H, s), 7.32 (1H, s), 7.40 (1H, dd, J=8 Hz, 5 Hz), 7.42 (1H, s), 7.63 (1H, s), 8.10 (1H, s), 8.17 (1H, d, J=8 Hz), 8.46 (1H, d, J=5 Hz), 9.36 (1H, brs), 9.90 (1H, brs), 10.16 (1H, brs)

### Reference Example 187

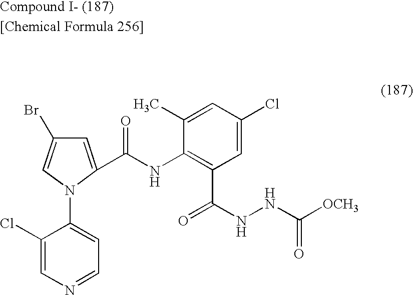

¹H-NMR (DMSO-d₆, TMS) δ(ppm): 2.16 (3H, s), 3.41-3.68 (3H, m), 7.29 (1H, brs), 7.33-7.40 (1H, m), 7.43 (1H, d, J=2 Hz), 7.52 (1H, d, J=2 Hz), 7.55 (1H, d, J=5 Hz), 8.59 (1H, d, J=5 Hz), 8.72 (1H, brs), 9.30 (1H, brs), 9.78 (1H, brs), 10.15 (1H, brs)

### Reference Example 188

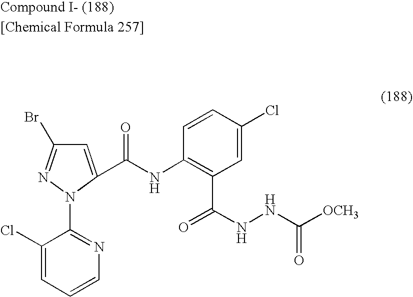

¹H-NMR (DMSO-d₆, TMS) δ(ppm): 3.68 (3H, brs), 7.23 (1H, brs), 7.62 (1H, dd, J=9 Hz, 2 Hz), 7.67 (1H, dd, J=8 Hz, 5 Hz), 7.88 (1H, s), 8.18 (1H, d, J=9 Hz), 8.25 (1H, dd, J=8 Hz, 1 Hz), 8.54 (1H, dd, J=5 Hz, 1 Hz), 9.49 (1H, brs), 10.78 (1H, brs), 11.77 (1H, brs)

### Reference Example 189

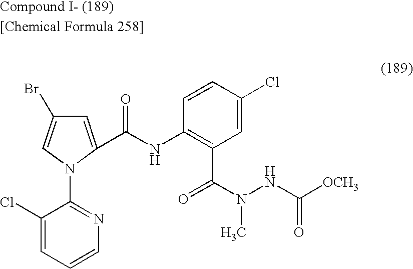

¹H-NMR (DMSO-d₆, TMS) δ(ppm): 3.07 (3H, s), 3.51 (3H, brs), 7.29 (2H, brs), 7.47-7.54 (2H, m), 7.65 (1H, dd, J=8 Hz, 5 Hz), 8.22 (1H, dd, J=8 Hz, 1 Hz), 8.52 (1H, dd, J=5 Hz, 1 Hz), 9.55 (1H, brs), 10.14 (1H, brs)

### Reference Example 190

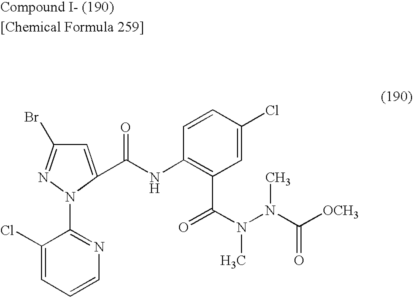

¹H-NMR (DMSO-d₆, TMS) δ(ppm): 2.83-3.07 (6H, m), 3.52-3.70 (3H, m), 7.29-7.60 (4H, m), 7.64 (1H, dd, J=8 Hz, 5 Hz), 8.22 (1H, dd, J=8 Hz, 2 Hz), 8.51 (1H, dd, J=5 Hz, 2 Hz), 10.53-10.68 (1H, brm).

### Reference Example 191

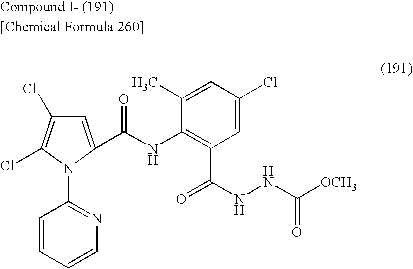

¹H-NMR (DMSO-d₆, TMS) δ(ppm): 2.13 (3H, s), 3.63 (3H, s), 7.24 (1H, s), 7.35 (1H, s), 7.49-7.51 (3H, m), 7.97 (1H, td, J=8 Hz, 2 Hz), 8.52 (1H, dd, J=6 Hz, 2 Hz), 9.31 (1H, brs), 9.78 (1H, brs), 10.12 (1H, brs)

### Reference Example 192

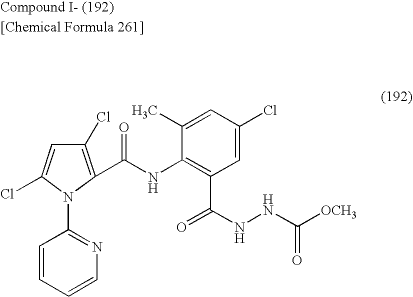

¹H-NMR (DMSO-d₆, TMS) δ(ppm): 2.09 (3H, s), 3.68 (3H, s), 6.69 (1H, s), 7.42 (1H, s), 7.48-7.60 (3H, m), 7.94-8.01 (1H, m), 8.51 (1H, d, J=5 Hz), 9.37 (1H, brs), 9.71 (1H, brs), 10.33 (1H, brs)

### Reference Example 193

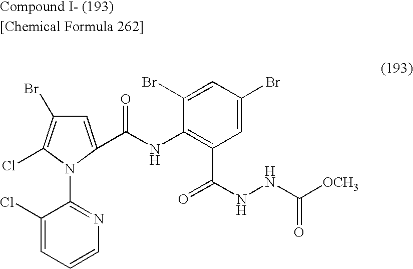

¹H-NMR (DMSO-d₆, TMS) δ(ppm): 3.62 (3H, s), 7.47 (1H, s), 7.58 (1H, dd, J=8 Hz, 5 Hz), 7.63 (1H, s), 8.10 (1H, s), 8.15 (1H, d, J=8 Hz), 8.51 (1H, d, J=5 Hz), 9.34 (1H, brs), 10.00 (1H, brs), 10.15 (1H, brs)

### Reference Example 194

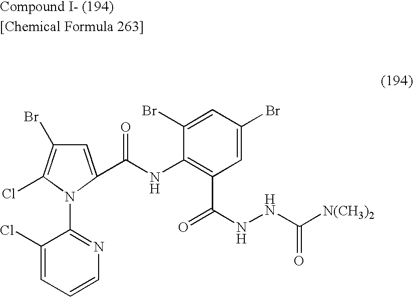

¹H-NMR (DMSO-d₆, TMS) δ(ppm): 2.85 (6H, s), 7.53 (1H, s), 7.59 (1H, dd, J=8 Hz, 5 Hz), 7.70 (1H, s), 8.06 (1H, s), 8.16 (1H, d, J=8 Hz), 8.51 (1H, d, J=5 Hz), 8.56 (1H, brs), 9.82 (1H, brs), 9.97 (1H, brs)

### Reference Example 195

A mixture of 0.59 g of 3-bromo-N-[4,6-dibromo-2-(hydrazinocarbonyl)phenyl]-1-(3-chloro-2-pyridinyl)-1H-pyrazole-5-carboxamide, 0.23 g of propargyl chloroformate, 0.16 g of pyridine and 2 mL of acetonitrile was stirred at room temperature for 1 hour. Water was poured into the reaction mixture, followed by extraction with ethyl acetate. The organic layer was washed with water, dried over sodium sulfate, and concentrated under reduced pressure. The resulting residue was washed with ethyl acetate to obtain 0.22 g of a compound I-(195).

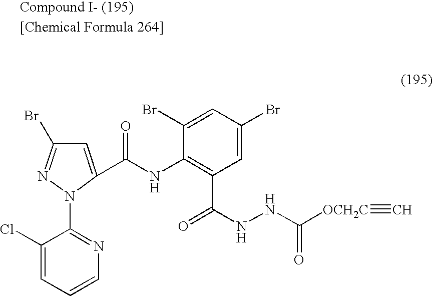

¹H-NMR (DMSO-d₆, TMS) δ(ppm): 3.56 (1H, s), 4.71 (2H, s), 7.41 (1H, s), 7.60 (1H, dd, J=8 Hz, 5 Hz), 7.66 (1H, s), 8.14-8.16 (2H, m), 8.50 (1H, dd, J=5 Hz, 1 Hz), 9.60 (1H, brs), 10.29 (1H, brs), 10.50 (1H, brs).

### Reference Example 196

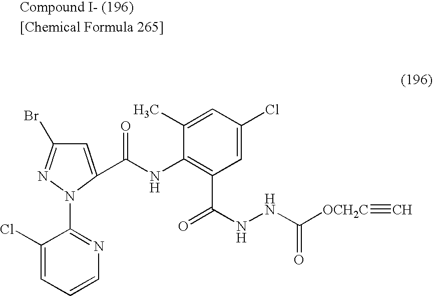

¹H-NMR (DMSO-d₆, TMS) δ(ppm): 2.15 (3H, s), 3.56 (1H, brs), 4.72 (2H, s), 7.35 (1H, s), 7.39 (1H, brs), 7.55 (1H, s), 7.61 (1H, dd, J=8 Hz, 5 Hz), 8.17 (1H, dd, J=8 Hz, 1 Hz), 8.50 (1H, dd, J=5 Hz, 1 Hz), 9.55 (1H, s), 10.23-10.26 (2H, brm).

### Reference Example 197

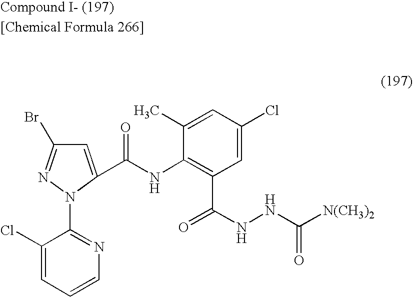

¹H-NMR (DMSO-d₆, TMS) δ(ppm): 2.20 (3H, s), 2.93 (6H, s), 7.50-7.52 (2H, m), 7.58 (1H, brs), 7.67 (1H, dd, J=8 Hz, 5 Hz), 8.24 (1H, d, J=8 Hz), 8.56 (1H, d, J=5 Hz), 8.60 (1H, s), 9.89 (1H, brs), 10.23 (1H, brs)

### Reference Example 198

To a mixture of 0.20 g of the compound I-(197), 0.10 mL of triethylamine and 5 mL of tetrahydrofuran was added dropwise 0.040 mL of methyl chloroformate under ice-cooling, and the mixture was stirred at room temperature for 2.5 hours. Water was poured into the reaction mixture, followed by extraction with ethyl acetate three times. Organic layers were combined, washed with water and a saturated solution of sodium chloride in water, dried over anhydrous magnesium sulfate, and concentrated under reduced pressure. The resulting residue was subjected to silica gel column chromatography to obtain 0.13 g of a compound I-(198).

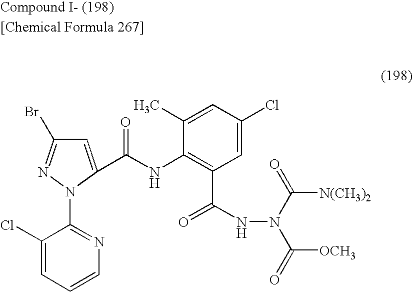

¹H-NMR (CDCl₃, TMS) δ(ppm): 2.22 (3H, s), 3.05 (3H, brs), 3.15 (3H, brs), 3.76 (3H, s), 6.99 (1H, s), 7.35-7.38 (2H, m), 7.44 (1H, s), 7.86 (1H, d, J=8 Hz), 8.39 (1H, s), 8.46 (1H, d, J=5 Hz), 9.40 (1H, s)

### Reference Example 199

A mixture of 1.0 g of 2-[3-bromo-1-(3-chloro-2-pyridinyl)-1H-pyrazol-5-yl]-6-chloro-8-methyl-4H-3,1-benzoxazin-4-one, 1.33 g of formic acid hydrazide and 40 mL of N,N-dimethylformamide was stirred at 50° C. for 3.5 hours and then at 70° C. for 7 hours. The reaction mixture was allowed to cool to room temperature, and water was poured thereto, followed by extraction with methyl tert-butyl ether. The organic layer was washed sequentially with water and a saturated solution of sodium chloride in water, dried over anhydrous magnesium sulfate, and concentrated under reduced pressure. The resulting residue was subjected to silica gel column chromatography to obtain 0.36 g of a compound I-(199).

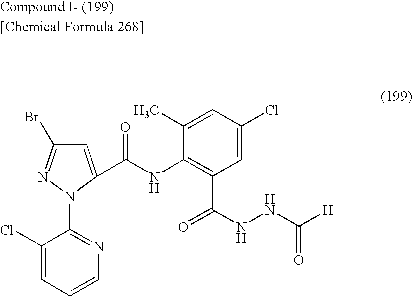

¹H-NMR (DMSO-d₆, TMS) δ(ppm): 2.10-2.21 (3.0H, m), 7.25-7.62 (4.7H, m), 7.79-7.81 (0.2H, m), 8.05 (0.3H, s), 8.16 (1.0H, d, J=8 Hz), 8.49 (1.0H, d, J=5 Hz), 9.48-9.55 (0.7H, m), 10.05-10.45 (2.1H, m)

### Reference Example 200

To a mixture of 0.20 g of the compound I-(115), 0.14 mL of triethylamine and 10 mL of acetonitrile was added dropwise 0.12 mL of methyl chloroformate at room temperature, and the mixture was stirred at room temperature for 18 hours. Water was poured into the reaction mixture, followed by extraction with ethyl acetate three times. Organic layers were combined, washed sequentially with water and a saturated solution of sodium chloride in water, dried over anhydrous magnesium sulfate, and concentrated under reduced pressure. The resulting residue was subjected to silica gel column chromatography to obtain 0.010 g of a compound I-(200).

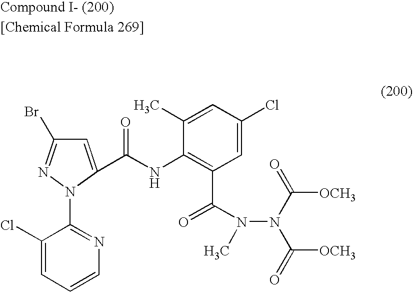

¹H-NMR (CDCl₃, TMS) δ(ppm): 2.21 (3H, s), 3.23 (3H, s), 3.89 (6H, brs), 6.46 (1H, s), 7.08 (1H, s), 7.30 (1H, s), 7.43 (1H, dd, J=8 Hz, 5 Hz), 8.92 (1H, d, J=8 Hz), 8.51 (1H, d, J=5 Hz), 9.21 (1H, s)

### Reference Example 201

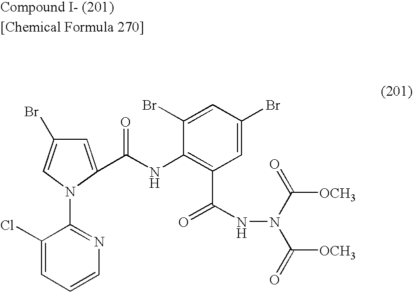

¹H-NMR (CDCl₃, TMS) δ(ppm): 3.74 (6H, s), 7.08 (2H, s), 7.30 (1H, dd, J=8 Hz, 5 Hz), 7.66 (1H, s), 7.82 (1H, d, J=8 Hz), 7.86 (1H, s), 8.28 (1H, brs), 8.32 (1H, d, J=5 Hz), 8.60 (1H, brs)

### Reference Example 202

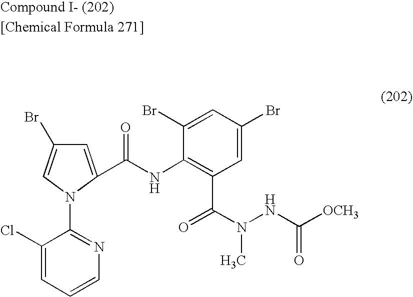

¹H-NMR (CDCl₃, TMS) δ(ppm): 3.05 (0.5H, brs), 3.13 (2.5H, s), 3.59 (2.5H, s), 3.82 (0.5H, brs), 7.05 (1.0H, d, J=2 Hz), 7.21 (1.0H, s), 7.35 (1.3H, dd, J=8 Hz, 5 Hz), 7.42 (1.0H, s), 7.65 (2.0H, s), 7.82 (1.0H, d, J=8 Hz), 8.43 (1.0H, dd, J=5H, 2 Hz), 8.57 (0.7H, s)

### Reference Example 203

A compound I-(203) was obtained according to the same manner as that of Reference Example 115, using 3-bromo-N-[4,6-dibromo-2-(N-methylhydrazinocarbonyl)phenyl]-1-(3-chloro-2-pyridinyl)-1H-pyrazole-5-caboxamide in place of 3-bromo-N-[4-chloro-2-(N-methylhydrazinocarbonyl)-6-methylphenyl]-1-(3-chloro-2-pyridinyl)-1H-pyrazole-5-carboxamide.

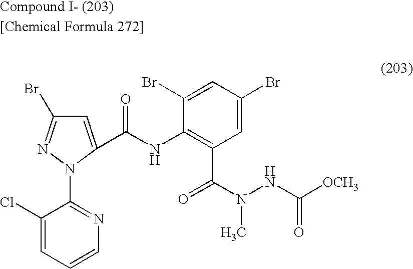

¹H-NMR (100° C., DMSO-d₆, TMS) δ(ppm): 2.96 (3H, s) , 3.04 (3H, brs), 7.30 (1H, s), 7.38 (1H, s), 7.58 (1H, dd, J=8 Hz, 5 Hz), 7.96 (1H, s), 8.11 (1H, d, J=8 Hz), 8.47 (1H, d, J=5 Hz), 8.68 (1H, brs), 10.08 (1H, brs)

### Reference Example 204

A mixture of 0.30 g of 3-bromo-N-[4,6-dibromo-2-(N,N′-dimethylhydrazinocarbonyl)phenyl]-1-(3-chloro-2-pyridinyl)-1H-pyrazole-5-carboxamide, 0.15 mL of methyl chloroformate and 3 mL of pyridine was stirred at room temperature for 2.5 hours. To the reaction mixture was added 0.08 mL of methyl chloroformate, and the mixture was further stirred for 1 hour. To the reaction mixture was added 0.08 mL of methyl chloroformate, and the mixture was further stirred for 0.5 hours. Water was poured into the reaction mixture, followed by extraction with ethyl acetate. The organic layer was dried over anhydrous magnesium sulfate, and concentrated under reduced pressure. The resulting residue was subjected to silica gel column chromatography to obtain 0.24 g of a compound I-(204).

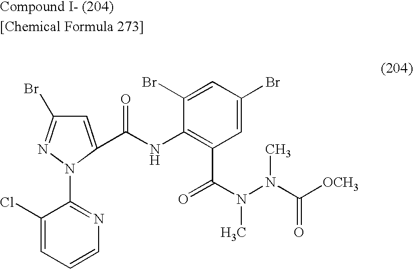

¹H-NMR (DMSO-d₆, TMS) δ(ppm): 2.71 (1.4H, s), 2.83 (1.6H, s), 2.94 (1.5H, s), 3.06 (1.5H, s), 3.35-3.70 (3.0H, m), 7.41 (0.5H, s), 7.45 (0.6H, s), 7.47 (0.6H, s), 7.60-7.64 (1.3H, m), 8.07 (0.5H, d, J=2 Hz), 8.13 (0.5H, s), 8.18 (1.0H, d, J=8 Hz), 8.50 (1.0H, m), 10.52 (0.5H, s), 10.67 (0.5H, s)

### Reference Example 205

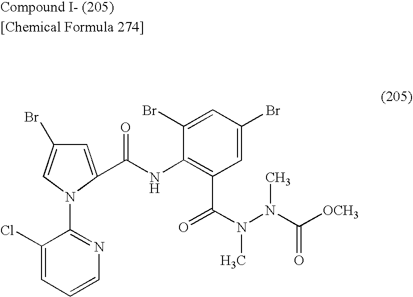

¹H-NMR (DMSO-d₆, TMS) δ(ppm): 2.73 (1.4H, s), 2.82 (1.8H, s), 2.89 (1.3H, s), 3.06 (1.5H, s), 3.35-3.70 (3.0H, m), 7.32 (0.5H, s), 7.34-7.38 (0.6H, m), 7.43 (0.5H, s), 7.48-7.53 (2.4H, m), 8.03 (0.4H, d, J=2 Hz), 8.07-8.10 (1.6H, m), 8.43-8.45 (1.0H, m), 9.93 (0.5H, s), 10.07 (0.5H, s)

### Reference Example 206

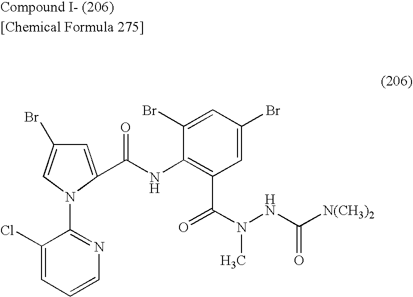

¹H-NMR (CDCl₃, TMS) δ(ppm): 2.47 (6H, s), 3.29 (3H, s), 7.04 (1H, d, J=2 Hz), 7.31 (1H, dd, J=8 Hz, 5 Hz), 7.43 (1H, d, J=2 Hz), 7.51 (1H, d, J=2 Hz), 7.53 (1H, d, J=2 Hz), 7.80 (1H, dd, J=8 Hz, 2 Hz), 8.09 (1H, s), 8.41 (1H, dd, J=5 Hz, 2 Hz), 9.67 (1H, s)

### Reference Example 207

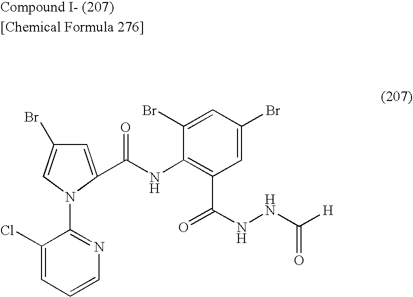

¹H-NMR (DMSO-d₆, TMS) δ(ppm): 7.31 (0.6H, s), 7.38 (0.3H, s), 7.44 (0.6H, d, J=2 Hz), 7.47-7.52 (1.5H, m), 7.65-7.75 (1.3H, m), 8.03-8.12 (2.7H, m), 8.43 (1.0H, dd, J=5 Hz, 2 Hz), 9.49-9.52 (0.3H, m), 9.94-9.99 (0.4H, m), 10.17 (1.0H, s), 10.39-10.44 (1.0H, m)

### Reference Example 208

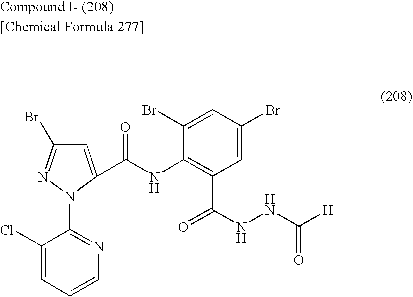

¹H-NMR (DMSO-d₆, TMS) δ(ppm): 7.41 (0.7H, s), 7.45 (0.3H, s), 7.58-7.63 (1.0H, m), 7.69-7.73 (1.0H, m), 7.77-7.79 (0.4H, m), 8.04 (0.6H, s), 8.13-8.18 (2.0H, m), 8.49-8.51 (1.0H, m), 9.55-9.58 (0.4H, m), 10.18 (0.6H, s), 10.45-10.60 (2.0H, m)

### Reference Example 209

A mixture of 0.30 g of 6,8-dibromo-2-[4-bromo-1-(3-chloro-2-pyridinyl)-1H-pyrrol-2-yl]-4H-3,1-benzoxazin⁻4-one, 0.28 g of N-methyl-N-methoxycarbonylhydrazine and 15 mL of N,N-dimethylformamide was stirred at 80° C. for 35 hours. The reaction mixture was allowed to cool to room temperature, and water was poured thereto, followed by extraction with methyl tert-butyl ether. The organic layer was washed sequentially with water and a saturated solution of sodium chloride in water, dried over anhydrous magnesium sulfate, and concentrated under reduced pressure. The resulting residue was subjected to silica gel chromatography to obtain 0.18 g of a compound I-(209).

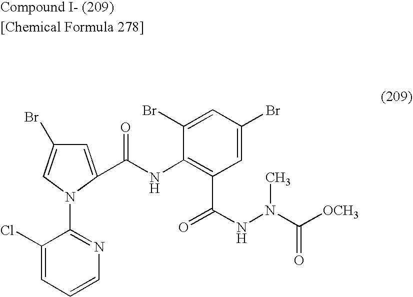

¹H-NMR (DMSO-d₆, TMS) δ(ppm): 2.84 (3H, s), 3.45-3.70 (3H, brm), 7.38 (1H, brs), 7.47 (1H, d, J=2 Hz), 7.50 (1H, dd, J=8 Hz, 5 Hz), 7.54 (1H, d, J=2 Hz), 8.05 (1H, dd, J=8 Hz, 2 Hz), 8.12 (1H, d, J=2 Hz), 8.41 (1H, dd, J=5 Hz, 2 Hz), 9.95 (1H, s), 10.50 (1H, s)

### Reference Example 210

A mixture of 0.16 g of 4-bromo-N-[4,6-dibromo-2-(N,N′-dimethylhydrazinocarbonyl)phenyl]-1-(3-chloro-2-pyridinyl)-1H-pyrrole-2-carboxamide, 0.12 mL of N,N-dimethylcarbamoyl chloride and 0.2 mL of pyridine was stirred at 80° C. for 5 hours. The reaction mixture was allowed to cool to room temperature, and water was poured thereto, followed by extraction with ethyl acetate. The organic layer was washed sequentially with water and a saturated solution of sodium chloride in water, dried over anhydrous magnesium sulfate, and concentrated under reduced pressure. The resulting residue was subjected to silica gel column chromatography to obtain 0.15 g of a compound I-(210).

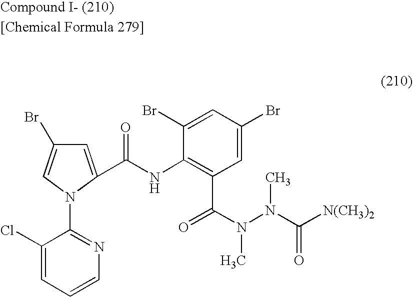

¹H-NMR (DMSO-d₆, TMS) δ(ppm): 2.44 (4.5H, s), 2.58 (3.0H, s), 2.74 (1.5H, brs), 2.78 (1.0H, s), 3.12 (2.0H, s), 7.14 (0.7H, d, J=2 Hz), 7.32 (0.7H, d, J=2 Hz), 7.38 (0.3H, s), 7.47-7.54 (2.3H, m), 8.00 (0.7H, d, J=2 Hz), 8.07-8.10 (1.3H, m), 8.42-8.45 (1.0H, m), 9.95 (0.7H, brs), 10.08 (0.3H, brs)

### Reference Example 211

A mixture of 0.16 g of 3-bromo-N-[4,6-dibromo-2-(N,N′-dimethylhydrazinocarbonyl)phenyl]-1-(3-chloro-2-pyridinyl)-1H-pyrazole-5-carboxamide, 0.12 mL of N,N-dimethylcarbamoyl chloride and 2 mL of pyridine was stirred at 80° C. for 5 hours. The reaction mixture was allowed to cool to room temperature, and water was poured thereto, followed by extraction with ethyl acetate. The organic layer was washed sequentially with water and a saturated solution of sodium chloride in water, dried over anhydrous magnesium sulfate, and concentrated under reduced pressure. The resulting residue was subjected to silica gel column chromatography to obtain 0.12 g of a compound I-(211).

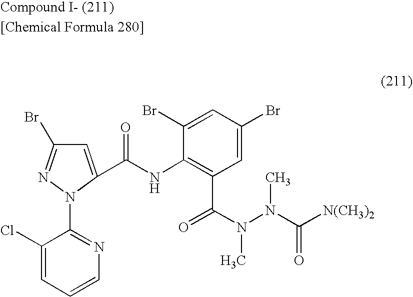

¹H-NMR (DMSO-d₆, TMS) δ(ppm): 2.35 (4.5H, s), 2.49 (2.0H, s), 2.57 (1.0H, brs), 2.67 (1.5H, brs), 2.73 (1.0H, s), 3.05 (2.0H, s), 7.10 (0.7H, s), 7.34 (0.7H, s), 7.39 (0.3H, s), 7.52-7.57 (1.3H, m), 7.97 (0.7H, d, J=2 Hz), 8.06 (0.3H, s), 8.11 (1.0H, dd, J=8 Hz, 2 Hz), 8.41-8.45 (1.0H, m), 10.49 (0.7H, s), 10.62 (0.3H, s)

### Reference Example 212

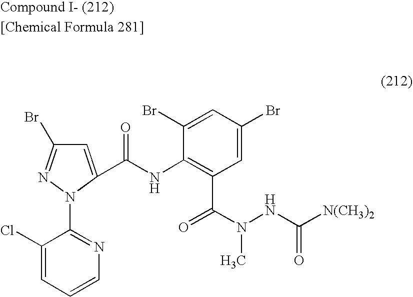

¹H-NMR (CDCl₃, TMS) δ(ppm): 2.50 (6H, s), 3.28 (3H, s), 7.38 (1H, dd, J=8 Hz, 5 Hz), 7.46 (1H, d, J=2 Hz), 7.50 (1H, s), 7.55 (1H, d, J=2 Hz), 7.78 (1H, s), 7.86 (1H, d, J=8 Hz), 8.46 (1H, d, J=5 Hz), 10.20 (1H, s).

### Reference Example 213

A compound I-(213) was obtained according to the same manner as that of Reference Example 114, using 2-[3-bromo-1-(3-chloro-2-pyridinyl)-1H-pyrazol-5-yl]-6,8-dibromo-4H-3,1-benzoxazin-4-one in place of 2-[3-bromo-1-(3-chloro-2-pyridinyl)-1H-pyrazol-5-yl]-6-chloro-8-methyl-4H-3,1-benzoxazin-4-one.

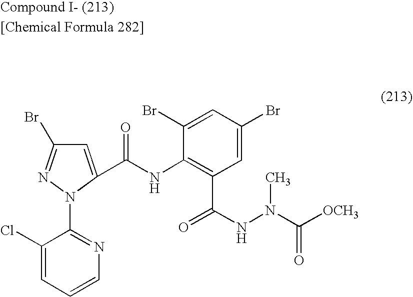

¹H-NMR (DMSO-d₆) δ(ppm): 2.87 (3H, s), 3.46-3.66 (3H, brm), 7.46 (1H, s), 7.58-7.61 (2H, m), 8.13-8.18 (2H, m), 8.47 (1H, dd, J=5 Hz, 2 Hz), 10.54 (1H, s), 10.61 (1H, s)

### Reference Example 214

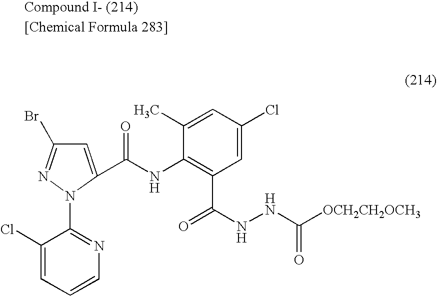

¹H-NMR (CDCl₃, TMS) δ(ppm): 2.21 (3H, s), 3.39 (3H, brs), 3.61 (2H, brs), 4.31 (2H, brs), 6.96 (1H, brs), 7.01 (1H, s), 7.32-7.39 (3H, m), 7.85 (1H, dd, J=8 Hz, 2 Hz), 8.03 (1H, brs), 8.41 (1H, d, J=5 Hz), 9.47 (1H, s)

### Reference Example 215

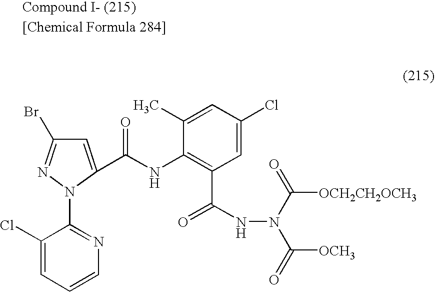

¹H-NMR (CDCl₃, TMS) δ(ppm): 2.24 (3H, s), 3.31 (3H, s), 3.58 (2H, t, J=5 Hz), 3.83 (3H, s), 4.32 (2H, brs), 6.98 (1H, s), 7.32-7.37 (2H, m), 7.46 (1H, d, J=2 Hz), 7.88 (1H, d, J=8 Hz), 8.34 (1H, d, J=5 Hz), 8.70 (1H, s), 9.33 (1H, s)

### Reference Example 216

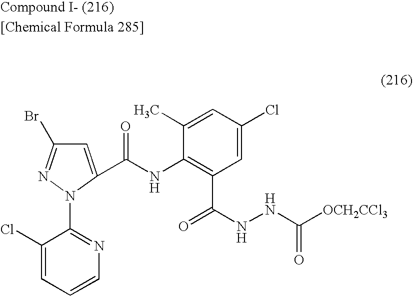

¹H-NMR (DMSO-d₆, TMS) δ(ppm): 2.22 (3.0H, s), 4.89 (0.4H, s), 4.97 (1.6H, s), 7.41 (1.0H, s), 7.46 (0.8H, s), 7.53 (0.2H, s), 7.62 (1.0H, s), 7.67 (1.0H, dd, J=8 Hz, 5 Hz), 8.24 (1.0H, dd, J=8 Hz, 2 Hz), 8.56 (1.0H, dd, J=5 Hz, 2 Hz), 9.52 (0.2H, s), 10.00 (0.8H, s), 10.31-10.36 (1.0H, brm), 10.41 (0.8H, s), 10.50 (0.2H, s)

### Reference Example 217

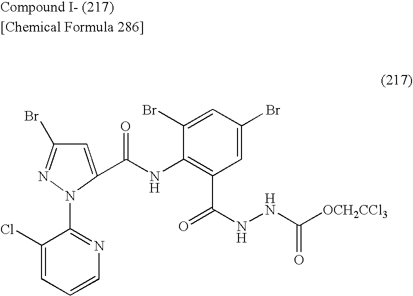

¹H-NMR (DMSO-d₆, TMS) δ(ppm): 4.83-4.90 (2.0H, brm), 7.40 (1.0H, s), 7.60 (1.0H, dd, J=8 Hz, 5 Hz), 7.67 (0.7H, s), 7.74 (0.3H, s), 8.14-8.18 (2.0H, m), 8.50 (1.0H, d, J=5 Hz), 9.51 (0.3H, s), 9.99 (0.7H, s), 10.41 (0.7H, s), 10.48-10.54 (1.3H, m)

### Reference Example 218

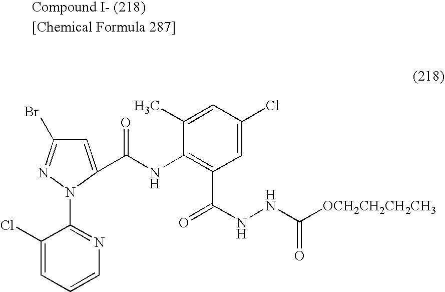

¹H-NMR (DMSO-d₆, TMS) δ(ppm): 0.90 (3H, brs), 1.36 (2H, brs), 1.56 (2H, brs), 2.15 (3H, s), 3.92-4.06 (2H, brm), 7.34-7.39 (2H, brm), 7.55 (1H, d, J=2 Hz), 7.61 (1H, dd, J=8 Hz, 5 Hz), 8.17 (1H, dd, J=8 Hz, 2 Hz), 8.49 (1H, dd, J=5 Hz, 2 Hz), 9.26 (1H, s), 10.13 (1H, s), 10.23 (1H, s)

### Reference Example 219

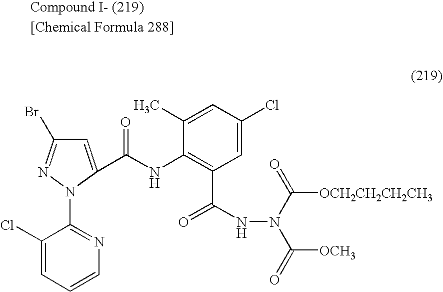

¹H-NMR (CDCl₃, TMS) δ(ppm): 0.93 (3H, t, J=7 Hz), 1.38 (2H, qt, J=7 Hz, 7 Hz), 1.65 (2H, tt, J=7 Hz, 7 Hz), 2.23 (3H, s), 3.81 (3H, s), 4.24 (2H, t, J=7 Hz), 6.97 (1H, s), 7.34-7.38 (2H, m), 7.44 (1H, d, J=2 Hz), 7.88 (1H, dd, J=8 Hz, 2 Hz), 8.35 (1H, s), 8.38 (1H, dd, J=5 Hz, 2 Hz), 9.24 (1H, s)

### Reference Example 220

A mixture of 0.30 g of 3-bromo-N-[4-chloro-2-(hydrazinocarbonyl)-6-methylphenyl]-1-(3-chloro-2-pyridinyl)-1H-pyrazole-5-carboxamide, 0.10 g of methoxy acetyl chloride and 3 mL of pyridine was stirred at room temperature for 2.5 hours. Water was poured into the reaction mixture, followed by extraction with ethyl acetate three times. The organic layer was washed with a saturated solution of sodium chloride in water, dried over anhydrous magnesium sulfate, and concentrated under reduced pressure. The resulting residue was subjected to silica gel column chromatography to obtain 0.21 g of a compound I-(220).

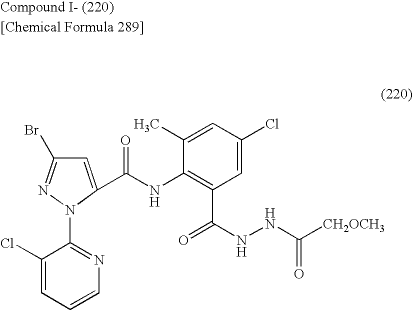

¹H-NMR (CDCl₃, TMS) δ(ppm): 2.21 (3H, s), 3.50 (3H, s), 4.08 (2H, s), 7.02 (1H, s), 7.34-7.40 (3H, m), 7.86 (1H, dd, J=8 Hz, 2 Hz), 8.44 (1H, dd, J=5 Hz, 2 Hz), 8.57 (1H, d, J=5 Hz), 8.85 (1H, d, J=5 Hz), 9.58 (1H, s).

### Reference Example 221

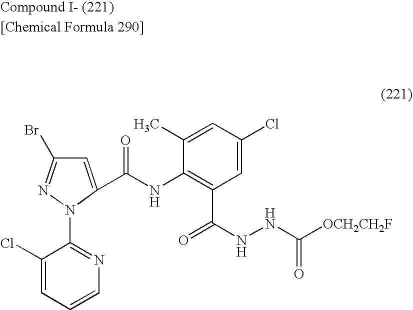

¹H-NMR (DMSO-d₆, TMS) δ(ppm): 2.13 (3H, s), 4.20-4.34 (2H, m), 4.53-4.70 (2H, m), 7.35 (1H, s), 7.39 (1H, s), 7.55 (1H, s), 7.61 (1H, dd, J=8 Hz, 5 Hz), 8.17 (1H, dd, J=8 Hz, 2 Hz), 8.50 (1H, dd, J=5 Hz, 2 Hz), 9.49 (1H, s), 10.19 (1H, brs), 10.24 (1H, brs)

### Reference Example 222

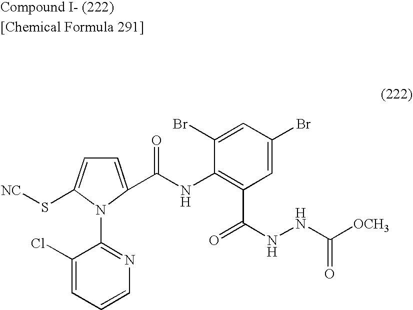

¹H-NMR (DMSO-d₆, TMS) δ(ppm): 3.61 (3H, s), 7.10 (1H, d, J=4 Hz), 7.38 (1H, d, J=4 Hz), 7.59 (1H, dd, J=8 Hz, 5 Hz), 7.64 (1H, brs), 8.11 (1H, d, J=2 Hz), 8.15 (1H, dd, J=8 Hz, 1 Hz), 8.54 (1H, dd, J=5 Hz, 1 Hz), 9.35 (1H, brs), 10.14 (2H, brs)

### Reference Example 223

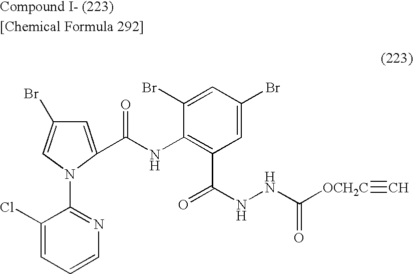

¹H-NMR (DMSO-d₆, TMS) δ(ppm): 3.55 (1H, s), 4.70 (2H, s), 7.30 (1H, s), 7.44 (1H, d, J=1 Hz), 7.49 (1H, dd, J=8 Hz, 5 Hz), 7.64 (1H, s), 8.05 (1H, d, J=8 Hz), 8.11 (1H, s), 8.43 (1H, dd, J=5 Hz, 1 Hz), 9.60 (1H, brs), 9.94 (1H, brs), 10.22 (1H, brs)

### Reference Example 224

A compound I-(224) was obtained according to the same manner as that of Reference Example 93, using N-[4,6-dibromo-2-(hydrazinocarbonyl)phenyl]-4,5-dichloro-1-(3-chloro-2-pyridinyl)-1H-pyrrole-2-carboxamide in place of 4-bromo-N-[4-chloro-2-(hydrazinocarbonyl)-6-methylphenyl]-1-(3-chloro-2-pyridinyl)-1H-pyrrole-2-carboxamide and using propargyl chloroformate in place of methyl chloroformate.

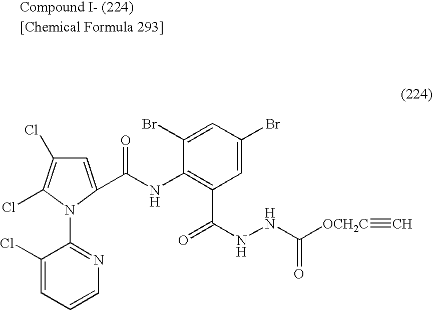

¹H-NMR (DMSO-d₆, TMS) δ(ppm): 3.55 (1H, s), 4.71 (2H, s), 7.44 (1H, s), 7.56-7.64 (2H, m), 8.10 (1H, s), 8.15 (1H, dd, J=8 Hz, 1 Hz), 8.51 (1H, dd, J=5 Hz, 1 Hz), 9.58 (1H, brs), 10.02 (1H, brs), 10.23 (1H, brs)

### Reference Example 225

A mixture of 0.10 g of 6,8-dibromo-2-[4-bromo-1-(3-chloro-2-pyridinyl)-1H-imidazol-2-yl]-4H-3,1-benoxazin-4-one, 0.16 g of methyl carbazate and 10 mL of N,N-dimethylformamide was stirred at room temperature for 1 day. The reaction mixture was poured into water, and then extracted with ethyl acetate three times. Organic layers were combined, washed sequentially with water and a saturated solution of sodium chloride in water, dried over anhydrous sodium sulfate, and concentrated under reduced pressure. The resulting residue was subjected to silica gel chromatography to obtain 0.080 g of a compound I-(225).

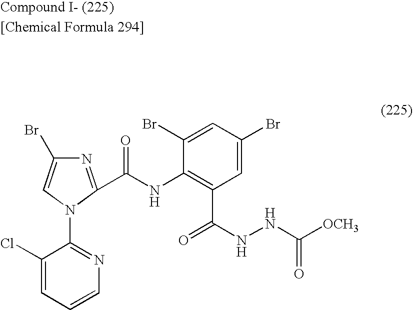

¹H-NMR (DMSO-d₆, TMS) δ(ppm): 3.63 (3H, s), 7.59 (1H, dd, J=8 Hz, 5 Hz), 7.90 (1H, s), 8.04 (1H, d, J=2 Hz), 8.11 (1H, d, J=8 Hz), 8.24 (1H, s), 8.49 (1H, d, J=5 Hz), 9.36 (1H, brs), 10.17 (1H, brs), 10.27 (1H, brs)

### Reference Example 226

A compound I-(226) was obtained according to the same manner as that of Reference Example 122, using 6,8-dibromo-2-[1-(3-chloro-2-pyridinyl)-5-methylsulfonyl-1H-pyrrol-2-yl]-4H-3,1-benzoxazin-4-one in place of 6,8-dibromo-2-[4-bromo-1-(3-chloro-2-pyridinyl)-1H-pyrrol-2-yl]-4H-3,1-benzoxazin-4-one.

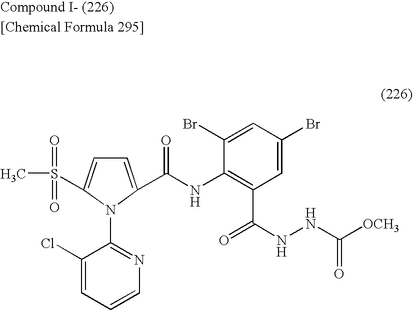

¹H-NMR (DMSO-d₆, TMS) δ(ppm): 3.27 (3H, s), 3.61 (3H, s), 7.11 (1H, d, J=4 Hz), 7.36 (1H, d, J=4 Hz), 7.53 (1H, dd, J=8 Hz, 5 Hz), 7.65 (1H, brs), 8.04 (1H, dd, J=8 Hz, 2 Hz), 8.12 (1H, d, J=2 Hz), 8.46 (1H, dd, J=5 Hz, 2 Hz), 9.36 (1H, brs), 10.16 (1H, brs), 10.22 (1H, brs)

### Reference Example 227

A compound I-(227) was obtained according to the same manner as that of Reference Example 122, using 6,8-dibromo-2-[1-(3-chloro-2-pyridinyl)-5-methylthio-1H-pyrrol-2-yl]-4H-3,1-benzoxazin-4-one in place of 6,8-dibromo-2-[4-bromo-1-(3-chloro-2-pyridinyl)-1H-pyrrol-2-yl]-4H-3,1-benzoxazin-4-one.

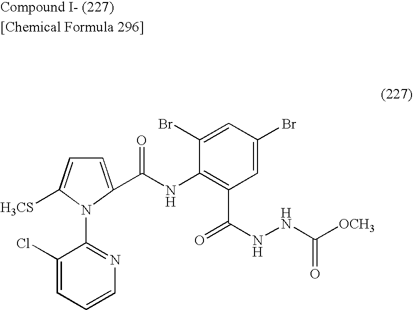

¹H-NMR (DMSO-d₆, TMS) δ(ppm): 2.25 (3H, s), 3.60 (3H, s), 6.52 (1H, d, J=4 Hz), 7.27 (1H, d, J=4 Hz), 7.49 (1H, dd, J=8 Hz, 5 Hz), 7.62 (1H, brs), 8.04 (1H, dd, J=8 Hz, 1 Hz), 8.07 (1H, d, J=2 Hz), 8.45 (1H, dd, J=5 Hz, 1 Hz), 9.34 (1H, brs), 9.77 (1H, brs), 10.10 (1H, brs)

### Reference Example 228

A compound I-(228) was obtained according to the same manner as that of Reference Example 72, using 6-chloro-2-{1-(3-chloro-2-pyridinyl)-3-[1,1,2-trifluoro-2-(trifluoromethoxy)ethoxy]-1H-pyrazol-5-yl}-8-methyl-4H-3,1-benzoxazin-4-one in place of 2-[3-bromo-1-(3-chloro-2-pyridinyl)-1H-pyrazol-5-yl]-8-chloro-4H-3,1-benzoxazin-4-one.

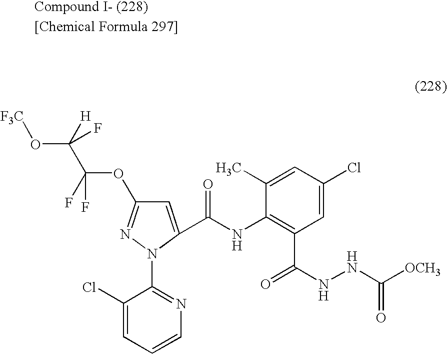

¹H-NMR (DMSO-d₆, TMS) δ(ppm): 2.16 (3H, s), 3.62 (3H, brs), 7.20 (1H, s), 7.37 (1H, dt, J=51 Hz, 4 Hz), 7.38 (1H, s), 7.55 (1H, s), 7.61 (1H, dd, J=8 Hz, 5 Hz), 8.17 (1H, d, J=8 Hz), 8.50 (1H, d, J=5 Hz), 9.32 (1H, s), 10.16 (1H, s), 10.30 (1H, s)

### Reference Example 229

A compound I-(229) was obtained according to the same manner as that of Reference Example 114, using 6-chloro-2-{1-(3-chloro-2-pyridinyl)-3-[1,1,2-trifluoro-2-(trifluoromethoxy)ethoxy]-1H-pyrazol-5-yl}-8-methyl-4H-3,1-benzoxazin-4-one in place of 2-[3-bromo-1-(3-chloro-2-pyridinyl)-1H-pyrazol-5-yl]-6-chloro-8-methyl-4H-3,1-benzoxazin-4-one.

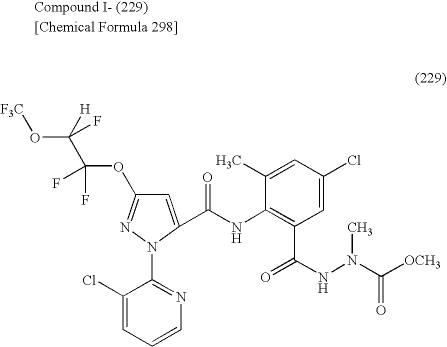

¹H-NMR (DMSO-d₆, TMS) δ(ppm): 2.22 (3H, s), 2.91 (3H, s), 3.47-3.68 (3H, brm), 7.24 (1H, s), 7.31 (1H, s), 7.37 (1H, dt, J=51 Hz, 4 Hz), 7.57 (1H, d, J=2 Hz), 7.61 (1H, dd, J=8 Hz, 5 Hz), 8.17 (1H, dd, J=8 Hz, 1 Hz), 8.48 (1H, dd, J=5 Hz, 1 Hz), 10.32 (1H, s), 10.53 (1H, s)

### Reference Example 230

A compound I-(230) was obtained according to the same manner as that of Reference Example 72, using 6-chloro-2-[1-(3-chloro-2-pyridinyl)-3-(trifluoromethylthio)-1H-pyrazol-5-yl]-8-methyl-4H-3,1-benzoxazin-4-one in place of 2-[3-bromo-1-(3-chloro-2-pyridinyl)-1H-pyrazol-5-yl]-8-chloro-4H-3,1-benzoxazin-4-one.

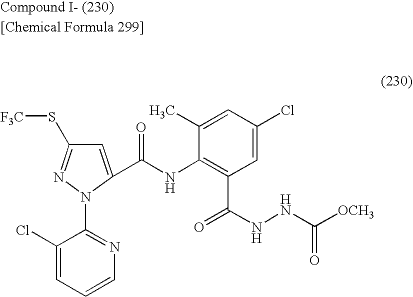

¹H-NMR (DMSO-d₆, TMS) δ(ppm): 2.15 (3H, s), 3.62 (3H, brs), 7.39 (1H, brs), 7.55 (1H, s), 7.62-7.68 (2H, m), 8.20 (1H, dd, J=8 Hz, 2 Hz), 8.52 (1H, dd, J=5 Hz, 2 Hz), 9.32 (1H, brs), 10.16 (1H, brs), 10.36 (1H, brs)

### Reference Example 231

Under ice-cooling, 0.50 g of 3-bromo-N-[4,6-dichloro-2-(N,N′-dimethylhydrazinocarbonyl)phenyl]-1-(3-chloro-2-pyridinyl)-1H-pyrazole-5-carboxamide, 0.18 g of methyl chloroformate, 0.16 g of pyridine and 10 mL of acetonitrile were mixed. The mixture was stirred for 3.5 hours under ice-cooling. Water was poured into the reaction mixture, followed by extraction with ethyl acetate. The organic layer was washed sequentially with water and a saturated solution of sodium chloride in water, dried over anhydrous magnesium sulfate, and concentrated under reduced pressure. The resulting residue was washed with a mixed solvent of methyl tert-butyl ether and hexane to obtain 0.47 g of a compound I-(231).

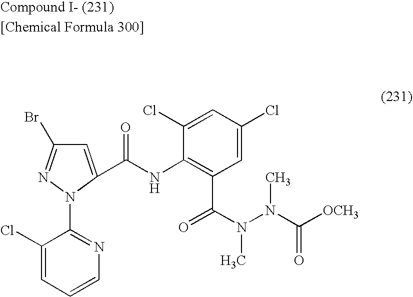

¹H-NMR (DMSO-d₆, TMS) δ(ppm): 2.73 (1.4H, s), 2.83 (1.6H, s), 2.95 (1.6H, s), 3.07 (1.4H, s), 3.49-3.68 (3.0H, m), 7.32-7.44 (2.0H, m), 7.62 (1.0H, dd, J=8 Hz, 5 Hz), 7.85 (0.5H, d, J=2 Hz), 7.92 (0.5H, s), 8.19 (1.0H, dd, J=8 Hz, 1 Hz), 8.49-8.52 (1.0H, m), 10.53 (0.5H, s), 10.71 (0.5H, s).

### Reference Example 232

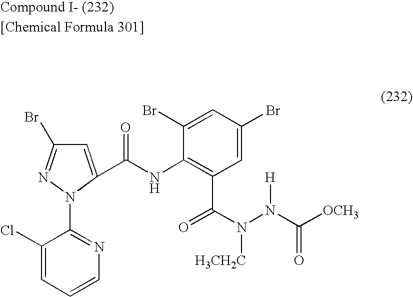

¹H-NMR (DMSO-d₆, TMS) δ(ppm): 0.86 (1.0H, t, J=7 Hz), 0.99 (2.0H, t, J=7 Hz), 3.10 (1.7H, brs), 3.50 (2.4H, s), 3.64 (0.6H, s), 3.85 (0.3H, brs), 7.36-7.44 (2.OH, m), 7.59-7.65 (1.0H, m), 8.07-8.21 (2.0H, m), 8.49-8.51 (1.0H, m), 9.04 (0.7H, brs), 9.71 (0.3H, brs), 10.30 (0.7H, brs), 10.66 (0.3H, brs)

### Reference Example 233

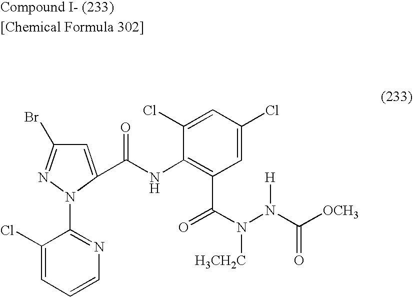

¹H-NMR (CDCl₃, TMS) δ(ppm): 1.03-1.07 (3.0H, m), 3.31-3.82 (5.0H, m), 7.23 (2.0H, s), 7.31 (1.0H, s), 7.39 (1.0H, dd, J=8, 5 Hz), 7.54 (1.0H, s), 7.87 (1.0H, dd, J=8, 1 Hz), 8.46 (1.0H, dd, J=5, 1 Hz), 9.65 (0.2H, brs), 9.86 (0.8H, brs)

Then, Formulation Examples will be explained.

### Formulation Example 1

### Emulsifiable Concentrate (1:1)

To a solution of 9 parts of the compound X and 9 parts of the compound I in 33.5 parts of xylene and 33.5 parts of dimethylformamide are added 10 parts of polyoxyethylene styryl phenyl ether and 5 parts of calcium dodecylbenzenesulfonate. The mixture is stirred well to obtain an emulsifiable concentrate.

### Formulation Example 2

### Wettable Powder (1:2)

To a mixture of 4 parts of sodium laurylsulfate, 2 parts of calcium ligninsulfonate, 20 parts of synthetic hydrous silicon oxide fine powder and 65 parts of diatomaceous earth are added 3 parts of the compound X and 6 parts of any one of compounds I-(1) to (233). The mixture is stirred well to obtain a wettable powder.

### Formulation Example 3

### Dust Formulation (8:1)

Four parts of the compound X, 0.5 parts of the compound I, 1 part of synthetic hydrous silicon oxide fine powder, 1 part of Driless B (manufactured by Sankyo) as an aggregating agent and 7 parts of clay are mixed well with a mortar, and then stirred and mixed with a juice mixer. To the mixture are added 86.5 parts of cut clay. The resulting mixture is stirred well to obtain a dust formulation.

### Formulation Example 4

### Flowable Formulation (4:1)

Five parts of polyoxyethylene styryl phenyl ether sulfate salt, 20 parts of a 1% solution of xanthan gum in water, 3 parts of a smectite mineral, and 62 parts of water are uniformly dissolved. To the solution are added 8 parts of the compound X and 2 parts of the compound I. The mixture is stirred well, and then wet-ground with a sand mill to obtain a flowable formulation.

### Formulation Example 5

### Microcapsule (2:1)

A mixture of 6 parts of the compound X, 3 parts of the compound I, 10 parts of phenylxylethane and 0.5 parts of Sumidur L-75 (tolylene diisocyanate manufactured by Sumitomo Bayer Urethane Co., Ltd.) is added to 20 parts of a 10% solution of gum arabic in water. The mixture is stirred with a homomixer to obtain an emulsion having an average particle diameter of 20 μm. To the emulsion is added 2 parts of ethylene glycol, and they are reacted in a warm bath at 60° C. for 24 hours to obtain microcapsule slurry. Separately, 0.2 parts of xanthan gum and 1 part of Beegum R (aluminum magnesium silicate manufactured by Sanyo Chemical Industries, Ltd.) are dispersed in 57.3 parts of ion-exchanged water to obtain a thickener solution.

Then, 42.5 parts of the microcapsule slurry and 57.5 parts of the thickener solution are mixed to obtain a 10% microcapsule.

### Formulation Example 6

### Oil Solution (3:1)

A solution of 0.6 parts of the compound X and 0.2 parts of the compound I in 5 parts of xylene and 5 parts of trichloroethane is mixed with 89.2 parts of deodorized kerosene to obtain an oil solution.

### Formulation Example 7

### Granule (2:1)

A mixture of 2 parts of the compound X, 1 part of the compound I, 5 parts of synthetic hydrous silicon oxide fine powder, 5 parts of sodium dodecylbenzenesulfonate, 30 parts of bentonite and 57 parts of clay is stirred well. To the mixture is added an appropriate amount of water. The resulting mixture is further stirred, subjected to size adjustment with a granulator, and dried by cross ventilation to obtain a granule.

### Formulation Example 8

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(5). The mixture is stirred well to obtain a wettable powder.

### Formulation Example 9

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(21). The mixture is stirred well to obtain a wettable powder.

### Formulation Example 10

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(34). The mixture is stirred well to obtain a wettable powder.

### Formulation Example 11

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(49). The mixture is stirred well to obtain a wettable powder.

### Formulation Example 12

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(56). The mixture is stirred well to obtain a wettable powder.

### Formulation Example 13

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(59). The mixture is stirred well to obtain a wettable powder.

### Formulation Example 14

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(68). The mixture is stirred well to obtain a wettable powder.

### Formulation Example 15

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(70). The mixture is stirred well to obtain a wettable powder.

### Formulation Example 16

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(74). The mixture is stirred well to obtain a wettable powder.

### Formulation Example 17

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(114). The mixture is stirred well to obtain a wettable powder.

### Formulation Example 18

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(115). The mixture is stirred well to obtain a wettable powder.

### Formulation Example 19

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(117). The mixture is stirred well to obtain a wettable powder.

### Formulation Example 20

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(119). The mixture is stirred well to obtain a wettable powder.

### Formulation Example 21

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(135). The mixture is stirred well to obtain a wettable powder.

### Formulation Example 22

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(138). The mixture is stirred well to obtain a wettable powder.

### Formulation Example 23

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(144). The mixture is stirred well to obtain a wettable powder.

### Formulation Example 24

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(154). The mixture is stirred well to obtain a wettable powder.

### Formulation Example 25

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(203). The mixture is stirred well to obtain a wettable powder.

### Formulation Example 26

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(204). The mixture is stirred well to obtain a wettable powder.

### Formulation Example 27

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(213). The mixture is stirred well to obtain a wettable powder.

### Formulation Example 28

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(231). The mixture is stirred well to obtain a wettable powder.

### Formulation Example 29

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(232). The mixture is stirred well to obtain a wettable powder.

### Formulation Example 30

To a mixture of 4 parts of sodium laurylsulfate, 2 parts of calcium ligninsulfonate, 20 parts of synthetic hydrous silicon oxide fine powder and 54 parts of diatomaceous earth are added 10 parts of the compound X and 10 parts of the compound I-(233). The mixture is stirred well to obtain a wettable powder.

The following Examples show that the composition of the present invention has efficacy in pest control.

### Test Example 1

Ten parts of the compound X was dissolved in 40 parts of xylene and 40 parts of N,N-dimethylformamide, and thereto was added 10 parts of Sorpol 3005X (manufactured by TOHO Chemical Industry Co., LTD.). The mixture was stirred well to prepare a formulation.

Separately, 10 parts of any one of the compound I-(5), the compound I-(34), the compound I-(68), the compound I-(70), the compound I-(74), the compound I-(115), the compound I-(117), the compound I-(119), the compound I-(204) and the compound I-(213) was dissolved in 40 parts of xylene and 40 parts of N,N-dimethylformamide, and thereto was added 10 parts of Sorpol 3005X (manufactured by TOHO Chemical Industry Co., LTD.). The mixture was stirred well to prepare a formulation.

The formulation of the compound X was diluted with water to a predetermined concentration (1000 ppm). To the water dilution was added the formulation of any one of the compound I-(5), the compound I-(34), the compound I-(68), the compound I-(70), the compound I-(74), the compound I-(115), the compound I-(117), the compound I-(119), the compound I-(204) and the compound I-(213) so that the concentration of the compound I became a predetermined concentration (400 ppm). To the resulting dilution was added 1/5000 by volume of a spreading agent (New Rinou manufactured by Nihon Nohyaku) to prepare a test diluted solution.

Separately, the formulation of of any one of the compound I-(5), the compound I-(34), the compound I-(68), the compound I-(70), the compound I-(74), the compound I-(115), the compound I-(117), the compound I-(119), the compound I-(204) and the compound I-(213) was diluted with water to a predetermined concentration (400 ppm). To the water dilution was added 1/5000 by volume of a spreading agent (New Rinou manufactured by Nihon Nohyaku) to prepare a test diluted solution. Similarly, to a water dilution of the formulation of the compound X with a predetermined concentration (1000 ppm) was added a spreading agent (New Rinou manufactured by Nihon Nohyaku) to prepare a test diluted solution.

On the other hand, 3 mL of 1% agar was put in a glass cup having an internal diameter of 2.6 cm and a height of 4.5 cm. A cabbage leaf disc was immersed in the test diluted solution for 30 seconds, and then placed on the agar. Then, about 20 imagoes of Bemisia tabaci were placed on the cabbage leaf disc. After 4 days, the life or death of the Bemisia tabaci imagoes was determined, and a controlling value was calculated by the following equation:

Controlling value (%)={1−(Cb×Tai)/(Cai×Tb)}×100

wherein
Cb: the number of insects in a non-treated section before treatment,
Cai: the number of insects in a non-treated section on observation,
Tb: the number of insects in a treated-section before treatment,
Tai: the number of insects in a treated section on observation.

Generally, a control effect expected from a treatment with a mixture of given two kinds of active ingredients can be obtained by the following Mathematical formula 1 which corresponds to a Colby's calculation formula:

[Mathematical formula 1]

E=X+Y−{(X×Y)/100}
X: Pest controlling value (%) obtained from a treatment with the active ingredient A alone at a concentration of m (ppm)
Y: Pest controlling value (%) obtained from a treatment with the active ingredient B alone at a concentration of n (ppm)
E: Pest controlling value (%) expected from a treatment with the active ingredient A at a concentration of m (ppm) and the active ingredient B at a concentration of n (ppm) (hereinafter, referred to as an “expected pest controlling value”).

Generally, when a pest controlling value (%) obtained from a treatment with a mixture of the active ingredient A and the active ingredient B is not smaller than the expected pest controlling value (%), it can be said that the combination of the active ingredients has no antagonistic effect on each other and has a mixed effect due to complementation of spectra or the like. It can be simply confirmed that the composition of the present invention has an excellent efficacy in pest control by carrying out the above-described test.

Results are shown in Table 1.

TABLE 1

| | Pest | Expected pest |
|---|---|---|
| | controlling | controlling value |
| | value (%) | (%) |
| compound X | 23 | |
| compound I-(5) | 100 | |
| compound I-(34) | 100 | |
| compound I-(68) | 95 | |
| compound I-(70) | 90 | |
| compound I-(74) | 100 | |
| compound I-(115) | 51 | |
| compound I-(117) | 86 | |
| compound I-(119) | 100 | |
| compound I-(204) | 100 | |
| compound I-(213) | 100 | |
| compound X + compound I-(5) | 100 | 100 |
| compound X + compound I-(34) | 100 | 100 |
| compound X + compound I-(68) | 100 | 96 |
| compound X + compound I-(70) | 100 | 93 |
| compound X + compound I-(74) | 100 | 100 |
| compound X + compound I-(115) | 100 | 63 |
| compound X + compound I-(117) | 93 | 89 |
| compound X + compound I-(119) | 100 | 100 |
| compound X + compound I-(204) | 100 | 100 |
| compound X + compound I-(213) | 100 | 100 |

### Test Example 2

Ten parts of the compound I-(138) was dissolved in 40 parts of xylene and 40 parts of N,N-dimethylformamide, and thereto was added 10 parts of Sorpol 3005X (manufactured by TOHO Chemical Industry Co., LTD.). The mixture was stirred well to prepare a formulation.

The formulation of the compound X prepared in Test Example 1 was diluted with water to a predetermined concentration (2000 ppm). To the water dilution was added the formulation of the compound I-(138) so that the concentration of the compound I became a predetermined concentration (800 ppm). To the resulting dilution was added 1/5000 by volume of a spreading agent (New Rinou manufactured by Nihon Nohyaku) to prepare a test diluted solution.

Separately, the formulation of the compound I-(138) was diluted with water to a predetermined concentration (800 ppm). To the water dilution was added 1/5000 by volume of a spreading agent (New Rinou manufactured by

Nihon Nohyaku) to prepare a test diluted solution. Similarly, to a water dilution of the formulation of the compound X with a predetermined concentration (2000 ppm) was added a spreading agent (New Rinou manufactured by Nihon Nohyaku) to prepare a test diluted solution.

On the other hand, 3 mL of 1% agar was put in a glass cup having an internal diameter of 2.6 cm and a height of 4.5 cm. A cabbage leaf disc was immersed in the test diluted solution for 30 seconds, and then placed on the agar. Then, about 20 imagoes of Bemisia tabaci were placed on the cabbage leaf disc. After 2 days, the life or death of the Bemisia tabaci imagoes was determined, and a controlling value was calculated by the above-described equation.

Results are shown in Table 2.

TABLE 2

| | Pest | Expected pest |
|---|---|---|
| | controlling | controlling value |
| | value (%) | (%) |
| compound X | 75 | |
| compound I-(138) | 33 | |
| compound X + compound I- | 100 | 83 |
| (138) | | |

### Test Example 3

Ten parts of the compound I-(232) was dissolved in 40 parts of xylene and 40 parts of N,N-dimethylformamide, and thereto was added 10 parts of Sorpol 3005X (manufactured by TOHO Chemical Industry Co., LTD.). The mixture was stirred well to prepare a formulation.

The formulation of the compound X prepared in Test Example 1 was diluted with water to a predetermined concentration (1000 ppm). To the water dilution was added the formulation of the compound I-(232) so that the concentration of the compound I became a predetermined concentration (400 ppm). To the resulting dilution was added 1/5000 by volume of a spreading agent (New Rinou manufactured by Nihon Nohyaku) to prepare a test diluted solution.

Separately, the formulation of the compound I-(232) was diluted with water to a predetermined concentration (400 ppm). To the water dilution was added 1/5000 by volume of a spreading agent (New Rinou manufactured by Nihon Nohyaku) to prepare a test diluted solution.

A test was carried out as in Test Example 1. After 4 days, the life or the death of the parasitized Bemisia tabaci imagoes was determined, and a controlling value was calculated. As a result, a controlling value obtained from a treatment with the test diluted solution containing the compound X and the compound I-(232) was more than an expected controlling value calculated from a controlling value of a treatment with a test diluted solution containing the compound X or the compound I-(233) alone.

### INDUSTRIAL APPLICABILITY

According to the present invention, a pest controlling composition having an excellent efficacy in pest control can be provided.

1. A pest controlling composition which comprises, as active ingredients, a pyrimidine compound represented by the formula (X): 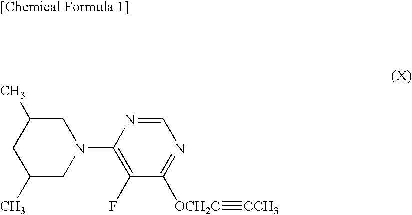
and a hydrazide compound represented by the formula (I): 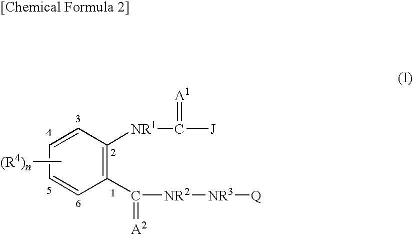
wherein
R¹ represents a hydrogen atom, an optionally halogenated C1-C6 alkyl group, a C2-C6 cyanoalkyl group, an optionally halogenated C2-C6 alkoxyalkyl group, an optionally halogenated C2-C6 alkenyl group, an optionally halogenated C3-C6 alkynyl group, or a C7-C9 phenylalkyl group in which the benzene ring moiety may be substituted with the following substituent A;
R² and R³ independently represent a hydrogen atom, a C1-C6 alkyl group optionally substituted with the following substituent D, an optionally halogenated C3-C6 alkenyl group, an optionally halogenated C3-C6 alkynyl group, a formyl group, a C2-C6 alkylcarbonyl group, a C2-C6 alkoxycarbonyl group, a C3-C7 N,N-dialkylcarbamoyl group, or a phenyl group optionally substituted with the following substituent C, or
R² and R³ may be taken together with two nitrogen atoms to which they are attached to form a 5- to 8-membered non-aromatic heterocyclic group optionally substituted with the following substituent E;
R⁴ represents a halogen atom, a cyano group, a nitro group, an optionally halogenated C1-C6 alkyl group, an optionally halogenated C1-C6 alkoxy group, an optionally halogenated phenyl group, an optionally halogenated C1-C6 alkylthio group, an optionally halogenated C1-C6 alkylsulfinyl group, or an optionally halogenated C1-C6 alkylsulfonyl group, or
two R⁴ groups which respectively form a bond to one of carbon atoms adjacent to each other may bond to one another at their terminals to form —CR⁴¹═CR⁴²—CR⁴³═CR⁴⁴— or —(CR⁴⁵R⁴⁶)ₕ— (wherein R⁴¹, R⁴², R⁴³ and R⁴⁴ independently represent a hydrogen atom, a halogen atom, a cyano group, a nitro group, an optionally halogenated C1-C6 alkyl group, an optionally halogenated C1-C6 alkoxy group, an optionally halogenated C1-C6 alkylthio group, an optionally halogenated C1-C6 alkylsulfinyl group, or an optionally halogenated C1-C6 alkylsufonyl group;
R⁴⁵ and R⁴⁶ independently represent a hydrogen atom, or an optionally halogenated C1-C6 alkyl group,
h represents an integer of 3 or 4);
n represents an integer of 0 to 4 (wherein, when n is an integer of 2 or more, R⁴'s may be the same or different);
Q represents any one of Q1 to Q6
[Chemical Formula 3]
Q1: —C(=A³¹)—R⁵
Q2: —C(=A³²)—OR⁶
Q3: —C(=A³³)—SR⁷
Q4: —C(=A³⁴)—NR⁸R⁹
Q5: —S(O)₂—R¹⁰
Q6: —S(O)₂—NR¹¹R¹²;
A³¹, A³², A³³ and A³⁴ represent an oxygen atom or a sulfur atom;
R⁵ represents a hydrogen atom, an optionally halogenated C2-C6 alkenyl group, an optionally halogenated C2-C6 alkynyl group, a C1-C6 alkyl group optionally substituted with the following substituent F, a C3-C6 cycloalkyl group optionally substituted with the following substituent B, a phenyl group optionally substituted with the following substituent G, a naphthyl group optionally substituted with the following substituent A, a 5- to 6-membered heteroaryl group optionally substituted with the following substituent A, a 3- to 8-membered nonaromatic heterocyclic group optionally substituted with the following substituent B, a C7-C9 phenylalkyl group in which the benzene ring moiety may be substituted with the following substituent A, or a C7-C9 phenoxyalkyl group in which the benzene ring moiety may be substituted with the following substituent A;
R⁶ and R⁷ represent an optionally halogenated C1-C6 alkyl group, an optionally halogenated C3-C6 alkoxyalkyl group, an optionally halogenated C2-C6 alkenyl group, an optionally halogenated C3-C6 alkynyl group, a C3-C6 cycloalkyl group optionally substituted with the following substituent B, a phenyl group optionally substituted with the following substituent G, a 5- to 6-membered heteroaryl group optionally substituted with the following substituent A, or a C7-C9 phenylalkyl group in which the benzene ring moiety may be substituted with the following substituent A;
R⁸ and R⁹ independently represent a hydrogen atom, an optionally halogenated C1-C6 alkyl group, an optionally halogenated C2-C6 alkoxyalkyl group, an optionally halogenated C2-C6 alkenyl group, an optionally halogenated C3-C6 alkynyl group, a C3-C6 cycloalkyl group optionally substituted with the following substituent B, a phenyl group optionally substituted with the following substituent G, a 5- to 6-membered heteroaryl group optionally substituted with the following substituent A, or a C7-C9 phenylalkyl group in which the benzene ring moiety may be substituted with the following substituent A;
R¹⁰ represents an optionally halogenated C1-C6 alkyl group, or a phenyl group optionally substituted with the following substituent A;
R¹¹ and R¹² independently represent an optionally halogenated C1-C6 alkyl group, a C3-C6 cycloalkyl group optionally substituted with the following substituent B, or a phenyl group optionally substituted with the following substituent A, or
R¹¹ and R¹² may be taken together with the nitrogen atom to which they are attached to form a 3- to 8-membered nonaromatic heterocyclic group optionally substituted with the following substituent E;
J represents J1 or J2, 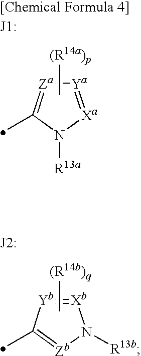
X^{a}, Y^{a}, Z^{a}, X^{b}, Y^{b} and Z^{b} independently represent CH or a nitrogen atom;
R^{13a} and R^{13b} represent an optionally halogenated C1-C6 alkyl group, a C2-C6 cyanoalkyl group, an optionally halogenated C2-C6 alkoxyalkyl group, an optionally halogenated C2-C6 alkenyl group, an optionally halogenated C2-C6 alkynyl group, a C3-C6 cycloalkyl group optionally substituted with the following substituent B, a phenyl group optionally substituted with the following substituent H, a 5- to 6-membered heteroaryl group optionally substituted with the following substituent A, a C7-C9 phenylalkyl group in which the benzene ring moiety may be substituted with the following substituent A, or a C7-C9 pyridinylalkyl group in which the pyridine ring moiety may be substituted with the following substituent A;
R^{14a} and R^{14b} represent a halogen atom, a cyano group, a nitro group, an isocyanato group, an optionally halogenated C1-C6 alkyl group, an optionally halogenated C1-C6 alkoxy group, a C2-C6 cyanoalkyloxy group, an optionally halogenated C3-C6 alkoxyalkyloxy group, an optionally halogenated C3-C6 alkenyloxy group, an optionally halogenated C3-C6 alkynyloxy group, an optionally halogenated C1-C6 alkylthio group, an optionally halogenated C1-C6 alkylsulfinyl group, an optionally halogenated C1-C6 alkylsulfonyl group, a phenyl group optionally substituted with the following substituent A, a 5- to 6-membered heteroaryl group optionally substituted with the following substituent A, or a phenoxy group optionally substituted with the following substituent A;
p represents an integer of 0 to 3;
q represents an integer of 0 to 3
(wherein, when p is an integer of 2 or 3, two or more R^{14a}'s may be the same or different and, when q is an integer of 2 or 3, two or more R^{14b}'s may be the same or different); and
A¹ and A² independently represent an oxygen atom or a sulfur atom; wherein,
the substituent A is a substituent selected from the group consisting of (1) a halogen atom, (2) a cyano group, (3) a nitro group, (4) an optionally halogenated C1-C6 alkyl group, and (5) an optionally halogenated C1-C6 alkoxy group;
the substituent B is a substituent selected from the group consisting of (1) a halogen atom and (2) an optionally halogenated C1-C6 alkyl group;
the substituent C is a substituent selected from the group consisting of (1) a halogen atom, (2) a cyano group, (3) a nitro group and (4) an optionally halogenated C1-C6 alkyl group;
the substituent D is a substituent selected from the group consisting of (1) a halogen atom, (2) a cyano group, (3) a nitro group, (4) an optionally halogenated C1-C6 alkoxy group, (5) a formyl group, (6) a C2-C6 alkylcarbonyl group, (7) a C2-C6 alkoxycarbonyl group and (8) a C3-C7 N,N-dialkylcarbamoyl group;
the substituent E is a substituent selected from the group consisting of (1) a halogen atom, (2) an optionally halogenated C1-C6 alkyl group and (3) an optionally halogenated C2-C6 alkoxycarbonyl group;
the substituent F is a substituent selected from the group consisting of (1) a halogen atom, (2) a C1-C6 alkoxy group, (3) a C1-C6 alkylthio group, (4) a C1-C6 alkylsulfinyl group, (5) a C1-C6 alkylsulfonyl group, (6) a C2-C6 dialkylamino group and (7) a C3-C6 cycloalkyl group;
the substituent G is a substituent selected from the group consisting of (1) a halogen atom, (2) a cyano group, (3) a nitro group, (4) an optionally halogenated C1-C6 alkyl group, (5) an optionally halogenated C1-C6 alkoxy group, (6) an optionally halogenated C1-C6 alkylthio group, (7) an optionally halogenated C1-C6 alkylsulfinyl group, (8) an optionally halogenated C1-C6 alkylsulfonyl group, (9) an optionally halogenated C2-C6 dialkylamino group and (10) an optionally halogenated C2-C6 alkoxycarbonyl group; and
the substituent H is a substituent selected from the group consisting of (1) a halogen atom, (2) a cyano group, (3) a nitro group, (4) an optionally halogenated C1-C6 alkyl group, (5) an optionally halogenated C1-C6 alkoxy group, (6) an optionally halogenated C1-C6 alkylthio group, (7) an optionally halogenated C1-C6 alkylsulfinyl group and (8) an optionally halogenated C1-C6 alkylsulfonyl group.

2. The pest controlling composition according to claim 1, wherein in the formula (I),
R¹ is a hydrogen atom, or an optionally halogenated C1-C6 alkyl group; R² is a hydrogen atom or a C1-C6 alkyl group optionally substituted with the substituent D, and R³ is a hydrogen atom, an optionally halogenated C1-C6 alkyl group, or a C2-C6 alkoxycarbonyl group, or R² and R³ are taken together with two nitrogen atoms to which they are attached to form a 5- to 8-membered nonaromatic heterocyclic group; R⁴ is a halogen atom, a cyano group, an optionally halogenated C1-C6 alkyl group, an optionally halogenated C1-C6 alkoxy group or an optionally halogenated phenyl group, or two R⁴ groups which respectively form a bond to one of carbon atoms adjacent to each other may bond to one another at their terminals to form —CH═CH—CH═CH—; n is an integer of 0 to 3; Q is any one of Q1 to Q6; A³¹, A³² and A³³ are an oxygen atom; A³⁴ is an oxygen atom or a sulfur atom; R⁵ is a hydrogen atom, a C1-C6 alkyl group optionally substituted with the substituent F, a C3-C6 cycloalkyl group optionally substituted with the substituent B, a phenyl group optionally substituted with the substituent G, a 5- to 6-membered heteroaryl group optionally substituted with the substituent A, or a 3- to 8-membered nonaromatic heterocyclic group optionally substituted with the substituent B; R⁶ is an optionally halogenated C1-C6 alkyl group, an optionally halogenated C2-C6 alkynyl group, or a phenyl group optionally substituted with the substituent G; R⁷ is an optionally halogenated C1-C6 alkyl group; R⁸ and R⁹ are independently a hydrogen atom, an optionally halogenated C1-C6 alkyl group, or a phenyl group optionally substituted with the substituent G; R¹⁰ is an optionally halogenated C1-C6 alkyl group; R¹¹ and R¹² are independently an optionally halogenated C1-C6 alkyl group; J is J1 or J2; X^{a} is CH or a nitrogen atom; Y^{a} is CH; Z^{a} is CH or a nitrogen atom; X^{b} is CH or a nitrogen atom; Y^{b} is CH; Z^{b} is CH or a nitrogen atom; R^{13a} is an optionally halogenated C1-C6 alkyl group, a C3-C6 cycloalkyl group optionally substituted with the substituent B, a phenyl group optionally substituted with the substituent H, or a 5- to 6-membered heteroaryl group optionally substituted with the substituent A; R^{13b} is an optionally halogenated C1-C6 alkyl group; R¹⁴ is a halogen atom, a cyano group, an optionally halogenated C1-C6 alkyl group, an optionally halogenated C1-6 alkylthio group, an optionally halogenated C1-C6 alkylsulfinyl group, an optionally halogenated C1-C6 alkylsulfonyl group, or a phenyl group optionally substituted with the substituent A; R^{14b} is an optionally halogenated C1-C6 alkyl group, or a phenyl group optionally substituted with the substituent A; p is an integer of 0 to 2 (wherein, when p is 2, two R^{14a}'s may be the same or different); q is 1; and A¹ and A² are an oxygen atom.

3. The pest controlling composition according to claim 1, wherein in the formula (I),
R¹ is a hydrogen atom, or an optionally halogenated C1-C6 alkyl group; R² is a hydrogen atom, or an optionally halogenated C1-C6 alkyl group; R³ is a hydrogen atom, an optionally halogenated C1-C6 alkyl group, or a C2-C6 alkoxycarbonyl group; R⁴ is a halogen atom, a cyano group, an optionally halogenated C1-C6 alkyl group, an optionally halogenated C1-C6 alkoxy group or an optionally halogenated phenyl group, or two R⁴ groups which respectively form a bond to one of carbon atoms adjacent to each other may bond to one another at their terminals to form —CH═CH—CH═CH—; n is an integer of 0 to 3; Q is any one of Q1 to Q4; A³¹, A³², A³³ and A³⁴ are an oxygen atom; R⁵ is a hydrogen atom, a C1-C6 alkyl group optionally substituted with the substituent F, a C3-C6 cycloalkyl group optionally substituted with the substituent B, a phenyl group optionally substituted with the substituent G, a 5- to 6-membered heteroaryl group optionally substituted with the substituent A, or a 3- to 8-membered nonaromatic heterocyclic group optionally substituted with the substituent B; R⁶ is an optionally halogenated C1-C6 alkyl group, an optionally halogenated C2-C6 alkenyl group, or a phenyl group optionally substituted with the substituent G; R⁷ is an optionally halogenated C1-C6 alkyl group; R⁸ and R⁹ are independently a hydrogen atom, an optionally halogenated C1-C6 alkyl group, or a phenyl group optionally substituted with the substituent G; J is J1; X^{a} is CH or a nitrogen atom; Y^{a} is CH; Z^{a} is CH; R^{13a} is a 5- to 6-membered heteroaryl group optionally substituted with the substituent A; R^{14a} is a halogen atom, a cyano group, or an optionally halogenated C1-C6 alkyl group; p is an integer of 0 to 1; and A¹ and A² are an oxygen atom.

4. The pest controlling composition according to claim 1, wherein the hydrazide compound represented by the formula (I) is a hydrazide compound represented by the formula (I-o): 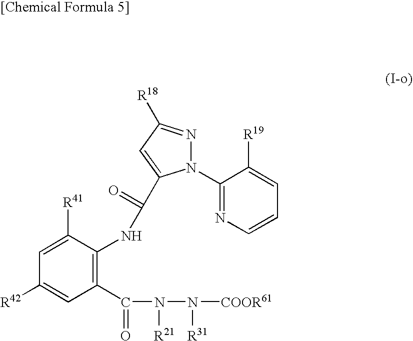
wherein R²¹ and R³¹ independently represent a hydrogen atom or a C1-C6 alkyl group,
R⁶¹ represents a C1-C6 alkyl group,
R⁴¹ represents a halogen atom or a C1-C6 alkyl group,
R⁴² represents a halogen atom or a cyano group,
R¹⁸ represents a halogen atom or an optionally halogenated C1-C6 alkyl group, and
R¹⁹ represents a halogen atom.

5. The pest controlling composition according to claim 4, wherein in the formula (I-o), R²¹ and R³¹ are independently a hydrogen atom, a methyl group or an ethyl group, R⁶¹ is a methyl group, R⁴¹ is a chlorine atom, a bromine atom or a methyl group, R⁴² is a chlorine atom, a bromine atom or a cyano group, R¹⁸ is a chlorine atom, a bromine atom or a trifluoromethyl group, and R¹⁹ is a chlorine atom.

6. The pest controlling composition according to any one of claims 1 to 5, wherein the weight ratio of the pyrimidine compound represented by the formula (X) and the hydrazide compound represented by the formula (I) is in a range of 25:1 to 1:250.

7. A method for controlling pests, which comprises applying the pest controlling composition according to claim 1 to the pests or a place where the pests inhabit.

8. A method for controlling pests, which comprises applying the pyrimidine compound represented by the formula (X) and the hydrazide compound represented by the formula (I) to the pests or a place where the pests inhabit.
